(19) United States
(12) Patent Application Publication
(10) Pub. No.: US 2023/0226536 A1
(43) Pub. Date: Jul. 20, 2023

(54) SELECTION OF A HETEROGENEOUS CATALYSTS WITH METALLIC SURFACE STATES

(71) Applicants: MAX PLANCK GESELLSCHAFT ZUR FÖRDERUNG DER WISSENSCHAFTEN EV, München (DE); THE TRUSTEES OF PRINCETON UNIVERSITY, Princeton, NJ (US)

(72) Inventors: Yuanfeng XU, Halle (DE); Claudia FELSER, Halle (DE); Guowei LI, Dresden (DE); Chenguang FU, Dresden (DE); Yan SUN, Dresden (DE); Bogdan Andrei BERNEVIG, Lawrence Township, NJ (US); Zhida SONG, Plainsboro Township, NJ (US)

(73) Assignees: MAX PLANCK GESELLSCHAFT ZUR FÖRDERUNG DER WISSENSCHAFTEN EV, München (DE); THE TRUSTEES OF PRINCETON UNIVERSITY, Princeton, NJ (US)

(21) Appl. No.: 18/009,434

(22) PCT Filed: Jun. 10, 2020
(86) PCT No.: PCT/EP2020/066076

§ 371 Date: Dec. 9, 2022

(51) Int. Cl. B01J 37/03; B01J 37/00

(52) U.S. Cl. CPC B01J 37/031; B01J 37/0009

(57) ABSTRACT

A method for controllably making catalysts with at least one metallic surface state, that includes:
a) identifying all the topological insulators in the ICSD,
b) calculating the Real Space Invariants of the valence bands for all these topological insulators in order to
c) identify in all these topological insulators the Wyckoff Positions where the irreducible Wannier Charge Centers (WCCs) are localized, and then
d) selecting as potentially catalytic active compound a topological insulator in which the position of WCCs is not occupied by any atom;
e) synthesizing a crystal of the selected potentially catalytic active compound either so that it is grown in a predefined crystallographic direction (characterized by its Miller indices (h,k,l)) which exposes the metallic surface state; or cutting the crystal in a predefined crystallographic direction (characterized by its Miller indices (h,k,l)), so that the metallic surface state is exposed
when

$$( ( \{ \begin{matrix}( h , k , l ) \cdot ( x - {X}_{j} , y - {Y}_{j} , z - {Z}_{j} ) = 0 , \\ ( h , k , l ) \cdot ( x - {x}_{i} , y - {y}_{i} , z - {z}_{i} ) \neq 0 , \\ h , k , l ϵ Z\end{matrix} ) )$$

### BACKGROUND

Heterogeneous catalysis reactions like photocatalytic/electrochemical water splitting (HER/OER), ammonia synthesis, CO₂ reduction, and oxygen reduction reaction (ORR) in fuel cells, are getting increasing attention because of their advantages in facing the energy crisis and environmental issues. With the aid of these technologies, hydrogen can be produced from water and then used directly in fuel cells without any emission of pollutants. CO₂ and N₂ can be transformed into specific carbon products or ammonia, which are important for industry and fertilizers. Unfortunately, all these reactions require that the corresponding catalysts lower the activation energy for scalable production. The design of and search for high-performance catalysts are strongly dependent on the understanding of the catalysis reaction details and the physical properties of the catalysts. At present, d-band theory (J. Nørskov, et al. PNAS, 2011, 108, 937; L. Pettersson, et al., Top. Catal. 2014, 57, 2) has had great success in explaining of the catalytic efficiency of a selected catalyst. Within the framework of d-band theory, the reaction kinetics is determined by the adsorption energy between the reaction intermediates and catalyst active sites. However, a fundamental and unanswered question is why the adsorption energy is different for different crystal surfaces of a same catalyst, and how one can identify the active sites for a selected catalyst.

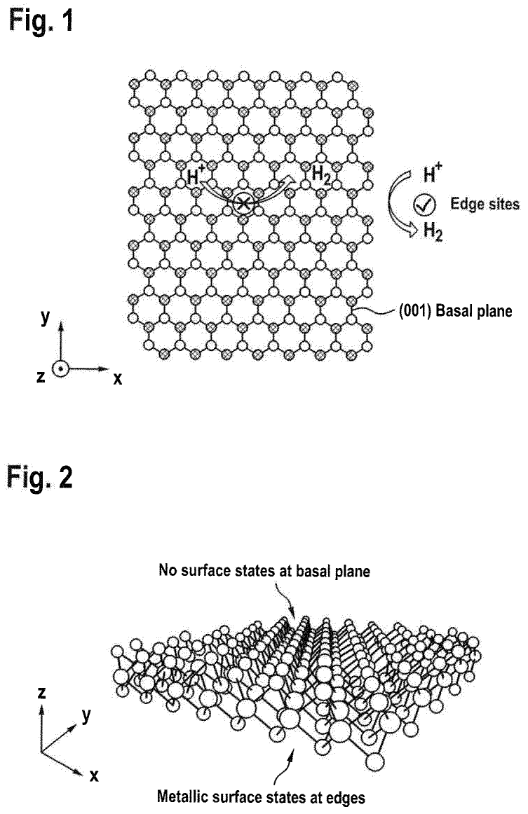

Transition metal dichalcogenides such as MoS₂ are potential alternatives to noble-metal based catalysts because of their high catalytic efficiency and stability. It is experimentally very well proven that the (001) basal plane of a MoS₂ crystal is inert for the catalytic process of the photocatalytic/electrochemical water splitting reaction. It is the edges of the crystal which serve as active sites (see FIG. 1). Only if defects such as elemental vacancies are introduced into the basal plane, the basal plane can be activated for catalysis. The same phenomenon is observed in other materials such as PtSe₂, PtTe₂, and PdTe₂. However, it is still not clear why the catalytic efficiency is markedly different at different crystal surfaces of the same catalyst and what the factor is that determines the adsorption energy. This is of great importance to the design of new high-performance catalysts.

### PRIOR ART

US20140353166A1 discloses a method for scalable synthesis of molybdenum disulfide monolayer and few-layer films. When deposited on SiO₂/Si substrates and used as electrocatalyst for hydrogen evolution, they exhibit high efficiency with large exchange current densities and low Tafel slopes. The reference states that the mono and few-layer films have more active sites than nanoparticles and bulk phase.

WO2018165449A1 discloses the formation of molybdenum disulfide nanosheets on a carbon fiber substrate. These nanosheets have a plurality of catalytically active edge sites along basal planes and show good activity towards hydrogen evolution.

JP2009252412A relates to the use of RuTe₂ as an active ingredient for direct methanol fuel cells. The fuel cell with RuTe₂ as a catalyst can be used for portable electrical products.

M. Asadi, K. Kim, C. Liu, A. V. Addepalli, P. Abbasi, P. Yasaei, P. Phillips, A. Behranginia, J. M. Cerrato, R. Haasch, P. Zapol, B. Kumar, R. F. Klie, J. Abiade, L. A. Curtiss, A. Salehi-Khojin (Science, 2016, 353, 467) report that nanostructured transition metal dichalcogenides such as MoS₂, WS₂, MoSe₂, and WSe₂ are excellent electrocatalysts for CO₂ reduction. The authors found that the metallic edge sites of the nanoflakes are active centers because of the strong binding to CO molecules.

C. Tsai, K. Chan, F. Abild-Pedersen, J. K. Nørskov (Phys. Chem. Chem. Phys. 2014, 16, 13156); T. F. Jaramillo, K. P. Jørgensen, J. Bonde, J. H. Nielsen, S. Horch, Ib Chorkendorff (Science, 2007, 317, 100); R. Abinaya J. Archana, S. Harish, M. Navaneethan, S. Ponnusamy, C. Muthamizhchelvan, M. Shimomura and Y. Hayakawa (RSC Adv., 2018, 8, 26664) report that the photocatalytic and electrochemical efficiency of transition metal dichalcogenides (MoS₂) is correlated to the number of edge sites of the crystal, while the (001) basal plane of MoS₂ crystal is inert towards hydrogen evolution.

H. Li, M. Du, M. J. Mleczko, A. Koh, Y. Nishi, E. Pop, A. J. Bard, and X. Zheng (J. Am. Chem. Soc. 2016, 138, 5123); S. Kang, S. Han, Y. Kang (ChemSusChem, 2019, 12, 2671); L. Zeng, S. Chen, J. van der Zalm, X. Li, A. Chen (Chem. Commun., 2019, 55, 7386) found that by introducing sulfur vacancies in the (001) basal plane of MoS₂ crystals, the catalytic activity of MoS₂ can be boosted in the hydrogen evolution reaction, CO₂ reduction, and NH₃ synthesis.

A. Politano, G. Chiarello, C. Kuo, C. Lue, R. Edla, P. Torelli, V. Pellegrini, D. W. Boukhvalov (Adv. Funct. Mater. 2018, 28, 1706504); H. Huang, X. Fan, D. J. Singh, and W. Zheng (ACS Omega 2018, 3, 10058) found that the pristine surface of layered transition-metal dichalcogenides (PtSe₂, PtTe₂) are chemically inert toward most common ambient gases, including O₂, H₂O, and even in the air. However, by doping or introducing selenium or tellurium vacancies, a large density of active sites can be created in the (001) basal plane for water splitting and water-gas shift reaction.

Despite all these efforts, it is still not understood what the active site(s) is/are for the various catalytic processes. For example, it is not understood why the adsorption energy can be altered significantly by introducing defects such as vacancies. The answer to these questions is very important for the design of high-performance catalysts with controllable active sites for a given heterogeneous reaction.

### OBJECT OF THE INVENTION

It is, therefore, an object of the invention to provide
a method for controllably making catalysts with active surface site(s), and/or
a method for improving the efficiency of a known catalysts which has hitherto not been made available with access to its most active surface site(s);
catalysts exhibiting active surface site(s), determined by the above method.

### BRIEF DESCRIPTION OF THE INVENTION

The above object is achieved by selecting from the Inorganic Crystal Structure Database, FIZ Karlsruhe, Germany (ICSD, https://icsd.fiz-karlsruhe.de) those topological insulators, specifically topological trivial insulators, wherein the position of WCCs (Wannier Charge Centers) is not occupied by an atom. These compounds are characterized by a metallic surface state at a predefined specified crystal surface determined by the method according to the present invention. In order to expose the metallic surface state to a potential reactant for photocatalytic/electrochemical reaction a crystal of the selected insulator compound is cut or grown in a predefined crystallographic direction (characterized by its Miller index (h,k,l)).

It has been found that a given obstructed atomic insulator (OAI) with atoms sitting at WP_{occ}={xᵢ,yᵢ,zᵢ|i∈occupied position} and obstructed WCCs localized at WP_{OAI}={Xⱼ, Yⱼ, Zⱼ|j∉occupied position} has metallic surface states on surface planes characterized by the equation f(x, y, z)=0 with Miller index (or normal vector) (h,k,l) when it satisfies the following conditions:

$$\{ \begin{matrix}( h , k , l ) \cdot ( x - {X}_{j} , y - {Y}_{j} , - {Z}_{j} ) = 0 , \\ ( h , k , l ) \cdot ( x - {x}_{i} , y - {y}_{i} , z - {z}_{i} ) \neq 0 , \\ h , k , l ϵ Z\end{matrix}$$

This means that the surface plane f(x, y, z)=0 with normal vector (h,k,l) cuts through the position of obstructed WCCs (Xⱼ, Yⱼ, Zⱼ), but stays away from the atoms' positions (xᵢ, yᵢ, zᵢ).

Topological trivial insulators, i.e. those insulators without topological electronic structures, are characterized by an indirect band gap (of about 0.001-7.000 eV) in the bulk with different crystal momentum (k-vector) for the conduction and valence band. Using the Topological quantum chemistry theory (Nature 547.7663 (2017): 298-305), and the Real Space Invariants (RSI) disclosed in “Science 367 (6479), 794-797 (2020)”, it was found that some of the topological insulators, specifically topological trivial insulators, have crystalline symmetry-protected metallic surface states on certain crystallographic surfaces and that these metal surface states can explain the catalytic performance.

Thus, the present invention can provide new and/or improved catalysts, especially for photocatalytic/electrochemical reactions, such as water splitting (Oxygen Evolution Reaction, OER, or Hydrogen Evolution Reaction, HER), ammonia synthesis, CO₂ reduction, and oxygen reduction reaction (ORR) in fuel cells.

### DETAILED DESCRIPTION OF THE INVENTION

It was found that the active sites for heterogeneous reactions are metallic surface states, localized at/on specific crystallographic surfaces, characterized by their surface normal expressed as (h,k,l)-index (Miller index). The metallic surface states can be imagined as “dangling bonds” which extend from the catalyst's surface and which cause metallic conductivity. Inside the crystal body of a catalytic compound (the bulk) all bonds are saturated; the atomic orbitals (AOs) of the elements, which make up the catalytic compound, overlap each other, thereby forming molecular orbitals (MOs) with joint electrons. However, at the boundaries of the crystal certain atomic orbitals have no corresponding binding partner for forming a MO; they remain “unsaturated” and extend beyond the crystal boundary as “dangling bond”. Of course, the metallic surface states, or “dangling bonds”, can also be created through the introduction of defects in the crystal structure, such as elemental vacancies. It was found that the above-defined metal surface states increase catalytic efficiency. Thus, with the knowledge of the above finding one can
a) explain the catalytic efficiency of known catalytic compounds,
b) turn a given compound, which has yet uncovered catalytic potential, into an efficient catalyst by cutting or growing a crystal of this potential catalytic material in a predefined crystallographic direction (characterized by its surface normal, expressed in Miller indices (h,k,l)), thereby revealing the metal surface states. The direction is determined by the crystal surface with metallic surface states, which can be calculated (see below) or obtained from the below material list
c) eventually improve the catalytic efficiency of known catalytic compounds with method b),
d) screen known compounds for catalytic material, and/or
e) provide a list of compounds that can be used as catalysts.

As used herein the following terms have the following meaning:

“Surface properties” means the bonding and electronic structures at the surface of a crystal.

“Topological trivial insulator” means an insulator according to the traditional definition, i.e. one that has no topological feature(s) such as band inversion between conduction and valence band. Consequently, insulators that exhibit (a) topological feature(s) are called “topological insulators”.

“Indirect band gap” means that the bottom of the conduction band and the top of the valence band have different crystal momentum (k-vector) in the Brillouin zone.

“Metallic surface states” means the dangling bonds derived electronic states, which are located between the conduction and valence band. These surface states have de-localized electrons and are highly electrically conductive. In the real space, they are at the crystal surface.

In the Momentum space (k), they are located in the gap between the bulk conduction and valence band.

“Certain surfaces” means the surface of a catalyst crystal with a surface normal of a designated Miller-index ((h,k,l)-index).

“Catalytic active site” means the crystal surfaces where heterogeneous catalysis reactions may occur.

“Occupied positions” means the available Wyckoff positions in a given space group which is/are occupied by (an) atom(s). An example is given below for space group No. 25 (Pmm2):

Wyckoff Positions of Group Pmm2 (No. 25)

| | Wyckoff | Site | |
|---|---|---|---|
| Multiplicity | letter | symmetry | Coordinates |
| 4 | i | 1 | (x, y, z) (−x, −y, z) |
| | | | (x, −y, z) (−x, y, z) |
| 2 | h | m.. | (½, y, z) (½, −y, z) |
| 2 | g | m.. | (0, y, z) (0, −y, z) |
| 2 | f | .m. | (x, ½, z) (−x, ½, z) |
| 2 | e | .m. | (x, 0, z) (−x, 0, z) |
| 1 | d | mm2 | (½, ½, z) |
| 1 | c | mm2 | (½, 0, z) |
| 1 | b | mm2 | (0, ½, z) |
| 1 | a | mm2 | (0, 0, z) |

Thus, a Wyckoff position of a defined space group consists of all points X for which the site-symmetry groups are conjugate subgroups of the defined space group. Each Wyckoff position of a space group is labelled by a letter which is called the Wyckoff letter. The number of different Wyckoff positions of each space group is finite, the maximal numbers being 9 for plane groups (realized in p2 mm) and 27 for space groups (realized in Pmmm). There is a total of 72 Wyckoff positions in plane groups and 1731 Wyckoff positions in space groups.

Heterogeneous catalytic reactions are a type of catalytic process where the catalyst and the reactants are not present in the same phase. This occurs e.g. in reactions between gases or liquids or both at the surface of a solid catalyst. Typical heterogeneous catalytic reactions include photocatalytic/electrochemical water splitting, ammonia synthesis, CO₂ reduction, and oxygen reduction reaction (ORR) e.g. in fuel cells. According to the classic surface adsorption theory, a heterogeneous reaction comprises four stages:
1) Diffusion of a reactant to the solid catalyst surface. The diffusion rate is determined by the bulk concentration of the reactant and the thickness of the boundary layer (a layer of solution formed at the catalyst surface) surrounding the catalyst particle.
2) The adsorption of reactants onto the surface of the catalyst through chemical or physical bonding.
3) Oxidation or reduction at the catalyst surface, which is characterized by an electron transfer between the catalyst and adsorbates.
4) Desorption of the reaction product. This process is accompanied by a breaking of (a) bond(s) as the product(s) desorb from the surface of the catalyst.

The catalytic efficiency generally depends on the adsorption energy of the adsorbates/reaction intermediates and the catalytic active site(s). A good catalyst requires that the adsorption energy is “just right” so that the products can be formed and released as quickly as possible. Adsorption energy can be positive or negative; positive energy means the adsorption is weak, while negative energy means good, i.e. strong adsorption. However, an adsorption energy which is too positive will lead to a low concentration of reactants at the catalyst surface(s) and therefore will increase the reaction kinetics. On the other hand, if the adsorption energy is too negative the products remain on the catalyst surface too long and may act as “poison” to the active site(s).

It was now found that the catalytic efficiency of topological insulators, specifically topological trivial insulators, directly correlates with its metallic surface states. Using the Topological Quantum Chemistry (TQC) Theory (Nature 547.7663 (2017): 298-305), all of the topological trivial, as well as the topologically nontrivial, band insulators in the Inorganic Crystal Structure Database (ICSD) (Nature 566.7745) (2017): 480-485) were identified. Topologically trivial insulators come in two distinct categories: with and without surface states.

The Band Representations (BRs) of the valence bands of all these topological band insulators were identified (see: Nature 566.7745) (2017): 480-485; and in the Topological materials database, see: https://www.topologicalquantumchemistry.com). For a given topological band insulator with atoms sitting at the Wyckoff positions WP_{occ}={xᵢ, yᵢ, zᵢ|i∈occ=occupied position}, using the BRs and the formulae of Real Space Invariants (RSI) e.g. disclosed in “Science 367 (6479), 794-797 (2020)”, one can calculate the RSIs of all the Wyckoff positions (WPs) of the crystal symmetry group. Thus, for a given space group, one can define RSIs for each of the Wyckoff positions of that space group. For a topological band insulator, the RSI defined at a Wyckoff position is always an integer, which stands for the number of irreducible Wannier orbitals (=irreducible Wannier Charge Centers (WCCs)) at that Wyckoff position.

The Wyckoff positions with nonzero RSI give the positions of irreducible Wannier Charge Centers (WCCs) (Physical Review B 89.11 (2014)), WP_{wcc}={xₖ,yₖ,zₖ|RSIₖ≠0}. Any BRs of a topological band insulator, which have at least one irreducible WCC localized at the empty Wyckoff position (i.e. a Wyckoff position which is not occupied by atom), is in the obstructed atomic limit phase, i.e. ∃(Xⱼ, Yⱼ, Zⱼ)∈WP_{wcc}, (Xⱼ, Yⱼ, Zⱼ)∉WP_{occ}. Thus, all of the Wyckoff positions, which have nonzero RSI and which are not occupied by the atoms of the material are called “obstructed Wyckoff positions”, WP_{OAI}={Xⱼ, Yⱼ, Zⱼ|RSIⱼ≠0, j∉occupied positions}. A band insulator is a not obstructed atomic insulator when all of its irreducible WCCs are occupied by atoms. Otherwise, it is an Obstructed Atomic Insulator (OAI).

For Obstructed Atomic Insulators with occupied Wyckoff Positions WP_{occ}={xᵢ, yᵢ, zᵢ|i∈occupied positions} and obstructed Wyckoff positions WP_{OAI}={Xⱼ, Yⱼ, Zⱼ|RSIⱼ≠0, j∈occupied positions}, their surface planes f(x, y, z)=0 with Miller index (or normal vector) (h,k,l) have metallic surface states when (h,k,l) satisfy the following conditions:

$$\{ \begin{matrix}( h , k , l ) \cdot ( x - {X}_{j} , y - {Y}_{j} , - {Z}_{j} ) = 0 , \\ ( h , k , l ) \cdot ( x - {x}_{i} , y - {y}_{i} , z - {z}_{i} ) \neq 0 , \\ h , k , l ϵ Z\end{matrix}$$

This means that the surface plane f(x, y, z)=0 with normal vector (h,k,l) cuts through the position of obstructed Wyckoff positions, but stays away from the occupied positions in a crystal.

Any cleaved crystal surface that cuts through theses obstructed Wyckoff Positions must have metallic surface states on that crystal surface. The location of these metallic surface states on the surface of a catalyst crystal can be predicted with the above theory. This is illustrated in FIGS. 1 and 2 for a MoS₂ crystal. The surface states are located at the edge sites with dangling bonds. The (001) basal plane has no surface states and is inert for catalytic reactions. However, edge sites which are normal to the (001) face, like (100), or (010), or (110) etc. are active towards catalytic reactions such as hydrogen evolution. When these metallic surface states are located near the Fermi level (i.e. up to about 0.5 eV below or above the Fermi level) they can be transferred easily in catalytic reactions, and can serve as active centers for chemical reactions.

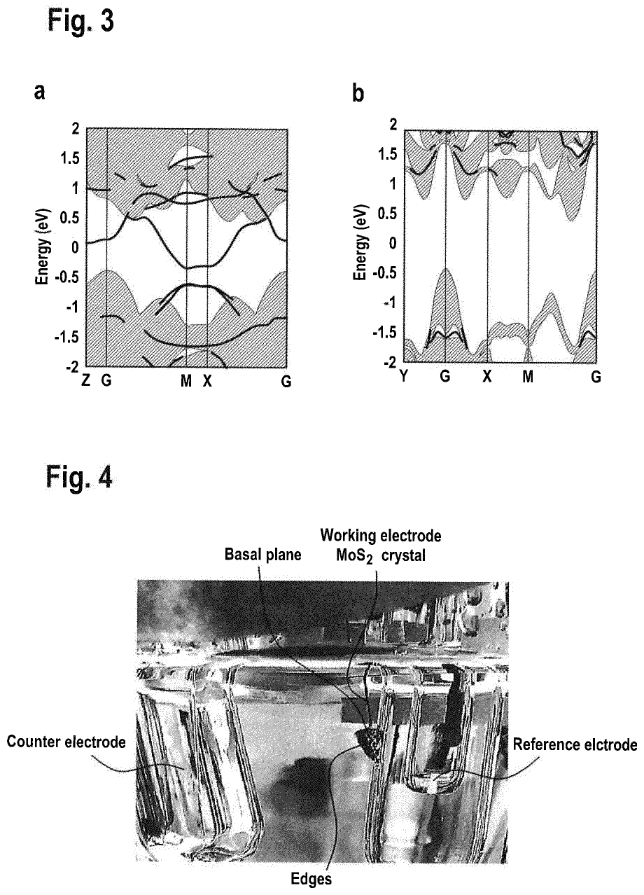

The position of the metallic surface state in a MoS₂ crystal is shown in FIG. 3. MoS₂ crystallizes in space group P6₃/mmc (#194) with Mo and S at Wyckoff position 2c (⅓, ⅔, ¼) and 4f (⅓, ⅔, z) (where z is a general position not equal to ¼), respectively. Using the Topological quantum chemistry (TQC) theory, the Real Space Invariants (RSI) at Wyckoff position 2b (0,0,¼) is δ(b)=1.0. Thus, there is an irreducible WCC localized at the 2b position, which is not occupied by an atom. This shows, that with the above theory one can identify the surface plane in MoS₂ which has metallic surface states (indicated by its Miller index (1,0,0)) as shown in FIG. 3(a). On the other hand, the surface with Miller index (0,0,1) cuts the 2c position which is occupied with an atom. Therefore, the (001) surface does not have metallic surface states within the energy gap, as shown in FIG. 3(b).

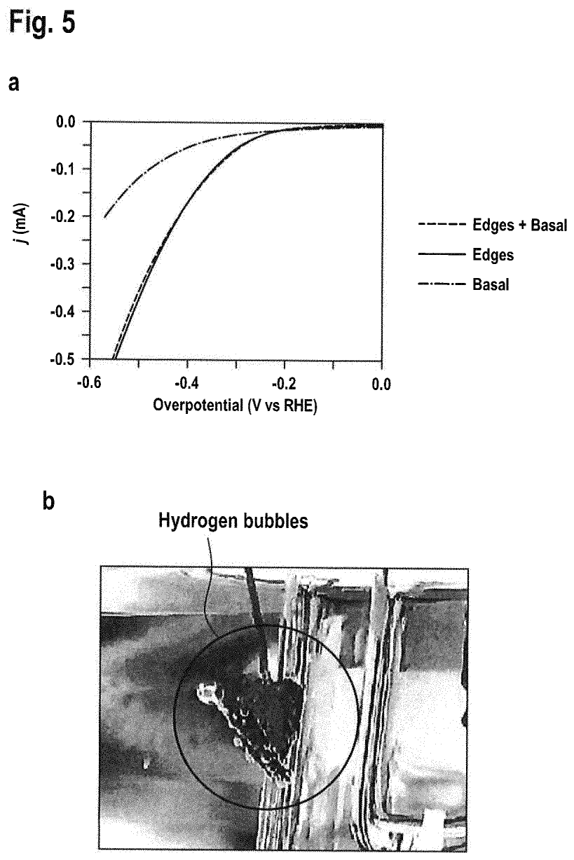

The prediction of the catalytic behavior of MoS₂ crystal has been proven experimentally. FIG. 4 shows the experimental setup for the HER. The bulk MoS₂ single crystal is attached to a titanium wire with silver paint. The edges and basal plane can be seen clearly in FIG. 4. FIG. 5a shows the linear polarization curves for the whole crystal (Edge+basal plane), Edges only, and basal plane. It can be seen that the activity of the whole crystal is almost the same as that of the edges. The activities decrease significantly when the edges are partially covered with a gel. FIG. 5b shows a photo taken at an overpotential of −0.57 vs RHE. Hydrogen bubbles are formed at the edges, but not on the basal plane. Thus, it can be concluded that the HER activity comes from the crystal edges.

Accordingly, the invention provides a method of selecting a potentially catalytic active compound which method comprises
identifying all the topological insulators in the ICSD, preferably all the topological trivial insulators,
calculating the Real Space Invariants of the valence bands for all these topological insulators in order to
identify in all these topological insulators the Wyckoff Positions where the irreducible Wannier Charge Centers (WCCs) are localized, and then
selecting as potentially catalytic active compound a topological insulator wherein the position of WCCs is not occupied by any atom.

This method was applied to all compounds in the ICSD and the potentially catalytic active compounds have been identified. These compounds are listed in the attached Table labelled “OAI”. Many compounds in this table have multiple listings. Multiple listings of the same compound (meaning the same stoichiometry) may occur when different contributors to the ICSD have reported (slightly) varying data like varying lattice parameter, different space group allocations or Wyckoff allocations etc. The condensed list of unique compounds (=one listing only) is reproduced in the following Table 1:

TABLE 1
Ba₁P₈, I₄P₂, Mn₁P₄, Nb₂Se₉, Os₁P₄, P₃Ru₁, P₄Ru₁, P₅Re₂, Re₁S₂, Re₁Se₂, S₂Tc₁, Lu₁P₅, P₅Y₁, As₁Ge₁,
As₁Si₁, Ba₁P₃, Bi₁S₂, Bi₁Se₂, Br₄Nb₁, Br₆Si₂, C₂₂F₁₄, C₂Ca₁, Ca₅P₈, Cl₃Mo₁, Cl₃Y₂, Cl₄Nb₁, Cl₄Ta₁,
Cs₅Te₃, Ga₁Te₁, Ge₁P₁, Hg₁O₂, In₁Se₁, K₁Sb₂, Na₁P₂, O₂Rb₂, P₃Sr₁, Rb₁Sb₂, Ag₁P₂, As₂Co₁, As₂Ir₁,
As₂La₁, As₂Rh₁, Au₁O₁, B₂F₄, B₄Mn₁, Ca₁O₂, Cd₁P₄, Co₁P₂, Cs₁Te₄, Cs₂I₈, Cu₁P₂, Fe₁P₄, Fe₁S₁, Ga₂I₃,
Hg₂N₆, Ir₁N₂, Ir₁P₂, Ir₁Sb₂, La₁P₇, La₁S₂, La₁Se₂, Li₂O₂, Mg₁P₄, N₂O₄, N₂S₂, O₂Tc₁, P₂Rh₁, P₇Pb₁,
Rh₁Sb₂, Rh₁Si₁, Sb₁Zn₁, Ba₁S₂, Ba₁Se₂, C₂Ba₁, C₂Sr₁, I₆Pt₂, Ni₁P₂, O₂Si₁, P₂Pd₁, S₂Yb₁, S₄V₁, Se₃Tl₂,
Se₉V₂, Te₃Tl₂, As₃Ca₄, Cs₂Te₂, K₂O₂, Rb₂Te₂, As₂Fe₁, As₂Os₁, As₂Ru₁, C₁N₁, Fe₁P₂, Fe₁S₂, Fe₁Sb₂,
Fe₁Se₂, In₁S₁, N₂Pt₁, Os₁P₂, Os₁Sb₂, P₂Ru₁, Ru₁Sb₂, Ru₁Te₂, Ge₃Os₂, Ge₃Ru₂, Os₂Si₃, Ru₂Si₃, As₁Cd₁,
As₁Zn₁, B₂Cl₄, C₂N₂, Cd₁Sb₁, Cl₁O₂, P₄Re₁, P₄Tc₁, Pd₁S₂, B₂Fe₁, Na₁P₅, P₃Re₁, P₃Tc₁, Ba₅P₄, Ba₅Sb₄,
K₁Tl₁, Ba₁O₂, F₃La₁, As₆Cs₄, As₆Rb₄, Cs₄P₆, K₄P₆, P₆Rb₄, Al₂Ru₁, Ga₂Os₁, Ga₂Ru₁, C₂Li₂, C₂Na₂,
Cs₂O₂, Cs₂S₂, Rb₂S₂, B₃Si₁, H₆Ru₁, O₆₄Si₃₂, K₅Te₃, B₁₀F₁₂, Li₁Si₁, C₁N₂, Ca₁In₃, Ga₃K₁, Ga₃Rb₁,
H₈Si₁, C₂Mg₁, Fe₁Ga₃, Ga₃Os₁, Ga₃Ru₁, In₃Ru₁, Li₂S₂, B₄Os₁, Cl₂Zn₁, Hg₁I₂, Hg₂I₄, Al₂Os₁, As₁Ca₂,
Bi₁Ca₂, Br₁Hg₁, Br₂Hg₂, Cl₂Hg₂, F₂Hg₂, Ga₃K₂, Hg₁I₁, Hg₂I₂, In₃Rb₂, O₂Sr₁, Ba₁Te₂, O₂Zn₁, S₂Sr₁,
Au₁Br₁, Au₁Cl₁, O₃U₁, Br₁₂Zr₆, Cl₁₂Zr₆, I₁₂Zr₆, I₆Si₂, As₁B₆, As₂B₁₂, B₁₂P₂, B₁₂Si₃, B₆O₁, B₆P₁,
Br₈Nb₃, C₁B₄, C₃B₁₂, Ga₁S₁, I₈Nb₃, Cr₁N₂, Ga₁Se₁, Mo₁N₂, N₂W₁, Ca₁P₁, Ca₂P₂, K₂S₂, K₂Se₂, Na₂O₂,
Na₂S₂, P₁Sr₁, C₂Os₁, Hf₁N₂, K₂Te₂, Mo₁S₂, Mo₁Se₂, Mo₁Te₂, Na₁S₁, Na₂Se₂, S₂W₁, Se₂W₁, Te₂W₁,
As₂Pt₁, Cd₁O₂, Cd₁S₂, Cd₁Se₂, Fe₁Te₂, Mg₁O₂, Mg₁Se₂, Mg₁Te₂, N₂Pd₁, Os₁S₂, Os₁Se₂, Os₁Te₂, P₂Pt₁,
Ru₁S₂, Ru₁Se₂, S₂Zn₁, Se₂Zn₁, Ag₁Br₁, Ag₁Cl₁, Ag₁I₁, B₄Fe₁, Be₅Pt₁, Br₁Cu₁, Cd₁S₁, Cd₁Se₁, Cd₁Te₁,
Cl₁Cu₁, Cu₁I₁, Cu₅Tb₁, O₁Zn₁, S₁Sn₁, S₁Zn₁, Se₁Zn₁, Te₁Zn₁, B₆Ca₁, B₆Si₁, B₆Sr₁ and B₁Li₁,
Al₂Cd₂Cl₈, Al₄Cl₁₄Te₄, As₁Fe₁S₁, Au₁Br₈Te₁, B₁₈Cs₈S₁₈, B₁₈Rb₈S₁₈, B₁₈Rb₈Se₁₈, B₈Br₆P₄, Bi₂Br₈Te₄,
Bi₄Cl₁₆Te₁₄, Bi₆Cl₂₀Te₄, Br₁₂Ta₂Te₄, Br₁Mo₁Te₄, Br₂Nb₁S₂, Br₂Nb₁Se₂, C₂₂Co₆O₁₈, C₂I₁₀La₆, C₂O₄Pb₁,
Cl₁₂Ta₂Te₄, Cl₁₈P₂Re₂, Cl₂Nb₁Se₂, Cl₅O₄Re₂, Cl₆Hf₁Te₄, Cl₈Ga₂Hg₂, Cs₁Sb₂Se₄, Cs₂S₆Sn₂, Cs₂S₈Sb₄,
Cs₂Se₆Sn₂, Cs₄P₂Se₁₀, Cu₄P₃Se₄, F₁₂I₄Sb₂, F₁₂Sb₂Te₄, Ge₁Li₁Te₂, Ge₂Te₆Tl₆, Hg₁O₃V₁, Hg₂P₂S₆,
I₁₂Nb₂Te₈, I₁Ta₁Te₄, In₂O₅P₁, K₂O₈S₂, K₂Sb₄Se₈, La₆O₁₈Re₄, Li₁Mo₁S₂, Mo₄N₁₄Sr₁₀, Na₂O₈S₂,
Rb₂Sb₄Se₈, Si₂Te₆Tl₆, As₂Ga₂Sr₁, C₂Ca₁O₄, Al₂Na₇Sb₅, Ba₃P₆Si₄, Bi₉I₃Rh₂, Cl₇Nb₃Se₅, Ir₂Se₅Sn₁,
K₄P₈Te₄, Al₁O₄W₁, As₁Cl₂Hg₂, As₂F₁₂I₄, As₃Ba₂Cd₂, As₃Sr₂Zn₂, Ba₅Cr₁N₅, Bi₄Br₂Ru₁, Br₁₀Te₄Zr₂,
C₁B₂O₂, C₁N₁Th₁, C₂Br₂Gd₂, C₂La₂O₂, C₄Cs₂O₄, C₄Li₂O₄, C₄O₄Rb₂, Cd₁P₁S₃, Cd₂P₂S₆, Cd₆Sb₁₂Sr₁₁,
Cl₂Hg₂P₁, Cl₂Nb₁S₂, Fe₁P₁S₃, Fe₂P₂S₆, Ge₁K₃S₃, Ge₂K₆S₆, Ge₂K₆Se₆, Hg₆O₇Si₂, I₂O₁Ta₁, K₆Si₂Te₆,
Mg₁P₁S₃, Na₄P₂S₆, Ni₁P₁S₃, Ni₁P₁Se₃, Ni₂P₂S₆, P₁S₃Zn₁, P₂S₆V₂, P₂S₆Zn₂, P₆Si₈Zn₄, Hg₂Mo₂O₇,
Hg₂O₄S₁, Hg₂O₄Se₁, Hg₄O₇P₂, K₂Mo₈O₁₆, Ag₅Ge₁O₄, As₁Cd₂Cl₂, As₁Fe₁Se₁, As₁Fe₁Te₁, As₁Ru₁Te₁,
As₂Cs₄Te₆, As₂F₁₂Hg₄, As₂Hg₆O₁₀, As₂Hg₆O₈, Ba₁P₃Pt₂, Ba₂P₂S₆, Ba₂P₂Se₆, Ba₆P₆Sn₂, Bi₁Os₁Se₁,
Br₁₄Ga₄Te₄, Br₃Hg₂Te₁, C₁D₁K₁O₃, C₂Ag₂O₄, C₂Cd₁O₄, C₂H₆O₆, C₂Li₂O₄, C₂Na₂O₄, C₂O₄Tl₂,
C₂O₄Zn₁, C₄Na₂O₄, Ca₁Mo₅O₈, Ca₂P₂S₆, Ca₂P₂Se₆, Cd₂Cl₂P₁, Cl₁₄Ga₄Te₄, Cl₃Cu₁K₁, Cl₃Mo₁S₂,
Cl₇O₃Re₂, Co₁K₂O₂, Cs₁O₅V₂, Cs₂O₈S₂, Cs₂Se₆Te₂, Cu₁La₂S₄, Fe₁P₁S₁, Fe₁P₁Se₁, Fe₁S₁Sb₁,
Fe₁Sb₁Se₁, Fe₁Sb₁Te₁, Ge₂Na₆Se₆, Ge₂Na₆Te₆, H₄B₂O₄, Hg₁O₄Re₁, Hg₂N₂O₄, Hg₄N₂O₈, Hg₆O₈P₂,
I₁Nb₂Te₆, In₄P₆S₁₈, K₄O₈P₂, K₆Se₆Sn₂, K₆Sn₂Te₆, Mo₅O₈Sr₁, Na₆Si₂Te₆, Os₁P₁S₁, Os₁P₁Se₁, Os₁S₁Sb₁,
Os₁Sb₁Se₁, Os₁Sb₁Te₁, P₁Pb₁Se₃, P₁Ru₁S₁, P₁Ru₁Se₁, P₁Se₃Sn₁, P₂Pb₂S₆, P₂Pb₂Se₆, P₂S₆Sn₂, P₂S₆Sr₂,
P₂Se₆Sn₂, P₂Se₆Sr₂, P₂Se₆Tl₄, Ru₁S₁Sb₁, Ru₁Sb₁Se₁, Ru₁Sb₁Te₁, Ag₂O₂Pb₁, As₁F₆I₅, As₃Br₁Cd₂,
As₃Br₁Hg₂, As₃Cd₂I₁, As₆Ba₁Pt₄, As₆Pt₄Sr₁, Au₁Cl₁O₂, Au₁Cl₄Cs₁, Au₁Cl₄Rb₁, Au₁Cl₄Tl₁, Au₁F₄Li₁,
Au₁Li₁S₁, B₂Li₂Se₅, Bi₃Cl₁O₄, Br₁Cd₂P₃, Br₂Hg₂O₆, C₂O₄Sn₁, C₄Ag₂O₄, Cd₂Cl₁P₃, Cd₂I₁P₃, Cd₂O₁₂P₄,
Cl₁Hg₂O₁, Cl₁Hg₂P₃, Cl₂Hg₄O₂, Cl₄Os₁Sc₄, Cs₁F₇Sb₂, Cs₂Re₃Se₆, Cs₄Re₆S₁₃, Cs₄Re₆Se₁₃, Cs₄S₁₃Tc₆,
Cs₄Se₁₃Tc₆, Cs₆Ge₂Se₆, Cs₆Ge₂Te₆, Cs₆Sn₂Te₆, Cu₂O₂Pb₁, Cu₂Re₃Se₆, Fe₂O₁₂P₄, Ge₂K₆Te₆, Hg₂P₂Se₆,
K₂Re₃S₆, K₂Re₃Se₆, K₄Re₆Se₁₂, K₄S₁₂Tc₆, K₄Se₁₂Tc₆, Mn₂Mo₁P₁₂, Na₂Nb₄O₁₁, Na₂Re₃S₆, Na₂Re₃Se₆,
O₃Si₁Sr₁, O₄Pd₁S₁, O₄Pt₁S₁, O₇P₂Pd₂, P₆Pt₄Sr₁, Rb₂Re₃S₆, Rb₂Re₃Se₆, Rb₄Re₆S₁₂, Rb₄Re₆S₁₃,
Rb₄Re₆Se₁₂, Rb₄S₁₃Tc₆, Rb₄Se₁₂Tc₆, Re₃S₆Tl₂, Re₃Se₆Tl₂, Re₆Se₁₂Tl₄, Br₁₁Cs₁Nb₄, Br₁₁Nb₄Rb₁,
Cl₁₁Cs₁Nb₄, Cl₁₁Nb₄Rb₁, Al₂Ca₅Sb₆, Al₂Cl₈Se₄, As₆Ca₅Ga₂, Ba₁Nb₈O₁₄, Ba₃O₁Sb₂, Ba₅In₂Sb₆,
C₂K₂O₄, C₂O₄Rb₂, Ca₅In₂Sb₆, In₂Sb₆Sr₅, Nb₈O₁₄Sr₁, Ag₅O₄Si₁, Br₁Hg₂P₃, Nb₂Ni₁O₆, O₉P₂V₂,
Al₂Cl₈Te₄, Au₁O₄S₁, Cl₂N₄S₆, Co₁Ge₁Te₁, Cu₁O₃Se₁, Cu₁P₂Se₁, Ge₁Rh₁Te₁, O₆P₂Tl₄, Pt₁Sb₁Si₁,
Al₁K₁Sb₄, Al₁P₃Si₁, As₁La₁Te₁, As₂Hg₄O₇, Ba₁P₄Te₂, Cs₂Ge₁Te₄, Cs₂Sn₁Te₄, Ga₁K₁Sb₄, H₂B₁Li₁,
La₁Mn₁S₃, La₁P₁S₁, P₁S₁Y₁, P₂Ru₂Th₁, I₁K₄P₂₁, I₁P₂₁Rb₄, B₁₂Li₂Si₂, B₂Ba₁Se₆, In₉K₁Na₃, La₂O₂S₂,
Na₄P₂Se₆, Nb₁P₂S₈, F₆Pa₁Rb₁, Au₁Na₁S₁, Cs₂Ni₃S₄, Cs₂Ni₃Se₄, Cs₂Pd₃Se₄, Cs₂Pt₃S₄, Cs₂Pt₃Se₄,
Li₂O₄U₁, Na₂O₄U₁, Ni₃Rb₂S₄, Pt₃Rb₂S₄, Au₁Cs₁F₄, Au₅Cs₇O₂, Au₅O₂Rb₇, Br₃Cs₁Li₂, Cl₂I₂Ta₁,
Cl₃Cs₁Li₂, Hf₂N₂S₁, Li₂Ni₁O₂, Na₂O₃Ti₁, Na₂O₄Pd₃, O₃Pd₁Sr₂, Al₁B₁₄Li₁, Ba₁Ce₁O₃, C₂B₁₃Li₁,
Cu₁₁K₃Te₁₆, O₄P₁Rh₁, O₄Si₁Zn₂, P₂S₆Th₁, P₂S₆Zr₁, Ba₉Br₃₄O₁Pr₆, Bi₄I₂Ru₁, La₄O₁₀Re₂, Br₂Cs₁F₁,
C₂Ag₁K₁, C₂Au₁Cs₁, C₂Au₁K₁, C₂Au₁Na₁, C₂Au₁Rb₁, C₂Cu₁Rb₁, C₂Ag₁Cs₁, C₂Cu₁K₁, Cl₃O₁W₁,
I₃O₁W₁, Li₆O₄Zn₁, Cl₆Hf₁Se₄, Cl₆Se₄Zr₁, Br₂Cs₂F₂, Cs₂I₆Pd₁, C₄Ba₁O₄, Ag₃Cu₁S₂, Ba₁Cu₂O₂,
Ba₁O₇U₂, C₄O₄Pb₁, Cd₁In₂O₄, Cl₂O₁Pd₂, Cu₂O₂Sr₁, Al₁Si₁Te₃, B₁₂Br₁₂Cs₂, B₁₂Cl₁₂Cs₂, B₁₂Cs₂I₁₂,
Cd₂P₂Se₆, Cs₈O₁Tl₈, Fe₁P₁Se₃, Fe₂P₂Se₆, Mg₂P₂Se₆, Nb₆O₁₂Ti₂, As₂Hg₂O₆, Ca₁O₆Os₂, O₆Ru₂Sr₁,
C₂Cs₂Pd₁, C₂Cs₂Pt₁, C₂K₂Pd₁, C₂K₂Pt₁, C₂Na₂Pd₁, C₂Na₂Pt₁, C₂Pd₁Rb₂, C₂Pt₁Rb₂, H₂B₂Ca₁,
Mg₃Nb₆O₁₁, O₂Pr₂S₁, O₂Pr₂Se₁, B₉Mg₁N₁, Cs₄O₁Tl₂, F₁Gd₁O₁, H₈F₄N₂, Br₉Os₂Rb₃, C₉Fe₂O₉,
Mo₁S₁Se₁, Ag₂I₁₀Tl₆, Ba₅O₁₀Ru₂, Ca₁Ga₂P₂, Ca₁In₂P₂, Cl₉Cs₃Ru₂, Cl₉Cs₃Ti₂, Cs₃F₉Fe₂, Cs₃I₉Zr₂,
In₂P₂Sr₁, K₁Nb₁S₂, K₁Nb₁Se₂, Li₁Nb₁O₂, Li₁Nb₁S₂, Na₁Nb₁O₂, Na₁Nb₁S₂, Na₁Nb₁Se₂, H₁₂B₁₂Cs₂,
H₁₂B₁₂K₂, H₁₂B₁₂Rb₂, H₁₂B₁₂Tl₂, H₂₀B₁₂N₂, As₁Rb₃Se₁₆, K₃P₁Se₁₆, H₆Cl₂N₂, F₆O₂Pt₁, Ag₁Cu₄Tb₁,
Au₁Sc₁Sn₁, Bi₁Co₁Zr₁, Bi₁Lu₁Ni₁, Bi₁Ni₁Sc₁, Bi₁Ni₁Y₁, Co₁Sb₁Ti₁, Cu₁Rb₁Te₁, Fe₁Nb₁Sb₁, Fe₁Sb₁V₁,
Ge₁Pt₁Ti₁, Hf₁Ni₁Sn₁, Hf₁Pd₁Sn₁, Lu₁Ni₁Sb₁, Nb₁Ru₁Sb₁, Ni₁Sb₁Sc₁, Ni₁Sb₁Y₁, Ni₁Sn₁Ti₁, Ni₁Sn₁Zr₁,
O₄S₁Zn₁, Pd₁Sb₁Sc₁, Pt₁Sb₁Sc₁, Pt₁Sb₁Y₁, Pt₁Sn₁Ti₁, Rh₁Sb₁Th₁, Ru₁Sb₁Ta₁, Ru₁Sb₁V₁, Ag₆Ge₁₀P₁₂,
Nb₃Sb₂Te₅, In₃O₈P₂, Fe₂Ge₁Ti₁, H₆B₆Cs₂, H₆B₆K₂, Ag₂Mo₁O₄, Ag₆K₂S₄, Al₁Cs₁O₂, Al₁K₁O₂,
Al₁O₂Rb₁, Al₂Cd₁O₄, Al₂Cd₁S₄, Al₂Cd₁Se₄, Al₂Hg₁S₄, Al₂Hg₁Se₄, Al₂O₄Zn₁, Al₂S₄Zn₁, Al₂Se₄Zn₁,
As₄He₂O₆, Ba₂Ge₄S₁₀, Cd₁Ga₂O₄, Cd₁In₂S₄, Cd₁In₂Se₄, Cd₁Lu₂S₄, Cd₁Lu₂Se₄, Cd₁O₄Rh₂, Cd₁S₄Sc₂,
Cd₁S₄Y₂, Cd₁Sc₂Se₄, Cd₁Se₄Y₂, Cd₂O₄Si₁, Cd₂O₄Sn₁, Cl₄Li₂Zn₁, Cs₁N₂Nb₁, Ga₂O₄Zn₁, Hg₁In₂S₄,
In₂O₄Zn₁, In₂S₄Zn₁, K₈Sb₄Sn₁, Lu₂Mg₁S₄, Lu₂Mg₁Se₄, Mg₁O₄Rh₂, Mg₁Se₄Y₂, O₄Rh₂Zn₁, O₄Sn₁Zn₂,
S₄Sc₂Zn₁, S₄Y₂Zn₁, Se₄Y₂Zn₁,
Ag₁Bi₁P₂S₆, As₁Cl₃F₆S₃, As₂Cd₁Ge₁K₁, As₂Cd₁Ge₁Rb₁, B₁₈Cs₄Hg₂Se₁₈, B₁₈Hg₂Rb₄Se₁₈, B₃Cu₁Li₃O₇,
Br₁₀O₁Ta₂Te₄, C₁₀H₁₈Cu₂N₂O₁₀, C₁₀H₁₈N₂O₁₀Rh₂, C₁F₃Hg₁O₃S₁, C₁H₅Eu₁O₇P₁, C₁H₅Nd₁O₇P₁,
C₁H₅O₇P₁Pr₁, C₂H₁₀Ga₂Ge₄N₂O₁₂, C₂H₂₆B₁₂N₈, C₂H₆Ca₁O₇, C₂H₆K₂O₁₃S₁U₁, C₂H₆O₁₂U₂,
C₂H₈Br₃Cu₁N₁O₁, C₂H₈In₂O₁₄Se₂, C₃H₇F₁N₁O₅Sn₁, C₄H₁₁N₁O₁₀, C₄H₁₂Ba₂N₂O₁₀S₂, C₄H₁₂Fe₁O₆S₄,
C₄H₁₂N₆O₁₄Se₂U₂, C₄H₁₄F₃N₁O₂V₁, C₄H₁₆Cl₆Cu₂N₂, C₄H₇Cs₁O₁₀, C₄H₇K₁O₁₀, C₅H₁₀N₁O₆,
C₆F₆Na₄O₁₂Sn₄, C₆H₁₂Fe₁N₈O₈, C₆H₄Na₄Np₂O₁₈, C₈H₂₀N₆O₁₈S₂U₂, C₈H₂₈F₆N₂O₄V₂,
C₈H₄K₆N₈O₆Os₂S₂, C₈I₂Mo₂O₈, Cl₁₀Mo₂N₄S₄, Cl₁₀Nb₂O₁Te₄, Cl₂N₄O₁₂S₁₀, Cs₂P₂Se₆Zn₁,
Cu₁O₉Se₃Sr₂, Cu₂Na₂O₁₁Si₄, F₂N₂O₄Xe₁, F₂O₇Te₂V₂, H₁₀F₈In₂N₂O₂, H₁₂I₈Mg₁O₆, H₁₂Mg₁O₁₂S₂,
H₁₂O₁₂S₂Zn₁, H₁₄Hg₂O₁₄Te₂, H₁₄N₄O₈S₂, H₁₆B₁₂Na₂O₁₄S₆, H₁₈O₁₂Se₄Sn₁Sr₂, H₂₄Li₂N₈Te₂,
H₂₆B₂₀K₄O₄, H₃₂N₁₄Se₆Sn₂, H₃₄Cl₄Cr₂N₈O₆, H₄Cu₂Na₂O₁₃Si₄, H₆B₂F₈N₂, H₆Cs₂O₁₂P₄, H₆F₂₂N₂Sb₄,
H₆O₁₂P₄Rb₂, H₈Na₆O₁₄P₄, K₄Mn₁Mo₃O₁₂, K₄N₂O₁₄S₄, Lu₁Na₁P₂S₆, Na₁P₂S₆Tb₁, Na₁P₂S₆Y₁,
P₂Rb₂Se₆Zn₁, C₄H₃Cs₁O₁₄U₂, C₄H₅K₁O₁₅U₂, C₄H₅O₁₅Rb₁U₂, Cs₂Cu₂O₁₉Si₈, Cu₂Ge₄O₁₃Sc₂,
K₃P₅Ru₁Se₁₀, Ag₂Br₆Hg₇P₈, Ag₂Hg₇I₆P₈, Au₂K₂P₂Se₆, Au₂La₄O₂P₄, Au₂P₂Se₆Tl₂, C₂Cl₂O₄Pb₂,
C₂H₂Ag₁O₉S₁Tb₁, C₂H₄Ca₂Cl₂O₆, C₂H₆N₂Rb₂, C₄H₆B₁₂Cs₂I₁₂N₂, C₄H₈N₂O₄, H₂₀B₁₂Li₂O₄, In₁K₂P₂S₇,
La₂P₄S₁₄Tl₄, C₈H₁₂Ag₂N₄O₄, Ag₁As₁K₁S₂, Ag₁Cu₁O₄P₁, Ag₂Cs₂P₂Se₆, Ag₂O₈P₂V₁, Ag₂P₂Se₆Tl₂,
Al₁As₁Cu₁O₅, Al₁Cu₁O₈P₂Rb₁, Al₂Br₆N₂S₂, Al₂Br₆N₂Se₂, As₁F₆N₂S₃, Ba₁La₁Sb₂Se₆, Ba₁Mo₂O₁₆P₄,
C₁₀F₄Mn₂O₈, C₁₂Bi₂O₁₂Ru₄, C₁O₆P₁Sn₂, C₂As₂F₁₂N₂Te₄, C₂Cl₁₀N₂Sb₂, C₂Cu₁O₆Tl₂, C₂F₆N₄O₆S₄Se₄,
C₂F₆N₄O₆S₈, C₂H₁Cs₁O₄, C₂H₂Na₂O₆, C₂H₄Cs₂O₆, C₂H₄F₆O₆S₂Si₂, C₂H₄Fe₄O₁₄P₂, C₂H₄O₁₄P₂Zn₄,
C₂H₆K₂N₂, C₂H₆K₄N₈O₁₀, C₃H₂Na₁O₇Zn₁, C₃H₃Ba₁O₇, C₄H₁₂Cl₈Nb₂S₂, C₄H₁₈B₂P₂, C₄H₂Fe₂O₆,
C₄H₂O₈Tl₂, C₆H₁₀O₆Sn₁, C₆H₄Mg₂Na₂O₁₄, C₆O₁₆Rb₂U₂, Cd₁Mo₁O₆P₁, Cd₁P₂Rb₂Se₆, Cl₁₂Mo₂O₄P₂,
Cs₂O₁₂P₂U₂, Cs₄O₂S₁₀V₂, Cu₁P₁Se₃Tl₁, Cu₂P₂S₆Tl₂, Cu₂P₂Se₆Tl₂, F₂N₄O₆S₈, Fe₁I₁N₂O₂, Fe₁K₂P₂S₆,
Fe₁K₂P₂Se₆, Fe₂K₁O₈P₂, H₁₀Br₂N₂O₂, H₁₀N₂O₈P₂, H₁₂N₄O₄P₂, H₁₂O₆P₂Rb₄S₆, H₁₄Ni₁O₁₂P₂,
H₂Hg₆N₄O₁₄, H₂O₆P₂Tl₂, H₃K₁O₆P₂, H₅O₇P₁V₁, H₆Cs₂N₂P₄, H₈K₄O₄P₂S₆, H₈Li₄O₁₂P₂, Hg₁K₂P₂Se₆,
K₂Mg₁P₂Se₆, K₂P₂Se₆Zn₁, Li₂O₈P₂V₁, Mo₂O₁₆P₄Sr₁, Na₂O₈P₂V₁, Ni₁O₁₀P₂V₂, Ag₃P₄S₁₂Tl₅,
Ba₁In₂O₁₄P₄, Ba₁La₂O₁₄Te₅, Ba₁O₈P₂Th₁, Ba₂Gd₂O₁₃Si₄, Bi₂Cl₈Hg₃Te₂, C₁Ag₂Cl₁N₁O₄S₁,
C₂Ag₁N₂Na₁, C₂F₆Na₂O₄Sb₂, C₂H₂Cs₂O₅, C₂H₂K₂O₅, C₂H₂K₂O₆, C₂H₂O₅Rb₂, C₂H₄B₂O₂,
C₂H₆Fe₁N₂O₄, C₂H₈Cl₃Cu₁N₁, C₂H₈I₂N₄S₂, C₂N₂O₆S₂, C₄H₁₂Mg₁O₆S₄, C₄H₁₆F₄Mn₁N₁O₂,
C₄H₄O₁₀Th₁, C₄H₆Ba₁O₁₀, C₄H₆Cd₁O₂S₄, C₄H₆Na₂O₇, C₄H₆O₇Sr₁, C₄H₈Cd₁Cl₂N₂, C₄H₈O₁₂Th₁,
C₄H₈O₈Zn₁, C₆H₆Ag₃Co₁N₈, Cd₃Na₂O₁₀Si₃, Cl₃Na₂O₁₂Te₄Y₃, Cu₁Mo₂O₈Sb₁, Eu₁O₈Rb₁S₂, F₉K₅O₄U₂,
H₁₄Na₃Np₁O₁₂, H₂F₄K₁Mn₁O₁, H₂F₄Mn₁O₁Rb₁, H₄Ca₂O₁₃P₃V₁, H₄F₄O₂Rb₁V₁, H₈Ni₁O₁₀V₂,
Hg₁In₁S₃Tl₁, Hg₁O₇P₂Pd₁, K₂Rb₂Re₆S₁₃, K₄Mo₈O₅₂P₁₂, O₁₄Sr₃Te₄U₁, As₂Cl₃Hg₃Tl₁, Br₃Hg₃Sb₂Tl₁,
H₈Cs₄O₄P₂Se₆, H₈O₄P₂Rb₄Se₆, La₂O₈S₂Ta₃, Cl₁N₂S₁Se₂, Cr₂Li₄N₆Sr₂, H₆F₆N₂Si₁, H₆F₁N₁O₂,
H₆F₅N₂Sb₁, As₆Ba₄Cd₃Li₂, Ba₄Cd₃Li₂P₆, C₄H₁₂Cl₈Nb₂Se₂, H₈K₄O₄P₂Se₆, Ba₁O₇Sr₁Ta₂, Br₉Cs₅Nb₂S₄,
Br₉Nb₂S₄Tl₅, Cl₈Cs₅I₁S₄U₂, Cl₉Cs₅Nb₂S₄, Cl₉Nb₂S₄Tl₅, F₁K₁Nb₂O₆Sr₁, H₁La₂Li₁O₃, La₁O₁₁Sr₂Ta₃,
C₄N₄Pt₁Rb₂, Cs₁F₃Mo₁O₂, H₄Al₁F₅O₂Zn₁, K₁Na₂O₁₅Si₆Y₁, La₁Nb₂O₇Rb₁, Li₂O₇P₂Pd₁, O₁₄P₄Pd₃Tl₂,
C₄Cd₁Hg₁N₄S₄, C₄Cd₁Hg₁N₄Se₄, C₄Cd₁N₄S₄Zn₁, C₄Cd₁N₄Se₄Zn₁, C₄Co₁Cs₁O₄, C₄Hg₁N₄S₄Zn₁,
C₄Hg₁N₄Se₄Zn₁, Cl₁K₂Na₁O₆S₂, Ba₁O₇Si₂V₁, C₄H₈In₁K₁O₁₂, C₄H₈K₁Lu₁O₁₂, C₈K₁O₈Y₁,
Cl₂K₅Na₁O₁₂S₄, Br₄Cs₂I₂Pd₁, Br₄I₂Pd₁Rb₂, Cl₄Cs₂I₂Pd₁, Ba₄Bi₃K₁O₁, Ba₄K₁O₁Sb₃, Ba₄O₁Rb₁Sb₃,
As₂Cs₂O₈Th₁, Ce₁K₂O₈P₂, Cl₂Cs₂N₂O₆Pb₁, As₁K₁Ni₁O₄, As₁Na₁Ni₁O₄, As₂Ba₁Ni₂O₈, Ba₁Ni₂O₈P₂,
C₄H₄Cd₁O₆, Ca₂Li₆Mn₂N₆, Br₁₅Cs₂La₁O₃Ta₆, Cl₁₈Cs₁Lu₁Nb₆, C₈H₂₄Cl₁₈N₂Nb₆, Ce₁O₁P₁Zn₁,
H₁₂B₁₂Br₁Cs₃, H₁₂B₁₂Br₁K₃, H₁₂B₁₂Br₁Rb₃, H₁₂B₁₂Cl₁Cs₃, H₁₂B₁₂Cl₁Rb₃, H₁₂B₁₂Cs₃I₁, H₁₂B₁₂I₁K₃,
H₁₂B₁₂I₁Rb₃, As₂Ba₆Na₂O₁₇Ru₂, Ba₅Br₂O₉Ru₂, Ba₆Na₂O₁₇Ru₂V₂, C₄Fe₂Na₆O₁₆S₁, Cs₃Mo₄O₁₆P₃,
Ag₃Ge₃P₆Sn₂, Ag₃P₆Si₃Sn₂, C₄Cd₁K₂N₄, C₄Hg₁K₂N₄ and C₄K₂N₄Zn₁.

In one aspect of the invention, a method is provided for controllably making catalysts with the active surface site(s), which method comprises
selecting a potentially catalytic active compound either according to the above selection process or from the above Table 1,
synthesizing a crystal of this potentially catalytic active compound either so that it is grown in a predefined crystallographic direction (characterized by its h,k,l-indices) which exposes the metallic surface state; or cutting the crystal in a predefined crystallographic direction (characterized by its h,k,l-indices), so that the metallic surface state is exposed,

wherein the predefined crystallographic direction is the direction of the normal vector (h,k,l) of the surface plane f(x, y, z)=0 which cuts through the position of obstructed WCCs, but stays away from the atoms' positions, condition which is fulfilled when:

$$\{ \begin{matrix}( h , k , l ) \cdot ( x - {X}_{j} , y - {Y}_{j} , - {Z}_{j} ) = 0 , \\ ( h , k , l ) \cdot ( x - {x}_{i} , y - {y}_{i} , z - {z}_{i} ) \neq 0 , \\ h , k , l ϵ Z\end{matrix}$$

with the obstructed WCCs localized at WP_{OAI}={Xⱼ, Yⱼ, Zⱼ|RSIⱼ≠0, j∉occupied positions} and atoms occupying WP_{occ}={xᵢ, yᵢ, zᵢ|i∈occupied positions}.

A further aspect of the invention comprises a method for converting
a compound, which
   either has been selected with the above method or
   has been selected from Table 1,
and which compound does not provide a surface with a metal surface state

into a compound which provides a surface with a metal surface state, by cutting or growing a crystal of this compound in a predefined crystallographic direction thereby revealing metal surface states, wherein the predefined crystallographic direction is determined as described above.

Moreover, the present invention comprises a catalyst selected from the compounds listed in Table 1
wherein a crystal of the selected compound is grown in a predefined crystallographic direction (characterized by its h,k,l-indices); or is cut in a predefined crystallographic direction (characterized by its h,k,l-indices),
wherein the predefined crystallographic direction is the direction of the normal vector (h,k,l) of the surface plane f(x, y, z)=0 which cuts through the position of obstructed WCCs, but stays away from the atoms' positions, condition which is fulfilled when:

$$\{ \begin{matrix}( h , k , l ) \cdot ( x - {X}_{j} , y - {Y}_{j} , - {Z}_{j} ) = 0 , \\ ( h , k , l ) \cdot ( x - {x}_{i} , y - {y}_{i} , z - {z}_{i} ) \neq 0 , \\ h , k , l ϵ Z\end{matrix}$$

with the obstructed WCCs localized at WP_{OAI}={Xⱼ, Yⱼ, Zⱼ|RSIⱼ≠0, j∈occupied positions} and atoms occupying WP_{occ}={xᵢ, yᵢ, zᵢ|i∈occupied positions}.

### Method of Making the Compounds

The compounds of the present invention can e.g. be grown out of a stoichiometric mixture of the elements of the compound. The elements may be mixed together and then heated, preferably to a temperature of about 300° C., preferably 200° C., most preferred 100° C. above the melting point of the lowest melting element over a period of 1 h to 10 h, preferably 2 h to 8 h, more preferably 3 h to 7 h and then kept for 5 h to 50 h, preferably 10 h to 30 h, more preferably about 20 h at that temperature. Preferably, the mixture is placed in an inert crucible for heating, e.g. an alumina crucible which preferably is sealed, e.g. in a quartz tube under a partial pressure of an inert gas, e.g. Ar. Thereafter the mixture is slowly cooled to a temperature of about 450° C., preferably 400° C., more preferably 350° C. over a period of 40 h to 90 h, preferably 50 h to 80 h, more preferably 55 h to 65 h.

In an alternative method first, a polycrystalline ingot is prepared, e.g. using induction or arc melting technique with the stoichiometric mixture of the elements. The polycrystalline ingot is then crushed into microcrystalline powders and filled preferably in an alumina tube with a cone shape end and then fully sealed in a tantalum tube. The tube is then heated up to a temperature higher than the melting point of the compound to obtain a fully molten state and then slowly cooled to about 650° C. and then to room temperature.

In general, the compounds are manufactured so that they grow in a predefined crystallographic direction (characterized by its (h,k,l)-indices) which exposes the metallic surface state. It is known that the morphology of the crystal is closely related to the surface energy of each crystal surface. In the crystal growth process, the crystal surface with high surface energy has a faster growth rate than the lower one. Thus, according to the thermodynamic equilibrium theory, those surfaces with high surface energy will disappear while the surfaces with the lowest total energy will survive (M. Khan, et al. CrystEngComm, 2013, 15, 2631). Thus, one can design a catalyst if the metallic surface states coincide with the surface with the lowest surface energy. If the metallic surface states are located at the crystal surface with high surface energy, it is possible to control the surface energy by using additives. The additives, such as polyvinylpyrrolidone, sodium dodecyl sulfate, and hypophosphorous acid, can bind to a specific crystallographic surface and decrease the surface energy. This will reduce the crystal growth rate and alter morphology, exposing the desired crystal surface with metallic surface states (J. P. van der Eerden, et al. Electrochim. Acta, 1986, 31, 1007; A. Ballabh, et al, Cryst. Growth Des., 2006, 6, 1591). A crystal can also be “cut” in a predefined crystallographic direction (characterized by its h,k,l-indices), so that the metallic surface state is exposed. For catalysts in the form of a bulk crystal, the crystal structure and crystal orientation can be determined by single-crystal X-ray diffraction. After the orientation has being determined, one can cut the crystal along a specified direction and expose the desired crystal surface.

OAI Table

| | | | | Number of valence | | |
|---|---|---|---|---|---|---|
| Space | ICSD- | Chemical | Indirect | electrons per unit | | Occupied |
| group | No. | formula | gap(eV) | cell | Obstructed RSI list | Wyckoff positions |
| 2 | 96544 | Ba₁P₈ | 0.765 | 100 | δ1(a) = 1.0, δ1(b) = 1.0 | {i} |
| 2 | 203216 | I₄P₂ | 1.556 | 38 | δ1(d) = 1.0 | {i} |
| 2 | 36293 | I₄P₂ | 1.097 | 38 | δ1(h) = 1.0 | {i} |
| 2 | 426518 | I₄P₂ | 1.604 | 38 | δ1(f) = 1.0 | {i} |
| 2 | 100786 | Mn₁P₄ | 0.383 | 54 | δ1(c) = 1.0, δ1(d) = 1.0, δ1(h) = 1.0 | {i} |
| 2 | 16416 | Mn₁P₄ | 0.428 | 162 | δ1(a) = 1.0, δ1(c) = 1.0, δ1(g) = 1.0 | {i} |
| 2 | 62538 | Nb₂Se₉ | 0.629 | 160 | δ1(a) = 1.0, δ1(h) = 1.0 | {i} |
| 2 | 645386 | Nb₂Se₉ | 0.669 | 160 | δ1(a) = 1.0, δ1(h) = 1.0 | {i} |
| 2 | 8179 | Nb₂Se₉ | 0.684 | 160 | δ1(a) = 1.0, δ1(h) = 1.0 | {i} |
| 2 | 647710 | Os₁P₄ | 1.396 | 84 | δ1(e) = 1.0, δ1(f) = 1.0, δ1(h) = 1.0 | {a, i} |
| 2 | 62420 | P₃Ru₁ | 1.12 | 92 | δ1(b) = 1.0, δ1(d) = 1.0, | {i} |
| | | | | | δ1(e) = 1.0, δ1(g) = 1.0 | |
| 2 | 2492 | P₄Ru₁ | 1.287 | 84 | δ1(e) = 1.0, δ1(f) = 1.0, δ1(h) = 1.0 | {a, i} |
| 2 | 24808 | P₅Re₂ | 0.436 | 156 | δ1(a) = 1.0, δ1(b) = 1.0, | {i} |
| | | | | | δ1(c) = 1.0, δ1(d) = 1.0, | |
| | | | | | δ1(e) = 1.0, δ1(h) = 1.0 | |
| 2 | 650077 | Re₁S₂ | 0.806 | 76 | δ1(g) = 1.0, δ1(h) = 1.0 | {i} |
| 2 | 75459 | Re₁S₂ | 1.122 | 76 | δ1(c) = 1.0, δ1(e) = 1.0 | {i} |
| 2 | 26256 | Re₁Se₂ | 0.677 | 76 | δ1(g) = 1.0, δ1(h) = 1.0 | {i} |
| 2 | 650094 | Re₁Se₂ | 0.674 | 76 | δ1(g) = 1.0, δ1(h) = 1.0 | {i} |
| 2 | 66658 | Re₁Se₂ | 0.677 | 76 | δ1(g) = 1.0, δ1(h) = 1.0 | {i} |
| 2 | 81813 | Re₁Se₂ | 0.969 | 76 | δ1(g) = 1.0, δ1(h) = 1.0 | {i} |
| 2 | 81816 | S₂Tc₁ | 0.933 | 76 | δ1(g) = 1.0, δ1(h) = 1.0 | {i} |
| 11 | 409187 | Lu₁P₅ | 0.138 | 100 | δ1(b) = 1.0, δ1(d) = 1.0 | {f, e} |
| 11 | 409188 | P₅Y₁ | 0.104 | 72 | δ1(b) = 1.0, δ1(d) = 1.0 | {f, e} |
| 12 | 610598 | As₁Ge₁ | 0.301 | 54 | δ1(c) = −1.0 | {i} |
| 12 | 153457 | As₁Si₁ | 0.944 | 54 | δ1(b) = −1.0 | {i} |
| 12 | 43227 | As₁Si₁ | 0.944 | 54 | δ1(c) = −1.0 | {i} |
| 12 | 611404 | As₁Si₁ | 0.495 | 54 | δ1(c) = −1.0 | {i} |
| 12 | 673902 | As₁Si₁ | 1.05 | 54 | δ1(b) = −1.0 | {i} |
| 12 | 23618 | Ba₁P₃ | 0.59 | 50 | δ1(b) = −1.0 | {j, i} |
| 12 | 426771 | Ba₁P₃ | 0.521 | 50 | δ1(c) = −1.0 | {j, i} |
| 12 | 194722 | Bi₁S₂ | 0.825 | 68 | δ1(a) = −1.0, δ1(c) = −1.0 | {i} |
| 12 | 194720 | Bi₁Se₂ | 0.47 | 68 | δ1(a) = −1.0, δ1(c) = −1.0 | {i} |
| 12 | 239640 | Br₄Nb₁ | 0.851 | 82 | δ1(a) = −1.0 | {j, i, g} |
| 12 | 239354 | Br6Si₂ | 4.096 | 50 | δ1(d) = −1.0 | {j, i} |
| 12 | 411879 | C₂₂F₁₄ | 2.41 | 186 | δ1(b) = −1.0 | {i, i} |
| 12 | 411880 | C₂₂F₁₄ | 2.415 | 186 | δ1(c) = −1.0 | {j, i} |
| 12 | 252725 | C₂Ca₁ | 1.997 | 20 | δ1(a) = 1.0, δ1(d) = 1.0 | {i} |
| 12 | 252731 | C₂Ca₁ | 1.8 | 20 | δ1(a) = 1.0, δ1(d) = 1.0 | {i} |
| 12 | 252740 | C₂Ca₁ | 1.712 | 20 | δ1(a) = 1.0, δ1(d) = 1.0 | {i} |
| 12 | 252743 | C₂Ca₁ | 0.36 | 20 | δ1(a) = 1.0, δ1(d) = 1.0 | {i} |
| 12 | 252746 | C₂Ca₁ | 2.183 | 20 | δ1(a) = 1.0, δ1(d) = 1.0 | {i} |
| 12 | 252749 | C₂Ca₁ | 2.779 | 20 | δ1(b) = 1.0, δ1(c) = 1.0 | {i} |
| 12 | 252752 | C₂Ca₁ | 2.043 | 20 | δ1(a) = 1.0, δ1(d) = 1.0 | {i} |
| 12 | 252755 | C₂Ca₁ | 2.695 | 20 | δ1(a) = 1.0, δ1(d) = 1.0 | {i} |
| 12 | 252758 | C₂Ca₁ | 1.746 | 20 | δ1(a) = 1.0, δ1(d) = 1.0 | {i} |
| 12 | 252761 | C₂Ca₁ | 1.896 | 20 | δ1(a) = 1.0, δ1(d) = 1.0 | {i} |
| 12 | 252764 | C₂Ca₁ | 2.176 | 20 | δ1(a) = 1.0, δ1(d) = 1.0 | {i} |
| 12 | 252767 | C₂Ca₁ | 2.13 | 20 | δ1(a) = 1.0, δ1(d) = 1.0 | {i} |
| 12 | 252770 | C₂Ca₁ | 1.938 | 20 | δ1(a) = 1.0, δ1(d) = 1.0 | {i} |
| 12 | 252773 | C₂Ca₁ | 2.058 | 20 | δ1(b) = 1.0, δ1(c) = 1.0 | {i} |
| 12 | 252776 | C₂Ca₁ | 2.343 | 20 | δ1(b) = 1.0, δ1(c) = 1.0 | {i} |
| 12 | 290833 | C₂Ca₁ | 2.32 | 20 | δ1(b) = 1.0, δ1(c) = 1.0 | {i} |
| 12 | 411190 | C₂Ca₁ | 2.756 | 20 | δ1(b) = 1.0, δ1(c) = 1.0 | {i} |
| 12 | 54185 | C₂Ca₁ | 1.159 | 20 | δ1(b) = 1.0, δ1(c) = 1.0 | {i} |
| 12 | 54188 | C₂Ca₁ | 1.624 | 20 | δ1(b) = 1.0, δ1(c) = 1.0 | {i} |
| 12 | 672970 | C₂Ca₁ | 2.308 | 20 | δ1(b) = 1.0, δ1(c) = 1.0 | {i} |
| 12 | 94385 | C₂Ca₁ | 2.159 | 20 | δ1(b) = 1.0, δ1(c) = 1.0 | {i} |
| 12 | 74854 | Ca₅P₈ | 1.181 | 50 | δ1(a) = −1.0 | {j, h, d, i, g} |
| 12 | 26108 | Cl₃Mo₁ | 0.046 | 54 | δ1(a) = 1.0 | {j, i, g} |
| 12 | 83878 | Cl₃Mo₁ | 0.057 | 54 | δ1(a) = 1.0 | {j, i, g} |
| 12 | 23337 | Cl₃Y₂ | 0.73 | 86 | δ1(a) = −1.0 | {i} |
| 12 | 1010 | Cl₄Nb₁ | 0.851 | 82 | δ1(a) = −1.0 | {j, i, g} |
| 12 | 402406 | Cl₄Ta₁ | 1.043 | 66 | δ1(b) = −1.0 | {j, i, g} |
| 12 | 34000 | Cs₅Te₃ | 0.236 | 126 | δ1(b) = −1.0 | {h, i, g} |
| 12 | 153456 | Ga₁Te₁ | 0.881 | 54 | δ1(b) = −1.0 | {i} |
| 12 | 635512 | Ga₁Te₁ | 0.847 | 54 | δ1(b) = −1.0 | {i} |
| 12 | 8249 | Ga₁Te₁ | 0.884 | 54 | δ1(d) = −1.0 | {i} |
| 12 | 427243 | Ge₁P₁ | 0.484 | 54 | δ1(a) = −1.0 | {i} |
| 12 | 637492 | Ge₁P₁ | 0.489 | 54 | δ1(c) = −1.0 | {i} |
| 12 | 48214 | Hg₁O₂ | 0.319 | 24 | δ1(d) = −1.0 | {a, i} |
| 12 | 655816 | Hg₁O₂ | 0.077 | 24 | δ1(d) = −1.0 | {a, i} |
| 12 | 672535 | In₁Se₁ | 0.85 | 18 | δ1(d) = −1.0 | {i} |
| 12 | 71083 | In₁Se₁ | 1.07 | 18 | δ1(d) = −1.0 | {i} |
| 12 | 80945 | K₁Sb₂ | 0.182 | 38 | δ1(a) = −1.0 | {i} |
| 12 | 673935 | Na₁P₂ | 0.807 | 22 | δ1(a) = −1.0 | {i} |
| 12 | 671296 | O₂Rb₂ | 2.848 | 30 | δ1(d) = −1.0 | {i} |
| 12 | 23628 | P₃Sr₁ | 0.355 | 100 | δ1(f) = 1.0 | {j, i} |
| 12 | 419402 | Rb₁Sb₂ | 0.313 | 38 | δ1(a) = −1.0 | {i} |
| 14 | 35283 | Ag₁P₂ | 0.622 | 84 | δ1(c) = 1.0 | {e} |
| 14 | 605629 | Ag₁P₂ | 0.536 | 84 | δ1(d) = 1.0 | {e} |
| 14 | 174220 | As₂Co₁ | 0.036 | 76 | δ1(d) = 1.0 | {e} |
| 14 | 30242 | As₂Co₁ | 0.077 | 76 | δ1(d) = 1.0 | {e} |
| 14 | 42613 | As₂Co₁ | 0.054 | 76 | δ1(d) = 1.0 | {e} |
| 14 | 610026 | As₂Co₁ | 0.051 | 76 | δ1(c) = 1.0 | {e} |
| 14 | 610039 | As₂Co₁ | 0.098 | 76 | δ1(d) = 1.0 | {e} |
| 14 | 42573 | As₂Ir₁ | 0.721 | 76 | δ1(d) = 1.0 | {e} |
| 14 | 610734 | As₂Ir₁ | 0.687 | 76 | δ1(c) = 1.0 | {e} |
| 14 | 610739 | As₂Ir₁ | 0.736 | 76 | δ1(d) = 1.0 | {e} |
| 14 | 610742 | As₂Ir₁ | 0.72 | 76 | δ1(c) = 1.0 | {e} |
| 14 | 610769 | As₂La₁ | 0.172 | 84 | δ1(b) = 1.0 | {e} |
| 14 | 42616 | As₂Rh₁ | 0.374 | 76 | δ1(d) = 1.0 | {e} |
| 14 | 611263 | As₂Rh₁ | 0.338 | 76 | δ1(d) = 1.0 | {e} |
| 14 | 611271 | As₂Rh₁ | 0.44 | 76 | δ1(d) = 1.0 | {e} |
| 14 | 611275 | As₂Rh₁ | 0.375 | 76 | δ1(d) = 1.0 | {e} |
| 14 | 657340 | As₂Rh₁ | 0.416 | 76 | δ1(d) = 1.0 | {e} |
| 14 | 673552 | Au₁O₁ | 0.396 | 68 | δ1(d) = 1.0 | {e} |
| 14 | 27867 | B₂F₄ | 4.979 | 68 | δ1(c) = 1.0 | {e} |
| 14 | 425100 | B₄Mn₁ | 0.011 | 76 | δ1(c) = 1.0 | {e} |
| 14 | 426770 | Ba₁P₃ | 1.36 | 100 | δ1(a) = 1.0 | {e} |
| 14 | 671326 | Ca₁O₂ | 2.296 | 56 | δ1(a) = 1.0, δ1(b) = 1.0 | {e} |
| 14 | 25605 | Cd₁P₄ | 0.343 | 64 | δ1(d) = 1.0 | {a, e} |
| 14 | 620212 | Cd₁P₄ | 0.343 | 64 | δ1(d) = 1.0 | {a, e} |
| 14 | 38316 | Co₁P₂ | 0.344 | 76 | δ1(d) = 1.0 | {e} |
| 14 | 47182 | Cs₁Te₄ | 0.478 | 132 | δ1(a) = 1.0 | {e} |
| 14 | 44621 | Cs₂I₈ | 1.438 | 148 | δ1(b) = 1.0 | {e} |
| 14 | 5413 | Cs₂I₈ | 1.371 | 148 | δ1(b) = 1.0 | {e} |
| 14 | 35282 | Cu₁P₂ | 0.847 | 84 | δ1(d) = 1.0 | {e} |
| 14 | 628625 | Cu₁P₂ | 0.842 | 84 | δ1(d) = 1.0 | {e} |
| 14 | 653601 | Cu₁P₂ | 0.839 | 84 | δ1(b) = 1.0 | {e} |
| 14 | 2413 | Fe₁P₄ | 0.896 | 168 | δ1(d) = 1.0 | {a, e} |
| 14 | 87501 | Fe₁S₁ | 0.002 | 168 | δ1(a) = 1.0, δ1(d) = 1.0 | {e} |
| 14 | 89381 | Fe₁S₁ | 0.002 | 168 | δ1(a) = 1.0, δ1(d) = 1.0 | {e} |
| 14 | 24822 | Ga₂I₃ | 2.252 | 108 | δ1(a) = 1.0 | {e} |
| 14 | 426345 | Hg₂N6 | 2.41 | 108 | δ1(d) = 1.0 | {e} |
| 14 | 98661 | Hg₂N6 | 2.479 | 108 | δ1(b) = 1.0 | {e} |
| 14 | 160623 | Ir₁N₂ | 0.479 | 76 | δ1(a) = 1.0 | {e} |
| 14 | 240755 | Ir₁N₂ | 0.328 | 76 | δ1(a) = 1.0 | {e} |
| 14 | 174222 | Ir₁P₂ | 0.722 | 76 | δ1(c) = 1.0 | {e} |
| 14 | 174229 | Ir₁P₂ | 0.701 | 76 | δ1(c) = 1.0 | {e} |
| 14 | 174230 | Ir₁P₂ | 0.688 | 76 | δ1(d) = 1.0 | {e} |
| 14 | 174232 | Ir₁P₂ | 0.681 | 76 | δ1(d) = 1.0 | {e} |
| 14 | 174233 | Ir₁P₂ | 0.738 | 76 | δ1(c) = 1.0 | {e} |
| 14 | 174234 | Ir₁P₂ | 0.701 | 76 | δ1(d) = 1.0 | {e} |
| 14 | 174235 | Ir₁P₂ | 0.717 | 76 | δ1(d) = 1.0 | {e} |
| 14 | 174236 | Ir₁P₂ | 0.701 | 76 | δ1(c) = 1.0 | {e} |
| 14 | 44661 | Ir₁P₂ | 0.998 | 76 | δ1(d) = 1.0 | {e} |
| 14 | 42620 | Ir₁Sb₂ | 0.622 | 76 | δ1(d) = 1.0 | {e} |
| 14 | 43502 | Ir₁Sb₂ | 0.653 | 76 | δ1(d) = 1.0 | {e} |
| 14 | 640955 | Ir₁Sb₂ | 0.608 | 76 | δ1(b) = 1.0 | {e} |
| 14 | 640961 | Ir₁Sb₂ | 0.627 | 76 | δ1(b) = 1.0 | {e} |
| 14 | 41938 | La₁P7 | 0.856 | 184 | δ1(b) = 1.0, δ1(c) = 1.0 | {e} |
| 14 | 641821 | La₁S₂ | 0.581 | 92 | δ1(a) = 1.0 | {e} |
| 14 | 32529 | La₁Se₂ | 0.202 | 92 | δ1(c) = 1.0 | {e} |
| 14 | 32530 | La₁Se₂ | 0.204 | 92 | δ1(c) = 1.0 | {e} |
| 14 | 671295 | Li₂O₂ | 3.457 | 28 | δ1(c) = 1.0 | {e} |
| 14 | 113 | Mg₁P₄ | 0.534 | 44 | δ1(d) = 1.0 | {a, e} |
| 14 | 23555 | Mg₁P₄ | 0.531 | 44 | δ1(d) = 1.0 | {a, e} |
| 14 | 42030 | Mg₁P₄ | 0.491 | 44 | δ1(d) = 1.0 | {a, e} |
| 14 | 28331 | N₂O₄ | 2.569 | 68 | δ1(b) = 1.0 | {e} |
| 14 | 33998 | N₂O₄ | 2.777 | 68 | δ1(a) = 1.0 | {e} |
| 14 | 165331 | N₂S₂ | 3.056 | 44 | δ1(a) = 1.0 | {e} |
| 14 | 37353 | N₂S₂ | 2.897 | 44 | δ1(a) = 1.0 | {e} |
| 14 | 41968 | N₂S₂ | 2.846 | 44 | δ1(a) = 1.0 | {e} |
| 14 | 173153 | O₂Tc₁ | 0.09 | 76 | δ1(d) = 1.0 | {e} |
| 14 | 647708 | Os₁P₄ | 1.02 | 56 | δ1(c) = 1.0 | {e, b} |
| 14 | 174221 | P₂Rh₁ | 0.421 | 76 | δ1(c) = 1.0 | {e} |
| 14 | 174223 | P₂Rh₁ | 0.34 | 76 | δ1(d) = 1.0 | {e} |
| 14 | 174224 | P₂Rh₁ | 0.386 | 76 | δ1(c) = 1.0 | {e} |
| 14 | 174225 | P₂Rh₁ | 0.395 | 76 | δ1(d) = 1.0 | {e} |
| 14 | 174226 | P₂Rh₁ | 0.37 | 76 | δ1(d) = 1.0 | {e} |
| 14 | 174227 | P₂Rh₁ | 0.457 | 76 | δ1(d) = 1.0 | {e} |
| 14 | 174228 | P₂Rh₁ | 0.399 | 76 | δ1(c) = 1.0 | {e} |
| 14 | 42615 | P₂Rh₁ | 0.666 | 76 | δ1(c) = 1.0 | {e} |
| 14 | 648018 | P₄Ru₁ | 0.704 | 56 | δ1(d) = 1.0 | {a, e} |
| 14 | 427804 | P7Pb₁ | 0.629 | 156 | δ1(d) = 1.0 | {e} |
| 14 | 650249 | Rh₁Sb₂ | 0.005 | 76 | δ1(a) = 1.0 | {e} |
| 14 | 653588 | Rh₁Si₁ | 0.408 | 52 | δ1(c) = 1.0 | {e} |
| 14 | 79235 | Rh₁Si₁ | 0.251 | 52 | δ1(b) = 1.0 | {e} |
| 14 | 673942 | Sb₁Zn₁ | 0.054 | 68 | δ1(a) = 1.0 | {e} |
| 15 | 2004 | Ba₁S₂ | 1.556 | 44 | δ1(c) = 1.0 | {f, e} |
| 15 | 23639 | Ba₁S₂ | 1.559 | 44 | δ1(d) = 1.0 | {f, e} |
| 15 | 42134 | Ba₁S₂ | 1.569 | 44 | δ1(c) = 1.0 | {f, e} |
| 15 | 16358 | Ba₁Se₂ | 0.992 | 44 | δ1(d) = 1.0 | {f, e} |
| 15 | 88102 | C₂Ba₁ | 1.841 | 36 | δ1(d) = −1.0 | {f, e} |
| 15 | 252715 | C₂Ca₁ | 2.105 | 20 | δ1(d) = −1.0 | {f, e} |
| 15 | 252721 | C₂Ca₁ | 1.384 | 20 | δ1(d) = −1.0 | {f, e} |
| 15 | 252722 | C₂Ca₁ | 1.636 | 20 | δ1(c) = −1.0 | {f, e} |
| 15 | 252724 | C₂Ca₁ | 2.69 | 20 | δ1(d) = −1.0 | {f, e} |
| 15 | 252727 | C₂Ca₁ | 2.846 | 20 | δ1(d) = −1.0 | {f, e} |
| 15 | 252730 | C₂Ca₁ | 2.553 | 20 | δ1(c) = −1.0 | {f, e} |
| 15 | 252733 | C₂Ca₁ | 2.835 | 20 | δ1(d) = −1.0 | {f, e} |
| 15 | 252736 | C₂Ca₁ | 1.91 | 20 | δ1(d) = −1.0 | {f, e} |
| 15 | 252739 | C₂Ca₁ | 2.312 | 20 | δ1(d) = −1.0 | {f, e} |
| 15 | 252742 | C₂Ca₁ | 2.28 | 20 | δ1(c) = −1.0 | {f, e} |
| 15 | 252745 | C₂Ca₁ | 2.477 | 20 | δ1(d) = −1.0 | {f, e} |
| 15 | 252748 | C₂Ca₁ | 2.452 | 20 | δ1(d) = −1.0 | {f, e} |
| 15 | 252751 | C₂Ca₁ | 2.386 | 20 | δ1(c) = −1.0 | {f, e} |
| 15 | 252754 | C₂Ca₁ | 2.414 | 20 | δ1(d) = −1.0 | {f, e} |
| 15 | 252757 | C₂Ca₁ | 1.993 | 20 | δ1(c) = −1.0 | {f, e} |
| 15 | 252760 | C₂Ca₁ | 2.163 | 20 | δ1(c) = −1.0 | {f, e} |
| 15 | 252763 | C₂Ca₁ | 1.627 | 20 | δ1(c) = −1.0 | {f, e} |
| 15 | 252766 | C₂Ca₁ | 1.704 | 20 | δ1(c) = −1.0 | {f, e} |
| 15 | 252769 | C₂Ca₁ | 2.159 | 20 | δ1(d) = −1.0 | {f, e} |
| 15 | 252772 | C₂Ca₁ | 2.013 | 20 | δ1(c) = −1.0 | {f, e} |
| 15 | 252775 | C₂Ca₁ | 1.823 | 20 | δ1(d) = −1.0 | {f, e} |
| 15 | 54184 | C₂Ca₁ | 2.244 | 20 | δ1(c) = −1.0 | {f, e} |
| 15 | 54187 | C₂Ca₁ | 2.161 | 20 | δ1(d) = −1.0 | {f, e} |
| 15 | 672969 | C₂Ca₁ | 2.477 | 20 | δ1(d) = −1.0 | {f, e} |
| 15 | 91051 | C₂Sr₁ | 2.43 | 36 | δ1(c) = −1.0 | {f, e} |
| 15 | 671322 | Ca₁O₂ | 3.146 | 28 | δ1(d) = 1.0 | {f, e} |
| 15 | 671327 | Ca₁O₂ | 3.311 | 28 | δ1(c) = 1.0 | {f, e} |
| 15 | 633067 | Fe₁P₄ | 0.741 | 112 | δ1(a) = 1.0, δ1(b) = 1.0, δ1(c) = 3.0 | {f, d, e} |
| 15 | 65415 | Fe₁P₄ | 0.743 | 112 | δ1(a) = 1.0, δ1(b) = 1.0, δ1(c) = 3.0 | {f, d, e} |
| 15 | 47120 | I6Pt₂ | 0.285 | 124 | δ1(d) = 4.0 | {f, c, e} |
| 15 | 1829 | Mn₁P₄ | 0.468 | 216 | δ1(c) = 1.0 | {f} |
| 15 | 27160 | Ni₁P₂ | 0.627 | 40 | δ1(c) = 1.0 | {f, d} |
| 15 | 646107 | Ni₁P₂ | 0.634 | 40 | δ1(c) = 1.0 | {f, d} |
| 15 | 91560 | Ni₁P₂ | 0.633 | 40 | δ1(d) = 1.0 | {f, c} |
| 15 | 100081 | O₂Si₁ | 5.897 | 128 | δ1(d) = −2.0 | {f, c, e} |
| 15 | 100749 | O₂Si₁ | 5.899 | 128 | δ1(d) = −2.0 | {f, c, e} |
| 15 | 100750 | O₂Si₁ | 5.898 | 128 | δ1(d) = −2.0 | {f, c, e} |
| 15 | 100751 | O₂Si₁ | 6.002 | 128 | δ1(d) = −2.0 | {f, c, e} |
| 15 | 100752 | O₂Si₁ | 6.054 | 128 | δ1(d) = −2.0 | {f, c, e} |
| 15 | 100753 | O₂Si₁ | 6.063 | 128 | δ1(d) = −2.0 | {f, c, e} |
| 15 | 100754 | O₂Si₁ | 6.11 | 128 | δ1(c) = −2.0 | {f, d, e} |
| 15 | 100755 | O₂Si₁ | 6.142 | 128 | δ1(d) = −2.0 | {f, c, e} |
| 15 | 156195 | O₂Si₁ | 5.896 | 128 | δ1(d) = −2.0 | {f, c, e} |
| 15 | 162627 | O₂Si₁ | 5.654 | 128 | δ1(c) = −2.0 | {f, d, e} |
| 15 | 162628 | O₂Si₁ | 6.042 | 128 | δ1(c) = −2.0 | {f, d, e} |
| 15 | 172286 | O₂Si₁ | 5.896 | 128 | δ1(d) = −2.0 | {f, c, e} |
| 15 | 172287 | O₂Si₁ | 5.902 | 128 | δ1(d) = −2.0 | {f, c, e} |
| 15 | 172288 | O₂Si₁ | 6.012 | 128 | δ1(d) = −2.0 | {f, c, e} |
| 15 | 172289 | O₂Si₁ | 6.04 | 128 | δ1(d) = −2.0 | {f, c, e} |
| 15 | 172290 | O₂Si₁ | 6.096 | 128 | δ1(d) = −2.0 | {f, c, e} |
| 15 | 172291 | O₂Si₁ | 6.135 | 128 | δ1(d) = −2.0 | {f, c, e} |
| 15 | 172292 | O₂Si₁ | 6.167 | 128 | δ1(d) = −2.0 | {f, c, e} |
| 15 | 172293 | O₂Si₁ | 6.217 | 128 | δ1(d) = −2.0 | {f, c, e} |
| 15 | 172294 | O₂Si₁ | 6.222 | 128 | δ1(d) = −2.0 | {f, c, e} |
| 15 | 172295 | O₂Si₁ | 6.287 | 128 | δ1(d) = −2.0 | {f, c, e} |
| 15 | 172296 | O₂Si₁ | 6.324 | 128 | δ1(d) = −2.0 | {f, c, e} |
| 15 | 193155 | O₂Si₁ | 6.022 | 128 | δ1(c) = −2.0 | {f, d, e} |
| 15 | 193156 | O₂Si₁ | 6.159 | 128 | δ1(d) = −2.0 | {f, c, e} |
| 15 | 193157 | O₂Si₁ | 6.35 | 128 | δ1(d) = −2.0 | {f, c, e} |
| 15 | 193158 | O₂Si₁ | 6.467 | 128 | δ1(d) = −2.0 | {f, c, e} |
| 15 | 30869 | O₂Si₁ | 5.988 | 128 | δ1(d) = −2.0 | {f, c, e} |
| 15 | 49813 | O₂Si₁ | 5.854 | 128 | δ1(d) = −2.0 | {f, c, e} |
| 15 | 49814 | O₂Si₁ | 5.864 | 128 | δ1(d) = −2.0 | {f, c, e} |
| 15 | 65370 | O₂Si₁ | 5.895 | 128 | δ1(d) = −2.0 | {f, c, e} |
| 15 | 65371 | O₂Si₁ | 5.892 | 128 | δ1(d) = −2.0 | {f, c, e} |
| 15 | 75655 | O₂Si₁ | 5.713 | 64 | δ1(c) = −2.0 | {f, d, e} |
| 15 | 166275 | P₂Pd₁ | 0.274 | 40 | δ1(b) = 1.0 | {a, f} |
| 15 | 48163 | P₂Pd₁ | 0.711 | 40 | δ1(d) = 4.0 | {f, c} |
| 15 | 651433 | S₂Yb₁ | 0.152 | 72 | δ1(c) = 1.0 | {f, e} |
| 15 | 16797 | S₄V₁ | 0.684 | 116 | δ1(d) = 1.0 | {f} |
| 15 | 428285 | S₄V₁ | 0.578 | 116 | δ1(d) = 1.0 | {f} |
| 15 | 64770 | S₄V₁ | 0.651 | 116 | δ1(d) = 1.0 | {f} |
| 15 | 652069 | Se₃Tl₂ | 0.548 | 48 | δ1(d) = 1.0 | {f, e} |
| 15 | 48145 | Se₉V₂ | 0.425 | 128 | δ1(c) = 1.0 | {f, e} |
| 15 | 410895 | Te₃Tl₂ | 0.319 | 48 | δ1(c) = 1.0 | {f, e} |
| 48 | 170533 | O₂Si₁ | 4.304 | 128 | δ1(f) = −2.0 | {m, j, e, k, i} |
| 55 | 252055 | As₃Ca₄ | 0.506 | 184 | δ1(a) = −1.0, δ1(b) = −1.0 | {e, f, h, i, g} |
| 55 | 83351 | Cs₂Te₂ | 0.963 | 60 | δ1(c) = −1.0 | {h, g} |
| 55 | 671294 | K₂O₂ | 2.737 | 60 | δ1(b) = −1.0 | {h, g} |
| 55 | 83350 | Rb₂Te₂ | 0.792 | 60 | δ1(a) = −1.0 | {h, g} |
| 58 | 41724 | As₂Fe₁ | 0.236 | 36 | δ1(b) = −1.0, δ1(c) = −1.0 | {a, g} |
| 58 | 41805 | As₂Fe₁ | 0.27 | 36 | δ1(a) = −1.0, δ1(d) = −1.0 | {c, g} |
| 58 | 42114 | As₂Fe₁ | 0.236 | 36 | δ1(b) = −1.0, δ1(c) = −1.0 | {a, g} |
| 58 | 42603 | As₂Fe₁ | 0.327 | 36 | δ1(b) = −1.0, δ1(c) = −1.0 | {a, g} |
| 58 | 42723 | As₂Fe₁ | 0.328 | 36 | δ1(b) = −1.0, δ1(c) = −1.0 | {a, g} |
| 58 | 610453 | As₂Fe₁ | 0.205 | 36 | δ1(b) = −1.0, δ1(c) = −1.0 | {a, g} |
| 58 | 610456 | As₂Fe₁ | 0.215 | 36 | δ1(b) = −1.0, δ1(c) = −1.0 | {a, g} |
| 58 | 610471 | As₂Fe₁ | 0.215 | 36 | δ1(b) = −1.0, δ1(c) = −1.0 | {a, g} |
| 58 | 65168 | As₂Fe₁ | 0.236 | 36 | δ1(a) = −1.0, δ1(d) = −1.0 | {b, g} |
| 58 | 672723 | As₂Fe₁ | 0.224 | 36 | δ1(b) = −1.0, δ1(c) = −1.0 | {d, g} |
| 58 | 94062 | As₂Fe₁ | 0.22 | 36 | δ1(b) = −1.0, δ1(c) = −1.0 | {a, g} |
| 58 | 238253 | As₂Os₁ | 0.625 | 36 | δ1(b) = −1.0, δ1(c) = −1.0 | {a, g} |
| 58 | 42610 | As₂Os₁ | 0.63 | 36 | δ1(b) = −1.0, δ1(c) = −1.0 | {a, g} |
| 58 | 611135 | As₂Os₁ | 0.617 | 36 | δ1(b) = −1.0, δ1(c) = −1.0 | {a, g} |
| 58 | 611138 | As₂Os₁ | 0.617 | 36 | δ1(a) = −1.0, δ1(d) = −1.0 | {b, g} |
| 58 | 995 | As₂Os₁ | 0.615 | 36 | δ1(b) = −1.0, δ1(c) = −1.0 | {a, g} |
| 58 | 42578 | As₂Ru₁ | 0.191 | 36 | δ1(b) = −1.0, δ1(c) = −1.0 | {a, g} |
| 58 | 611289 | As₂Ru₁ | 0.433 | 36 | δ1(b) = −1.0, δ1(c) = −1.0 | {a, g} |
| 58 | 611294 | As₂Ru₁ | 0.431 | 36 | δ1(b) = −1.0, δ1(c) = −1.0 | {a, g} |
| 58 | 994 | As₂Ru₁ | 0.434 | 36 | δ1(b) = −1.0, δ1(c) = −1.0 | {a, g} |
| 58 | 672096 | C₁N₁ | 3.643 | 36 | δ1(a) = −1.0 | {g} |
| 58 | 15027 | Fe₁P₂ | 0.35 | 36 | δ1(b) = −1.0, δ1(c) = −1.0 | {a, g} |
| 58 | 42904 | Fe₁P₂ | 0.434 | 36 | δ1(b) = −1.0, δ1(c) = −1.0 | {a, g} |
| 58 | 633052 | Fe₁P₂ | 0.348 | 36 | δ1(b) = −1.0, δ1(c) = −1.0 | {a, g} |
| 58 | 633072 | Fe₁P₂ | 0.302 | 36 | δ1(b) = −1.0, δ1(c) = −1.0 | {a, g} |
| 58 | 109374 | Fe₁S₂ | 0.735 | 40 | δ1(c) = −1.0 | {a, g} |
| 58 | 26756 | Fe₁S₂ | 0.733 | 40 | δ1(c) = −1.0 | {a, g} |
| 58 | 42415 | Fe₁S₂ | 0.733 | 40 | δ1(c) = −1.0 | {a, g} |
| 58 | 42416 | Fe₁S₂ | 0.727 | 40 | δ1(c) = −1.0 | {a, g} |
| 58 | 633255 | Fe₁S₂ | 0.705 | 40 | δ1(c) = −1.0 | {a, g} |
| 58 | 633275 | Fe₁S₂ | 0.738 | 40 | δ1(c) = −1.0 | {a, g} |
| 58 | 633304 | Fe₁S₂ | 0.721 | 40 | δ1(c) = −1.0 | {a, g} |
| 58 | 151397 | Fe₁Sb₂ | 0.111 | 36 | δ1(a) = −1.0, δ1(d) = −1.0 | {c, g} |
| 58 | 25680 | Fe₁Se₂ | 0.211 | 40 | δ1(c) = −1.0 | {a, g} |
| 58 | 42041 | Fe₁Se₂ | 0.226 | 40 | δ1(a) = −1.0 | {c, g} |
| 58 | 42115 | Fe₁Se₂ | 0.24 | 40 | δ1(c) = −1.0 | {a, g} |
| 58 | 44751 | Fe₁Se₂ | 0.215 | 40 | δ1(c) = −1.0 | {a, g} |
| 58 | 633469 | Fe₁Se₂ | 0.205 | 40 | δ1(c) = −1.0 | {a, g} |
| 58 | 633479 | Fe₁Se₂ | 0.225 | 40 | δ1(c) = −1.0 | {a, g} |
| 58 | 15931 | In₁S₁ | 0.675 | 36 | δ1(d) = −1.0 | {g} |
| 58 | 640349 | In₁S₁ | 0.675 | 36 | δ1(a) = −1.0 | {g} |
| 58 | 673915 | In₁S₁ | 1.365 | 36 | δ1(c) = −1.0 | {g} |
| 58 | 81338 | In₁S₁ | 1.145 | 36 | δ1(a) = −1.0 | {g} |
| 58 | 81339 | In₁S₁ | 1.088 | 36 | δ1(a) = −1.0 | {g} |
| 58 | 81340 | In₁S₁ | 0.74 | 36 | δ1(a) = −1.0 | {g} |
| 58 | 81341 | In₁S₁ | 0.597 | 36 | δ1(a) = −1.0 | {g} |
| 58 | 81342 | In₁S₁ | 0.466 | 36 | δ1(a) = −1.0 | {g} |
| 58 | 157940 | N₂Pt₁ | 0.403 | 40 | δ1(c) = −1.0 | {a, g} |
| 58 | 166463 | N₂Pt₁ | 0.38 | 40 | δ1(c) = −1.0 | {a, g} |
| 58 | 238252 | Os₁P₂ | 0.686 | 36 | δ1(a) = −1.0, δ1(d) = −1.0 | {c, g} |
| 58 | 42609 | Os₁P₂ | 0.723 | 36 | δ1(a) = −1.0, δ1(d) = −1.0 | {b, g} |
| 58 | 42740 | Os₁P₂ | 0.051 | 36 | δ1(b) = −1.0, δ1(c) = −1.0 | {a, g} |
| 58 | 647706 | Os₁P₂ | 0.723 | 36 | δ1(a) = −1.0, δ1(d) = −1.0 | {b, g} |
| 58 | 647711 | Os₁P₂ | 0.723 | 36 | δ1(b) = −1.0, δ1(c) = −1.0 | {a, g} |
| 58 | 672577 | Os₁P₂ | 0.707 | 36 | δ1(a) = −1.0, δ1(d) = −1.0 | {c, g} |
| 58 | 993 | Os₁P₂ | 0.703 | 36 | δ1(b) = −1.0, δ1(c) = −1.0 | {a, g} |
| 58 | 238254 | Os₁Sb₂ | 0.405 | 36 | δ1(b) = −1.0, δ1(c) = −1.0 | {a, g} |
| 58 | 42611 | Os₁Sb₂ | 0.407 | 36 | δ1(b) = −1.0, δ1(c) = −1.0 | {a, g} |
| 58 | 647754 | Os₁Sb₂ | 0.316 | 36 | δ1(b) = −1.0, δ1(c) = −1.0 | {a, g} |
| 58 | 647757 | Os₁Sb₂ | 0.396 | 36 | δ1(b) = −1.0, δ1(c) = −1.0 | {a, g} |
| 58 | 647758 | Os₁Sb₂ | 0.31 | 36 | δ1(b) = −1.0, δ1(c) = −1.0 | {a, g} |
| 58 | 997 | Os₁Sb₂ | 0.323 | 36 | δ1(b) = −1.0, δ1(c) = −1.0 | {a, g} |
| 58 | 42607 | P₂Ru₁ | 0.539 | 36 | δ1(b) = −1.0, δ1(c) = −1.0 | {a, g} |
| 58 | 42737 | P₂Ru₁ | 0.539 | 36 | δ1(b) = −1.0, δ1(c) = −1.0 | {a, g} |
| 58 | 648016 | P₂Ru₁ | 0.44 | 36 | δ1(b) = −1.0, δ1(c) = −1.0 | {a, g} |
| 58 | 648022 | P₂Ru₁ | 0.441 | 36 | δ1(a) = −1.0, δ1(d) = −1.0 | {c, g} |
| 58 | 992 | P₂Ru₁ | 0.44 | 36 | δ1(b) = −1.0, δ1(c) = −1.0 | {a, g} |
| 58 | 42608 | Ru₁Sb₂ | 0.031 | 36 | δ1(b) = −1.0, δ1(c) = −1.0 | {a, g} |
| 58 | 42739 | Ru₁Sb₂ | 0.031 | 36 | δ1(b) = −1.0, δ1(c) = −1.0 | {a, g} |
| 58 | 996 | Ru₁Sb₂ | 0.002 | 36 | δ1(b) = −1.0, δ1(c) = −1.0 | {a, g} |
| 58 | 106001 | Ru₁Te₂ | 0.179 | 40 | δ1(c) = −1.0 | {a, g} |
| 58 | 406722 | Ru₁Te₂ | 0.19 | 40 | δ1(b) = −1.0 | {d, g} |
| 58 | 650713 | Ru₁Te₂ | 0.178 | 40 | δ1(c) = −1.0 | {a, g} |
| 60 | 637466 | Ge₃Os₂ | 0.634 | 224 | δ1(a) = 1.0, δ1(b) = 1.0 | {c, d} |
| 60 | 95592 | Ge₃Os₂ | 0.69 | 224 | δ1(a) = 1.0, δ1(b) = 1.0 | {c, d} |
| 60 | 2345 | Ge₃Ru₂ | 0.36 | 224 | δ1(a) = 1.0, δ1(b) = 1.0 | {c, d} |
| 60 | 42121 | Ge₃Ru₂ | 0.373 | 224 | δ1(a) = 1.0, δ1(b) = 1.0 | {c, d} |
| 60 | 637740 | Ge₃Ru₂ | 0.453 | 224 | δ1(a) = 1.0, δ1(b) = 1.0 | {c, d} |
| 60 | 637743 | Ge₃Ru₂ | 0.373 | 224 | δ1(a) = 1.0, δ1(b) = 1.0 | {c, d} |
| 60 | 85205 | Ge₃Ru₂ | 0.389 | 224 | δ1(a) = 1.0, δ1(b) = 1.0 | {c, d} |
| 60 | 95588 | Ge₃Ru₂ | 0.381 | 224 | δ1(a) = 1.0, δ1(b) = 1.0 | {c, d} |
| 60 | 647772 | Os₂Si₃ | 0.671 | 224 | δ1(a) = 1.0, δ1(b) = 1.0 | {c, d} |
| 60 | 647782 | Os₂Si₃ | 0.682 | 224 | δ1(a) = 1.0, δ1(b) = 1.0 | {c, d} |
| 60 | 95590 | Os₂Si₃ | 0.794 | 224 | δ1(a) = 1.0, δ1(b) = 1.0 | {c, d} |
| 60 | 2344 | Ru₂Si₃ | 0.461 | 224 | δ1(a) = 1.0, δ1(b) = 1.0 | {c, d} |
| 60 | 42122 | Ru₂Si₃ | 0.534 | 224 | δ1(a) = 1.0, δ1(b) = 1.0 | {c, d} |
| 60 | 56644 | Ru₂Si₃ | 0.447 | 224 | δ1(a) = 1.0, δ1(b) = 1.0 | {c, d} |
| 60 | 650619 | Ru₂Si₃ | 0.444 | 224 | δ1(a) = 1.0, δ1(b) = 1.0 | {c, d} |
| 60 | 95586 | Ru₂Si₃ | 0.549 | 224 | δ1(a) = 1.0, δ1(b) = 1.0 | {c, d} |
| 61 | 432 | As₁Cd₁ | 0.179 | 136 | δ1(b) = 1.0 | {c} |
| 61 | 427612 | As₁Zn₁ | 0.363 | 136 | δ1(a) = 1.0 | {c} |
| 61 | 427613 | As₁Zn₁ | 0.359 | 136 | δ1(a) = 1.0 | {c} |
| 61 | 431 | As₁Zn₁ | 0.248 | 136 | δ1(a) = 1.0 | {c} |
| 61 | 14213 | B₂Cl₄ | 2.672 | 136 | δ1(a) = 1.0 | {c} |
| 61 | 31693 | B₂Cl₄ | 2.622 | 136 | δ1(b) = 1.0 | {c} |
| 61 | 15870 | C₂N₂ | 5.245 | 72 | δ1(a) = 1.0 | {c} |
| 61 | 52830 | Cd₁Sb₁ | 0.098 | 136 | δ1(a) = 1.0 | {c} |
| 61 | 52831 | Cd₁Sb₁ | 0.067 | 136 | δ1(b) = 1.0 | {c} |
| 61 | 620394 | Cd₁Sb₁ | 0.117 | 136 | δ1(b) = 1.0 | {c} |
| 61 | 620395 | Cd₁Sb₁ | 0.082 | 136 | δ1(b) = 1.0 | {c} |
| 61 | 180778 | Cl₁O₂ | 0.391 | 152 | δ1(a) = −1.0 | {c} |
| 61 | 67663 | Cl₁O₂ | 0.343 | 152 | δ1(b) = −1.0 | {c} |
| 61 | 67664 | Cl₁O₂ | 0.391 | 152 | δ1(a) = −1.0 | {c} |
| 61 | 67665 | Cl₁O₂ | 0.411 | 152 | δ1(b) = −1.0 | {c} |
| 61 | 67666 | Cl₁O₂ | 0.424 | 152 | δ1(a) = −1.0 | {c} |
| 61 | 24774 | Hg₁O₂ | 0.324 | 96 | δ1(b) = 1.0 | {a, c} |
| 61 | 8197 | P₄Re₁ | 0.764 | 216 | δ1(b) = 1.0 | {c} |
| 61 | 35117 | P₄Tc₁ | 0.863 | 216 | δ1(a) = 1.0 | {c} |
| 61 | 648753 | Pd₁S₂ | 0.092 | 88 | δ1(b) = 1.0 | {a, c} |
| 61 | 43265 | Sb₁Zn₁ | 0.066 | 136 | δ1(b) = 1.0 | {c} |
| 61 | 43653 | Sb₁Zn₁ | 0.067 | 136 | δ1(a) = 1.0 | {c} |
| 61 | 601137 | Sb₁Zn₁ | 0.056 | 136 | δ1(a) = 1.0 | {c} |
| 61 | 651770 | Sb₁Zn₁ | 0.043 | 136 | δ1(a) = 1.0 | {c} |
| 61 | 671286 | Sb₁Zn₁ | 0.018 | 136 | δ1(b) = 1.0 | {c} |
| 61 | 673941 | Sb₁Zn₁ | 0.02 | 136 | δ1(b) = 1.0 | {c} |
| 61 | 76937 | Sb₁Zn₁ | 0.099 | 136 | δ1(a) = 1.0 | {c} |
| 62 | 425310 | B₂Fe₁ | 0.427 | 56 | δ1(a) = 1.0 | {c, d} |
| 62 | 673936 | Na₁P₅ | 1.393 | 104 | δ1(a) = 1.0 | {c, d} |
| 62 | 99177 | Na₁P₅ | 1.334 | 104 | δ1(a) = 1.0 | {c, d} |
| 62 | 647985 | P₃Re₁ | 0.07 | 88 | δ1(b) = 1.0 | {c} |
| 62 | 35200 | P₃Tc₁ | 0.417 | 88 | δ1(a) = 1.0 | {c} |
| 64 | 429733 | Ba₅P₄ | 0.857 | 140 | δ1(a) = −1.0 | {f, d, b, g} |
| 64 | 280022 | Ba₅Sb₄ | 0.227 | 140 | δ1(a) = −1.0 | {f, d, b, g} |
| 64 | 262063 | K₁Tl₁ | 0.116 | 144 | δ1(b) = −2.0 | {f, d, e, g} |
| 64 | 262067 | K₁Tl₁ | 0.034 | 144 | δ1(b) = −2.0 | {f, d, e, g} |
| 64 | 180559 | K₂O₂ | 2.538 | 60 | δ1(a) = −1.0 | {f, e} |
| 64 | 25527 | K₂O₂ | 2.403 | 60 | δ1(a) = −1.0 | {f, e} |
| 64 | 36641 | K₂O₂ | 2.478 | 60 | δ1(a) = −1.0 | {f, e} |
| 65 | 180398 | Ba₁O₂ | 0.484 | 22 | δ1(c) = −1.0 | {a, j} |
| 67 | 164055 | F₃La₁ | 4.816 | 128 | δ1(c) = 2.0, δ1(f) = 2.0 | {n, b, e, h, d, g} |
| 68 | 170527 | O₂Si₁ | 4.623 | 128 | δ1(d) = −2.0 | {c, e, h, i, g} |
| 69 | 409382 | As6Cs₄ | 0.427 | 66 | δ1(a) = 1.0 | {f, h, n, i} |
| 69 | 409381 | As6Rb₄ | 0.395 | 66 | δ1(a) = 1.0 | {f, h, n, i} |
| 69 | 65185 | Cs₄P6 | 0.84 | 66 | δ1(a) = 1.0 | {f, h, n, i} |
| 69 | 33259 | K₄P6 | 0.698 | 66 | δ1(a) = 1.0 | {f, h, n, i} |
| 69 | 65184 | P6Rb₄ | 0.749 | 66 | δ1(a) = 1.0 | {f, h, n, i} |
| 69 | 654296 | P6Rb₄ | 0.746 | 66 | δ1(a) = 1.0 | {f, h, n, i} |
| 70 | 58156 | Al₂Ru₁ | 0.095 | 28 | δ1(d) = 1.0 | {f, b} |
| 70 | 609228 | Al₂Ru₁ | 0.105 | 28 | δ1(d) = 1.0 | {f, b} |
| 70 | 103785 | Ga₂Os₁ | 0.544 | 28 | δ1(d) = 1.0 | {f, b} |
| 70 | 635227 | Ga₂Ru₁ | 0.203 | 28 | δ1(d) = 1.0 | {f, b} |
| 70 | 635228 | Ga₂Ru₁ | 0.101 | 28 | δ1(d) = 1.0 | {f, b} |
| 70 | 670154 | Ga₂Ru₁ | 0.089 | 28 | δ1(d) = 1.0 | {f, b} |
| 70 | 670380 | Ga₂Ru₁ | 0.234 | 28 | δ1(d) = 1.0 | {f, b} |
| 71 | 25705 | C₂Li₂ | 3.569 | 10 | δ1(c) = 1.0 | {i, g} |
| 71 | 670913 | C₂Li₂ | 3.304 | 10 | δ1(d) = 1.0 | {h, i} |
| 71 | 671740 | C₂Li₂ | 3.264 | 10 | δ1(c) = 1.0 | {i, g} |
| 71 | 671741 | C₂Li₂ | 3.177 | 10 | δ1(c) = 1.0 | {i, g} |
| 71 | 671742 | C₂Li₂ | 3.094 | 10 | δ1(c) = 1.0 | {i, g} |
| 71 | 671743 | C₂Li₂ | 3.024 | 10 | δ1(c) = 1.0 | {i, g} |
| 71 | 671744 | C₂Li₂ | 2.957 | 10 | δ1(c) = 1.0 | {i, g} |
| 71 | 671745 | C₂Li₂ | 2.895 | 10 | δ1(c) = 1.0 | {i, g} |
| 71 | 671746 | C₂Li₂ | 2.841 | 10 | δ1(c) = 1.0 | {i, g} |
| 71 | 671747 | C₂Li₂ | 2.786 | 10 | δ1(c) = 1.0 | {i, g} |
| 71 | 671748 | C₂Li₂ | 2.732 | 10 | δ1(c) = 1.0 | {i, g} |
| 71 | 671749 | C₂Li₂ | 2.658 | 10 | δ1(c) = 1.0 | {i, g} |
| 71 | 671750 | C₂Li₂ | 2.585 | 10 | δ1(c) = 1.0 | {i, g} |
| 71 | 671751 | C₂Li₂ | 2.507 | 10 | δ1(c) = 1.0 | {i, g} |
| 71 | 671752 | C₂Li₂ | 2.442 | 10 | δ1(c) = 1.0 | {i, g} |
| 71 | 671753 | C₂Li₂ | 2.365 | 10 | δ1(c) = 1.0 | {i, g} |
| 71 | 671754 | C₂Li₂ | 2.071 | 10 | δ1(a) = 1.0 | {i, g} |
| 71 | 671755 | C₂Li₂ | 1.906 | 10 | δ1(c) = 1.0 | {i, g} |
| 71 | 89535 | C₂Li₂ | 3.497 | 10 | δ1(a) = 1.0 | {i, g} |
| 71 | 95835 | C₂Na₂ | 3.648 | 10 | δ1(c) = 1.0 | {i, g} |
| 71 | 25529 | Cs₂O₂ | 1.745 | 30 | δ1(c) = −1.0 | {i, g} |
| 71 | 200474 | Cs₂S₂ | 1.79 | 30 | δ1(d) = −1.0 | {h, i} |
| 71 | 167554 | F₃La₁ | 5.594 | 32 | δ1(b) = 2.0 | {a, c, j} |
| 71 | 180560 | O₂Rb₂ | 1.929 | 30 | δ1(c) = −1.0 | {i, g} |
| 71 | 25528 | O₂Rb₂ | 1.806 | 30 | δ1(c) = −1.0 | {i, g} |
| 71 | 73175 | Rb₂S₂ | 1.697 | 30 | δ1(a) = −1.0 | {i, g} |
| 74 | 412621 | B₃Si₁ | 1.405 | 104 | δ1(b) = 1.0, δ1(d) = −1.0 | {h, j, i} |
| 74 | 674920 | H6Ru₁ | 0.228 | 56 | δ1(d) = −1.0 | {h, j, i, g} |
| 74 | 84260 | O6₄Si₃₂ | 3.856 | 256 | δ1(d) = 2.0 | {j, b, e, h, i, g} |
| 87 | 66024 | K₅Te₃ | 0.103 | 126 | δ1(a) = −1.0 | {h, d, e} |
| 87 | 96743 | K₅Te₃ | 0.117 | 126 | δ1(a) = −1.0 | {h, d, e} |
| 88 | 412618 | B₁0F₁₂ | 3.268 | 228 | δ1(a) = 1.0 | {f, e} |
| 88 | 160538 | Li₁Si₁ | 0.012 | 40 | δ1(d) = 1.0 | {f} |
| 119 | 247678 | C₁N₂ | 0.115 | 14 | δ1(b) = 1.0 | {d, e} |
| 119 | 102867 | Cs₁In₃ | 0.054 | 54 | δ1(d) = −1.0 | {a, f, b, i} |
| 119 | 103649 | Ga₃K₁ | 0.208 | 54 | δ1(c) = −1.0 | {a, f, b, i} |
| 119 | 20664 | Ga₃K₁ | 0.212 | 54 | δ1(a) = −1.0 | {c, d, e, i} |
| 119 | 634466 | Ga₃K₁ | 0.206 | 54 | δ1(c) = −1.0 | {a, f, b, i} |
| 119 | 103943 | Ga₃Rb₁ | 0.25 | 54 | δ1(c) = −1.0 | {a, f, b, i} |
| 119 | 169739 | H₈Si₁ | 6.013 | 12 | δ1(b) = 1.0, δ1(d) = 1.0 | {a, f, e, i} |
| 136 | 88057 | C₂Mg₁ | 2.847 | 20 | δ1(a) = 1.0 | {f, b} |
| 136 | 103447 | Fe₁Ga₃ | 0.084 | 68 | δ1(a) = −1.0 | {f, c, j} |
| 136 | 103448 | Fe₁Ga₃ | 0.439 | 68 | δ1(b) = −1.0 | {f, c, j} |
| 136 | 412077 | Fe₁Ga₃ | 0.41 | 68 | δ1(a) = −1.0 | {c, j, g} |
| 136 | 631748 | Fe₁Ga₃ | 0.442 | 68 | δ1(b) = −1.0 | {f, c, j} |
| 136 | 631760 | Fe₁Ga₃ | 0.44 | 68 | δ1(b) = −1.0 | {f, c, j} |
| 136 | 670144 | Fe₁Ga₃ | 0.44 | 68 | δ1(b) = −1.0 | {c, j, g} |
| 136 | 635024 | Ga₃Os₁ | 0.438 | 68 | δ1(b) = −1.0 | {f, c, j} |
| 136 | 412078 | Ga₃Ru₁ | 0.353 | 68 | δ1(b) = −1.0 | {f, c, j} |
| 136 | 635229 | Ga₃Ru₁ | 0.361 | 68 | δ1(a) = −1.0 | {f, c, j} |
| 136 | 55514 | In₃Ru₁ | 0.185 | 68 | δ1(b) = −1.0 | {f, c, j} |
| 136 | 640343 | In₃Ru₁ | 0.181 | 68 | δ1(b) = −1.0 | {f, c, j} |
| 136 | 671853 | Li₂S₂ | 1.778 | 28 | δ1(b) = −1.0 | {f, d} |
| 137 | 674671 | B₄Os₁ | 1.962 | 40 | δ1(b) = −1.0 | {a, g} |
| 137 | 26152 | Cl₂Zn₁ | 3.837 | 52 | δ1(b) = −1.0 | {a, d} |
| 137 | 150345 | Hg₁I₂ | 0.926 | 52 | δ1(a) = −1.0 | {d, b} |
| 137 | 22241 | Hg₁I₂ | 0.96 | 52 | δ1(a) = −1.0 | {d, b} |
| 137 | 22401 | Hg₁I₂ | 0.975 | 52 | δ1(b) = −1.0 | {a, d} |
| 137 | 36312 | Hg₁I₂ | 1.05 | 52 | δ1(b) = −1.0 | {a, d} |
| 137 | 67069 | Hg₁I₂ | 0.967 | 52 | δ1(b) = −1.0 | {a, d} |
| 137 | 68262 | Hg₁I₂ | 0.959 | 52 | δ1(a) = −1.0 | {d, b} |
| 137 | 241170 | Hg₂I₄ | 0.912 | 52 | δ1(a) = −1.0 | {d, b} |
| 137 | 241171 | Hg₂I₄ | 0.914 | 52 | δ1(a) = −1.0 | {d, b} |
| 137 | 241172 | Hg₂I₄ | 0.919 | 52 | δ1(a) = −1.0 | {d, b} |
| 137 | 241173 | Hg₂I₄ | 0.926 | 52 | δ1(a) = −1.0 | {d, b} |
| 137 | 241174 | Hg₂I₄ | 0.932 | 52 | δ1(a) = −1.0 | {d, b} |
| 137 | 241175 | Hg₂I₄ | 0.941 | 52 | δ1(a) = −1.0 | {d, b} |
| 139 | 58108 | Al₂Os₁ | 0.264 | 14 | δ1(c) = −1.0 | {a, e} |
| 139 | 166865 | As₁Ca₂ | 0.02 | 18 | δ2(b) = −1.0 | {c, e} |
| 139 | 42357 | As₁Ca₂ | 0.02 | 18 | δ2(b) = −1.0 | {c, e} |
| 139 | 180397 | Ba₁O₂ | 1.872 | 22 | δ2(b) = −1.0 | {a, e} |
| 139 | 24248 | Ba₁O₂ | 1.238 | 22 | δ2(b) = −1.0 | {a, e} |
| 139 | 24729 | Ba₁O₂ | 2.172 | 22 | δ2(a) = −1.0 | {e, b} |
| 139 | 80750 | Ba₁O₂ | 2.151 | 22 | δ2(b) = −1.0 | {a, e} |
| 139 | 42136 | Bi₁Ca₂ | 0.006 | 18 | δ2(b) = −1.0 | {c, e} |
| 139 | 673918 | Br₁Hg₁ | 2.355 | 38 | δ2(a) = −1.0 | {e} |
| 139 | 157980 | Br₂Hg₂ | 1.658 | 38 | δ2(a) = −1.0 | {e} |
| 139 | 23721 | Br₂Hg₂ | 1.727 | 38 | δ2(a) = −1.0 | {e} |
| 139 | 31174 | Br₂Hg₂ | 2.068 | 38 | δ2(a) = −1.0 | {e} |
| 139 | 168410 | C₂Ba₁ | 1.469 | 18 | δ1(b) = 1.0 | {a, e} |
| 139 | 186575 | C₂Ba₁ | 1.457 | 18 | δ1(b) = 1.0 | {a, e} |
| 139 | 56160 | C₂Ba₁ | 1.394 | 18 | δ1(b) = 1.0 | {a, e} |
| 139 | 615792 | C₂Ba₁ | 1.646 | 18 | δ1(b) = 1.0 | {a, e} |
| 139 | 615794 | C₂Ba₁ | 0.409 | 18 | δ1(b) = 1.0 | {a, e} |
| 139 | 88098 | C₂Ba₁ | 1.664 | 18 | δ1(b) = 1.0 | {a, e} |
| 139 | 88101 | C₂Ba₁ | 1.414 | 18 | δ1(b) = 1.0 | {a, e} |
| 139 | 252714 | C₂Ca₁ | 1.728 | 10 | δ1(b) = 1.0 | {a, e} |
| 139 | 252717 | C₂Ca₁ | 2.122 | 10 | δ1(b) = 1.0 | {a, e} |
| 139 | 252720 | C₂Ca₁ | 0.228 | 10 | δ1(b) = 1.0 | {a, e} |
| 139 | 252723 | C₂Ca₁ | 0.281 | 10 | δ1(b) = 1.0 | {a, e} |
| 139 | 252726 | C₂Ca₁ | 1.588 | 10 | δ1(b) = 1.0 | {a, e} |
| 139 | 252729 | C₂Ca₁ | 1.449 | 10 | δ1(b) = 1.0 | {a, e} |
| 139 | 252732 | C₂Ca₁ | 1.632 | 10 | δ1(b) = 1.0 | {a, e} |
| 139 | 252735 | C₂Ca₁ | 1.774 | 10 | δ1(b) = 1.0 | {a, e} |
| 139 | 252738 | C₂Ca₁ | 2.293 | 10 | δ1(b) = 1.0 | {a, e} |
| 139 | 252741 | C₂Ca₁ | 1.73 | 10 | δ1(b) = 1.0 | {a, e} |
| 139 | 252744 | C₂Ca₁ | 1.732 | 10 | δ1(b) = 1.0 | {a, e} |
| 139 | 252747 | C₂Ca₁ | 2.388 | 10 | δ1(b) = 1.0 | {a, e} |
| 139 | 252750 | C₂Ca₁ | 1.723 | 10 | δ1(b) = 1.0 | {a, e} |
| 139 | 252753 | C₂Ca₁ | 2.387 | 10 | δ1(b) = 1.0 | {a, e} |
| 139 | 252756 | C₂Ca₁ | 1.449 | 10 | δ1(b) = 1.0 | {a, e} |
| 139 | 252759 | C₂Ca₁ | 1.729 | 10 | δ1(b) = 1.0 | {a, e} |
| 139 | 252762 | C₂Ca₁ | 1.272 | 10 | δ1(b) = 1.0 | {a, e} |
| 139 | 252765 | C₂Ca₁ | 1.254 | 10 | δ1(b) = 1.0 | {a, e} |
| 139 | 252768 | C₂Ca₁ | 1.732 | 10 | δ1(b) = 1.0 | {a, e} |
| 139 | 252771 | C₂Ca₁ | 1.731 | 10 | δ1(b) = 1.0 | {a, e} |
| 139 | 252774 | C₂Ca₁ | 2.151 | 10 | δ1(b) = 1.0 | {a, e} |
| 139 | 410313 | C₂Ca₁ | 1.569 | 10 | δ1(b) = 1.0 | {a, e} |
| 139 | 411188 | C₂Ca₁ | 1.539 | 10 | δ1(b) = 1.0 | {a, e} |
| 139 | 54186 | C₂Ca₁ | 1.205 | 10 | δ1(b) = 1.0 | {a, e} |
| 139 | 56158 | C₂Ca₁ | 1.725 | 10 | δ1(b) = 1.0 | {a, e} |
| 139 | 617300 | C₂Ca₁ | 1.539 | 10 | δ1(b) = 1.0 | {a, e} |
| 139 | 617303 | C₂Ca₁ | 1.521 | 10 | δ1(b) = 1.0 | {a, e} |
| 139 | 672968 | C₂Ca₁ | 1.325 | 10 | δ1(b) = 1.0 | {a, e} |
| 139 | 74665 | C₂Ca₁ | 1.596 | 10 | δ1(b) = 1.0 | {a, e} |
| 139 | 410316 | C₂Sr₁ | 2.014 | 18 | δ1(b) = 1.0 | {a, e} |
| 139 | 410317 | C₂Sr₁ | 1.849 | 18 | δ1(b) = 1.0 | {a, e} |
| 139 | 618813 | C₂Sr₁ | 1.951 | 18 | δ1(b) = 1.0 | {a, e} |
| 139 | 618815 | C₂Sr₁ | 0.872 | 18 | δ1(b) = 1.0 | {a, e} |
| 139 | 91048 | C₂Sr₁ | 1.914 | 18 | δ1(b) = 1.0 | {a, e} |
| 139 | 91050 | C₂Sr₁ | 2.004 | 18 | δ1(b) = 1.0 | {a, e} |
| 139 | 20275 | Ca₁O₂ | 1.636 | 14 | δ2(a) = −1.0 | {e, b} |
| 139 | 619462 | Ca₁O₂ | 1.384 | 14 | δ2(b) = −1.0 | {a, e} |
| 139 | 671324 | Ca₁O₂ | 2.897 | 14 | δ2(b) = −1.0 | {a, e} |
| 139 | 157979 | Cl₂Hg₂ | 1.833 | 38 | δ2(a) = −1.0 | {e} |
| 139 | 23720 | Cl₂Hg₂ | 2.836 | 38 | δ2(a) = −1.0 | {e} |
| 139 | 31173 | Cl₂Hg₂ | 2.367 | 38 | δ2(a) = −1.0 | {e} |
| 139 | 36195 | Cl₂Hg₂ | 2.413 | 38 | δ2(a) = −1.0 | {e} |
| 139 | 65441 | Cl₂Hg₂ | 2.913 | 38 | δ2(a) = −1.0 | {e} |
| 139 | 23719 | F₂Hg₂ | 1.635 | 38 | δ2(a) = −1.0 | {e} |
| 139 | 27700 | F₂Hg₂ | 1.325 | 38 | δ2(a) = −1.0 | {e} |
| 139 | 72354 | F₂Hg₂ | 1.72 | 38 | δ2(a) = −1.0 | {e} |
| 139 | 160496 | Ga₃K₂ | 0.119 | 54 | δ1(a) = −1.0, δ1(c) = −1.0 | {d, e, i} |
| 139 | 673919 | Hg₁I₁ | 1.607 | 38 | δ2(a) = −1.0 | {e} |
| 139 | 157981 | Hg₁I₁ | 1.106 | 38 | δ2(a) = −1.0 | {e} |
| 139 | 262368 | Hg₂I₂ | 1.594 | 38 | δ2(a) = −1.0 | {e} |
| 139 | 36189 | Hg₂I₂ | 1.197 | 38 | δ2(a) = −1.0 | {e} |
| 139 | 370026 | In₃Rb₂ | 0.048 | 54 | δ1(a) = −1.0, δ1(c) = −1.0 | {d, e, i} |
| 139 | 24249 | O₂Sr₁ | 2.202 | 22 | δ2(b) = −1.0 | {a, e} |
| 139 | 647474 | O₂Sr₁ | 2.778 | 22 | δ2(b) = −1.0 | {a, e} |
| 140 | 75555 | Ba₃Te₂ | 0.345 | 44 | δ1(d) = −1.0 | {a, h} |
| 140 | 80280 | Ba₃Te₂ | 0.345 | 44 | δ1(d) = −1.0 | {a, h} |
| 140 | 671323 | Ca₁O₂ | 2.952 | 28 | δ1(d) = −1.0 | {a, h} |
| 140 | 672113 | O₂Zn₁ | 3.207 | 48 | δ1(d) = −1.0 | {a, h} |
| 140 | 23640 | S₂Sr₁ | 1.334 | 44 | δ1(d) = −1.0 | {a, h} |
| 140 | 642 | S₂Sr₁ | 1.3 | 44 | δ1(d) = −1.0 | {a, h} |
| 141 | 200286 | Au₁Br₁ | 1.49 | 72 | δ1(d) = −5.0 | {c, e} |
| 141 | 6052 | Au₁Cl₁ | 1.226 | 72 | δ1(c) = −5.0 | {d, e} |
| 141 | 1093 | O₃U₁ | 1.347 | 256 | δ1(c) = 2.0 | {h, d, e} |
| 141 | 15884 | O₃U₁ | 0.503 | 256 | δ1(d) = 2.0 | {c, e, h} |
| 141 | 670375 | O₃U₁ | 1.349 | 256 | δ1(c) = 2.0 | {h, d, e} |
| 141 | 153257 | O₆₄Si₃₂ | 5.621 | 256 | δ1(c) = 2.0 | {e, h, d, i, g} |
| 148 | 41540 | Br₁₂Zr6 | 0.013 | 108 | δ2(a) = −2.0 | {f} |
| 148 | 41539 | Cl₁₂Zr6 | 0.025 | 108 | δ2(a) = −2.0 | {f} |
| 148 | 35145 | I₁₂Zr6 | 0.005 | 108 | δ2(a) = −2.0 | {f} |
| 148 | 239355 | I6Si₂ | 2.809 | 50 | δ2(a) = −1.0 | {f, c} |
| 164 | 247679 | C₁N₂ | 2.316 | 28 | δ2(a) = −1.0, δ1(f) = −1.0 | {c, d} |
| 164 | 670188 | C₂Mg₁ | 0.686 | 10 | δ1(e) = −1.0 | {d, b} |
| 166 | 107916 | As₁B6 | 2.573 | 46 | δ2(a) = 1.0, δ2(b) = −1.0, δ1(d) = −1.0 | {c, h} |
| 166 | 68151 | As₁B6 | 2.655 | 46 | δ2(a) = 1.0, δ2(b) = −1.0, δ1(d) = −1.0 | {c, h} |
| 166 | 62749 | As₂B₁₂ | 2.64 | 46 | δ2(a) = 1.0, δ2(b) = −1.0, δ1(d) = −1.0 | {c, h} |
| 166 | 62748 | B₁₂P₂ | 2.419 | 46 | δ2(a) = 1.0, δ2(b) = −1.0, δ1(d) = −1.0 | {c, h} |
| 166 | 615435 | B₁₂Si₃ | 0.67 | 48 | δ2(a) = 1.0, δ1(d) = −1.0 | {c, h, b} |
| 166 | 615112 | B6O₁ | 1.192 | 48 | δ2(a) = 1.0, δ1(d) = −1.0 | {c, h} |
| 166 | 656230 | B6O₁ | 2.057 | 48 | δ2(a) = 1.0, δ1(d) = −1.0 | {c, h} |
| 166 | 656231 | B6O₁ | 1.67 | 48 | δ2(a) = 1.0, δ1(d) = −1.0 | {c, h} |
| 166 | 71065 | B6O₁ | 1.67 | 48 | δ2(a) = 1.0, δ1(d) = −1.0 | {c, h} |
| 166 | 71066 | B6O₁ | 2.057 | 48 | δ2(a) = 1.0, δ1(d) = −1.0 | {c, h} |
| 166 | 82879 | B6O₁ | 1.683 | 48 | δ2(a) = 1.0, δ1(d) = −1.0 | {c, h} |
| 166 | 615156 | B6P₁ | 2.375 | 46 | δ2(a) = 1.0, δ2(b) = −1.0, δ1(d) = −1.0 | {c, h} |
| 166 | 615157 | B6P₁ | 2.375 | 46 | δ2(a) = 1.0, δ2(b) = −1.0, δ1(d) = −1.0 | {c, h} |
| 166 | 25766 | Br₈Nb₃ | 0.069 | 190 | δ2(b) = −1.0 | {c, h} |
| 166 | 421609 | Br₈Nb₃ | 0.06 | 190 | δ2(b) = −1.0 | {c, h} |
| 166 | 29093 | C₁B₄ | 1.102 | 48 | δ2(a) = 1.0, δ1(d) = −1.0 | {c, h, b} |
| 166 | 654971 | C₁B₄ | 1.106 | 48 | δ2(a) = 1.0, δ1(d) = −1.0 | {c, h, b} |
| 166 | 186576 | C₂Ba₁ | 1.043 | 18 | δ1(b) = 1.0 | {a, c} |
| 166 | 236872 | C₂Ca₁ | 2.086 | 10 | δ1(b) = 1.0 | {a, c} |
| 166 | 236873 | C₂Sr₁ | 1.677 | 18 | δ1(b) = 1.0 | {a, c} |
| 166 | 612562 | C₃B₁₂ | 0.84 | 48 | δ2(a) = 1.0, δ1(d) = −1.0 | {c, h, b} |
| 166 | 40824 | Ga₁S₁ | 1.553 | 18 | δ2(a) = −1.0 | {c} |
| 166 | 25767 | I₈Nb₃ | 0.091 | 190 | δ2(b) = −1.0 | {c, h} |
| 187 | 673442 | Cr₁N₂ | 0.609 | 16 | δ1(0) = 1.0, δ1(f) = 1.0, δ1(h) = 1.0 | {a, i} |
| 187 | 601159 | Ga₁Se₁ | 1.024 | 36 | δ1(0) = 1.0, δ1(f) = 1.0 | {h, i, g} |
| 187 | 635363 | Ga₁Se₁ | 1.003 | 36 | δ1(b) = 1.0, δ1(e) = 1.0 | {h, i, g} |
| 187 | 635372 | Ga₁Se₁ | 1.05 | 36 | δ1(b) = 1.0, δ1(e) = 1.0 | {h, i, g} |
| 187 | 71082 | Ga₁Se₁ | 1.068 | 36 | δ1(a) = 1.0, δ1(f) = 1.0 | {h, i, g} |
| 187 | 73387 | Ga₁Se₁ | 1.068 | 36 | δ1(b) = 1.0, δ1(e) = 1.0 | {h, i, g} |
| 187 | 640503 | In₁Se₁ | 0.66 | 36 | δ1(a) = 1.0, δ1(f) = 1.0 | {h, i, g} |
| 187 | 674581 | Mo₁N₂ | 0.765 | 16 | δ1(d) = 1.0, δ1(e) = 1.0, δ1(1) = 1.0 | {a, h} |
| 187 | 290433 | N₂W₁ | 0.81 | 16 | δ1(a) = 1.0, δ1(d) = 1.0, δ1(h) = 1.0 | {f, g} |
| 189 | 26261 | Ca₁P₁ | 0.405 | 42 | δ1(b) = 1.0, δ1(0) = −1.0 | {f, h, e, g} |
| 189 | 83352 | Ca₂P₂ | 0.281 | 42 | δ1(b) = 1.0, δ1(0) = −1.0 | {f, h, e, g} |
| 189 | 43406 | K₂S₂ | 1.517 | 90 | δ1(b) = 1.0, δ1(0) = −1.0 | {f, h, e, g} |
| 189 | 73171 | K₂S₂ | 1.44 | 90 | δ1(a) = 1.0, δ1(d) = −1.0 | {f, h, e, g} |
| 189 | 73172 | K₂Se₂ | 0.697 | 90 | δ1(a) = 1.0, δ1(d) = −1.0 | {f, h, e, g} |
| 189 | 109276 | Na₂O₂ | 1.981 | 42 | δ1(a) = 1.0, δ1(d) = −1.0 | {f, h, e, g} |
| 189 | 180558 | Na₂O₂ | 1.438 | 42 | δ1(a) = 1.0, δ1(d) = −1.0 | {f, h, e, g} |
| 189 | 25526 | Na₂O₂ | 1.975 | 42 | δ1(b) = 1.0, δ1(0) = −1.0 | {f, h, e, g} |
| 189 | 26575 | Na₂O₂ | 1.978 | 42 | δ1(a) = 1.0, δ1(d) = −1.0 | {f, h, e, g} |
| 189 | 43405 | Na₂S₂ | 0.861 | 42 | δ1(b) = 1.0, δ1(0) = −1.0 | {f, h, e, g} |
| 189 | 73180 | Na₂S₂ | 0.896 | 42 | δ1(a) = 1.0, δ1(d) = −1.0 | {f, h, e, g} |
| 189 | 26262 | P₁Sr₁ | 0.457 | 90 | δ1(b) = 1.0, δ1(0) = −1.0 | {f, h, e, g} |
| 189 | 73176 | Rb₂S₂ | 1.03 | 90 | δ1(a) = 1.0, δ1(d) = −1.0 | {f, h, e, g} |
| 194 | 168280 | C₂Os₁ | 0.018 | 32 | δ2(a) = −1.0 | {d, e} |
| 194 | 673438 | Cr₁N₂ | 0.762 | 32 | δ2(a) = −1.0, δ1(0) = 1.0 | {d, e} |
| 194 | 167394 | Ga₁S₁ | 1.574 | 36 | δ1(0) = 1.0 | {f} |
| 194 | 173940 | Ga₁S₁ | 1.553 | 36 | δ1(0) = 1.0 | {f} |
| 194 | 173941 | Ga₁S₁ | 1.552 | 36 | δ1(0) = 1.0 | {f} |
| 194 | 201344 | Ga₁S₁ | 1.553 | 36 | δ1(0) = 1.0 | {f} |
| 194 | 201345 | Ga₁S₁ | 1.552 | 36 | δ1(0) = 1.0 | {f} |
| 194 | 25660 | Ga₁S₁ | 1.566 | 36 | δ1(0) = 1.0 | {f} |
| 194 | 53586 | Ga₁S₁ | 1.469 | 36 | δ1(0) = 1.0 | {f} |
| 194 | 53587 | Ga₁S₁ | 1.586 | 36 | δ1(0) = 1.0 | {f} |
| 194 | 53588 | Ga₁S₁ | 0.972 | 36 | δ1(0) = 1.0 | {f} |
| 194 | 53589 | Ga₁S₁ | 1.21 | 36 | δ1(0) = 1.0 | {f} |
| 194 | 53590 | Ga₁S₁ | 1.06 | 36 | δ1(0) = 1.0 | {f} |
| 194 | 59 | Ga₁S₁ | 1.574 | 36 | δ1(0) = 1.0 | {f} |
| 194 | 635244 | Ga₁S₁ | 1.575 | 36 | δ1(0) = 1.0 | {f} |
| 194 | 635251 | Ga₁S₁ | 1.588 | 36 | δ1(0) = 1.0 | {f} |
| 194 | 635254 | Ga₁S₁ | 1.042 | 36 | δ1(b) = 1.0 | {f, e} |
| 194 | 658768 | Ga₁S₁ | 1.613 | 36 | δ1(0) = 1.0 | {f} |
| 194 | 673912 | Ga₁S₁ | 1.966 | 36 | δ1(0) = 1.0 | {f} |
| 194 | 20237 | Ga₁Se₁ | 1.175 | 36 | δ1(0) = 1.0 | {f} |
| 194 | 41978 | Ga₁Se₁ | 0.886 | 36 | δ1(0) = 1.0 | {f} |
| 194 | 43540 | Ga₁Se₁ | 0.886 | 36 | δ1(0) = 1.0 | {f} |
| 194 | 63122 | Ga₁Se₁ | 0.929 | 36 | δ1(0) = 1.0 | {f} |
| 194 | 635369 | Ga₁Se₁ | 0.913 | 36 | δ1(0) = 1.0 | {f} |
| 194 | 635382 | Ga₁Se₁ | 0.933 | 36 | δ1(0) = 1.0 | {f} |
| 194 | 673913 | Ga₁Se₁ | 1.048 | 36 | δ1(0) = 1.0 | {f} |
| 194 | 673914 | Ga₁Te₁ | 0.479 | 36 | δ1(0) = 1.0 | {f} |
| 194 | 290428 | Hf₁N₂ | 0.49 | 28 | δ2(a) = −1.0 | {d, e} |
| 194 | 185172 | In₁Se₁ | 0.479 | 36 | δ1(0) = 1.0 | {f} |
| 194 | 430520 | K₂Se₂ | 0.887 | 60 | δ1(d) = 1.0 | {a, c, f} |
| 194 | 73174 | K₂Te₂ | 0.483 | 60 | δ1(d) = 1.0 | {a, c, f} |
| 194 | 96741 | K₂Te₂ | 0.428 | 60 | δ1(d) = 1.0 | {a, c, f} |
| 194 | 152183 | Li₂O₂ | 1.977 | 28 | δ1(d) = 1.0 | {a, c, f} |
| 194 | 180557 | Li₂O₂ | 1.562 | 28 | δ1(d) = 1.0 | {a, c, f} |
| 194 | 25530 | Li₂O₂ | 2.254 | 28 | δ1(d) = 1.0 | {a, c, f} |
| 194 | 674574 | Mo₁N₂ | 0.896 | 32 | δ2(a) = −1.0, δ1(0) = 1.0 | {d, e} |
| 194 | 105091 | Mo₁S₂ | 0.737 | 36 | δ1(b) = 1.0, δ1(e) = 2.0 | {f, c} |
| 194 | 191305 | Mo₁S₂ | 0.888 | 36 | δ1(b) = 1.0, δ1(e) = 2.0 | {f, c} |
| 194 | 196994 | Mo₁S₂ | 0.847 | 36 | δ1(b) = 1.0, δ1(e) = 2.0 | {f, d} |
| 194 | 24000 | Mo₁S₂ | 0.869 | 36 | δ1(b) = 1.0, δ1(e) = 2.0 | {f, c} |
| 194 | 31067 | Mo₁S₂ | 1.002 | 36 | δ1(b) = 1.0, δ1(e) = 2.0 | {f, c} |
| 194 | 49801 | Mo₁S₂ | 0.861 | 36 | δ1(b) = 1.0, δ1(e) = 2.0 | {f, c} |
| 194 | 601647 | Mo₁₁S₂ | 0.848 | 36 | δ1(b) = 1.0, δ1(e) = 2.0 | {f, c} |
| 194 | 644245 | Mo₁S₂ | 0.868 | 36 | δ1(b) = 1.0, δ1(e) = 2.0 | {f, c} |
| 194 | 644246 | Mo₁S₂ | 0.87 | 36 | δ1(b) = 1.0, δ1(e) = 2.0 | {f, c} |
| 194 | 644250 | Mo₁S₂ | 0.866 | 36 | δ1(b) = 1.0, δ1(e) = 2.0 | {f, c} |
| 194 | 644259 | Mo₁S₂ | 0.906 | 36 | δ1(d) = 1.0 | {f, b} |
| 194 | 674349 | Mo₁S₂ | 0.878 | 36 | δ1(b) = 1.0, δ1(e) = 2.0 | {f, c} |
| 194 | 674355 | Mo₁S₂ | 0.843 | 36 | δ1(b) = 1.0, δ1(e) = 2.0 | {f, c} |
| 194 | 674361 | Mo₁S₂ | 0.85 | 36 | δ1(b) = 1.0, δ1(e) = 2.0 | {f, c} |
| 194 | 674383 | Mo₁S₂ | 0.807 | 36 | δ1(b) = 1.0, δ1(e) = 2.0 | {f, c} |
| 194 | 84180 | Mo₁S₂ | 0.847 | 36 | δ1(b) = 1.0, δ1(e) = 2.0 | {f, d} |
| 194 | 95569 | Mo₁S₂ | 0.888 | 36 | δ1(b) = 1.0, δ1(e) = 2.0 | {f, c} |
| 194 | 95570 | Mo₁S₂ | 0.906 | 36 | δ1(b) = 1.0, δ1(e) = 2.0 | {f, c} |
| 194 | 167357 | Mo₁Se₂ | 0.861 | 36 | δ1(b) = 1.0, δ1(e) = 2.0 | {f, c} |
| 194 | 191306 | Mo₁Se₂ | 0.843 | 36 | δ1(b) = 1.0, δ1(e) = 2.0 | {f, c} |
| 194 | 49800 | Mo₁Se₂ | 0.822 | 36 | δ1(b) = 1.0, δ1(e) = 2.0 | {f, c} |
| 194 | 601045 | Mo₁Se₂ | 0.812 | 36 | δ1(b) = 1.0, δ1(e) = 2.0 | {f, d} |
| 194 | 644334 | Mo₁Se₂ | 0.863 | 36 | δ1(b) = 1.0, δ1(e) = 2.0 | {f, c} |
| 194 | 644335 | Mo₁Se₂ | 0.82 | 36 | δ1(b) = 1.0, δ1(e) = 2.0 | {f, c} |
| 194 | 644340 | Mo₁Se₂ | 0.826 | 36 | δ1(b) = 1.0, δ1(e) = 2.0 | {f, c} |
| 194 | 644346 | Mo₁Se₂ | 0.856 | 36 | δ1(d) = 1.0 | {f, b} |
| 194 | 674350 | Mo₁Se₂ | 0.828 | 36 | δ1(b) = 1.0, δ1(e) = 2.0 | {f, c} |
| 194 | 674356 | Mo₁Se₂ | 0.812 | 36 | δ1(b) = 1.0, δ1(e) = 2.0 | {f, c} |
| 194 | 674362 | Mo₁Se₂ | 0.814 | 36 | δ1(b) = 1.0, δ1(e) = 2.0 | {f, c} |
| 194 | 15431 | Mo₁Te₂ | 0.72 | 36 | δ1(b) = 1.0, δ1(e) = 2.0 | {f, c} |
| 194 | 24155 | Mo₁Te₂ | 0.699 | 36 | δ1(b) = 1.0, δ1(e) = 2.0 | {f, c} |
| 194 | 644476 | Mo₁Te₂ | 0.711 | 36 | δ1(b) = 1.0, δ1(e) = 2.0 | {f, c} |
| 194 | 644481 | Mo₁Te₂ | 0.715 | 36 | δ1(b) = 1.0, δ1(e) = 2.0 | {f, c} |
| 194 | 674351 | Mo₁Te₂ | 0.66 | 36 | δ1(b) = 1.0, δ1(e) = 2.0 | {f, c} |
| 194 | 674357 | Mo₁Te₂ | 0.656 | 36 | δ1(b) = 1.0, δ1(e) = 2.0 | {f, c} |
| 194 | 674363 | Mo₁Te₂ | 0.662 | 36 | δ1(b) = 1.0, δ1(e) = 2.0 | {f, c} |
| 194 | 290434 | N₂W₁ | 1.031 | 32 | δ2(a) = −1.0, δ1(c) = 1.0 | {d, e} |
| 194 | 644958 | Na₁S₁ | 1.263 | 28 | δ1(d) = 1.0 | {a, c, f} |
| 194 | 43407 | Na₂S₂ | 1.263 | 28 | δ1(d) = 1.0 | {a, c, f} |
| 194 | 644955 | Na₂S₂ | 1.212 | 28 | δ1(d) = 1.0 | {a, c, f} |
| 194 | 73173 | Na₂S₂ | 1.234 | 28 | δ1(d) = 1.0 | {a, c, f} |
| 194 | 43408 | Na₂Se₂ | 0.573 | 28 | δ1(d) = 1.0 | {a, c, f} |
| 194 | 196773 | S₂W₁ | 0.918 | 36 | δ1(b) = 1.0, δ1(e) = 2.0 | {f, c} |
| 194 | 196993 | S₂W₁ | 0.825 | 36 | δ1(b) = 1.0, δ1(e) = 2.0 | {f, d} |
| 194 | 202366 | S₂W₁ | 0.94 | 36 | δ1(b) = 1.0, δ1(e) = 2.0 | {f, c} |
| 194 | 56014 | S₂W₁ | 1.006 | 36 | δ1(b) = 1.0, δ1(e) = 2.0 | {f, d} |
| 194 | 651384 | S₂W₁ | 0.823 | 36 | δ1(b) = 1.0, δ1(e) = 2.0 | {f, d} |
| 194 | 651387 | S₂W₁ | 0.813 | 36 | δ1(b) = 1.0, δ1(e) = 2.0 | {f, d} |
| 194 | 674352 | S₂W₁ | 0.959 | 36 | δ1(b) = 1.0, δ1(e) = 2.0 | {f, c} |
| 194 | 674358 | S₂W₁ | 0.924 | 36 | δ1(b) = 1.0, δ1(e) = 2.0 | {f, c} |
| 194 | 674364 | S₂W₁ | 0.957 | 36 | δ1(b) = 1.0, δ1(e) = 2.0 | {f, c} |
| 194 | 84181 | S₂W₁ | 0.825 | 36 | δ1(b) = 1.0, δ1(e) = 2.0 | {f, d} |
| 194 | 196992 | Se₂W₁ | 0.867 | 36 | δ1(b) = 1.0, δ1(e) = 2.0 | {f, d} |
| 194 | 40752 | Se₂W₁ | 0.881 | 36 | δ1(b) = 1.0, δ1(e) = 2.0 | {f, c} |
| 194 | 652167 | Se₂W₁ | 0.863 | 36 | δ1(b) = 1.0, δ1(e) = 2.0 | {f, d} |
| 194 | 652170 | Se₂W₁ | 0.869 | 36 | δ1(b) = 1.0, δ1(e) = 2.0 | {f, d} |
| 194 | 674353 | Se₂W₁ | 0.889 | 36 | δ1(b) = 1.0, δ1(e) = 2.0 | {f, c} |
| 194 | 674359 | Se₂W₁ | 0.862 | 36 | δ1(b) = 1.0, δ1(e) = 2.0 | {f, c} |
| 194 | 674365 | Se₂W₁ | 0.872 | 36 | δ1(b) = 1.0, δ1(e) = 2.0 | {f, c} |
| 194 | 84182 | Se₂W₁ | 0.867 | 36 | δ1(b) = 1.0, δ1(e) = 2.0 | {f, d} |
| 194 | 653170 | Te₂W₁ | 0.564 | 36 | δ1(b) = 1.0, δ1(e) = 2.0 | {f, c} |
| 194 | 674354 | Te₂W₁ | 0.611 | 36 | δ1(b) = 1.0, δ1(e) = 2.0 | {f, c} |
| 194 | 674360 | Te₂W₁ | 0.582 | 36 | δ1(b) = 1.0, δ1(e) = 2.0 | {f, c} |
| 194 | 674366 | Te₂W₁ | 0.613 | 36 | δ1(b) = 1.0, δ1(e) = 2.0 | {f, c} |
| 204 | 201140 | N₂O₄ | 2.83 | 102 | δ1(b) = −1.0 | {d, g} |
| 204 | 201141 | N₂O₄ | 2.85 | 102 | δ1(b) = −1.0 | {d, g} |
| 204 | 201142 | N₂O₄ | 2.873 | 102 | δ1(b) = −1.0 | {d, g} |
| 204 | 29047 | N₂O₄ | 3.597 | 102 | δ1(b) = −1.0 | {d, g} |
| 204 | 52347 | N₂O₄ | 2.321 | 102 | δ1(b) = −1.0 | {e, g} |
| 205 | 196823 | As₂Pt₁ | 0.252 | 80 | δ2(b) = −1.0 | {a, c} |
| 205 | 24156 | As₂Pt₁ | 0.345 | 80 | δ2(b) = −1.0 | {a, c} |
| 205 | 24203 | As₂Pt₁ | 0.225 | 80 | δ2(b) = −1.0 | {a, c} |
| 205 | 38428 | As₂Pt₁ | 0.243 | 80 | δ2(b) = −1.0 | {a, c} |
| 205 | 43104 | As₂Pt₁ | 0.252 | 80 | δ2(b) = −1.0 | {a, c} |
| 205 | 52375 | As₂Pt₁ | 0.249 | 80 | δ2(b) = −1.0 | {a, c} |
| 205 | 611228 | As₂Pt₁ | 0.25 | 80 | δ2(b) = −1.0 | {a, c} |
| 205 | 611230 | As₂Pt₁ | 0.307 | 80 | δ2(b) = −1.0 | {a, c} |
| 205 | 109339 | Cd₁O₂ | 1.45 | 96 | δ2(a) = −1.0 | {c, b} |
| 205 | 36151 | Cd₁O₂ | 1.392 | 96 | δ2(b) = −1.0 | {a, c} |
| 205 | 60764 | Cd₁O₂ | 1.392 | 96 | δ2(b) = −1.0 | {a, c} |
| 205 | 620201 | Cd₁O₂ | 1.399 | 96 | δ2(b) = −1.0 | {a, c} |
| 205 | 620305 | Cd₁S₂ | 0.693 | 96 | δ2(b) = −1.0 | {a, c} |
| 205 | 620416 | Cd₁Se₂ | 0.5 | 96 | δ2(b) = −1.0 | {a, c} |
| 205 | 109377 | Fe₁S₂ | 0.598 | 80 | δ2(b) = −1.0 | {a, c} |
| 205 | 15012 | Fe₁S₂ | 0.512 | 80 | δ2(b) = −1.0 | {a, c} |
| 205 | 316 | Fe₁S₂ | 0.614 | 80 | δ2(b) = −1.0 | {a, c} |
| 205 | 43716 | Fe₁S₂ | 0.511 | 80 | δ2(b) = −1.0 | {a, c} |
| 205 | 52372 | Fe₁S₂ | 0.709 | 80 | δ2(b) = −1.0 | {a, c} |
| 205 | 53529 | Fe₁S₂ | 0.708 | 80 | δ2(b) = −1.0 | {a, c} |
| 205 | 53935 | Fe₁S₂ | 0.132 | 80 | δ2(b) = −1.0 | {a, c} |
| 205 | 633254 | Fe₁S₂ | 0.61 | 80 | δ2(b) = −1.0 | {a, c} |
| 205 | 633270 | Fe₁S₂ | 0.61 | 80 | δ2(b) = −1.0 | {a, c} |
| 205 | 633273 | Fe₁S₂ | 0.512 | 80 | δ2(b) = −1.0 | {a, c} |
| 205 | 633274 | Fe₁S₂ | 0.61 | 80 | δ2(b) = −1.0 | {a, c} |
| 205 | 633287 | Fe₁S₂ | 0.29 | 80 | δ2(b) = −1.0 | {a, c} |
| 205 | 633288 | Fe₁S₂ | 0.5 | 80 | δ2(b) = −1.0 | {a, c} |
| 205 | 633289 | Fe₁S₂ | 0.709 | 80 | δ2(b) = −1.0 | {a, c} |
| 205 | 633293 | Fe₁S₂ | 0.61 | 80 | δ2(b) = −1.0 | {a, c} |
| 205 | 656511 | Fe₁S₂ | 0.61 | 80 | δ2(b) = −1.0 | {a, c} |
| 205 | 633475 | Fe₁Se₂ | 0.408 | 80 | δ2(b) = −1.0 | {a, c} |
| 205 | 633869 | Fe₁Te₂ | 0.034 | 80 | δ2(b) = −1.0 | {a, c} |
| 205 | 290429 | Hf₁N₂ | 0.882 | 56 | δ2(b) = −1.0 | {a, c} |
| 205 | 35479 | Mg₁O₂ | 3.905 | 56 | δ2(a) = −1.0 | {c, b} |
| 205 | 41732 | Mg₁O₂ | 3.942 | 56 | δ2(b) = −1.0 | {a, c} |
| 205 | 642815 | Mg₁Se₂ | 1.566 | 56 | δ2(b) = −1.0 | {a, c} |
| 205 | 30390 | Mg₁Te₂ | 1.201 | 56 | δ2(b) = −1.0 | {a, c} |
| 205 | 41733 | Mg₁Te₂ | 1.094 | 56 | δ2(b) = −1.0 | {a, c} |
| 205 | 642881 | Mg₁Te₂ | 1.059 | 56 | δ2(b) = −1.0 | {a, c} |
| 205 | 191245 | N₂Pd₁ | 0.643 | 80 | δ2(b) = −1.0 | {a, c} |
| 205 | 166462 | N₂Pt₁ | 1.089 | 80 | δ2(b) = −1.0 | {a, c} |
| 205 | 169857 | N₂Pt₁ | 1.477 | 80 | δ2(b) = −1.0 | {a, c} |
| 205 | 290447 | N₂Pt₁ | 1.231 | 80 | δ2(b) = −1.0 | {a, c} |
| 205 | 60763 | O₂Zn₁ | 2.322 | 96 | δ2(b) = −1.0 | {a, c} |
| 205 | 647668 | O₂Zn₁ | 2.328 | 96 | δ2(b) = −1.0 | {a, c} |
| 205 | 24187 | Os₁S₂ | 0.086 | 80 | δ2(b) = −1.0 | {a, c} |
| 205 | 300224 | Os₁S₂ | 0.051 | 80 | δ2(b) = −1.0 | {a, c} |
| 205 | 56020 | Os₁S₂ | 1.517 | 80 | δ2(a) = −1.0 | {c, b} |
| 205 | 647749 | Os₁S₂ | 0.035 | 80 | δ2(b) = −1.0 | {a, c} |
| 205 | 647750 | Os₁S₂ | 0.029 | 80 | δ2(b) = −1.0 | {a, c} |
| 205 | 24202 | Os₁Se₂ | 0.104 | 80 | δ2(b) = −1.0 | {a, c} |
| 205 | 647826 | Os₁Te₂ | 0.588 | 80 | δ2(b) = −1.0 | {a, c} |
| 205 | 647829 | Os₁Te₂ | 0.583 | 80 | δ2(b) = −1.0 | {a, c} |
| 205 | 647831 | Os₁Te₂ | 0.578 | 80 | δ2(b) = −1.0 | {a, c} |
| 205 | 647832 | Os₁Te₂ | 0.581 | 80 | δ2(b) = −1.0 | {a, c} |
| 205 | 15026 | P₂Pt₁ | 1.114 | 80 | δ2(b) = −1.0 | {a, c} |
| 205 | 43103 | P₂Pt₁ | 1.002 | 80 | δ2(b) = −1.0 | {a, c} |
| 205 | 602147 | P₂Pt₁ | 1.166 | 80 | δ2(b) = −1.0 | {a, c} |
| 205 | 647967 | P₂Pt₁ | 1.116 | 80 | δ2(b) = −1.0 | {a, c} |
| 205 | 647970 | P₂Pt₁ | 0.983 | 80 | δ2(b) = −1.0 | {a, c} |
| 205 | 647971 | P₂Pt₁ | 0.985 | 80 | δ2(b) = −1.0 | {a, c} |
| 205 | 71029 | P₂Pt₁ | 1.119 | 80 | δ2(b) = −1.0 | {a, c} |
| 205 | 74514 | P₂Pt₁ | 1.126 | 80 | δ2(b) = −1.0 | {a, c} |
| 205 | 24186 | Ru₁S₂ | 0.59 | 80 | δ2(b) = −1.0 | {a, c} |
| 205 | 41996 | Ru₁S₂ | 0.069 | 80 | δ2(b) = −1.0 | {a, c} |
| 205 | 52374 | Ru₁S₂ | 0.919 | 80 | δ2(a) = −1.0 | {c, b} |
| 205 | 56019 | Ru₁S₂ | 1.823 | 80 | δ2(b) = −1.0 | {a, c} |
| 205 | 600680 | Ru₁S₂ | 0.705 | 80 | δ2(b) = −1.0 | {a, c} |
| 205 | 604472 | Ru₁S₂ | 0.398 | 80 | δ2(b) = −1.0 | {a, c} |
| 205 | 650577 | Ru₁S₂ | 0.705 | 80 | δ2(b) = −1.0 | {a, c} |
| 205 | 650579 | Ru₁S₂ | 0.705 | 80 | δ2(b) = −1.0 | {a, c} |
| 205 | 650581 | Ru₁S₂ | 0.705 | 80 | δ2(b) = −1.0 | {a, c} |
| 205 | 657507 | Ru₁S₂ | 0.705 | 80 | δ2(b) = −1.0 | {a, c} |
| 205 | 68472 | Ru₁S₂ | 0.738 | 80 | δ2(b) = −1.0 | {a, c} |
| 205 | 24201 | Ru₁Se₂ | 0.416 | 80 | δ2(b) = −1.0 | {a, c} |
| 205 | 650607 | Ru₁Se₂ | 0.415 | 80 | δ2(a) = −1.0 | {c, b} |
| 205 | 650609 | Ru₁Se₂ | 0.416 | 80 | δ2(b) = −1.0 | {a, c} |
| 205 | 650610 | Ru₁Se₂ | 0.32 | 80 | δ2(b) = −1.0 | {a, c} |
| 205 | 650611 | Ru₁Se₂ | 0.323 | 80 | δ2(b) = −1.0 | {a, c} |
| 205 | 657508 | Ru₁Se₂ | 0.415 | 80 | δ2(b) = −1.0 | {a, c} |
| 205 | 68473 | Ru₁Se₂ | 0.383 | 80 | δ2(b) = −1.0 | {a, c} |
| 205 | 24188 | Ru₁Te₂ | 0.139 | 80 | δ2(b) = −1.0 | {a, c} |
| 205 | 650710 | Ru₁Te₂ | 0.061 | 80 | δ2(b) = −1.0 | {a, c} |
| 205 | 650714 | Ru₁Te₂ | 0.072 | 80 | δ2(b) = −1.0 | {a, c} |
| 205 | 650719 | Ru₁Te₂ | 0.071 | 80 | δ2(b) = −1.0 | {a, c} |
| 205 | 650721 | Ru₁Te₂ | 0.124 | 80 | δ2(b) = −1.0 | {a, c} |
| 205 | 650722 | Ru₁Te₂ | 0.134 | 80 | δ2(b) = −1.0 | {a, c} |
| 205 | 65169 | Ru₁Te₂ | 0.076 | 80 | δ2(b) = −1.0 | {a, c} |
| 205 | 659137 | Ru₁Te₂ | 0.072 | 80 | δ2(b) = −1.0 | {a, c} |
| 205 | 651447 | S₂Zn₁ | 1.263 | 96 | δ2(b) = −1.0 | {a, c} |
| 205 | 652213 | Se₂Zn₁ | 0.695 | 96 | δ2(b) = −1.0 | {a, c} |
| 216 | 672039 | Ag₁Br₁ | 1.02 | 18 | δ1(d) = −1.0 | {a, c} |
| 216 | 672042 | Ag₁Cl₁ | 1.138 | 18 | δ1(d) = −1.0 | {a, c} |
| 216 | 670429 | Ag₁I₁ | 1.142 | 18 | δ1(d) = −1.0 | {a, c} |
| 216 | 670858 | B₄Fe₁ | 0.676 | 20 | δ1(b) = 1.0 | {a, e} |
| 216 | 616395 | Be₅Pt₁ | 0.006 | 20 | δ1(b) = 1.0 | {a, c, e} |
| 216 | 30090 | Br₁Cu₁ | 0.464 | 18 | δ1(d) = −1.0 | {a, c} |
| 216 | 670437 | Br₁Cu₁ | 0.4 | 18 | δ1(d) = −1.0 | {a, c} |
| 216 | 186009 | Cd₁S₁ | 1.099 | 18 | δ1(d) = −1.0 | {c, b} |
| 216 | 670446 | Cd₁S₁ | 1.024 | 18 | δ1(d) = −1.0 | {a, c} |
| 216 | 670449 | Cd₁Se₁ | 0.388 | 18 | δ1(d) = −1.0 | {a, c} |
| 216 | 290011 | Cd₁Te₁ | 0.321 | 18 | δ1(d) = −1.0 | {c, b} |
| 216 | 670452 | Cd₁Te₁ | 0.315 | 18 | δ1(d) = −1.0 | {a, c} |
| 216 | 93944 | Cd₁Te₁ | 0.509 | 18 | δ1(d) = −1.0 | {c, b} |
| 216 | 23988 | Cl₁Cu₁ | 0.395 | 18 | δ1(d) = −1.0 | {c, b} |
| 216 | 670453 | Cl₁Cu₁ | 0.444 | 18 | δ1(d) = −1.0 | {a, c} |
| 216 | 157431 | Cu₁I₁ | 0.996 | 18 | δ1(d) = −1.0 | {a, c} |
| 216 | 163427 | Cu₁I₁ | 1.005 | 18 | δ1(d) = −1.0 | {a, c} |
| 216 | 163436 | Cu₁I₁ | 1.002 | 18 | δ1(d) = −1.0 | {a, c} |
| 216 | 24771 | Cu₁I₁ | 0.89 | 18 | δ1(d) = −1.0 | {c, b} |
| 216 | 30085 | Cu₁I₁ | 1.029 | 18 | δ1(d) = −1.0 | {a, c} |
| 216 | 33724 | Cu₁I₁ | 1.027 | 18 | δ1(d) = −1.0 | {a, c} |
| 216 | 670438 | Cu₁I₁ | 0.927 | 18 | δ1(d) = −1.0 | {a, c} |
| 216 | 76611 | Cu₁I₁ | 0.991 | 18 | δ1(d) = −1.0 | {a, c} |
| 216 | 629316 | Cu₅Tb₁ | 0.015 | 74 | δ1(d) = −1.0 | {a, c, e} |
| 216 | 670493 | O₁Zn₁ | 0.612 | 18 | δ1(d) = −1.0 | {a, c} |
| 216 | 670479 | S₁Sn₁ | 0.134 | 10 | δ1(d) = 1.0 | {a, c} |
| 216 | 601048 | S₁Zn₁ | 2.119 | 18 | δ1(d) = −1.0 | {a, c} |
| 216 | 651445 | S₁Zn₁ | 2.096 | 18 | δ1(d) = −1.0 | {a, c} |
| 216 | 651451 | S₁Zn₁ | 1.938 | 18 | δ1(d) = −1.0 | {a, c} |
| 216 | 651454 | S₁Zn₁ | 2.097 | 18 | δ1(d) = −1.0 | {a, c} |
| 216 | 651455 | S₁Zn₁ | 2.097 | 18 | δ1(d) = −1.0 | {a, c} |
| 216 | 651457 | S₁Zn₁ | 2.096 | 18 | δ1(d) = −1.0 | {a, c} |
| 216 | 651458 | S₁Zn₁ | 2.109 | 18 | δ1(d) = −1.0 | {a, c} |
| 216 | 670469 | S₁Zn₁ | 1.959 | 18 | δ1(d) = −1.0 | {a, c} |
| 216 | 167830 | Se₁Zn₁ | 1.153 | 18 | δ1(d) = −1.0 | {c, b} |
| 216 | 652209 | Se₁Zn₁ | 1.201 | 18 | δ1(d) = −1.0 | {a, c} |
| 216 | 652210 | Se₁Zn₁ | 1.178 | 18 | δ1(d) = −1.0 | {a, c} |
| 216 | 652211 | Se₁Zn₁ | 0.982 | 18 | δ1(d) = −1.0 | {a, c} |
| 216 | 652212 | Se₁Zn₁ | 1.208 | 18 | δ1(d) = −1.0 | {a, c} |
| 216 | 652214 | Se₁Zn₁ | 1.204 | 18 | δ1(d) = −1.0 | {a, c} |
| 216 | 652215 | Se₁Zn₁ | 1.197 | 18 | δ1(d) = −1.0 | {a, c} |
| 216 | 652216 | Se₁Zn₁ | 1.195 | 18 | δ1(d) = −1.0 | {a, c} |
| 216 | 652220 | Se₁Zn₁ | 1.195 | 18 | δ1(d) = −1.0 | {a, c} |
| 216 | 652221 | Se₁Zn₁ | 1.201 | 18 | δ1(d) = −1.0 | {a, c} |
| 216 | 652222 | Se₁Zn₁ | 1.198 | 18 | δ1(d) = −1.0 | {a, c} |
| 216 | 652223 | Se₁Zn₁ | 1.193 | 18 | δ1(d) = −1.0 | {a, c} |
| 216 | 652224 | Se₁Zn₁ | 1.197 | 18 | δ1(d) = −1.0 | {a, c} |
| 216 | 652226 | Se₁Zn₁ | 1.21 | 18 | δ1(d) = −1.0 | {a, c} |
| 216 | 652227 | Se₁Zn₁ | 1.238 | 18 | δ1(d) = −1.0 | {a, c} |
| 216 | 652228 | Se₁Zn₁ | 1.238 | 18 | δ1(d) = −1.0 | {a, c} |
| 216 | 670495 | Se₁Zn₁ | 1.026 | 18 | δ1(d) = −1.0 | {a, c} |
| 216 | 52513 | Te₁Zn₁ | 0.986 | 18 | δ1(d) = −1.0 | {a, c} |
| 216 | 653193 | Te₁Zn₁ | 0.986 | 18 | δ1(d) = −1.0 | {a, c} |
| 216 | 653194 | Te₁Zn₁ | 0.992 | 18 | δ1(d) = −1.0 | {a, c} |
| 216 | 653195 | Te₁Zn₁ | 0.994 | 18 | δ1(d) = −1.0 | {a, c} |
| 216 | 653196 | Te₁Zn₁ | 0.982 | 18 | δ1(d) = −1.0 | {a, c} |
| 216 | 653198 | Te₁Zn₁ | 0.992 | 18 | δ1(d) = −1.0 | {a, c} |
| 216 | 653199 | Te₁Zn₁ | 0.992 | 18 | δ1(d) = −1.0 | {a, c} |
| 216 | 653205 | Te₁Zn₁ | 1.017 | 18 | δ1(d) = −1.0 | {a, c} |
| 216 | 670486 | Te₁Zn₁ | 0.76 | 18 | δ1(d) = −1.0 | {a, c} |
| 221 | 26753 | B6Ca₁ | 0.213 | 20 | δ1(a) = −1.0, δ2(d) = −1.0 | {e, b} |
| 221 | 44985 | B6Ca₁ | 0.412 | 20 | δ1(b) = −1.0, δ2(c) = −1.0 | {a, f} |
| 221 | 655040 | B6Ca₁ | 0.213 | 20 | δ1(b) = −1.0, δ2(c) = −1.0 | {f, a} |
| 221 | 20240 | B6Si₁ | 0.435 | 22 | δ1(b) = −1.0, δ2(c) = −1.0 | {a, f} |
| 221 | 659503 | B6Sr₁ | 0.164 | 28 | δ1(b) = −1.0, δ2(c) = −1.0 | {f, a} |
| 227 | 236959 | B₁Li₁ | 1.454 | 8 | δ2(c) = −1.0 | {a, b} |
| 227 | 162620 | O₂Si₁ | 5.436 | 32 | δ1(d) = 1.0, δ2(d) = 1.0 | {a, c} |
| 227 | 170476 | O₂Si₁ | 6.021 | 128 | δ1(c) = 1.0, δ2(c) = 1.0 | {f, d, e} |
| 227 | 35536 | O₂Si₁ | 5.668 | 32 | δ1(d) = 1.0, δ2(d) = 1.0 | {a, c} |
| 227 | 77458 | O₂Si₁ | 5.671 | 32 | δ1(d) = 1.0, δ2(d) = 1.0 | {a, c} |
| 227 | 77459 | O₂Si₁ | 5.67 | 32 | δ1(d) = 1.0, δ2(d) = 1.0 | {a, c} |
| 227 | 77460 | O₂Si₁ | 5.669 | 32 | δ1(d) = 1.0, δ2(d) = 1.0 | {a, c} |
| 2 | 59173 | Al₂Cd₂Cl₈ | 2.978 | 86 | δ1(f) = 1.0 | {i} |
| 2 | 62038 | Al₂Cd₂Cl₈ | 3.048 | 86 | δ1(g) = 1.0 | {i} |
| 2 | 426520 | Al₄Cl₁₄Te₄ | 0.032 | 134 | δ1(a) = 1.0 | {i} |
| 2 | 43508 | As₁Fe₁S₁ | 0.225 | 76 | δ1(e) = 1.0, δ1(g) = 1.0 | {i} |
| 2 | 43509 | As₁Fe₁S₁ | 0.118 | 76 | δ1(f) = 1.0, δ1(g) = 1.0 | {i} |
| 2 | 63129 | Au₁Br₈Te₁ | 1.046 | 146 | δ1(c) = 1.0 | {i} |
| 2 | 98522 | B₁₈Cs₈S₁₈ | 3.127 | 234 | δ1(a) = −1.0 | {i} |
| 2 | 98521 | B₁₈Rb₈S₁₈ | 3.084 | 234 | δ1(a) = −1.0 | {i} |
| 2 | 410757 | B₁₈Rb₈Se₁₈ | 2.270 | 234 | δ1(a) = −1.0 | {i} |
| 2 | 432662 | B₈Br6P₄ | 3.104 | 86 | δ1(h) = 1.0 | {i} |
| 2 | 83806 | Bi₂Br₈Te₄ | 1.061 | 90 | δ1(c) = 1.0 | {i} |
| 2 | 391157 | Bi₄Cl₁6Te₁₄ | 0.571 | 216 | δ1(b) = 1.0, δ1(e) = 1.0 | {i} |
| 2 | 426521 | Bi6Cl₂0Te₄ | 1.363 | 194 | δ1(f) = 1.0 | {i} |
| 2 | 83805 | Bi6Cl₂0Te₄ | 1.348 | 194 | δ1(b) = 1.0 | {i} |
| 2 | 401905 | Br₁₂Ta₂Te₄ | 0.961 | 118 | δ1(f) = 1.0 | {i} |
| 2 | 82245 | Br₁Mo₁Te₄ | 0.809 | 74 | δ1(a) = 1.0 | {i} |
| 2 | 424413 | Br₂Nb₁S₂ | 1.403 | 78 | δ1(a) = 1.0 | {i} |
| 2 | 202821 | Br₂Nb₁Se₂ | 0.919 | 78 | δ1(a) = 1.0 | {i} |
| 2 | 165428 | C₂₂Co6O₁₈ | 1.419 | 250 | δ1(h) = −1.0 | {i} |
| 2 | 415092 | C₂I₁0La6 | 0.201 | 144 | δ1(a) = 2.0 | {i} |
| 2 | 109830 | C₂O₄Pb₁ | 2.607 | 72 | δ1(e) = 1.0, δ1(g) = 1.0 | {i} |
| 2 | 109831 | C₂O₄Pb₁ | 2.720 | 72 | δ1(e) = 1.0, δ1(g) = 1.0 | {i} |
| 2 | 401907 | Cl₁₂Ta₂Te₄ | 1.149 | 118 | δ1(f) = 1.0 | {i} |
| 2 | 410188 | Cl₁₈P₂Re₂ | 0.009 | 150 | δ1(h) = −1.0 | {i} |
| 2 | 10483 | Cl₂Nb₁Se₂ | 0.947 | 78 | δ1(a) = 1.0 | {i} |
| 2 | 416429 | Cl₅O₄Re₂ | 0.019 | 146 | δ1(e) = 1.0 | {i} |
| 2 | 401589 | Cl6Hf₁Te₄ | 1.163 | 70 | δ1(h) = 1.0 | {a, i} |
| 2 | 413579 | Cl₈Ga₂Hg₂ | 3.055 | 86 | δ1(c) = 1.0 | {i} |
| 2 | 415580 | Cs₁Sb₂Se₄ | 1.032 | 86 | δ1(a) = 1.0 | {i} |
| 2 | 61220 | Cs₁Sb₂Se₄ | 1.020 | 86 | δ1(c) = 1.0 | {i} |
| 2 | 73008 | Cs₂S6Sn₂ | 1.846 | 62 | δ1(c) = 1.0 | {i} |
| 2 | 67976 | Cs₂S₈Sb₄ | 1.283 | 86 | δ1(c) = 1.0 | {i} |
| 2 | 402842 | Cs₂Se6Sn₂ | 1.193 | 62 | δ1(c) = 1.0 | {i} |
| 2 | 408148 | Cs₂Se6Sn₂ | 1.180 | 62 | δ1(g) = 1.0 | {i} |
| 2 | 418434 | Cs₄P₂Se₁0 | 1.524 | 106 | δ1(h) = 1.0 | {i} |
| 2 | 430940 | Cu₄P₃Se₄ | 0.935 | 166 | δ1(b) = 1.0, δ1(c) = 1.0, δ1(f) = 1.0 | {i} |
| 2 | 63301 | F₁₂I₄Sb₂ | 0.573 | 122 | δ1(a) = −1.0 | {i} |
| 2 | 201222 | F₁₂Sb₂Te₄ | 1.064 | 118 | δ1(c) = 1.0 | {i} |
| 2 | 35676 | Ge₁Li₁Te₂ | 0.342 | 102 | δ1(g) = 1.0 | {d, b, i} |
| 2 | 49658 | Ge₂Te6Tl6 | 0.468 | 124 | δ1(c) = 1.0, δ1(f) = 1.0 | {i} |
| 2 | 82242 | Hg₁O₃V₁ | 1.825 | 70 | δ1(f) = 1.0 | {i} |
| 2 | 2564 | Hg₂P₂S6 | 1.792 | 70 | δ1(h) = 1.0 | {i} |
| 2 | 639130 | Hg₂P₂S6 | 1.828 | 70 | δ1(h) = 1.0 | {i} |
| 2 | 78371 | I₁₂Nb₂Te₈ | 0.525 | 158 | δ1(h) = 1.0 | {i} |
| 2 | 67533 | I₁Ta₁Te₄ | 0.286 | 72 | δ1(a) = 1.0, δ1(d) = 1.0 | {i} |
| 2 | 413858 | In₂O₅P₁ | 2.526 | 82 | δ1(d) = 1.0 | {i} |
| 2 | 16972 | K₂O₈S₂ | 0.435 | 78 | δ1(a) = 1.0 | {i} |
| 2 | 54024 | K₂O₈S₂ | 3.750 | 78 | δ1(c) = 1.0 | {i} |
| 2 | 402886 | K₂Sb₄Se₈ | 1.088 | 86 | δ1(h) = 1.0 | {i} |
| 2 | 30535 | La6O₁₈Re₄ | 0.137 | 202 | δ1(d) = −1.0 | {i} |
| 2 | 150688 | Li₁Mo₁S₂ | 0.988 | 76 | δ1(d) = 1.0, δ1(e) = 1.0 | {i} |
| 2 | 95571 | Li₁Mo₁S₂ | 0.136 | 76 | δ1(d) = 1.0, δ1(f) = 1.0 | {i} |
| 2 | 413932 | Mo₄N₁₄Sr₁0 | 1.236 | 194 | δ1(h) = 1.0 | {i} |
| 2 | 171374 | Na₂O₈S₂ | 3.839 | 62 | δ1(f) = 1.0 | {i} |
| 2 | 402887 | Rb₂Sb₄Se₈ | 1.092 | 86 | δ1(h) = 1.0 | {i} |
| 2 | 416310 | Si₂Te6Tl6 | 0.793 | 124 | δ1(c) = 1.0, δ1(f) = 1.0 | {i} |
| 10 | 422527 | As₂Ga₂Sr₁ | 0.257 | 104 | δ1(a) = −1.0, δ1(g) = −1.0 | {c, d, n, m} |
| 10 | 246004 | C₂Ca₁O₄ | 2.314 | 136 | δ1(b) = −1.0, δ1(c) = −1.0, δ1(d) = −1.0, | {o, m, l, n, j} |
| | | | | | δ1(h) = −1.0 | |
| 10 | 246005 | C₂Ca₁O₄ | 2.259 | 136 | δ1(a) = −1.0, δ1(e) = −1.0, δ1(f) = −1.0, | {o, m, n, k, i} |
| | | | | | δ1(g) = −1.0 | |
| 11 | 48168 | Al₂Na7Sb₅ | 0.278 | 76 | δ1(b) = 1.0 | {f, e} |
| 11 | 29261 | Ba₃P6Si₄ | 0.353 | 152 | δ1(a) = 1.0 | {f, e} |
| 11 | 411136 | Bi₉I₃Rh₂ | 0.198 | 168 | δ1(a) = 1.0 | {f, e} |
| 11 | 10066 | Cl7Nb₃Se₅ | 0.920 | 236 | δ1(a) = 1.0 | {f, e} |
| 11 | 430682 | Ir₂Se₅Sn₁ | 0.202 | 208 | δ1(a) = 1.0 | {f, e} |
| 11 | 249937 | K₄P₈Te₄ | 1.078 | 100 | δ1(d) = 1.0 | {f, e} |
| 12 | 4164 | Al₁O₄W₁ | 1.116 | 66 | δ1(a) = −1.0 | {j, i, g} |
| 12 | 39930 | As₁Cl₂Hg₂ | 1.642 | 172 | δ1(b) = −1.0, δ1(c) = −1.0 | {j, i} |
| 12 | 37001 | As₂F₁₂I₄ | 0.525 | 122 | δ1(a) = 1.0 | {j, i} |
| 12 | 420833 | As₃Ba₂Cd₂ | 0.026 | 118 | δ1(a) = −1.0 | {i} |
| 12 | 262413 | As₃Sr₂Zn₂ | 0.091 | 118 | δ1(a) = −1.0 | {i} |
| 12 | 82360 | Ba₅Cr₁N₅ | 0.112 | 162 | δ1(c) = −1.0 | {j, i, g} |
| 12 | 406951 | Bi₄Br₂Ru₁ | 0.336 | 84 | δ1(a) = −1.0, δ1(b) = −1.0 | {i, g} |
| 12 | 69975 | Br₁0Te₄Zr₂ | 1.043 | 102 | δ1(d) = −1.0 | {h, j, i, g} |
| 12 | 424414 | Br₂Nb₁S₂ | 1.313 | 78 | δ1(a) = −1.0 | {j, i, g} |
| 12 | 202822 | Br₂Nb₁Se₂ | 0.841 | 78 | δ1(a) = −1.0 | {j, i, g} |
| 12 | 672450 | C₁B₂O₂ | 4.656 | 44 | δ1(f) = 1.0 | {i} |
| 12 | 2785 | C₁N₁Th₁ | 1.018 | 42 | δ1(d) = 1.0 | {i} |
| 12 | 47225 | C₂Br₂Gd₂ | 0.002 | 58 | δ1(b) = −1.0 | {i} |
| 12 | 72274 | C₂Br₂Gd₂ | 0.003 | 58 | δ1(a) = −1.0 | {i} |
| 12 | 462 | C₂La₂O₂ | 3.038 | 42 | δ1(a) = 1.0 | {i} |
| 12 | 154357 | C₄Cs₂O₄ | 2.718 | 58 | δ1(a) = 1.0 | {j, i} |
| 12 | 154354 | C₄Li₂O₄ | 2.139 | 42 | δ1(c) = 1.0 | {h, i, g} |
| 12 | 154356 | C₄O₄Rb₂ | 2.717 | 58 | δ1(a) = 1.0 | {j, i} |
| 12 | 61393 | Cd₁P₁S₁ | 1.883 | 70 | δ1(a) = −1.0 | {j, i, g} |
| 12 | 620232 | Cd₁P₁S₁ | 1.739 | 70 | δ1(a) = −1.0 | {j, i, g} |
| 12 | 79556 | Cd₁P₁S₁ | 1.882 | 70 | δ1(a) = −1.0 | {j, i, g} |
| 12 | 657320 | Cd₂P₂S6 | 1.875 | 70 | δ1(a) = −1.0 | {j, i, g} |
| 12 | 413701 | Cd6Sb₁₂Sr₁₁ | 0.167 | 242 | δ1(d) = −1.0 | {a, i} |
| 12 | 418887 | Cd6Sb₁₂Sr₁₁ | 0.155 | 242 | δ1(b) = −1.0 | {c, i} |
| 12 | 50594 | Cl₁Hg₂P₁ | 1.796 | 86 | δ1(b) = −1.0, δ1(f) = 5.0 | {h, e, i} |
| 12 | 10484 | Cl₂Nb₁S₂ | 1.425 | 78 | δ1(a) = −1.0 | {j, i, g} |
| 12 | 25631 | Cl₂Nb₂S₂ | 1.330 | 78 | δ1(a) = −1.0 | {j, i, g} |
| 12 | 61392 | Fe₁P₁S₃ | 0.118 | 62 | δ1(a) = −1.0 | {j, i, g} |
| 12 | 16252 | Fe₂P₂S6 | 0.098 | 62 | δ1(a) = −1.0 | {j, i, g} |
| 12 | 27307 | Fe₂P₂S6 | 0.104 | 62 | δ1(a) = −1.0 | {j, i, g} |
| 12 | 633080 | Fe₂P₂S6 | 0.121 | 62 | δ1(a) = −1.0 | {j, i, g} |
| 12 | 633087 | Fe₂P₂S6 | 0.120 | 62 | δ1(a) = −1.0 | {j, i, g} |
| 12 | 657319 | Fe₂P₂S6 | 0.107 | 62 | δ1(a) = −1.0 | {j, i, g} |
| 12 | 636776 | Ge₁K₃S₃ | 2.684 | 98 | δ1(a) = −1.0 | {h, j, e, i} |
| 12 | 47111 | Ge₂K6S6 | 2.239 | 98 | δ1(c) = −1.0 | {f, j, i, g} |
| 12 | 47112 | Ge₂K6Se6 | 2.145 | 98 | δ1(a) = −1.0 | {h, j, e, i} |
| 12 | 69123 | Hg6O7Si₂ | 1.555 | 122 | δ1(a) = −1.0 | {j, b, i} |
| 12 | 80109 | I₂O₁Ta₁ | 0.754 | 50 | δ1(c) = −1.0 | {i} |
| 12 | 1238 | K6Si₂Te6 | 1.970 | 98 | δ1(a) = −1.0 | {h, j, e, i} |
| 12 | 642729 | Mg₁P₁S₃ | 2.531 | 50 | δ1(a) = −1.0 | {j, i, g} |
| 12 | 426907 | Na₄P₂S6 | 2.758 | 50 | δ1(a) = −1.0 | {h, j, i, g} |
| 12 | 602341 | Ni₁P₁S₃ | 0.005 | 66 | δ1(a) = 1.0 | {j, i, g} |
| 12 | 646133 | Ni₁P₁S₃ | 0.004 | 66 | δ1(a) = 1.0 | {j, i, g} |
| 12 | 646145 | Ni₁P₁Se₃ | 0.013 | 66 | δ1(a) = 1.0 | {j, i, g} |
| 12 | 657314 | Ni₂P₂S6 | 0.003 | 66 | δ1(a) = 1.0 | {j, i, g} |
| 12 | 79557 | P₁S₃Zn₁ | 2.074 | 70 | δ1(a) = −1.0 | {j, i, g} |
| 12 | 648076 | P₂S6V₂ | 0.152 | 56 | δ1(a) = −1.0, δ1(b) = −1.0, δ1(e) = 1.0 | {j, i, g} |
| 12 | 201933 | P₂S6Zn₂ | 2.073 | 70 | δ1(a) = −1.0 | {j, i, g} |
| 12 | 648084 | P₂S6Zn₂ | 2.035 | 70 | δ1(a) = −1.0 | {j, i, g} |
| 12 | 648089 | P₂S6Zn₂ | 2.089 | 70 | δ1(a) = −1.0 | {j, i, g} |
| 12 | 1434 | P6S₁₈Zn₄ | 1.763 | 186 | δ1(c) = −1.0 | {j, i} |
| 13 | 51511 | Hg₂Mo₂O7 | 2.326 | 156 | δ1(c) = 1.0 | {e, g} |
| 13 | 15005 | Hg₂O₄S₁ | 0.093 | 108 | δ1(d) = 1.0 | {e, g} |
| 13 | 248726 | Hg₂O₄S₁ | 2.134 | 108 | δ1(a) = 1.0 | {f, g} |
| 13 | 15006 | Hg₂O₄Se₁ | 0.272 | 108 | δ1(a) = 1.0 | {f, g} |
| 13 | 410762 | Hg₄O7P₂ | 1.841 | 200 | δ1(b) = 1.0 | {f, g} |
| 13 | 60242 | K₂Mo₈O₁6 | 0.066 | 324 | δ1(b) = 1.0 | {e, g} |
| 14 | 71897 | Ag₅Ge₁O₄ | 0.631 | 332 | δ1(b) = 1.0 | {e} |
| 14 | 72317 | Ag₅Ge₁O₄ | 0.631 | 332 | δ1(b) = 1.0 | {e} |
| 14 | 10323 | Al₄Cl₁₄Te₄ | 1.490 | 268 | δ1(b) = 1.0 | {e} |
| 14 | 26013 | As₁Cd₂Cl₂ | 1.171 | 172 | δ1(b) = 1.0 | {e} |
| 14 | 109206 | As₁Fe₁S₁ | 0.626 | 76 | δ1(a) = 1.0 | {e} |
| 14 | 15986 | As₁Fe₁S₁ | 0.128 | 76 | δ1(a) = 1.0 | {e} |
| 14 | 185809 | As₁Fe₁S₁ | 0.572 | 76 | δ1(c) = 1.0 | {e} |
| 14 | 62400 | As₁Fe₁S₁ | 0.134 | 76 | δ1(d) = 1.0 | {e} |
| 14 | 610526 | As₁Fe₁Se₁ | 0.243 | 76 | δ1(b) = 1.0 | {e} |
| 14 | 610529 | As₁Fe₁Te₁ | 0.541 | 76 | δ1(a) = 1.0 | {e} |
| 14 | 611299 | As₁Ru₁Te₁ | 0.898 | 76 | δ1(a) = 1.0 | {e} |
| 14 | 405235 | As₂Cs₄Te6 | 0.816 | 164 | δ1(b) = 1.0 | {e} |
| 14 | 35412 | As₂F₁₂Hg₄ | 1.005 | 284 | δ1(c) = 1.0 | {e} |
| 14 | 427418 | As₂Hg6O₁0 | 1.493 | 284 | δ1(c) = 1.0 | {e} |
| 14 | 2604 | As₂Hg6O₈ | 0.545 | 260 | δ1(d) = 1.0 | {e} |
| 14 | 413886 | As₂Hg6O₈ | 0.614 | 260 | δ1(a) = 1.0 | {e} |
| 14 | 62520 | Ba₁P₃Pt₂ | 0.112 | 180 | δ1(a) = 1.0 | {c, d, e} |
| 14 | 412764 | Ba₂P₂S6 | 3.205 | 132 | δ1(d) = 1.0 | {e} |
| 14 | 412768 | Ba₂P₂Se6 | 2.221 | 132 | δ1(d) = 1.0 | {e} |
| 14 | 35342 | Ba6P6Sn₂ | 0.864 | 196 | δ1(a) = 1.0 | {e} |
| 14 | 616892 | Bi₁Os₁Se₁ | 0.424 | 76 | δ1(d) = 1.0 | {e} |
| 14 | 415090 | Br₁₄Ga₄Te₄ | 1.343 | 268 | δ1(d) = 1.0 | {e} |
| 14 | 417407 | Br₃Hg₂Te₁ | 1.868 | 204 | δ1(c) = 1.0 | {e} |
| 14 | 2328 | C₁D₁K₁O₃ | 0.455 | 124 | δ1(d) = −1.0 | {e} |
| 14 | 109600 | C₂Ag₂O₄ | 1.004 | 108 | δ1(b) = 1.0 | {e} |
| 14 | 109601 | C₂Ag₂O₁ | 2.518 | 108 | δ1(b) = 1.0 | {e} |
| 14 | 109602 | C₂Ag₂O₄ | 2.533 | 108 | δ1(a) = 1.0 | {e} |
| 14 | 109603 | C₂Ag₂O₄ | 2.509 | 108 | δ1(b) = 1.0 | {e} |
| 14 | 170029 | C₂Cd₁O₄ | 3.324 | 88 | δ1(d) = 1.0 | {a, e} |
| 14 | 246777 | C₂H6O6 | 3.262 | 100 | δ1(a) = 1.0 | {e} |
| 14 | 246778 | C₂H6O6 | 3.414 | 100 | δ1(b) = 1.0 | {e} |
| 14 | 173993 | C₂Li₂O₄ | 3.609 | 68 | δ1(d) = 1.0 | {e} |
| 14 | 171458 | C₂Na₂O₄ | 2.513 | 68 | δ1(a) = 1.0 | {e} |
| 14 | 171459 | C₂Na₂O₄ | 3.486 | 68 | δ1(a) = 1.0 | {e} |
| 14 | 56906 | C₂Na₂O₄ | 3.369 | 68 | δ1(a) = 1.0 | {e} |
| 14 | 170127 | C₂O₄Tl₂ | 2.514 | 76 | δ1(d) = 1.0 | {e} |
| 14 | 109665 | C₂O₄Zn₁ | 2.341 | 88 | δ1(b) = 1.0 | {a, e} |
| 14 | 154355 | C₄Na₂O₄ | 2.563 | 84 | δ1(a) = −1.0 | {e} |
| 14 | 152115 | Ca₁Mo₅O₈ | 0.193 | 320 | δ1(c) = 1.0, δ1(d) = 1.0 | {e} |
| 14 | 280969 | Ca₁Mo₅O₈ | 0.142 | 320 | δ1(a) = 1.0, δ1(b) = 1.0 | {e} |
| 14 | 405192 | Ca₂P₂S6 | 3.158 | 100 | δ1(d) = 1.0 | {e} |
| 14 | 412765 | Ca₂P₂Se6 | 2.255 | 100 | δ1(d) = 1.0 | {e} |
| 14 | 412647 | Cd₂Cl₂P₁ | 1.560 | 172 | δ1(a) = 1.0 | {e} |
| 14 | 59914 | Cl₁₄Ga₄Te₄ | 1.477 | 268 | δ1(b) = 1.0 | {e} |
| 14 | 109325 | Cl₃Cu₁K₁ | 0.017 | 164 | δ1(b) = −1.0 | {e} |
| 14 | 28062 | Cl₃Mo₁S₂ | 1.319 | 156 | δ1(d) = 1.0 | {e} |
| 14 | 416053 | Cl7O₃Re₂ | 0.003 | 324 | δ1(d) = 1.0 | {e} |
| 14 | 74940 | Co₁K₂O₂ | 0.036 | 156 | δ1(d) = 1.0 | {e} |
| 14 | 16279 | Cs₁O₅V₂ | 0.006 | 196 | δ1(a) = 1.0 | {e} |
| 14 | 850 | Cs₁O₅V₂ | 0.030 | 196 | δ1(c) = 1.0 | {e} |
| 14 | 26726 | Cs₂O₈S₂ | 1.421 | 156 | δ1(c) = 1.0 | {e} |
| 14 | 84993 | Cs₂Se6Te₂ | 0.753 | 132 | δ1(d) = 1.0 | {e} |
| 14 | 412900 | Cu₁La₂S₄ | 1.579 | 228 | δ1(a) = 1.0 | {e} |
| 14 | 628243 | Cu₁La₂S₄ | 1.583 | 228 | δ1(a) = 1.0 | {e} |
| 14 | 633086 | Fe₁P₁S₁ | 0.318 | 76 | δ1(d) = 1.0 | {e} |
| 14 | 633093 | Fe₁P₁Se₁ | 0.320 | 76 | δ1(b) = 1.0 | {e} |
| 14 | 24161 | Fe₁S₁Sb₁ | 0.452 | 76 | δ1(b) = 1.0 | {e} |
| 14 | 633399 | Fe₁Sb₁Se₁ | 0.172 | 76 | δ1(d) = 1.0 | {e} |
| 14 | 633405 | Fe₁Sb₁Te₁ | 0.189 | 76 | δ1(b) = 1.0 | {e} |
| 14 | 61400 | Ge₂Na6Se6 | 2.071 | 100 | δ1(d) = 1.0 | {e} |
| 14 | 47113 | Ge₂Na6Te6 | 1.396 | 100 | δ1(b) = 1.0 | {e} |
| 14 | 170953 | H₄B₂O₄ | 4.792 | 136 | δ1(a) = 1.0, δ1(b) = 1.0 | {e} |
| 14 | 74885 | Hg₁O₄Re₁ | 3.000 | 172 | δ1(d) = 1.0 | {e} |
| 14 | 422481 | Hg₂N₂O₄ | 2.187 | 116 | δ1(a) = 1.0 | {e} |
| 14 | 60055 | Hg₂N₂O₄ | 2.174 | 116 | δ1(a) = 1.0 | {e} |
| 14 | 61064 | Hg₂N₂O₄ | 2.189 | 116 | δ1(c) = 1.0 | {e} |
| 14 | 59156 | Hg₄N₂O₈ | 1.687 | 212 | δ1(b) = 1.0 | {e} |
| 14 | 61101 | Hg₄N₂O₈ | 1.788 | 212 | δ1(a) = 1.0 | {e} |
| 14 | 61437 | Hg₄N₂O₈ | 1.788 | 212 | δ1(a) = 1.0 | {e} |
| 14 | 410760 | Hg6O₈P₂ | 0.919 | 260 | δ1(a) = 1.0 | {e} |
| 14 | 410761 | Hg6O₈P₂ | 2.510 | 260 | δ1(a) = 1.0 | {e} |
| 14 | 71516 | I₁Nb₂Te6 | 0.458 | 276 | δ1(b) = 1.0, δ1(c) = 1.0, δ1(d) = 1.0 | {e} |
| 14 | 1700 | In₄P6S₁₈ | 1.562 | 300 | δ1(b) = 1.0 | {e} |
| 14 | 418250 | K₄O₈P₂ | 3.529 | 188 | δ1(d) = 1.0 | {e} |
| 14 | 410863 | K6Se6Sn₂ | 1.881 | 196 | δ1(c) = 1.0 | {e} |
| 14 | 10109 | K6Sn₂Te6 | 1.426 | 196 | δ1(a) = 1.0 | {e} |
| 14 | 80470 | Mo₅O₈Sr₁ | 0.095 | 352 | δ1(c) = 1.0, δ1(d) = 1.0 | {e} |
| 14 | 15579 | Na6Si₂Te6 | 1.868 | 100 | δ1(a) = 1.0 | {e} |
| 14 | 647714 | Os₁P₁S₁ | 0.814 | 76 | δ1(d) = 1.0 | {e} |
| 14 | 647716 | Os₁P₁Se₁ | 0.740 | 76 | δ1(c) = 1.0 | {e} |
| 14 | 647751 | Os₁S₁Sb₁ | 0.381 | 76 | δ1(d) = 1.0 | {e} |
| 14 | 647759 | Os₁Sb₁Se₁ | 0.548 | 76 | δ1(d) = 1.0 | {e} |
| 14 | 647762 | Os₁Sb₁Te₁ | 0.500 | 76 | δ1(d) = 1.0 | {e} |
| 14 | 62230 | P₁Pb₁Se₃ | 1.591 | 108 | δ1(c) = 1.0 | {e} |
| 14 | 648023 | P₁Ru₁S₁ | 0.510 | 76 | δ1(c) = 1.0 | {e} |
| 14 | 648027 | P₁Ru₁Se₁ | 0.507 | 76 | δ1(d) = 1.0 | {e} |
| 14 | 648028 | P₁Ru₁Se₁ | 0.515 | 76 | δ1(d) = 1.0 | {e} |
| 14 | 655564 | P₁Se₃Sn₁ | 1.314 | 108 | δ1(d) = 1.0 | {e} |
| 14 | 647906 | P₂Pb₂S6 | 2.062 | 108 | δ1(d) = 1.0 | {e} |
| 14 | 647911 | P₂Pb₂Se6 | 1.573 | 108 | δ1(d) = 1.0 | {e} |
| 14 | 647914 | P₂Pb₂Se6 | 1.579 | 108 | δ1(d) = 1.0 | {e} |
| 14 | 39232 | P₂S6Sn₂ | 1.620 | 108 | δ1(a) = 1.0 | {e} |
| 14 | 72835 | P₂S6Sn₂ | 1.644 | 108 | δ1(c) = 1.0 | {e} |
| 14 | 405191 | P₂S6Sr₂ | 3.153 | 132 | δ1(c) = 1.0 | {e} |
| 14 | 64659 | P₂Se6Sn₂ | 1.315 | 108 | δ1(d) = 1.0 | {e} |
| 14 | 648111 | P₂Se6Sn₂ | 1.358 | 108 | δ1(d) = 1.0 | {e} |
| 14 | 648112 | P₂Se6Sn₂ | 0.127 | 108 | δ1(d) = 1.0 | {e} |
| 14 | 648114 | P₂Se6Sn₂ | 1.314 | 108 | δ1(d) = 1.0 | {e} |
| 14 | 412766 | P₂Se6Sr₂ | 2.224 | 132 | δ1(d) = 1.0 | {e} |
| 14 | 62697 | P₂Se6Tl₄ | 1.430 | 232 | δ1(b) = 1.0, δ1(c) = 1.0 | {e} |
| 14 | 650583 | Ru₁S₁Sb₁ | 0.172 | 76 | δ1(c) = 1.0 | {e} |
| 14 | 650594 | Ru₁Sb₁Se₁ | 0.296 | 76 | δ1(d) = 1.0 | {e} |
| 14 | 650595 | Ru₁Sb₁Te₁ | 0.328 | 76 | δ1(d) = 1.0 | {e} |
| 14 | 650596 | Ru₁Sb₁Te₁ | 0.355 | 76 | δ1(d) = 1.0 | {e} |
| 15 | 24037 | Ag₂O₂Pb₁ | 1.006 | 76 | δ1(c) = 5.0 | {f, d, e, b} |
| 15 | 65998 | Ag₂O₂Pb₁ | 0.997 | 76 | δ1(c) = 5.0 | {a, d, e, f} |
| 15 | 59115 | As₁F6I₅ | 1.290 | 164 | δ1(d) = −1.0 | {f, c, e} |
| 15 | 75170 | As₃Br₁Cd₂ | 1.311 | 92 | δ1(a) = 1.0 | {f, e} |
| 15 | 75169 | As₃Br₁Hg₂ | 1.182 | 92 | δ1(a) = 1.0 | {f, e} |
| 15 | 40449 | As₃Cd₂I₁ | 1.245 | 92 | δ1(a) = 1.0 | {f, e} |
| 15 | 62519 | As6Ba₁Pt₄ | 0.702 | 160 | δ1(c) = 1.0, δ1(d) = 1.0 | {a, f, b, e} |
| 15 | 62518 | As6Pt₄Sr₁ | 0.748 | 160 | δ1(c) = 1.0, δ1(d) = 1.0 | {a, f, b, e} |
| 15 | 670080 | Au₁Cl₁O₂ | 0.188 | 60 | δ1(a) = −1.0, δ1(c) = 5.0 | {f, d, e} |
| 15 | 423233 | Au₁Cl₄Cs₁ | 1.881 | 96 | δ1(d) = 4.0 | {f, c, e} |
| 15 | 26021 | Au₁Cl₄Rb₁ | 1.967 | 96 | δ1(d) = 4.0 | {f, c, e} |
| 15 | 62107 | Au₁Cl₄Tl₁ | 1.782 | 84 | δ1(c) = 4.0 | {f, d, e} |
| 15 | 9908 | Au₁F₄Li₁ | 1.179 | 80 | δ1(c) = 4.0 | {f, d, e} |
| 15 | 165259 | Au₁Li₁S₁ | 1.142 | 72 | δ1(d) = 5.0 | {f, c, b} |
| 15 | 411410 | B₂Li₂Se₅ | 1.716 | 76 | δ1(b) = 1.0 | {f, e} |
| 15 | 409330 | Bi₃Cl₁O₄ | 2.391 | 92 | δ1(d) = −2.0 | {f, c, e} |
| 15 | 100880 | Br₁Cd₂P₃ | 1.328 | 92 | δ1(b) = 1.0 | {f, e} |
| 15 | 31925 | Br₂Hg₂O6 | 3.493 | 148 | δ1(a) = 1.0 | {f} |
| 15 | 150101 | C₂O₄Sn₁ | 2.597 | 72 | δ1(d) = 1.0 | {f, e} |
| 15 | 54909 | C₂O₄Sn₁ | 2.554 | 72 | δ1(c) = 1.0 | {f, e} |
| 15 | 109770 | C₄Ag₂O₄ | 0.711 | 248 | δ1(b) = −1.0, δ1(d) = −1.0 | {f} |
| 15 | 100879 | Cd₂Cl₁P₃ | 1.441 | 92 | δ1(b) = 1.0 | {f, e} |
| 15 | 100881 | Cd₂I₁P₃ | 1.223 | 92 | δ1(b) = 1.0 | {f, e} |
| 15 | 260975 | Cd₂O₁₂P₄ | 4.397 | 232 | δ1(c) = 5.0 | {f, d, e} |
| 15 | 28115 | Cl₁Hg₂O₁ | 1.909 | 148 | δ1(c) = 5.0 | {f, d, e} |
| 15 | 74771 | Cl₁Hg₂P₃ | 1.510 | 92 | δ1(a) = 1.0 | {f, e} |
| 15 | 16662 | Cl₂Hg₄O₂ | 1.332 | 148 | δ1(d) = 5.0 | {f, c, e} |
| 15 | 28400 | Cl₂Hg₄O₂ | 1.249 | 148 | δ1(c) = 5.0 | {f, d, e} |
| 15 | 65483 | Cl₂Hg₄O₂ | 1.966 | 148 | δ1(d) = 5.0 | {f, c, e} |
| 15 | 421532 | Cl₄Os₁Sc₄ | 0.529 | 96 | δ1(a) = 1.0 | {f, e} |
| 15 | 14119 | Cs₁F7Sb₂ | 4.352 | 136 | δ1(c) = −2.0 | {f, d, e} |
| 15 | 24741 | Cs₁F7Sb₂ | 2.591 | 136 | δ1(d) = −2.0 | {f, c, e} |
| 15 | 627081 | Cs₂Re₃Se6 | 0.861 | 300 | δ1(a) = 1.0 | {f, e} |
| 15 | 627082 | Cs₂Re₃Se6 | 0.764 | 300 | δ1(a) = 1.0 | {f, e} |
| 15 | 65966 | Cs₄Re6S₁₃ | 1.368 | 312 | δ1(a) = 1.0 | {f, e} |
| 15 | 60096 | Cs₄Re6Se₁₃ | 1.038 | 312 | δ1(a) = 1.0 | {f, e} |
| 15 | 72541 | Cs₄S₁₃Tc6 | 0.974 | 312 | δ1(a) = 1.0 | {f, e} |
| 15 | 72542 | Cs₄Se₁₃Tc6 | 0.860 | 312 | δ1(a) = 1.0 | {f, e} |
| 15 | 409512 | Cs6Ge₂Se6 | 1.760 | 196 | δ1(d) = 1.0 | {f, e} |
| 15 | 89683 | Cs6Ge₂Te6 | 1.145 | 196 | δ1(d) = 1.0 | {f, e} |
| 15 | 280070 | Cs6Sn₂Te6 | 1.233 | 196 | δ1(c) = 1.0 | {f, e} |
| 15 | 400657 | Cu₂O₂Pb₁ | 0.783 | 76 | δ1(c) = 5.0 | {a, d, e, f} |
| 15 | 628762 | Cu₂Re₃Se6 | 0.329 | 316 | δ1(a) = 1.0 | {f, e} |
| 15 | 33740 | Fe₂O₁₂P₄ | 0.335 | 216 | δ1(d) = 3.0 | {f, c, e} |
| 15 | 63500 | Fe₂O₁₂P₄ | 0.412 | 216 | δ1(d) = 3.0 | {f, c, e} |
| 15 | 10108 | Ge₂K6Te6 | 1.166 | 196 | δ1(c) = 1.0 | {f, e} |
| 15 | 2565 | Hg₂P₂Se6 | 1.060 | 140 | δ1(d) = 1.0 | {f} |
| 15 | 639132 | Hg₂P₂Se6 | 1.092 | 140 | δ1(c) = 1.0 | {f} |
| 15 | 200836 | K₂Re₃S6 | 1.411 | 300 | δ1(a) = 1.0 | {f, e} |
| 15 | 641311 | K₂Re₃S6 | 1.426 | 300 | δ1(a) = 1.0 | {f, e} |
| 15 | 641312 | K₂Re₃S6 | 1.496 | 300 | δ1(a) = 1.0 | {f, e} |
| 15 | 641314 | K₂Re₃S6 | 1.439 | 300 | δ1(a) = 1.0 | {f, e} |
| 15 | 641315 | K₂Re₃Se6 | 1.120 | 300 | δ1(a) = 1.0 | {f, e} |
| 15 | 60101 | K₄Re6Sc₁₂ | 1.110 | 300 | δ1(a) = 1.0 | {f, e} |
| 15 | 72537 | K₄S₁₂Tc6 | 1.040 | 300 | δ1(a) = 1.0 | {f, e} |
| 15 | 72538 | K₄Se₁₂Tc6 | 0.874 | 300 | δ1(a) = 1.0 | {f, e} |
| 15 | 68107 | Mn₂Mo₁P₁₂ | 0.071 | 160 | δ1(a) = 1.0, δ1(c) = 1.0, δ1(d) = 1.0 | {f, e} |
| 15 | 18305 | Na₂Nb₄O₁₁ | 1.949 | 240 | δ1(c) = −2.0 | {f, d, e} |
| 15 | 200835 | Na₂Re₃S6 | 1.519 | 236 | δ1(a) = 1.0 | {f, e} |
| 15 | 644948 | Na₂Re₃S6 | 1.536 | 236 | δ1(a) = 1.0 | {f, e} |
| 15 | 644951 | Na₂Re₃S6 | 1.726 | 236 | δ1(a) = 1.0 | {f, e} |
| 15 | 76536 | Na₂Re₃S6 | 1.471 | 236 | δ1(a) = 1.0 | {f, e} |
| 15 | 644953 | Na₂Re₃Se6 | 1.180 | 236 | δ1(a) = 1.0 | {f, e} |
| 15 | 644954 | Na₂Re₃Se6 | 1.120 | 236 | δ1(a) = 1.0 | {f, e} |
| 15 | 261228 | O₃Si₁Sr₁ | 3.558 | 192 | δ1(c) = −2.0 | {f, d, e} |
| 15 | 671478 | O₄Pd₁S₁ | 0.977 | 80 | δ1(d) = 4.0 | {f, c, e} |
| 15 | 671485 | O₄Pt₁S₁ | 1.525 | 80 | δ1(d) = 4.0 | {f, c, e} |
| 15 | 166875 | O7P₂Pd₂ | 0.911 | 144 | δ1(c) = 4.0 | {a, d, e, f} |
| 15 | 195291 | O7P₂Pd₂ | 0.884 | 144 | δ1(d) = 4.0 | {a, c, f, e} |
| 15 | 195292 | O7P₂Pd₂ | 0.962 | 144 | δ1(c) = 4.0 | {a, d, e, f} |
| 15 | 195293 | O7P₂Pd₂ | 0.922 | 144 | δ1(c) = 4.0 | {a, d, e, f} |
| 15 | 415239 | O7P₂Pd₂ | 0.911 | 144 | δ1(c) = 4.0 | {a, d, e, f} |
| 15 | 62517 | P6Pt₄Sr₁ | 0.904 | 160 | δ1(c) = 1.0, δ1(d) = 1.0 | {a, f, b, e} |
| 15 | 650019 | Rb₂Re₃S6 | 1.344 | 300 | δ1(a) = 1.0 | {f, e} |
| 15 | 650022 | Rb₂Re₃Se6 | 1.007 | 300 | δ1(a) = 1.0 | {f, e} |
| 15 | 650023 | Rb₂Re₃Se6 | 1.021 | 300 | δ1(a) = 1.0 | {f, e} |
| 15 | 79583 | Rb₄Re6S₁₂ | 1.347 | 300 | δ1(a) = 1.0 | {f, e} |
| 15 | 60098 | Rb₄Re6S₁₃ | 1.203 | 312 | δ1(a) = 1.0 | {f, e} |
| 15 | 60100 | Rb₄Re6Se₁₂ | 1.038 | 300 | δ1(a) = 1.0 | {f, e} |
| 15 | 72539 | Rb₄S₁₃Tc6 | 0.941 | 312 | δ1(a) = 1.0 | {f, e} |
| 15 | 72540 | Rb₄Se₁₂Tc6 | 0.805 | 300 | δ1(a) = 1.0 | {f, e} |
| 15 | 650081 | Re₃S6Tl₂ | 0.966 | 252 | δ1(a) = 1.0 | {f, e} |
| 15 | 650082 | Re₃S6Tl₂ | 1.085 | 252 | δ1(a) = 1.0 | {f, e} |
| 15 | 600320 | Re₃Se6Tl₂ | 0.550 | 252 | δ1(a) = 1.0 | {f, e} |
| 15 | 650098 | Re₃Se6Tl₂ | 0.558 | 252 | δ1(a) = 1.0 | {f, e} |
| 15 | 65822 | Re6Se₁₂Tl₄ | 0.794 | 252 | δ1(a) = 1.0 | {f, e} |
| 51 | 26077 | Br₁₁Cs₁Nb₄ | 0.150 | 276 | δ1(b) = −1.0 | {l, j, e, k, f, i, g} |
| 51 | 380397 | Br₁₁Nb₄Rb₁ | 0.219 | 276 | δ1(b) = −1.0 | {l, j, k, e, f, i, g} |
| 51 | 26076 | Cl₁₁Cs₁Nb₄ | 0.348 | 276 | δ1(a) = −1.0 | {l, j, k, e, f, i, g} |
| 51 | 412126 | Cl₁₁Nb₄Rb₁ | 0.377 | 276 | δ1(a) = −1.0 | {l, j, e, k, f, i, g} |
| 55 | 183853 | Al₂Ca₅Sb6 | 0.131 | 92 | δ1(d) = −1.0 | {a, h, g} |
| 55 | 60146 | Al₂Ca₅Sb6 | 0.100 | 92 | δ1(a) = −1.0 | {h, d, g} |
| 55 | 201221 | Al₂Cl₈Se₄ | 1.462 | 344 | δ1(b) = −1.0, δ1(c) = −1.0 | {e, f, h, i, g} |
| 55 | 27 | As6Ca₅Ga₂ | 0.085 | 92 | δ1(a) = −1.0 | {h, d, g} |
| 55 | 79976 | Ba₁Nb₈O₁₄ | 0.339 | 396 | δ1(b) = −1.0 | {c, a, h, d, i, g} |
| 55 | 280592 | Ba₃O₁Sb₂ | 0.318 | 184 | δ1(b) = −1.0, δ1(d) = −1.0 | {h, g} |
| 55 | 62305 | Ba₅In₂Sb6 | 0.003 | 172 | δ1(a) = −1.0 | {h, d, g} |
| 55 | 163584 | C₂K₂O₄ | 2.813 | 100 | δ1(c) = −1.0 | {h, g} |
| 55 | 165561 | C₂K₂O₄ | 2.813 | 100 | δ1(c) = −1.0 | {h, g} |
| 55 | 163587 | C₂O₄Rb₂ | 3.187 | 100 | δ1(a) = −1.0 | {h, g} |
| 55 | 165563 | C₂O₄Rb₂ | 3.187 | 100 | δ1(a) = −1.0 | {h, g} |
| 55 | 36467 | Ca₅In₂Sb6 | 0.031 | 92 | δ1(a) = −1.0 | {h, d, g} |
| 55 | 672086 | Ca₅In₂Sb6 | 0.104 | 92 | δ1(b) = −1.0 | {c, h, g} |
| 55 | 36468 | In₂Sb6Sr₅ | 0.004 | 172 | δ1(a) = −1.0 | {h, d, g} |
| 55 | 202673 | Nb₈O₁₄Sr₁ | 0.259 | 396 | δ1(b) = −1.0 | {c, a, h, d, i, g} |
| 55 | 202674 | Nb₈O₁₄Sr₁ | 0.172 | 396 | δ1(c) = −1.0 | {a, b, h, d, i, g} |
| 58 | 165377 | Ag₅O₄Si₁ | 0.633 | 332 | δ1(a) = −1.0 | {h, g} |
| 60 | 74770 | Br₁Hg₂P₃ | 1.005 | 184 | δ1(a) = 1.0 | {c, d} |
| 60 | 15853 | Nb₂Ni₁O6 | 0.024 | 288 | δ1(a) = 1.0 | {c, d} |
| 60 | 91166 | O₉P₂V₂ | 0.029 | 296 | δ1(a) = 1.0 | {c, d} |
| 61 | 421883 | Al₂Cl₈Te₄ | 1.373 | 344 | δ1(b) = 1.0 | {c} |
| 61 | 411949 | Au₁O₄S₁ | 1.854 | 328 | δ1(b) = 1.0 | {c} |
| 61 | 201539 | Cl₂N₄S6 | 1.169 | 280 | δ1(b) = −1.0 | {c} |
| 61 | 160511 | Co₁Ge₁Te₁ | 0.154 | 152 | δ1(a) = 1.0 | {c} |
| 61 | 419780 | Co₁Ge₁Te₁ | 0.049 | 152 | δ1(a) = 1.0 | {c} |
| 61 | 29506 | Cu₁O₃Se₁ | 0.103 | 280 | δ1(a) = −1.0 | {c} |
| 61 | 61342 | Cu₁O₃Se₁ | 0.093 | 280 | δ1(b) = −1.0 | {c} |
| 61 | 430942 | Cu₁P₂Se₁ | 0.648 | 216 | δ1(b) = 1.0 | {c} |
| 61 | 260373 | Ge₁Rh₁Te₁ | 0.254 | 152 | δ1(a) = 1.0 | {c} |
| 61 | 429412 | O6P₂Tl₄ | 2.444 | 232 | δ1(b) = 1.0 | {c} |
| 61 | 413194 | Pt₁Sb₁Si₁ | 0.199 | 152 | δ1(a) = 1.0 | {c} |
| 62 | 300157 | Al₁K₁Sb₄ | 0.185 | 128 | δ1(b) = 1.0 | {c} |
| 62 | 10032 | Al₁P₃Si₁ | 0.274 | 88 | δ1(a) = 1.0 | {c, d, b} |
| 62 | 280231 | As₁La₁Te₁ | 0.045 | 88 | δ1(a) = 1.0 | {c} |
| 62 | 391228 | As₂Hg₄O7 | 1.379 | 400 | δ1(a) = 1.0, δ1(b) = 1.0 | {c, d} |
| 62 | 412643 | Ba₁P₄Te₂ | 1.019 | 168 | δ1(b) = 1.0 | {c, d} |
| 62 | 78830 | Cs₂Ge₁Te₄ | 0.521 | 184 | δ1(b) = 1.0 | {c, d} |
| 62 | 74826 | Cs₂Sn₁Te₄ | 0.688 | 184 | δ1(b) = 1.0 | {c, d} |
| 62 | 300158 | Ga₁K₁Sb₄ | 0.229 | 128 | δ1(a) = 1.0 | {c} |
| 62 | 153289 | H₂B₁Li₁ | 0.412 | 24 | δ1(b) = 1.0 | {c} |
| 62 | 673401 | La₁Mn₁S₃ | 0.333 | 144 | δ1(a) = 1.0 | {c} |
| 62 | 641637 | La₁P₁S₁ | 0.453 | 176 | δ1(b) = 1.0 | {c, d} |
| 62 | 648080 | P₁S₁Y₁ | 0.349 | 176 | δ1(a) = 1.0 | {c, d} |
| 62 | 71962 | P₂Ru₂Th₁ | 0.152 | 152 | δ1(b) = 1.0 | {c} |
| 63 | 391275 | I₁K₄P₂₁ | 1.087 | 296 | δ1(d) = 1.0 | {c, e, f, h, g} |
| 63 | 391274 | I₁P₂₁Rb₄ | 1.244 | 296 | δ1(d) = 1.0 | {c, e, f, h, g} |
| 64 | 418627 | B₁₂Li₂Si₂ | 1.682 | 92 | δ1(a) = 1.0 | {f, g} |
| 64 | 411967 | B₂Ba₁Se6 | 1.716 | 104 | δ1(c) = 1.0 | {a, d, f, g} |
| 64 | 165180 | In₉K₁Na₃ | 0.014 | 156 | δ1(b) = 1.0 | {f, e, g} |
| 64 | 68498 | La₂O₂S₂ | 1.570 | 92 | δ1(a) = −1.0 | {f, d, e} |
| 64 | 415240 | Na₄P₂Se6 | 1.943 | 100 | δ1(a) = −1.0 | {f, e, g} |
| 64 | 37326 | Nb₁P₂S₈ | 1.289 | 284 | δ1(a) = −1.0 | {f, d, g} |
| 67 | 36078 | F6Pa₁Rb₁ | 0.297 | 128 | δ1(f) = 2.0 | {n, d, o, g} |
| 68 | 165258 | Au₁Na₁S₁ | 2.138 | 288 | δ1(c) = 5.0 | {e, f, d, i, g} |
| 69 | 627055 | Cs₂Ni₃S₄ | 0.287 | 72 | δ1(c) = -4.0 | {a, e, i, m} |
| 69 | 33891 | Cs₂Ni₃Se₄ | 0.492 | 72 | δ1(c) = -4.0 | {e, b, i, m} |
| 69 | 33892 | Cs₂Pd₃Se₄ | 1.007 | 72 | δ1(c) = -4.0 | {e, b, i, m} |
| 69 | 26266 | Cs₂Pt₃S₄ | 1.117 | 72 | δ1(c) = -4.0 | {a, e, i, m} |
| 69 | 33893 | Cs₂Pt₃Se₄ | 1.216 | 72 | δ1(c) = -4.0 | {a, e, i, m} |
| 69 | 20578 | Li₂O₄U₁ | 0.764 | 40 | δ1(c) = 2.0 | {a, e, i} |
| 69 | 20579 | Na₂O₄U₁ | 1.179 | 40 | δ1(c) = 2.0 | {a, e, i} |
| 69 | 646311 | Ni₃Rb₂S₄ | 0.363 | 72 | δ1(c) = -4.0 | {a, e, i, m} |
| 69 | 26267 | Pt₃Rb₂S₄ | 0.974 | 72 | δ1(c) = -4.0 | {a, e, i, m} |
| 71 | 152056 | Au₁Cs₁F₄ | 2.190 | 96 | δ1(c) = -4.0 | {l, j, b, d, i, g} |
| 71 | 411334 | Au₅Cs7O₂ | 0.719 | 130 | δ1(c) = 2.0 | {a, l, j, h, d, i, g} |
| 71 | 95821 | Au₅Cs7O₂ | 1.123 | 130 | δ1(c) = 2.0 | {a, l, i, h, d, i, g} |
| 71 | 411333 | Au₅O₂Rb7 | 0.492 | 130 | δ1(c) = -5.0 | {a, l, j, h, d, i, g} |
| 71 | 91309 | Au₅O₂Rb7 | 0.491 | 130 | δ1(c) = -5.0 | {a, l, i, h, d, i, g} |
| 71 | 95825 | Au₅O₂Rb7 | 0.633 | 130 | δ1(c) = 2.0 | {a, l, j, h, d, i, g} |
| 71 | 245981 | Br₃Cs₁Li₂ | 3.899 | 32 | δ1(c) = 2.0 | {d, j, b, i} |
| 71 | 69688 | Cl₂I₂Ta₁ | 0.963 | 66 | δ1(c) = −1.0 | {f, n, j, i} |
| 71 | 245974 | Cl₃Cs₁Li₂ | 4.944 | 32 | δ1(b) = 2.0 | {a, c, j, i} |
| 71 | 250914 | Hf₂N₂S₁ | 1.532 | 24 | δ1(d) = 2.0 | {j, b, i} |
| 71 | 25000 | Li₂Ni₁O₂ | 0.406 | 24 | δ1(b) = -4.0 | {c, j, i} |
| 71 | 183666 | Na₂O₃Ti₁ | 1.019 | 24 | δ1(c) = 2.0 | {a, d, j, i} |
| 71 | 6157 | Na₂O₄Pd₃ | 0.292 | 56 | δ1(d) = -4.0 | {j, b, i, l} |
| 71 | 16536 | O₃Pd₁Sr₂ | 0.176 | 48 | δ1(c) = 2.0 | {a, d, i} |
| 71 | 31961 | O₃Pd₁Sr₂ | 0.092 | 48 | δ1(c) = 2.0 | {a, d, i} |
| 71 | 95214 | O₃Pd₁Sr₂ | 0.125 | 48 | δ1(c) = 2.0 | {a, d, i} |
| 74 | 35336 | Al₁B₁₄Li₁ | 1.264 | 92 | δ1(c) = 1.0 | {h, d, j, e} |
| 74 | 79626 | Ba₁Ce₁O₃ | 1.935 | 80 | δ1(a) = 2.0 | {f, d, e} |
| 74 | 88591 | Ba₁Ce₁O₃ | 1.941 | 80 | δ1(d) = 2.0 | {f, c, e} |
| 74 | 94347 | Ba₁Ce₁O₃ | 1.936 | 80 | δ1(b) = 2.0 | {f, c, e} |
| 74 | 415557 | C₂B₁₃Li₁ | 2.539 | 96 | δ1(d) = 1.0 | {h, j, e} |
| 74 | 88338 | Cu₁₁K₃Te₁6 | 0.206 | 488 | δ1(a) = 2.0, δ1(b) = −1.0 | {c, j, e, f, h, i, g} |
| 74 | 74726 | O₄P₁Rh₁ | 1.031 | 228 | δ1(a) = -3.0 | {c, j, e, f, h, i} |
| 74 | 167191 | O₄Si₁Zn₂ | 1.997 | 208 | δ1(c) = -5.0 | {a, j, e, h, g} |
| 84 | 35299 | P₂S6Th₁ | 2.523 | 116 | δ1(d) = −1.0 | {j, e, k} |
| 84 | 35298 | P₂S6Zr₁ | 1.572 | 100 | δ1(d) = −1.0 | {j, e, k} |
| 87 | 89497 | Ba₉Br₃₄O₁Pr6 | 0.008 | 406 | δ1(b) = −1.0 | {a, e, h, d, i, g} |
| 87 | 406949 | Bi₄I₂Ru₁ | 0.341 | 84 | δ2(a) = −1.0, δ1(b) = −1.0 | {h, e} |
| 87 | 81 | La₄O₁0Re₂ | 0.894 | 118 | δ2(a) = 1.0 | {h, d, e, i} |
| 123 | 69124 | Br₂Cs₁F₁ | 1.772 | 30 | δ2(d) = −1.0 | {a, h, c} |
| 123 | 84019 | Br₂Cs₁F₁ | 1.371 | 30 | δ2(d) = −1.0 | {a, h, c} |
| 123 | 410874 | C₂Ag₁K₁ | 2.357 | 28 | δ1(b) = 1.0 | {a, d, g} |
| 123 | 411251 | C₂Au₁Cs₁ | 1.710 | 28 | δ1(b) = 1.0 | {a, d, g} |
| 123 | 411255 | C₂Au₁K₁ | 1.861 | 28 | δ1(b) = 1.0 | {a, d, g} |
| 123 | 411254 | C₂Au₁Na₁ | 1.085 | 20 | δ1(b) = 1.0 | {a, d, g} |
| 123 | 411252 | C₂Au₁Rb₁ | 1.786 | 28 | δ1(b) = 1.0 | {a, d, g} |
| 123 | 391118 | C₂Cu₁Rb₁ | 2.008 | 28 | δ1(b) = 1.0 | {a, d, g} |
| 123 | 391119 | C₂Cu₁Rb₁ | 2.007 | 28 | δ1(b) = 1.0 | {a, d, g} |
| 131 | 410873 | C₂Ag₁Cs₁ | 2.576 | 56 | δ1(d) = 1.0 | {e, b, k} |
| 131 | 412037 | C₂Cu₁K₁ | 2.110 | 56 | δ1(d) = 1.0 | {b, e, k} |
| 131 | 412038 | C₂Cu₁K₁ | 2.111 | 56 | δ1(d) = 1.0 | {b, e, k} |
| 131 | 412039 | C₂Cu₁Rb₁ | 2.109 | 56 | δ1(d) = 1.0 | {b, e, k} |
| 131 | 412040 | C₂Cu₁Rb₁ | 2.092 | 56 | δ1(d) = 1.0 | {b, e, k} |
| 136 | 416393 | Cl₃O₁W₁ | 0.099 | 132 | δ1(a) = −1.0 | {f, i, g} |
| 136 | 65183 | I₃O₁W₁ | 0.389 | 132 | δ1(a) = −1.0 | {f, i, g} |
| 137 | 62137 | Li6O₄Zn₁ | 3.707 | 84 | δ1(a) = −1.0 | {f, d, b, g} |
| 138 | 401591 | Cl6Hf₁Se₄ | 1.375 | 280 | δ1(d) = −1.0 | {c, j, h, i} |
| 138 | 401590 | Cl6Se₄Zr₁ | 1.394 | 280 | δ1(d) = −1.0 | {c, j, h, i} |
| 139 | 84020 | Br₂Cs₂F₂ | 2.546 | 46 | δ2(a) = −1.0 | {e} |
| 139 | 84021 | Br₂Cs₂F₂ | 2.295 | 46 | δ2(a) = −1.0 | {e} |
| 139 | 84022 | Br₂Cs₂F₂ | 2.147 | 46 | δ2(a) = −1.0 | {e} |
| 139 | 280189 | Cs₂I6Pd₁ | 0.532 | 70 | δ2(b) = −1.0 | {a, h, d, e} |
| 140 | 412830 | C₄Ba₁O₄ | 2.531 | 100 | δ1(d) = 1.0 | {a, l} |
| 141 | 163982 | Ag₃Cu₁S₂ | 0.264 | 224 | δ1(c) = −5.0 | {h, d, e, g} |
| 141 | 67526 | Ag₃Cu₁S₂ | 0.327 | 224 | δ1(d) = −5.0 | {c, h, e, g} |
| 141 | 9456 | Ba₁Cu₂O₂ | 1.339 | 88 | δ1(c) = −5.0 | {a, d, e} |
| 141 | 22206 | Ba₁O7U₂ | 1.603 | 160 | δ1(d) = 2.0 | {c, a, e, b, f} |
| 141 | 248144 | C₄O₄Pb₁ | 3.071 | 88 | δ1(b) = 1.0 | {a, h, e} |
| 141 | 52389 | Cd₁In₂O₄ | 0.636 | 84 | δ1(b) = −1.0 | {a, h, d} |
| 141 | 61333 | Cl₂O₁Pd₂ | 0.765 | 80 | δ1(d) = −4.0 | {a, c, e} |
| 141 | 25002 | Cu₂O₂Sr₁ | 1.821 | 88 | δ1(c) = −5.0 | {a, d, e} |
| 147 | 75001 | Al₁Si₁Te₃ | 0.688 | 50 | δ2(b) = −1.0 | {c, d, g} |
| 148 | 151976 | B₁₂Br₁₄Cs₂ | 2.815 | 276 | δ2(a) = 1.0, δ2(b) = 1.0 | {f, c} |
| 148 | 151975 | B₁₂Cl₁₂Cs₂ | 3.473 | 276 | δ2(a) = 1.0, δ2(b) = 1.0 | {f, c} |
| 148 | 151977 | B₁₂Cs₂I₁₂ | 1.561 | 276 | δ2(a) = 1.0, δ2(b) = 1.0 | {f, c} |
| 148 | 620234 | Cd₂P₂Se6 | 1.235 | 70 | δ2(b) = −1.0 | {f, c} |
| 148 | 620237 | Cd₂P₂Se6 | 1.157 | 70 | δ2(b) = −1.0 | {f, c} |
| 148 | 415545 | Cs₈O₁Tl₈ | 0.268 | 102 | δ2(a) = −1.0 | {f, c, b} |
| 148 | 54141 | Fe₁P₁Se₃ | 0.187 | 62 | δ2(b) = −1.0 | {f, c} |
| 148 | 633091 | Fe₁P₁Se₃ | 0.183 | 62 | δ2(b) = −1.0 | {f, c} |
| 148 | 633094 | Fe₁P₁Se₃ | 0.184 | 62 | δ2(b) = −1.0 | {f, c} |
| 148 | 633095 | Fe₁P₁Se₃ | 0.184 | 62 | δ2(b) = −1.0 | {f, c} |
| 148 | 56890 | Fe₂P₂Se6 | 0.073 | 62 | δ2(b) = −1.0 | {f, c} |
| 148 | 413165 | Mg₂P₂Se6 | 2.367 | 50 | δ2(b) = −1.0 | {f, c} |
| 148 | 642731 | Mg₂P₂Se6 | 2.384 | 50 | δ2(b) = −1.0 | {f, c} |
| 148 | 280002 | Nb6O₁₂Ti₂ | 0.491 | 158 | δ2(a) = −1.0 | {f, c} |
| 162 | 411230 | As₂Hg₂O6 | 1.770 | 70 | δ2(a) = −1.0 | {d, e, k} |
| 162 | 673231 | Ca₁O6Os₂ | 0.164 | 54 | δ1(b) = −1.0 | {a, d, k} |
| 162 | 248351 | O6Ru₂Sr₁ | 0.071 | 62 | δ1(b) = −1.0 | {a, d, k} |
| 164 | 94396 | C₂Cs₂Pd₁ | 1.675 | 36 | δ1(b) = 1.0 | {a, c, d} |
| 164 | 94397 | C₂Cs₂Pt₁ | 0.918 | 36 | δ1(b) = 1.0 | {a, c, d} |
| 164 | 421489 | C₂K₂Pd₁ | 1.438 | 36 | δ1(b) = 1.0 | {a, c, d} |
| 164 | 421490 | C₂K₂Pd₁ | 1.434 | 36 | δ1(b) = 1.0 | {a, c, d} |
| 164 | 421491 | C₂K₂Pt₁ | 0.789 | 36 | δ1(b) = 1.0 | {a, c, d} |
| 164 | 421492 | C₂K₂Pt₁ | 0.808 | 36 | δ1(b) = 1.0 | {a, c, d} |
| 164 | 411388 | C₂Na₂Pd₁ | 0.783 | 20 | δ1(b) = 1.0 | {a, c, d} |
| 164 | 50172 | C₂Na₂Pd₁ | 0.930 | 20 | δ1(b) = 1.0 | {a, c, d} |
| 164 | 50173 | C₂Na₂Pt₁ | 0.334 | 20 | δ1(b) = 1.0 | {a, c, d} |
| 164 | 421493 | C₂Pd₁Rb₂ | 1.607 | 36 | δ1(b) = 1.0 | {a, c, d} |
| 164 | 421494 | C₂Pd₁Rb₂ | 1.570 | 36 | δ1(b) = 1.0 | {a, c, d} |
| 164 | 94394 | C₂Pd₁Rb₂ | 1.561 | 36 | δ1(b) = 1.0 | {a, c, d} |
| 164 | 94395 | C₂Pt₁Rb₂ | 0.919 | 36 | δ1(b) = 1.0 | {a, c, d} |
| 164 | 183134 | H₂B₂Ca₁ | 0.052 | 10 | δ1(f) = −1.0 | {a, d} |
| 164 | 200210 | Mg₃Nb6O₁₁ | 0.159 | 150 | δ2(a) = −1.0 | {d, e, b, i} |
| 164 | 62662 | Mg₃Nb6O₁₁ | 0.183 | 150 | δ2(a) = −1.0 | {d, e, b, i} |
| 164 | 109329 | O₂Pr₂S₁ | 0.009 | 44 | δ2(b) = −1.0 | {a, d} |
| 164 | 154585 | O₂Pr₂S₁ | 0.006 | 44 | δ2(b) = −1.0 | {a, d} |
| 164 | 25805 | O₂Pr₂Se₁ | 0.009 | 44 | δ2(b) = −1.0 | {a, d} |
| 164 | 94415 | O₂Pr₂Se₁ | 0.008 | 44 | δ2(b) = −1.0 | {a, d} |
| 166 | 280938 | B₉Mg₁N₁ | 1.681 | 68 | δ2(a) = −1.0, δ2(b) = 1.0 | {c, h} |
| 166 | 422336 | Cs₄O₁Tl₂ | 0.162 | 144 | δ2(b) = −2.0 | {c, h, a} |
| 166 | 184007 | F₁Gd₁O₁ | 0.013 | 62 | δ2(a) = −1.0 | {c} |
| 166 | 247802 | F₁Gd₁O₁ | 0.013 | 62 | δ2(a) = −1.0 | {c} |
| 166 | 247803 | F₁Gd₁O₁ | 0.013 | 62 | δ2(a) = −1.0 | {c} |
| 166 | 247804 | F₁Gd₁O₁ | 0.013 | 62 | δ2(a) = −1.0 | {c} |
| 166 | 247805 | F₁Gd₁O₁ | 0.013 | 62 | δ2(a) = −1.0 | {c} |
| 166 | 247806 | F₁Gd₁O₁ | 0.013 | 62 | δ2(a) = −1.0 | {c} |
| 166 | 87361 | H₈F₄N₂ | 1.807 | 46 | δ2(a) = −1.0 | {c, h} |
| 176 | 75452 | Br₉Os₂Rb₃ | 0.338 | 212 | δ1(c) = −1.0 | {f, h, a, i} |
| 176 | 31030 | C₉Fe₂O₉ | 2.544 | 212 | δ1(c) = −1.0 | {f, b, i} |
| 176 | 6010 | C₉Fe₂O₉ | 2.682 | 212 | δ1(c) = −1.0 | {f, h, i} |
| 187 | 191307 | Mo₁S₁Se₁ | 0.621 | 36 | δ1(a) = 1.0, δ1(b) = 1.0, δ1(g) = 2.0 | {h, d, e, i} |
| 190 | 35389 | Ag₂I₁0T₁6 | 0.795 | 220 | δ1(d) = −1.0 | {f, h, e, g} |
| 194 | 75386 | Ba₅O₁0Ru₂ | 0.036 | 252 | δ1(d) = 2.0 | {c, a, e, k, f, h} |
| 194 | 56896 | Br₉Os₂Rb₃ | 0.338 | 212 | δ1(c) = 1.0 | {f, h, b, k} |
| 194 | 422525 | Ca₁Ga₂P₂ | 0.245 | 36 | δ1(c) = 1.0 | {a, f} |
| 194 | 260562 | Ca₁In₂P₂ | 0.595 | 36 | δ1(d) = 1.0 | {a, f} |
| 194 | 201057 | Cl₉Cs₃Ru₂ | 0.332 | 212 | δ1(d) = 1.0 | {f, h, b, k} |
| 194 | 402407 | Cl₉Cs₃Ti₂ | 0.096 | 196 | δ1(d) = 1.0 | {f, h, b, k} |
| 194 | 201958 | Cs₃F₉Fe₂ | 0.011 | 212 | δ1(b) = 1.0 | {e, k, f, h, d} |
| 194 | 26565 | Cs₃I₉Zr₂ | 0.255 | 196 | δ1(d) = 1.0 | {f, h, b, k} |
| 194 | 260563 | In₂P₂Sr₁ | 0.403 | 52 | δ1(d) = 1.0 | {a, f} |
| 194 | 26286 | K₁Nb₁S₂ | 0.815 | 68 | δ1(d) = 1.0 | {a, f, b} |
| 194 | 26288 | K₁Nb₁Se₂ | 0.545 | 68 | δ1(d) = 1.0 | {a, f, b} |
| 194 | 300243 | Li₁Nb₁O₂ | 1.590 | 52 | δ1(b) = 1.0 | {f, d, a} |
| 194 | 42008 | Li₁Nb₁O₂ | 1.605 | 52 | δ1(b) = 1.0 | {a, d, f} |
| 194 | 451 | Li₁Nb₁O₂ | 1.617 | 52 | δ1(b) = 1.0 | {a, d, f} |
| 194 | 73109 | Li₁Nb₁O₂ | 1.590 | 52 | δ1(b) = 1.0 | {a, d, f} |
| 194 | 73110 | Li₁Nb₁O₂ | 1.592 | 52 | δ1(b) = 1.0 | {a, d, f} |
| 194 | 75880 | Li₁Nb₁O₂ | 1.583 | 52 | δ1(b) = 1.0 | {a, d, f} |
| 194 | 26284 | Li₁Nb₁S₂ | 0.702 | 52 | δ1(d) = 1.0 | {a, f, b} |
| 194 | 29282 | Na₁Nb₁O₂ | 1.478 | 52 | δ1(b) = 1.0 | {a, d, f} |
| 194 | 300244 | Na₁Nb₁O₂ | 1.256 | 52 | δ1(b) = 1.0 | {a, d, f} |
| 194 | 73111 | Na₁Nb₁O₂ | 0.340 | 52 | δ1(b) = 1.0 | {a, d, f} |
| 194 | 26285 | Na₁Nb₁S₂ | 0.606 | 52 | δ1(d) = 1.0 | {a, f, b} |
| 194 | 26287 | Na₁Nb₁Se₂ | 0.405 | 52 | δ1(d) = 1.0 | {a, f, b} |
| 202 | 92501 | H₁₂B₁₂Cs₂ | 5.609 | 66 | δ1(a) = 1.0 | {c, h} |
| 202 | 36148 | H₁₂B₁₂K₂ | 6.042 | 66 | δ1(a) = 1.0 | {c, h} |
| 202 | 98616 | H₁₂B₁₂K₂ | 5.976 | 66 | δ1(a) = 1.0 | {c, h} |
| 202 | 20015 | H₁₂B₁₂Rb₂ | 4.589 | 66 | δ1(a) = 1.0 | {c, h} |
| 202 | 98617 | H₁₂B₁₂Rb₂ | 5.807 | 66 | δ1(a) = 1.0 | {c, h} |
| 202 | 151981 | H₁₂B₁₂Tl₂ | 3.592 | 54 | δ1(b) = 1.0 | {c, h} |
| 202 | 261530 | H₁₂B₁₂Tl₂ | 3.600 | 54 | δ1(a) = 1.0 | {c, h} |
| 202 | 422433 | H₁₂B₁₂Tl₂ | 3.600 | 54 | δ1(a) = 1.0 | {c, h} |
| 202 | 98618 | H₂0B₁₂N₂ | 5.875 | 66 | δ1(a) = 1.0 | {f, c, h} |
| 203 | 405959 | As₁Rb₃Se₁6 | 1.057 | 256 | δ1(c) = 1.0, δ2(c) = 1.0 | {a, e, b, d, g} |
| 203 | 280849 | K₃P₁Se₁6 | 1.142 | 256 | δ1(d) = 1.0, δ2(d) = 1.0 | {c, a, e, b, g} |
| 205 | 23145 | H6Cl₂N₂ | 2.645 | 120 | δ2(a) = −1.0 | {c, d} |
| 205 | 240903 | H6Cl₂N₂ | 5.080 | 120 | δ2(a) = −1.0 | {c, d} |
| 206 | 78851 | F6O₂Pt₁ | 0.013 | 256 | δ1(a) = 1.0 | {c, e, b} |
| 216 | 605048 | Ag₁Cu₄Tb₁ | 0.009 | 74 | δ1(d) = −1.0 | {a, c, e} |
| 216 | 160459 | Au₁Sc₁Sn₁ | 0.014 | 18 | δ1(c) = −1.0 | {a, d, b} |
| 216 | 245754 | Au₁Sc₁Sn₁ | 0.013 | 18 | δ1(d) = −1.0 | {a, c, b} |
| 216 | 415827 | Au₁Sc₁Sn₁ | 0.018 | 18 | δ1(c) = −1.0 | {a, d, b} |
| 216 | 58583 | Au₁Sc₁Sn₁ | 0.017 | 18 | δ1(d) = −1.0 | {a, c, b} |
| 216 | 612303 | Au₁Sc₁Sn₁ | 0.017 | 18 | δ1(d) = −1.0 | {a, c, b} |
| 216 | 107120 | Bi₁Co₁Zr₁ | 0.956 | 18 | δ1(d) = −1.0 | {a, c, b} |
| 216 | 673864 | Bi₁Co₁Zr₁ | 0.969 | 18 | δ1(d) = −1.0 | {a, c, b} |
| 216 | 58802 | Bi₁Lu₁Ni₁ | 0.062 | 40 | δ1(d) = −1.0 | {a, c, b} |
| 216 | 58824 | Bi₁Ni₁Sc₁ | 0.142 | 18 | δ1(d) = −1.0 | {a, c, b} |
| 216 | 672840 | Bi₁Ni₁Sc₁ | 0.143 | 18 | δ1(d) = −1.0 | {a, c, b} |
| 216 | 58826 | Bi₁Ni₁Y₁ | 0.142 | 26 | δ1(d) = −1.0 | {a, c, b} |
| 216 | 672841 | Bi₁Ni₁Y₁ | 0.143 | 26 | δ1(d) = −1.0 | {a, c, b} |
| 216 | 169138 | Co₁Sb₁Ti₁ | 1.046 | 18 | δ1(d) = −1.0 | {a, c, b} |
| 216 | 169139 | Co₁Sb₁Ti₁ | 1.045 | 18 | δ1(d) = −1.0 | {a, c, b} |
| 216 | 169140 | Co₁Sb₁Ti₁ | 1.045 | 18 | δ1(d) = −1.0 | {a, c, b} |
| 216 | 169141 | Co₁Sb₁Ti₁ | 1.045 | 18 | δ1(d) = −1.0 | {a, c, b} |
| 216 | 169142 | Co₁Sb₁Ti₁ | 1.044 | 18 | δ1(d) = −1.0 | {a, c, b} |
| 216 | 169143 | Co₁Sb₁Ti₁ | 1.044 | 18 | δ1(d) = −1.0 | {a, c, b} |
| 216 | 169144 | Co₁Sb₁Ti₁ | 1.044 | 18 | δ1(d) = −1.0 | {a, c, b} |
| 216 | 169145 | Co₁Sb₁Ti₁ | 1.044 | 18 | δ1(d) = −1.0 | {a, c, b} |
| 216 | 169146 | Co₁Sb₁Ti₁ | 1.043 | 18 | δ1(d) = −1.0 | {a, c, b} |
| 216 | 169147 | Co₁Sb₁Ti₁ | 1.042 | 18 | δ1(d) = −1.0 | {a, c, b} |
| 216 | 169148 | Co₁Sb₁Ti₁ | 1.042 | 18 | δ1(d) = −1.0 | {a, c, b} |
| 216 | 169149 | Co₁Sb₁Ti₁ | 1.042 | 18 | δ1(d) = −1.0 | {a, c, b} |
| 216 | 169150 | Co₁Sb₁Ti₁ | 1.041 | 18 | δ1(d) = −1.0 | {a, c, b} |
| 216 | 169151 | Co₁Sb₁Ti₁ | 1.041 | 18 | δ1(d) = −1.0 | {a, c, b} |
| 216 | 169152 | Co₁Sb₁Ti₁ | 1.040 | 18 | δ1(d) = −1.0 | {a, c, b} |
| 216 | 169153 | Co₁Sb₁Ti₁ | 1.039 | 18 | δ1(d) = −1.0 | {a, c, b} |
| 216 | 169154 | Co₁Sb₁Ti₁ | 1.039 | 18 | δ1(d) = −1.0 | {a, c, b} |
| 216 | 169155 | Co₁Sb₁Ti₁ | 1.039 | 18 | δ1(d) = −1.0 | {a, c, b} |
| 216 | 169156 | Co₁Sb₁Ti₁ | 1.033 | 18 | δ1(d) = −1.0 | {a, c, b} |
| 216 | 169157 | Co₁Sb₁Ti₁ | 1.031 | 18 | δ1(d) = −1.0 | {a, c, b} |
| 216 | 169158 | Co₁Sb₁Ti₁ | 1.030 | 18 | δ1(d) = −1.0 | {a, c, b} |
| 216 | 169159 | Co₁Sb₁Ti₁ | 1.028 | 18 | δ1(d) = −1.0 | {a, c, b} |
| 216 | 169160 | Co₁Sb₁Ti₁ | 1.026 | 18 | δ1(d) = −1.0 | {a, c, b} |
| 216 | 169161 | Co₁Sb₁Ti₁ | 1.025 | 18 | δ1(d) = −1.0 | {a, c, b} |
| 216 | 169162 | Co₁Sb₁Ti₁ | 1.024 | 18 | δ1(d) = −1.0 | {a, c, b} |
| 216 | 169163 | Co₁Sb₁Ti₁ | 1.022 | 18 | δ1(d) = −1.0 | {a, c, b} |
| 216 | 169164 | Co₁Sb₁Ti₁ | 1.021 | 18 | δ1(d) = −1.0 | {a, c, b} |
| 216 | 169165 | Co₁Sb₁Ti₁ | 1.019 | 18 | δ1(d) = −1.0 | {a, c, b} |
| 216 | 53070 | Co₁Sb₁Ti₁ | 0.982 | 18 | δ1(d) = −1.0 | {a, c, b} |
| 216 | 624920 | Co₁Sb₁Ti₁ | 1.038 | 18 | δ1(d) = −1.0 | {a, c, b} |
| 216 | 670321 | Cu₁Rb₁Te₁ | 0.063 | 26 | δ1(d) = −1.0 | {a, c, b} |
| 216 | 672074 | Fe₁Nb₁Sb₁ | 0.526 | 26 | δ1(d) = −1.0 | {a, c, b} |
| 216 | 673076 | Fe₁Nb₁Sb₁ | 0.527 | 26 | δ1(d) = −1.0 | {a, c, b} |
| 216 | 83928 | Fe₁Nb₁Sb₁ | 0.528 | 26 | δ1(d) = −1.0 | {a, c, b} |
| 216 | 181131 | Fe₁Sb₁V₁ | 0.301 | 18 | δ1(d) = −1.0 | {a, c, b} |
| 216 | 188964 | Ge₁Pt₁Ti₁ | 0.750 | 18 | δ1(d) = −1.0 | {a, c, b} |
| 216 | 188965 | Ge₁Pt₁Ti₁ | 0.742 | 18 | δ1(d) = −1.0 | {a, c, b} |
| 216 | 670934 | Hf₁Ni₁Sn₁ | 0.304 | 18 | δ1(d) = −1.0 | {a, c, b} |
| 216 | 672837 | Hf₁Ni₁Sn₁ | 0.313 | 18 | δ1(d) = −1.0 | {a, c, b} |
| 216 | 106773 | Hf₁Pd₁Sn₁ | 0.401 | 18 | δ1(d) = −1.0 | {a, c, b} |
| 216 | 44913 | Lu₁Ni₁Sb₁ | 0.199 | 40 | δ1(d) = −1.0 | {a, c, b} |
| 216 | 642458 | Lu₁Ni₁Sb₁ | 0.191 | 40 | δ1(d) = −1.0 | {a, c, b} |
| 216 | 83929 | Nb₁Ru₁Sb₁ | 0.344 | 26 | δ1(d) = −1.0 | {a, c, b} |
| 216 | 672838 | Ni₁Sb₁Sc₁ | 0.241 | 18 | δ1(d) = −1.0 | {a, c, b} |
| 216 | 76695 | Ni₁Sb₁Sc₁ | 0.240 | 18 | δ1(d) = −1.0 | {a, c, b} |
| 216 | 105331 | Ni₁Sb₁Y₁ | 0.260 | 26 | δ1(d) = −1.0 | {a, c, b} |
| 216 | 672839 | Ni₁Sb₁Y₁ | 0.260 | 26 | δ1(d) = −1.0 | {a, c, b} |
| 216 | 174568 | Ni₁Sn₁Ti₁ | 0.439 | 18 | δ1(d) = −1.0 | {a, c, b} |
| 216 | 670932 | Ni₁Sn₁Ti₁ | 0.435 | 18 | δ1(d) = −1.0 | {a, c, b} |
| 216 | 672469 | Ni₁Sn₁Ti₁ | 0.436 | 18 | δ1(d) = −1.0 | {a, c, b} |
| 216 | 672836 | Ni₁Sn₁Ti₁ | 0.440 | 18 | δ1(d) = −1.0 | {a, c, b} |
| 216 | 672973 | Ni₁Sn₁Ti₁ | 0.433 | 18 | δ1(d) = −1.0 | {a, c, b} |
| 216 | 674781 | Ni₁Sn₁Ti₁ | 0.442 | 18 | δ1(d) = −1.0 | {a, c, b} |
| 216 | 670933 | Ni₁Sn₁Zr₁ | 0.479 | 18 | δ1(d) = −1.0 | {a, c, b} |
| 216 | 673865 | Ni₁Sn₁Zr₁ | 0.495 | 18 | δ1(d) = −1.0 | {a, c, b} |
| 216 | 674785 | Ni₁Sn₁Zr₁ | 0.529 | 18 | δ1(d) = −1.0 | {a, c, b} |
| 216 | 2457 | O₄S₁Zn₁ | 4.057 | 42 | δ1(c) = −1.0 | {a, d, e} |
| 216 | 415944 | Pd₁Sb₁Sc₁ | 0.243 | 18 | δ1(d) = −1.0 | {a, c, b} |
| 216 | 77948 | Pt₁Sb₁Sc₁ | 0.532 | 18 | δ1(d) = −1.0 | {a, c, b} |
| 216 | 44970 | Pt₁Sb₁Y₁ | 0.215 | 26 | δ1(d) = −1.0 | {a, c, b} |
| 216 | 649578 | Pt₁Sb₁Y₁ | 0.294 | 26 | δ1(d) = −1.0 | {a, c, b} |
| 216 | 105799 | Pt₁Sn₁Ti₁ | 0.688 | 18 | δ1(d) = −1.0 | {a, c, b} |
| 216 | 52067 | Rh₁Sb₁Th₁ | 0.654 | 26 | δ1(d) = −1.0 | {a, c, b} |
| 216 | 107123 | Ru₁Sb₁Ta₁ | 0.607 | 18 | δ1(d) = −1.0 | {a, c, b} |
| 216 | 107124 | Ru₁Sb₁V₁ | 0.163 | 18 | δ1(d) = −1.0 | {a, c, b} |
| 217 | 70055 | Ag6Ge₁0P₁₂ | 0.501 | 166 | δ1(a) = 1.0 | {c, d, e, g} |
| 217 | 417101 | Nb₃Sb₂Te₅ | 0.783 | 158 | δ1(b) = 1.0 | {c, d, e} |
| 220 | 66831 | In₃O₈P₂ | 3.522 | 268 | δ1(a) = 1.0 | {c, d, e} |
| 225 | 186057 | Fe₂Ge₁Ti₁ | 0.074 | 24 | δ1(d) = −1.0 | {a, c, b} |
| 225 | 65508 | H6B6Cs₂ | 4.158 | 42 | δ1(a) = −1.0 | {c, e} |
| 225 | 65507 | H6B6K₂ | 4.930 | 42 | δ1(a) = −1.0 | {c, e} |
| 227 | 238013 | Ag₂Mo₁O₄ | 2.161 | 104 | δ1(c) = −2.0, δ2(c) = −3.0 | {a, d, e} |
| 227 | 238014 | Ag₂Mo₁O₄ | 1.912 | 104 | δ1(c) = −2.0, δ2(c) = −3.0 | {a, d, e} |
| 227 | 28891 | Ag₂Mo₁O₄ | 1.799 | 104 | δ1(c) = −2.0, δ2(c) = −3.0 | {a, d, e} |
| 227 | 36187 | Ag₂Mo₁O₄ | 0.558 | 104 | δ1(c) = −2.0, δ2(c) = −3.0 | {a, d, e} |
| 227 | 73581 | Ag6K₂S₄ | 1.397 | 216 | δ1(c) = 1.0, δ2(c) = 1.0 | {f, d, e} |
| 227 | 28372 | Al₁Cs₁O₂ | 4.582 | 48 | δ1(d) = 1.0, δ2(d) = 1.0 | {a, c, b} |
| 227 | 262975 | Al₁K₁O₂ | 3.288 | 48 | δ1(d) = 1.0, δ2(d) = 1.0 | {a, c, b} |
| 227 | 28373 | Al₁O₂Rb₁ | 3.769 | 48 | δ1(d) = 1.0, δ2(d) = 1.0 | {a, c, b} |
| 227 | 183382 | Al₂Cd₁O₄ | 2.878 | 84 | δ1(b) = −1.0 | {a, d, e} |
| 227 | 43025 | Al₂Cd₁S₄ | 2.363 | 84 | δ1(b) = −1.0 | {a, d, e} |
| 227 | 51423 | Al₂Cd₁Se₄ | 1.594 | 84 | δ1(b) = −1.0 | {a, d, e} |
| 227 | 51424 | Al₂Cd₁Se₄ | 1.181 | 84 | δ1(b) = −1.0 | {a, d, e} |
| 227 | 606347 | Al₂Cd₁Se₄ | 1.522 | 84 | δ1(a) = −1.0 | {c, e, b} |
| 227 | 608160 | Al₂Hg₁S₄ | 1.611 | 84 | δ1(a) = −1.0 | {c, e, b} |
| 227 | 183397 | Al₂Hg₁Se₄ | 0.303 | 84 | δ1(b) = −1.0 | {a, d, e} |
| 227 | 608163 | Al₂Hg₁Se₄ | 0.585 | 84 | δ1(a) = −1.0 | {c, e, b} |
| 227 | 163268 | Al₂O₄Zn₁ | 4.093 | 84 | δ1(b) = −1.0 | {a, d, e} |
| 227 | 185609 | Al₂O₄Zn₁ | 3.815 | 84 | δ1(b) = −1.0 | {a, d, e} |
| 227 | 185709 | Al₂O₄Zn₁ | 4.092 | 84 | δ1(b) = −1.0 | {a, d, e} |
| 227 | 187878 | Al₂O₄Zn₁ | 4.093 | 84 | δ1(b) = −1.0 | {a, d, e} |
| 227 | 196109 | Al₂O₄Zn₁ | 4.090 | 84 | δ1(b) = −1.0 | {a, d, e} |
| 227 | 24494 | Al₂O₄Zn₁ | 3.359 | 84 | δ1(b) = −1.0 | {a, d, e} |
| 227 | 26849 | Al₂O₄Zn₁ | 4.098 | 84 | δ1(b) = −1.0 | {a, d, e} |
| 227 | 26856 | Al₂O₄Zn₁ | 4.033 | 84 | δ1(b) = −1.0 | {a, d, e} |
| 227 | 290016 | Al₂O₄Zn₁ | 4.400 | 84 | δ1(b) = −1.0 | {a, d, e} |
| 227 | 290666 | Al₂O₄Zn₁ | 3.460 | 84 | δ1(b) = −1.0 | {a, d, e} |
| 227 | 290967 | Al₂O₄Zn₁ | 4.102 | 84 | δ1(b) = −1.0 | {a, d, e} |
| 227 | 56118 | Al₂O₄Zn₁ | 3.839 | 84 | δ1(b) = −1.0 | {a, d, e} |
| 227 | 609005 | Al₂O₄Zn₁ | 3.834 | 84 | δ1(b) = −1.0 | {a, d, e} |
| 227 | 94155 | Al₂O₄Zn₁ | 4.042 | 84 | δ1(b) = −1.0 | {a, d, e} |
| 227 | 94156 | Al₂O₄Zn₁ | 4.049 | 84 | δ1(a) = −1.0 | {c, e, b} |
| 227 | 94157 | Al₂O₄Zn₁ | 4.046 | 84 | δ1(a) = −1.0 | {c, e, b} |
| 227 | 94158 | Al₂O₄Zn₁ | 4.061 | 84 | δ1(b) = −1.0 | {a, d, e} |
| 227 | 94159 | Al₂O₄Zn₁ | 4.088 | 84 | δ1(b) = −1.0 | {a, d, e} |
| 227 | 94160 | Al₂O₄Zn₁ | 4.114 | 84 | δ1(b) = −1.0 | {a, d, e} |
| 227 | 94161 | Al₂O₄Zn₁ | 4.148 | 84 | δ1(b) = −1.0 | {a, d, e} |
| 227 | 94162 | Al₂O₄Zn₁ | 4.197 | 84 | δ1(b) = −1.0 | {a, d, e} |
| 227 | 94163 | Al₂O₄Zn₁ | 4.237 | 84 | δ1(b) = −1.0 | {a, d, e} |
| 227 | 94164 | Al₂O₄Zn₁ | 4.294 | 84 | δ1(a) = −1.0 | {c, e, b} |
| 227 | 94165 | Al₂O₄Zn₁ | 4.373 | 84 | δ1(b) = −1.0 | {a, d, e} |
| 227 | 94166 | Al₂O₄Zn₁ | 4.421 | 84 | δ1(b) = −1.0 | {a, d, e} |
| 227 | 94167 | Al₂O₄Zn₁ | 4.467 | 84 | δ1(b) = −1.0 | {a, d, e} |
| 227 | 94168 | Al₂O₄Zn₁ | 4.492 | 84 | δ1(b) = −1.0 | {a, d, e} |
| 227 | 94169 | Al₂O₄Zn₁ | 4.525 | 84 | δ1(b) = −1.0 | {a, d, e} |
| 227 | 94170 | Al₂O₄Zn₁ | 4.536 | 84 | δ1(b) = −1.0 | {a, d, e} |
| 227 | 94171 | Al₂O₄Zn₁ | 4.552 | 84 | δ1(b) = −1.0 | {a, d, e} |
| 227 | 94172 | Al₂O₄Zn₁ | 4.538 | 84 | δ1(b) = −1.0 | {a, d, e} |
| 227 | 94173 | Al₂O₄Zn₁ | 4.598 | 84 | δ1(b) = −1.0 | {a, d, e} |
| 227 | 94174 | Al₂O₄Zn₁ | 4.640 | 84 | δ1(a) = −1.0 | {c, e, b} |
| 227 | 94175 | Al₂O₄Zn₁ | 4.674 | 84 | δ1(b) = −1.0 | {a, d, e} |
| 227 | 94176 | Al₂O₄Zn₁ | 4.723 | 84 | δ1(a) = −1.0 | {c, e, b} |
| 227 | 94177 | Al₂O₄Zn₁ | 4.754 | 84 | δ1(b) = −1.0 | {a, d, e} |
| 227 | 94178 | Al₂O₄Zn₁ | 4.792 | 84 | δ1(b) = −1.0 | {a, d, e} |
| 227 | 94179 | Al₂O₄Zn₁ | 4.827 | 84 | δ1(a) = −1.0 | {c, e, b} |
| 227 | 94180 | Al₂O₄Zn₁ | 4.870 | 84 | δ1(b) = −1.0 | {a, d, e} |
| 227 | 94181 | Al₂O₄Zn₁ | 4.926 | 84 | δ1(b) = −1.0 | {a, d, e} |
| 227 | 94182 | Al₂O₄Zn₁ | 5.012 | 84 | δ1(b) = −1.0 | {a, d, e} |
| 227 | 94183 | Al₂O₄Zn₁ | 5.069 | 84 | δ1(a) = −1.0 | {c, e, b} |
| 227 | 15377 | Al₂S₄Zn₁ | 2.159 | 84 | δ1(a) = −1.0 | {c, e, b} |
| 227 | 35380 | Al₂S₄Zn₁ | 2.484 | 84 | δ1(b) = −1.0 | {a, d, e} |
| 227 | 44889 | Al₂S₄Zn₁ | 2.452 | 84 | δ1(b) = −1.0 | {a, d, e} |
| 227 | 609270 | Al₂S₄Zn₁ | 2.507 | 84 | δ1(a) = −1.0 | {c, e, b} |
| 227 | 609272 | Al₂S₄Zn₁ | 2.504 | 84 | δ1(a) = −1.0 | {c, e, b} |
| 227 | 609276 | Al₂S₄Zn₁ | 2.505 | 84 | δ1(a) = −1.0 | {c, e, b} |
| 227 | 609283 | Al₂S₄Zn₁ | 2.505 | 84 | δ1(a) = −1.0 | {c, e, b} |
| 227 | 76278 | Al₂S₄Zn₁ | 2.455 | 84 | δ1(b) = −1.0 | {a, d, e} |
| 227 | 609325 | Al₂Se₄Zn₁ | 1.461 | 84 | δ1(a) = −1.0 | {c, e, b} |
| 227 | 238638 | As₄He₂O6 | 4.164 | 120 | δ2(d) = −1.0 | {f, c, e} |
| 227 | 238639 | As₄He₂O6 | 4.249 | 120 | δ2(d) = −1.0 | {f, c, e} |
| 227 | 238640 | As₄He₂O6 | 4.306 | 120 | δ2(d) = −1.0 | {f, c, e} |
| 227 | 66868 | Ba₂Ge₄S₁0 | 2.131 | 192 | δ1(c) = 1.0, δ2(c) = 1.0 | {f, d, e} |
| 227 | 159739 | Cd₁Ga₂O₄ | 1.568 | 84 | δ1(b) = −1.0 | {a, d, e} |
| 227 | 159740 | Cd₁In₂O₄ | 0.950 | 84 | δ1(b) = −1.0 | {a, d, e} |
| 227 | 4118 | Cd₁In₂O₄ | 1.124 | 84 | δ1(b) = −1.0 | {a, d, e} |
| 227 | 108215 | Cd₁In₂S₄ | 1.475 | 84 | δ1(a) = −1.0 | {c, e, b} |
| 227 | 601181 | Cd₁In₂S₄ | 1.393 | 84 | δ1(a) = −1.0 | {c, e, b} |
| 227 | 620025 | Cd₁In₂S₄ | 1.401 | 84 | δ1(a) = −1.0 | {c, e, b} |
| 227 | 620027 | Cd₁In₂S₄ | 1.365 | 84 | δ1(a) = −1.0 | {c, e, b} |
| 227 | 620029 | Cd₁In₂S₄ | 1.394 | 84 | δ1(a) = −1.0 | {c, e, b} |
| 227 | 52811 | Cd₁In₂Se₄ | 0.282 | 84 | δ1(b) = −1.0 | {a, d, e} |
| 227 | 37410 | Cd₁Lu₂S₄ | 0.961 | 172 | δ1(b) = −1.0, δ1(c) = 3.0, δ2(c) = 6.0 | {a, d, e} |
| 227 | 620127 | Cd₁Lu₂S₄ | 1.009 | 172 | δ1(a) = −1.0, δ1(d) = 3.0, δ2(d) = 6.0 | {c, e, b} |
| 227 | 620129 | Cd₁Lu₂Se₄ | 0.465 | 172 | δ1(a) = −1.0, δ1(d) = 3.0, δ2(d) = 6.0 | {c, e, b} |
| 227 | 262941 | Cd₁O₄Rh₂ | 0.856 | 108 | δ1(b) = −1.0, δ1(c) = −1.0, δ2(c) = −2.0 | {a, d, e} |
| 227 | 28954 | Cd₁O₄Rh₂ | 0.846 | 108 | δ1(b) = −1.0, δ1(c) = −1.0, δ2(c) = −2.0 | {a, d, e} |
| 227 | 620332 | Cd₁S₄Sc₂ | 0.865 | 84 | δ1(a) = −1.0 | {c, e, b} |
| 227 | 94994 | Cd₁S₄Sc₂ | 0.862 | 84 | δ1(b) = −1.0 | {a, d, e} |
| 227 | 620370 | Cd₁S₄Y₂ | 1.048 | 116 | δ1(a) = −1.0, δ1(d) = 1.0, δ2(d) = 1.0 | {c, e, b} |
| 227 | 620371 | Cd₁S₄Y₂ | 1.048 | 116 | δ1(a) = −1.0, δ1(d) = 1.0, δ2(d) = 1.0 | {c, e, b} |
| 227 | 620411 | Cd₁Sc₂Se₄ | 0.264 | 84 | δ1(a) = −1.0 | {c, e, b} |
| 227 | 620457 | Cd₁Se₄Y₂ | 0.451 | 116 | δ1(a) = −1.0, δ1(d) = 1.0, δ2(d) = 1.0 | {c, e, b} |
| 227 | 161025 | Cd₂O₄Si₁ | 1.423 | 104 | δ1(c) = −2.0, δ2(c) = −3.0 | {a, d, e} |
| 227 | 191508 | Cd₂O₄Si₁ | 1.255 | 104 | δ1(c) = −2.0, δ2(c) = −3.0 | {a, d, e} |
| 227 | 187040 | Cd₂O₄Sn₁ | 0.880 | 104 | δ1(c) = −2.0, δ2(c) = −3.0 | {a, d, e} |
| 227 | 202743 | Cl₄Li₂Zn₁ | 4.212 | 84 | δ1(b) = −1.0 | {a, d, e} |
| 227 | 402398 | Cl₄Li₂Zn₁ | 4.236 | 84 | δ1(b) = −1.0 | {a, d, e} |
| 227 | 72546 | Cs₁N₂Nb₁ | 1.813 | 64 | δ1(d) = 1.0, δ2(d) = 1.0 | {a, c, b} |
| 227 | 187290 | Ga₂O₄Zn₁ | 2.515 | 84 | δ1(b) = −1.0 | {a, d, e} |
| 227 | 290017 | Ga₂O₄Zn₁ | 2.751 | 84 | δ1(b) = −1.0 | {a, d, e} |
| 227 | 290667 | Ga₂O₄Zn₁ | 1.975 | 84 | δ1(b) = −1.0 | {a, d, e} |
| 227 | 432270 | Ga₂O₄Zn₁ | 2.659 | 84 | δ1(b) = −1.0 | {a, d, e} |
| 227 | 81105 | Ga₂O₄Zn₁ | 2.670 | 84 | δ1(a) = −1.0 | {c, e, b} |
| 227 | 81106 | Ga₂O₄Zn₁ | 2.670 | 84 | δ1(a) = −1.0 | {c, e, b} |
| 227 | 81107 | Ga₂O₄Zn₁ | 2.652 | 84 | δ1(b) = −1.0 | {a, d, e} |
| 227 | 81108 | Ga₂O₄Zn₁ | 2.657 | 84 | δ1(b) = −1.0 | {a, d, e} |
| 227 | 81109 | Ga₂O₄Zn₁ | 2.668 | 84 | δ1(b) = −1.0 | {a, d, e} |
| 227 | 81110 | Ga₂O₄Zn₁ | 2.650 | 84 | δ1(b) = −1.0 | {a, d, e} |
| 227 | 81111 | Ga₂O₄Zn₁ | 2.652 | 84 | δ1(b) = −1.0 | {a, d, e} |
| 227 | 81112 | Ga₂O₄Zn₁ | 2.628 | 84 | δ1(b) = −1.0 | {a, d, e} |
| 227 | 81113 | Ga₂O₄Zn₁ | 2.631 | 84 | δ1(b) = −1.0 | {a, d, e} |
| 227 | 9394 | Ga₂O₄Zn₁ | 2.676 | 84 | δ1(b) = −1.0 | {a, d, e} |
| 227 | 56081 | Hg₁In₂S₄ | 0.736 | 84 | δ1(b) = −1.0 | {a, d, e} |
| 227 | 290668 | In₂O₄Zn₁ | 1.132 | 84 | δ1(b) = −1.0 | {a, d, e} |
| 227 | 15637 | In₂O₄Zn₁ | 0.559 | 84 | δ1(a) = −1.0 | {c, e, b} |
| 227 | 81811 | In₂O₄Zn₁ | 1.318 | 84 | δ1(b) = −1.0 | {a, d, e} |
| 227 | 44679 | K₈Sb₄Sn₁ | 0.214 | 192 | δ1(d) = 1.0, δ2(d) = 1.0 | {f, c, a, e} |
| 227 | 37420 | Lu₂Mg₁S₄ | 1.542 | 152 | δ1(d) = 3.0, δ2(d) = 6.0 | {c, e, b} |
| 227 | 44912 | Lu₂Mg₁Se₄ | 1.224 | 152 | δ1(c) = 3.0, δ2(c) = 6.0 | {a, d, e} |
| 227 | 109299 | Mg₁O₄Rh₂ | 1.150 | 88 | δ1(c) = −1.0, δ2(c) = −2.0 | {a, d, e} |
| 227 | 76052 | Mg₁Se₄Y₂ | 1.062 | 96 | δ1(c) = 1.0, δ2(c) = 1.0 | {a, d, e} |
| 227 | 109298 | O₄Rh₂Zn₁ | 0.899 | 108 | δ1(b) = −1.0, δ1(c) = −1.0, δ2(c) = −2.0 | {a, d, e} |
| 227 | 161024 | O₄Si₁Zn₂ | 2.925 | 104 | δ1(c) = −2.0, δ2(c) = −3.0 | {a, d, e} |
| 227 | 167193 | O₄Si₁Zn₂ | 2.825 | 104 | δ1(c) = −2.0, δ2(c) = −3.0 | {a, d, e} |
| 227 | 191507 | O₄Si₁Zn₂ | 2.619 | 104 | δ1(c) = −2.0, δ2(c) = −3.0 | {a, d, e} |
| 227 | 187039 | O₄Sn₁Zn₂ | 0.493 | 104 | δ1(c) = −2.0, δ2(c) = −3.0 | {a, d, e} |
| 227 | 650850 | S₄Sc₂Zn₁ | 0.523 | 84 | δ1(a) = −1.0 | {c, e, b} |
| 227 | 650852 | S₄Sc₂Zn₁ | 0.520 | 84 | δ1(a) = −1.0 | {c, e, b} |
| 227 | 651411 | S₄Y₂Zn₁ | 0.485 | 116 | δ1(a) = −1.0, δ1(d) = 1.0, δ2(d) = 1.0 | {c, e, b} |
| 227 | 652188 | Se₄Y₂Zn₁ | 0.103 | 116 | δ1(a) = −1.0, δ1(d) = 1.0, δ2(d) = 1.0 | {c, e, b} |
| 2 | 170639 | Ag₁Bi₁P₂S6 | 0.927 | 124 | δ1(c) = 1.0, δ1(f) = 1.0 | {i} |
| 2 | 154804 | As₁Cl₃F6S₃ | 0.122 | 172 | δ1(d) = −1.0, δ1(h) = −1.0 | {i} |
| 2 | 75451 | As₁Cl₃F6S₃ | 0.122 | 172 | δ1(d) = −1.0, δ1(h) = −1.0 | {i} |
| 2 | 291309 | As₂Cd₁Ge₁K₁ | 0.740 | 140 | δ1(c) = 1.0, δ1(g) = 1.0 | {i} |
| 2 | 291310 | As₂Cd₁Ge₁Rb₁ | 0.771 | 140 | δ1(c) = 1.0, δ1(g) = 1.0 | {i} |
| 2 | 410759 | B₁₈Cs₄Hg₂Se₁₈ | 2.059 | 222 | δ1(f) = −1.0 | {i} |
| 2 | 410758 | B₁₈Hg₂Rb₄Se₁₈ | 2.086 | 222 | δ1(f) = −1.0 | {i} |
| 2 | 237524 | B₃Cu₁Li₃O7 | 0.400 | 130 | δ1(b) = −1.0 | {i} |
| 2 | 401906 | Br₁0O₁Ta₂Te₄ | 0.915 | 110 | δ1(a) = 1.0 | {h, i} |
| 2 | 171405 | C₁0H₁₈Cu₂N₂O₁0 | 0.538 | 150 | δ1(c) = −1.0 | {i} |
| 2 | 172423 | C₁0H₁₈Cu₂N₂O₁0 | 0.541 | 150 | δ1(h) = −1.0 | {i} |
| 2 | 172424 | C₁0H₁₈N₂O₁0Rh₂ | 1.707 | 146 | δ1(a) = 1.0 | {i} |
| 2 | 98942 | C₁F₃Hg₁O₃S₁ | 3.051 | 122 | δ1(b) = 1.0 | {i} |
| 2 | 161194 | C₁H₅Eu₁O7P₁ | 0.518 | 146 | δ1(b) = 1.0 | {i} |
| 2 | 161195 | C₁H₅Nd₁O7P₁ | 0.152 | 140 | δ1(b) = 1.0 | {i} |
| 2 | 161196 | C₁H₅O7P₁Pr₁ | 0.040 | 138 | δ1(b) = 1.0 | {i} |
| 2 | 158855 | C₂H₁0Ga₂Ge₄N₂O₁₂ | 3.729 | 122 | δ1(e) = 1.0 | {i} |
| 2 | 174167 | C₂H₂6B₁₂N₈ | 5.034 | 110 | δ1(d) = −1.0 | {i} |
| 2 | 159351 | C₂H6Ca₁O7 | 3.625 | 116 | δ1(c) = 1.0, δ1(h) = 1.0 | {i} |
| 2 | 77096 | C₂H6Ca₁O7 | 3.388 | 116 | δ1(c) = 1.0, δ1(h) = 1.0 | {i} |
| 2 | 250237 | C₂H6K₂O₁₃S₁U₁ | 1.335 | 260 | δ1(a) = 1.0, δ1(e) = 1.0 | {i} |
| 2 | 172777 | C₂H6O₁₂U₂ | 1.938 | 114 | δ1(g) = 1.0 | {i} |
| 2 | 110471 | C₂H₈Br₃Cu₁N₁O₁ | 0.004 | 118 | δ1(f) = −1.0 | {i} |
| 2 | 249780 | C₂H₈In₂O₁₄Se₂ | 3.400 | 118 | δ1(a) = 1.0 | {i} |
| 2 | 250206 | C₃H7F₁N₁O₅Sn₁ | 2.841 | 130 | δ1(b) = 1.0 | {i} |
| 2 | 237040 | C₄H₁₁N₁O₁0 | 3.140 | 184 | δ1(d) = 1.0, δ1(e) = 1.0 | {i} |
| 2 | 237041 | C₄H₁₁N₁O₁0 | 3.252 | 184 | δ1(d) = 1.0, δ1(e) = 1.0 | {i} |
| 2 | 249174 | C₄H₁₁N₁O₁0 | 2.925 | 184 | δ1(f) = 1.0, δ1(h) = 1.0 | {i} |
| 2 | 59807 | C₄H₁₂Ba₂N₂O₁0S₂ | 2.863 | 130 | δ1(f) = 1.0 | {i} |
| 2 | 203234 | C₄H₁₂Fe₁O6S₄ | 0.730 | 96 | δ1(b) = −1.0 | {a, i} |
| 2 | 183813 | C₄H₁₂N6O₁₄Se₂U₂ | 1.785 | 182 | δ1(b) = 1.0 | {i} |
| 2 | 109495 | C₄H₁₄F₃N₁O₂V₁ | 0.005 | 146 | δ1(d) = 1.0 | {i} |
| 2 | 110428 | C₄H₁6C₁6Cu₂N₂ | 0.017 | 212 | δ1(a) = −1.0, δ1(g) = −1.0 | {i} |
| 2 | 30930 | C₄H7Cs₁O₁0 | 1.762 | 184 | δ1(d) = 1.0, δ1(e) = 1.0 | {i} |
| 2 | 246803 | C₄H7K₁O₁0 | 2.279 | 184 | δ1(d) = 1.0, δ1(e) = 1.0 | {i} |
| 2 | 195083 | C₅H₁0N₁O6 | 2.451 | 142 | δ1(c) = 1.0 | {i} |
| 2 | 109824 | C6F6Na₄O₁₂Sn₄ | 2.367 | 158 | δ1(d) = 1.0 | {i} |
| 2 | 168722 | C6H₁₂Fe₁N₈O₈ | 1.122 | 132 | δ1(f) = 1.0 | {h, i} |
| 2 | 159906 | C6H₄Na₄Np₂O₁₈ | 0.009 | 170 | δ1(c) = 1.0 | {i} |
| 2 | 152170 | C₈H₂0N6O₁₈S₂U₂ | 1.485 | 230 | δ1(d) = 1.0 | {i} |
| 2 | 109491 | C₈H₂₈F6N₂O₄V₂ | 0.035 | 146 | δ1(g) = 1.0 | {i} |
| 2 | 110165 | C₈H₂₈F6N₂O₄V₂ | 0.035 | 146 | δ1(g) = 1.0 | {i} |
| 2 | 170794 | C₈H₄K6N₈O6Os₂S₂ | 2.351 | 194 | δ1(f) = 1.0 | {i} |
| 2 | 36 | C₈I₂Mo₂O₈ | 0.664 | 212 | δ1(a) = 1.0, δ1(h) = 1.0 | {i} |
| 2 | 47102 | Cl₁0Mo₂N₄S₄ | 0.516 | 126 | δ1(c) = 1.0 | {i} |
| 2 | 49920 | Cl₁0Nb₂O₁Te₄ | 1.136 | 126 | δ1(a) = 1.0 | {h, i} |
| 2 | 72781 | Cl₂N₄O₁₂S₁0 | 1.127 | 166 | δ1(a) = −1.0 | {i} |
| 2 | 241454 | Cs₂P₂Se6Zn₁ | 1.925 | 152 | δ1(a) = 1.0, δ1(b) = 1.0 | {i} |
| 2 | 62966 | Cu₁O₉Se₃Sr₂ | 0.076 | 206 | δ1(g) = −1.0 | {i} |
| 2 | 240930 | Cu₂Na₂O₁₁Si₄ | 0.068 | 106 | δ1(d) = −1.0 | {b, i} |
| 2 | 174513 | F₂N₂O₄Xe₁ | 2.623 | 56 | δ1(h) = 1.0 | {a, i} |
| 2 | 173748 | F₂O7Te₂V₂ | 0.063 | 78 | δ1(g) = 1.0 | {c, i} |
| 2 | 97067 | H₁0F₈In₂N₂O₂ | 4.719 | 94 | δ1(a) = 1.0 | {i} |
| 2 | 32507 | H₁₂I₈Mg₁O6 | 1.203 | 106 | δ1(f) = 1.0 | {a, i} |
| 2 | 1834 | H₁₂Mg₁O₁₂S₂ | 5.456 | 98 | δ1(h) = 1.0 | {a, i} |
| 2 | 1836 | H₁₂O₁₂S₂Zn₁ | 4.242 | 108 | δ1(h) = 1.0 | {a, i} |
| 2 | 412799 | H₁₄Hg₂O₁₄Te₂ | 3.271 | 134 | δ1(f) = 1.0 | {a, i, g} |
| 2 | 73623 | H₁₄N₄O₈S₂ | 4.941 | 94 | δ1(b) = 1.0 | {i} |
| 2 | 168493 | H₁6B₁₂Na₂O₁₄S6 | 2.216 | 174 | δ1(f) = −1.0 | {i} |
| 2 | 424875 | H₁₈O₁₂Se₄Sn₁Sr₂ | 0.652 | 138 | δ1(g) = 1.0 | {c, i} |
| 2 | 409556 | H₂₄Li₂N₈Te₂ | 1.237 | 78 | δ1(e) = 1.0 | {i} |
| 2 | 67549 | H₂6B₂0K₄O₄ | 0.573 | 146 | δ1(c) = 1.0 | {i} |
| 2 | 170179 | H₃₂N₁₄Se6Sn₂ | 1.865 | 146 | δ1(a) = 1.0 | {i} |
| 2 | 49621 | H₃₄Cl₄Cr₂N₈O6 | 0.290 | 150 | δ1(a) = −1.0 | {i} |
| 2 | 154123 | H₄Cu₂Na₂O₁₃Si₄ | 0.087 | 122 | δ1(a) = −1.0 | {f, i} |
| 2 | 414048 | H₄Cu₂Na₂O₁₃Si₄ | 0.083 | 122 | δ1(d) = −1.0 | {b, i} |
| 2 | 49614 | H6B₂F₈N₂ | 7.541 | 78 | δ1(a) = 1.0 | {i} |
| 2 | 423683 | H6Cs₂O₁₂P₄ | 4.742 | 116 | δ1(b) = 1.0, δ1(c) = 1.0 | {i} |
| 2 | 429157 | H6F₂₂N₂Sb₄ | 4.826 | 190 | δ1(b) = 1.0 | {i} |
| 2 | 423682 | H6O₁₂P₄Rb₂ | 5.425 | 116 | δ1(b) = 1.0, δ1(c) = 1.0 | {i} |
| 2 | 79097 | H₈Na6O₁₄P₄ | 3.552 | 118 | δ1(d) = 1.0 | {i} |
| 2 | 87486 | K₄Mn₁Mo₃O₁₂ | 0.021 | 266 | δ1(a) = 1.0 | {f, b, i} |
| 2 | 16879 | K₄N₂O₁₄S₄ | 0.440 | 154 | δ1(h) = −1.0 | {i} |
| 2 | 431529 | Lu₁Na₁P₂S6 | 2.550 | 144 | δ1(c) = 1.0, δ1(:0 = 1.0 | {i} |
| 2 | 431532 | Na₁P₂S6Tb₁ | 0.075 | 132 | δ1(a) = 1.0, δ1(h) = 1.0 | {i} |
| 2 | 431533 | Na₁P₂S6Y₁ | 2.548 | 116 | δ1(b) = 1.0, δ1(e) = 1.0 | {i} |
| 2 | 241453 | P₂Rb₂Se6Zn₁ | 1.904 | 152 | δ1(a) = 1.0, δ1(b) = 1.0 | {i} |
| 11 | 249033 | C₄H₃Cs₁O₁₄U₂ | 1.822 | 280 | δ1(b) = 1.0, δ1(c) = 1.0 | {f, e} |
| 11 | 249031 | C₄H₅K₁O₁₅U₂ | 1.810 | 296 | δ1(a) = 1.0, δ1(d) = 1.0 | {f, e} |
| 11 | 249032 | C₄H₅O₁₅Rb₁U₂ | 1.777 | 296 | δ1(a) = 1.0, δ1(d) = 1.0 | {f, e} |
| 11 | 32656 | Cs₂Cu₂O₁₉S₁₈ | 0.351 | 372 | δ1(a) = −1.0 | {f, d, e} |
| 11 | 99599 | Cu₂Ge₄O₁₃Sc₂ | 0.176 | 244 | δ1(a) = −1.0 | {f, e} |
| 11 | 99600 | Cu₂Ge₄O₁₃Sc₂ | 0.172 | 244 | δ1(a) = −1.0 | {f, e} |
| 11 | 99601 | Cu₂Ge₄O₁₃Sc₂ | 0.168 | 244 | δ1(a) = −1.0 | {f, e} |
| 11 | 99602 | Cu₂Ge₄O₁₃Sc₂ | 0.169 | 244 | δ1(a) = −1.0 | {f, e} |
| 11 | 99603 | Cu₂Ge₄O₁₃Sc₂ | 0.165 | 244 | δ1(a) = −1.0 | {f, e} |
| 11 | 406200 | K₃P₅Ru₁Se₁0 | 0.934 | 240 | δ1(b) = 1.0 | {f, e} |
| 12 | 171256 | Ag₂Br6Hg7P₈ | 0.911 | 188 | δ1(d) = −1.0 | {c, j, e, i} |
| 12 | 171257 | Ag₂Hg7I6P₈ | 0.820 | 188 | δ1(d) = −1.0 | {c, i, e, i} |
| 12 | 165322 | Au₂K₂P₂Se6 | 1.085 | 86 | δ1(c) = −1.0 | {j, i, g} |
| 12 | 423802 | Au₂La₄O₂P₄ | 0.100 | 98 | δ1(d) = −1.0 | {i} |
| 12 | 171216 | Au₂P₂Se6Tl₂ | 1.035 | 74 | δ1(c) = −1.0 | {j, i, g} |
| 12 | 99805 | C₂Cl₂O₄Pb₂ | 2.742 | 54 | δ1(d) = −1.0 | {h, j, i} |
| 12 | 261774 | C₂H₂Ag₁O₉S₁Tb₁ | 0.094 | 200 | δ1(a) = −1.0, δ1(d) = −1.0 | {h, j, i} |
| 12 | 95291 | C₂H₄Ca₂Cl₂O6 | 3.535 | 66 | δ1(d) = −1.0 | {h, j, i, g} |
| 12 | 425117 | C₂H6N₂Rb₂ | 3.945 | 84 | δ1(b) = 1.0, δ1(c) = 1.0 | {j, i} |
| 12 | 151090 | C₄H6B₁₂Cs₂I₁₂N₂ | 1.842 | 170 | δ1(b) = 1.0 | {h, j, i} |
| 12 | 172053 | C₄H₈N₂O₄ | 2.933 | 58 | δ1(a) = 1.0 | {h, j, i} |
| 12 | 172054 | C₄H₈N₂O₄ | 2.932 | 58 | δ1(d) = 1.0 | {j, i, g} |
| 12 | 163689 | H₂0B₁₂Li₂O₄ | 5.312 | 82 | δ1(a) = 1.0 | {h, j, i} |
| 12 | 163690 | H₂0B₁₂Li₂O₄ | 5.403 | 82 | δ1(a) = 1.0 | {h, j, i} |
| 12 | 248034 | In₁K₂P₂S7 | 2.052 | 146 | δ1(a) = −1.0 | {j, i, g} |
| 12 | 195314 | La₂P₄S₁₄Tl₄ | 2.035 | 138 | δ1(d) = −1.0 | {j, i} |
| 13 | 109996 | C₈H₁₂Ag₂N₄O₄ | 2.370 | 220 | δ1(d) = 1.0 | {a, f, e, g} |
| 14 | 431760 | Ag₁As₁K₁S₂ | 1.748 | 148 | δ1(d) = 1.0 | {e} |
| 14 | 165596 | Ag₁Cu₁O₁P₁ | 0.083 | 204 | δ1(b) = −1.0 | {e} |
| 14 | 165361 | Ag₂Cs₂P₂Se6 | 1.621 | 172 | δ1(a) = 1.0 | {e} |
| 14 | 84733 | Ag₂O₈P₂V₁ | 0.014 | 340 | δ1(c) = 1.0 | {e} |
| 14 | 195332 | Ag₂P₂Se6Tl₂ | 1.371 | 296 | δ1(a) = 1.0, δ1(d) = 1.0 | {e} |
| 14 | 91551 | Al₁As₁Cu₁O₅ | 0.315 | 196 | δ1(b) = −1.0 | {e} |
| 14 | 196430 | Al₁Cu₁O₈P₂Rb₁ | 0.096 | 324 | δ1(c) = −1.0 | {e} |
| 14 | 38378 | Al₂Br6N₂S₂ | 1.889 | 140 | δ1(b) = 1.0 | {e} |
| 14 | 82802 | Al₂Br6N₂Se₂ | 1.939 | 140 | δ1(a) = 1.0 | {e} |
| 14 | 4043 | As₁F6N₂S₃ | 1.346 | 300 | δ1(a) = −1.0 | {e} |
| 14 | 421269 | Ba₁La₁Sb₂Se6 | 0.493 | 268 | δ1(a) = 1.0 | {e} |
| 14 | 153066 | Ba₁Mo₂O₁6P₄ | 0.034 | 276 | δ1(a) = 1.0 | {d, e} |
| 14 | 61132 | C₁0F₄Mn₂O₈ | 2.675 | 260 | δ1(c) = 1.0 | {e} |
| 14 | 65278 | C₁₂Bi₂O₁₂Ru₄ | 1.144 | 324 | δ1(c) = 1.0 | {e} |
| 14 | 69074 | C₁₂Bi₂O₁₂Ru₄ | 1.144 | 324 | δ1(c) = 1.0 | {e} |
| 14 | 50969 | C₁O6P₁Sn₂ | 2.261 | 212 | δ1(d) = 1.0 | {e} |
| 14 | 420263 | C₂As₂F₁₂N₂Te₄ | 1.673 | 272 | δ1(a) = 1.0, δ1(d) = 1.0 | {e} |
| 14 | 279638 | C₂Cl₁0N₂Sb₂ | 2.333 | 196 | δ1(a) = 1.0 | {e} |
| 14 | 26526 | C₂Cu₁O6Tl₂ | 0.107 | 244 | δ1(b) = 1.0 | {e} |
| 14 | 66367 | C₂F6N₄O6S₄Se₄ | 1.443 | 308 | δ1(c) = −1.0 | {e} |
| 14 | 72782 | C₂F6N₄O6S₈ | 1.205 | 308 | δ1(d) = −1.0 | {e} |
| 14 | 39364 | C₂H₁Cs₁O₄ | 0.236 | 168 | δ1(c) = 1.0, δ1(d) = 1.0 | {e} |
| 14 | 246301 | C₂H₂Na₂O6 | 3.406 | 96 | δ1(a) = 1.0, δ1(c) = 1.0 | {e} |
| 14 | 39365 | C₂H₄Cs₂O6 | 3.725 | 132 | δ1(d) = 1.0 | {e} |
| 14 | 409803 | C₂H₄F6O6S₂Si₂ | 5.851 | 220 | δ1(c) = 1.0 | {e} |
| 14 | 150181 | C₂H₄Fe₄O₁₂P₂ | 0.208 | 276 | δ1(d) = 1.0 | {e} |
| 14 | 59806 | C₂H₄O₁₄P₂Zn₄ | 3.513 | 308 | δ1(c) = 1.0 | {e} |
| 14 | 425116 | C₂H6K₂N₂ | 3.955 | 84 | δ1(d) = −1.0 | {e} |
| 14 | 253542 | C₂H6K₄N₈O₁0 | 3.512 | 300 | δ1(d) = 1.0 | {e} |
| 14 | 239363 | C₃H₂Na₁O7Zn₁ | 3.272 | 276 | δ1(a) = 1.0 | {e} |
| 14 | 162709 | C₃H₃Ba₁O7 | 2.840 | 268 | δ1(b) = 1.0 | {e} |
| 14 | 432232 | C₄H₁₂Cl₈Nb₂S₂ | 0.729 | 244 | δ1(b) = 1.0 | {e} |
| 14 | 281782 | C₄H₁₈B₂P₂ | 5.866 | 100 | δ1(c) = 1.0 | {e} |
| 14 | 109774 | C₄H₂Fe₂O6 | 0.266 | 140 | δ1(c) = −1.0 | {e} |
| 14 | 251788 | C₄H₂O₈Tl₂ | 2.322 | 144 | δ1(c) = 1.0, δ1(d) = 1.0 | {e} |
| 14 | 243750 | C6H₁0O6Sn₁ | 2.784 | 148 | δ1(c) = −1.0 | {a, e} |
| 14 | 260040 | C6H₄Mg₂Na₂O₁₄ | 3.678 | 236 | δ1(d) = 1.0 | {e} |
| 14 | 174509 | C6O₁6Rb₂U₂ | 1.709 | 332 | δ1(b) = 1.0 | {e} |
| 14 | 82090 | Cd₁Mo₁O6P₁ | 1.506 | 236 | δ1(a) = 1.0 | {e} |
| 14 | 50959 | Cd₁P₂Rb₂Se6 | 2.029 | 152 | δ1(c) = 1.0 | {d, e} |
| 14 | 15320 | Cl₁₂Mo₂O₄P₂ | 0.046 | 260 | δ1(c) = 1.0 | {e} |
| 14 | 249982 | Cs₂O₁₂P₂U₂ | 0.042 | 204 | δ1(a) = −1.0 | {c, e} |
| 14 | 280814 | Cs₄O₂S₁0V₂ | 1.477 | 236 | δ1(d) = 1.0 | {e} |
| 14 | 171220 | Cu₁P₁Se₃Tl₁ | 1.369 | 148 | δ1(d) = 1.0 | {e} |
| 14 | 195339 | Cu₂P₂S6Tl₂ | 1.707 | 148 | δ1(c) = 1.0 | {e} |
| 14 | 195340 | Cu₂P₂Se6Tl₂ | 1.377 | 148 | δ1(a) = 1.0 | {e} |
| 14 | 31789 | F₂N₄O6S₈ | 1.119 | 236 | δ1(c) = −1.0 | {e} |
| 14 | 15285 | Fe₁I₁N₂O₂ | 0.335 | 296 | δ1(a) = 1.0, δ1(b) = 1.0 | {e} |
| 14 | 300226 | Fe₁K₂P₂S6 | 0.463 | 144 | δ1(d) = 1.0 | {c, e} |
| 14 | 657803 | Fe₁K₂P₂S6 | 0.463 | 144 | δ1(d) = 1.0 | {c, e} |
| 14 | 165358 | Fe₁K₂P₂Se6 | 0.343 | 144 | δ1(b) = 1.0 | {a, e} |
| 14 | 62320 | Fe₂K₁O₈P₂ | 0.007 | 332 | δ1(c) = 1.0 | {e} |
| 14 | 61783 | H₁0Br₂N₂O₂ | 4.032 | 92 | δ1(d) = 1.0 | {e} |
| 14 | 61784 | H₁0Br₂N₂O₂ | 4.066 | 92 | δ1(d) = 1.0 | {e} |
| 14 | 14169 | H₁0N₂O₈P₂ | 5.896 | 156 | δ1(c) = 1.0 | {e} |
| 14 | 2913 | H₁0N₂O₈P₂ | 5.805 | 156 | δ1(d) = 1.0 | {e} |
| 14 | 6211 | H₁₂N₄O₄P₂ | 1.665 | 132 | δ1(c) = 1.0 | {e} |
| 14 | 417327 | H₁₂O6P₂Rb₄S6 | 3.433 | 260 | δ1(a) = 1.0 | {e} |
| 14 | 190007 | H₁₄Ni₁O₁₂P₂ | 0.009 | 212 | δ1(c) = 1.0 | {e, b} |
| 14 | 422482 | H₂Hg6N₄O₁₄ | 2.566 | 356 | δ1(b) = 1.0 | {e} |
| 14 | 429411 | H₂O6P₂Tl₂ | 2.837 | 108 | δ1(b) = 1.0 | {e} |
| 14 | 236184 | H₃K₁O6P₂ | 5.649 | 232 | δ1(a) = 1.0, δ1(c) = 1.0 | {e} |
| 14 | 59361 | H₅O7P₁V₁ | 0.076 | 228 | δ1(b) = 1.0 | {e} |
| 14 | 68557 | H₅O7P₁V₁ | 0.046 | 228 | δ1(c) = 1.0 | {e} |
| 14 | 413072 | H6Cs₂N₂P₄ | 1.927 | 108 | δ1(a) = 1.0 | {e} |
| 14 | 417326 | H₈K₄O₄P₂S6 | 2.964 | 228 | δ1(b) = 1.0 | {e} |
| 14 | 418251 | H₈Li₄O₁₂P₂ | 3.883 | 188 | δ1(c) = 1.0 | {e} |
| 14 | 50960 | Hg₁K₂P₂Se6 | 1.574 | 304 | δ1(a) = 1.0, δ1(b) = 1.0 | {e} |
| 14 | 413168 | K₂Mg₁P₂Se6 | 2.113 | 132 | δ1(d) = 1.0 | {c, e} |
| 14 | 241452 | K₂P₂Se6Zn₁ | 1.972 | 304 | δ1(c) = 1.0, δ1(d) = 1.0 | {e} |
| 14 | 246133 | Li₂O₈P₂V₁ | 0.076 | 260 | δ1(a) = 1.0 | {e} |
| 14 | 411191 | Mo₂O₁6P₄Sr₁ | 0.030 | 276 | δ1(c) = 1.0 | {b, e} |
| 14 | 67597 | Na₂O₈P₂V₁ | 0.052 | 260 | δ1(a) = 1.0 | {e} |
| 14 | 419533 | Ni₁O₁0P₂V₂ | 0.047 | 180 | δ1(c) = 1.0 | {a, e} |
| 15 | 195333 | Ag₃P₄S₁₂Tl₅ | 1.590 | 280 | δ1(a) = 1.0, δ1(c) = 1.0 | {f, e} |
| 15 | 180003 | Ba₁In₂O₁₄P₄ | 4.434 | 240 | δ1(c) = −2.0 | {a, d, e, f} |
| 15 | 417616 | Ba₁La₂O₁₄Te₅ | 3.306 | 292 | δ1(d) = −2.0 | {f, c, e} |
| 15 | 421965 | Ba₁O₈P₂Th₁ | 4.941 | 160 | δ1(d) = −2.0 | {f, c, e} |
| 15 | 260737 | Ba₂Gd₂O₁₃Si₄ | 0.007 | 300 | δ1(b) = 1.0 | {f, e} |
| 15 | 195682 | Bi₂Cl₈Hg₃Te₂ | 2.605 | 228 | δ1(c) = 5.0 | {f, d} |
| 15 | 237619 | Bi₂Cl₈Hg₃Te₂ | 2.696 | 228 | δ1(d) = 5.0 | {f, c} |
| 15 | 410623 | C₁Ag₂Cl₁N₁O₄S₁ | 2.633 | 272 | δ1(d) = 5.0 | {f, c, e} |
| 15 | 65697 | C₂Ag₁N₂Na₁ | 2.744 | 60 | δ1(c) = 5.0 | {f, d, e} |
| 15 | 109946 | C₂F6Na₂O₄Sb₂ | 3.146 | 172 | δ1(a) = 1.0 | {f} |
| 15 | 249312 | C₂H₂Cs₂O₅ | 3.533 | 116 | δ1(d) = 1.0 | {f, e} |
| 15 | 249313 | C₂H₂Cs₂O₅ | 3.452 | 116 | δ1(d) = 1.0 | {f, e} |
| 15 | 249314 | C₂H₂Cs₂O₅ | 3.487 | 116 | δ1(c) = 1.0 | {f, e} |
| 15 | 249315 | C₂H₂Cs₂O₅ | 3.527 | 116 | δ1(c) = 1.0 | {f, e} |
| 15 | 246782 | C₂H₂K₂O₅ | 3.548 | 116 | δ1(d) = 1.0 | {f, e} |
| 15 | 246783 | C₂H₂K₂O₅ | 3.544 | 116 | δ1(d) = 1.0 | {f, e} |
| 15 | 246300 | C₂H₂K₂O6 | 3.507 | 128 | δ1(c) = 1.0 | {f} |
| 15 | 240494 | C₂H₂O₅Rb₂ | 3.592 | 116 | δ1(d) = 1.0 | {f, e} |
| 15 | 9561 | C₂H₄B₂O₂ | 3.994 | 60 | δ1(b) = 1.0 | {f} |
| 15 | 260020 | C₂H6Fe₁N₂O₄ | 0.732 | 112 | δ1(b) = 1.0 | {f, e} |
| 15 | 400123 | C₂H₈Cl₃Cu₁N₁ | 0.036 | 212 | δ1(b) = −1.0 | {f} |
| 15 | 2730 | C₂H₈I₂N₄S₂ | 1.994 | 124 | δ1(d) = −1.0 | {f, c, e} |
| 15 | 23342 | C₂N₂O6S₂ | 3.823 | 132 | δ1(a) = 1.0 | {f} |
| 15 | 240771 | C₄H₁₂Mg₁O6S₄ | 1.819 | 180 | δ1(d) = −1.0 | {f, e} |
| 15 | 110427 | C₄H₁6Cl6Cu₂N₂ | 0.037 | 212 | δ1(b) = −1.0 | {f} |
| 15 | 110707 | C₄H₁6F₄Mn₁N₁O₂ | 0.056 | 168 | δ1(c) = 2.0 | {f, d, e} |
| 15 | 248038 | C₄H₄O₁0Th₁ | 3.482 | 184 | δ1(a) = 1.0, δ1(b) = 1.0 | {f, e} |
| 15 | 162708 | C₄H6Ba₁O₁0 | 2.349 | 184 | δ1(b) = 1.0, δ1(c) = 1.0 | {f, e} |
| 15 | 110011 | C₄H6Cd₁O₂S₄ | 2.313 | 140 | δ1(c) = 5.0 | {f, d} |
| 15 | 151153 | C₄H6Na₂O7 | 2.611 | 132 | δ1(d) = −1.0 | {f, e} |
| 15 | 109771 | C₄H6O7Sr₁ | 2.899 | 148 | δ1(c) = −1.0 | {f, e} |
| 15 | 162987 | C₄H₈Cd₁Cl₂N₂ | 0.335 | 120 | δ1(d) = −1.0 | {f, e} |
| 15 | 249614 | C₄H₈O₁₂Th₁ | 3.308 | 216 | δ1(a) = 1.0, δ1(c) = 1.0 | {f, e} |
| 15 | 109772 | C₄H₈O₈Zn₁ | 2.643 | 168 | δ1(a) = −1.0 | {f, c} |
| 15 | 64628 | C6H6Ag₃Co₁N₈ | 3.012 | 224 | δ1(d) = 3.0 | {f, c, e} |
| 15 | 200237 | Cd₃Na₂O₁0Si₃ | 2.709 | 220 | δ1(d) = 5.0 | {f, c, e} |
| 15 | 28416 | Cd₃Na₂O₁0Si₃ | 2.709 | 220 | δ1(d) = 5.0 | {f, c, e} |
| 15 | 426510 | Cl₃Na₂O₁₂Te₄Y₃ | 3.511 | 304 | δ1(c) = −2.0 | {f, d, e} |
| 15 | 401295 | Cu₁Mo₂O₈Sb₁ | 0.797 | 152 | δ1(d) = 5.0 | {f, c, e} |
| 15 | 48002 | Eu₁O₈Rb₁S₂ | 0.526 | 172 | δ1(d) = −2.0 | {f, c, e} |
| 15 | 2047 | F₉K₅O₄U₂ | 0.183 | 320 | δ1(d) = −2.0 | {f, c, e} |
| 15 | 60091 | F₉K₅O₄U₂ | 2.021 | 320 | δ1(d) = −2.0 | {f, c, e} |
| 15 | 423945 | H₁₄Na₃Np₁O₁₂ | 1.242 | 208 | δ1(d) = −2.0 | {f, c, e} |
| 15 | 202650 | H₂F₄K₁Mn₁O₁ | 0.005 | 208 | δ1(d) = 2.0 | {f, c, e} |
| 15 | 63104 | H₂F₄K₁Mn₁O₁ | 0.012 | 208 | δ1(c) = 2.0 | {f, d, e} |
| 15 | 71838 | H₂F₄Mn₁O₁Rb₁ | 0.020 | 208 | δ1(c) = 2.0 | {f, d, e} |
| 15 | 165406 | H₄Ca₂O₁₃P₃V₁ | 0.063 | 212 | δ1(c) = 1.0 | {f, d, e} |
| 15 | 28219 | H₄F₄O₂Rb₁V₁ | 0.410 | 116 | δ1(c) = 1.0 | {f, d, e} |
| 15 | 91139 | H₈Ni₁O₁0V₂ | 0.014 | 176 | δ1(c) = 4.0 | {f, d} |
| 15 | 238682 | Hg₁In₁S₃Tl₁ | 1.550 | 144 | δ1(d) = 5.0 | {f, c, e} |
| 15 | 195303 | Hg₁O7P₂Pd₁ | 1.419 | 148 | δ1(d) = 5.0 | {a, c, f, e} |
| 15 | 420533 | Hg₁O7P₂Pd₁ | 1.413 | 148 | δ1(d) = 5.0 | {a, c, f, e} |
| 15 | 60099 | K₂Rb₂Re6S₁₃ | 1.332 | 312 | δ1(a) = 1.0 | {f, e} |
| 15 | 35463 | K₄Mo₈O₅₂P₁₂ | 0.008 | 228 | δ1(c) = −2.0 | {f, d, e} |
| 15 | 281062 | O₁₄Sr₃Te₄U₁ | 1.780 | 304 | δ1(d) = −2.0 | {f, c, e} |
| 57 | 411520 | As₂Cl₃Hg₃Tl₁ | 1.158 | 280 | δ1(b) = 1.0 | {a, c, d, e} |
| 57 | 411521 | Br₃Hg₃Sb₂Tl₁ | 0.999 | 280 | δ1(b) = 1.0 | {a, c, d, e} |
| 58 | 260478 | H₈Cs₄O₄P₂Se6 | 1.820 | 228 | δ1(c) = −1.0 | {a, h, b, g} |
| 58 | 260477 | H₈O₄P₂Rb₄Se6 | 1.629 | 228 | δ1(d) = −1.0 | {a, h, b, g} |
| 58 | 72103 | La₂O₈S₂Ta₃ | 0.776 | 388 | δ1(b) = −1.0 | {h, e, g} |
| 61 | 280667 | Cl₁N₂S₁Se₂ | 1.446 | 280 | δ1(b) = −1.0 | {c} |
| 61 | 412247 | Cr₂Li₄N6Sr₂ | 0.921 | 264 | δ1(a) = 1.0 | {c} |
| 61 | 23312 | H6F6N₂Si₁ | 6.775 | 248 | δ1(b) = 1.0 | {a, c} |
| 61 | 35702 | H6F6N₂Si₁ | 7.315 | 248 | δ1(b) = 1.0 | {a, c} |
| 62 | 28552 | H6F₁N₁O₂ | 3.682 | 120 | δ1(b) = 1.0 | {c, d} |
| 62 | 40979 | H6F₅N₂Sb₁ | 3.322 | 224 | δ1(b) = 1.0 | {c, d} |
| 63 | 427778 | As6Ba₄Cd₃Li₂ | 0.308 | 216 | δ1(b) = −1.0 | {f, c} |
| 63 | 427777 | Ba₄Cd₃Li₂P6 | 0.453 | 216 | δ1(b) = −1.0 | {f, c} |
| 64 | 241962 | C₄H₁₂Cl₈Nb₂Se₂ | 0.567 | 244 | δ1(a) = −1.0 | {f, g} |
| 64 | 260476 | H₈K₄O₄P₂Se6 | 2.003 | 228 | δ1(a) = −1.0 | {f, e, g} |
| 71 | 99953 | Ba₁O7Sr₁Ta₂ | 2.207 | 144 | δ1(d) = 2.0 | {c, l, j, b, i, g} |
| 71 | 410590 | Br₉Cs₅Nb₂S₄ | 1.692 | 158 | δ1(a) = −1.0, δ1(b) = 2.0 | {c, m, l, n, d, i} |
| 71 | 418796 | Br₉Nb₂S₄Tl₅ | 1.618 | 128 | δ1(b) = −1.0 | {c, m, l, n, j, d} |
| 71 | 291278 | Cl₈Cs₅I₁S₄U₂ | 0.066 | 160 | δ1(d) = 2.0 | {a, m, l, n, b, i} |
| 71 | 410591 | Cl₉Cs₅Nb₂S₄ | 1.588 | 158 | δ1(a) = −1.0, δ1(b) = 2.0 | {c, m, l, n, d, i} |
| 71 | 417942 | Cl₉Nb₂S₄Tl₅ | 1.532 | 128 | δ1(a) = −1.0, δ1(b) = 2.0 | {c, m, l, n, d, i} |
| 71 | 249327 | F₁K₁Nb₂O6Sr₁ | 1.932 | 176 | δ1(c) = 2.0 | {a, l, j, h, d, i} |
| 71 | 56744 | H₁La₂Li₁O₃ | 1.800 | 42 | δ1(c) = 2.0 | {a, d, b, i} |
| 71 | 95059 | La₁O₁₁Sr₂Ta₃ | 2.690 | 112 | δ1(c) = 2.0 | {a, l, j, b, d, i} |
| 74 | 171492 | C₄N₄Pt₁Rb₂ | 2.115 | 128 | δ1(b) = 2.0 | {c, a, e, f, h} |
| 74 | 9710 | Cs₁F₃Mo₁O₂ | 3.342 | 96 | δ1(a) = 2.0 | {c, e, i, h} |
| 74 | 245171 | H₄Al₁F₅O₂Zn₁ | 3.457 | 132 | δ1(b) = −5.0 | {a, j, e, d, i} |
| 74 | 97289 | K₁Na₂O₁₅Si6Y₁ | 5.053 | 272 | δ1(d) = 2.0 | {j, e, b, h, i, g} |
| 74 | 185292 | La₁Nb₂O7Rb₁ | 1.999 | 176 | δ1(c) = 2.0 | {a, h, e, g} |
| 74 | 72741 | Li₂O7P₂Pd₁ | 1.415 | 128 | δ1(a) = −4.0 | {c, j, e, h, g} |
| 74 | 195302 | O₁₄P₄Pd₃Tl₂ | 1.149 | 280 | δ1(c) = −4.0 | {a, j, e, h, d, i} |
| 82 | 4102 | C₄Cd₁Hg₁N₄S₄ | 1.960 | 84 | δ1(d) = −1.0 | {a, c, g} |
| 82 | 170700 | C₄Cd₁Hg₁N₄Se₄ | 2.464 | 84 | δ1(d) = −1.0 | {a, c, g} |
| 82 | 249203 | C₄Cd₁Hg₁N₄Se₄ | 2.425 | 84 | δ1(d) = −1.0 | {a, c, g} |
| 82 | 280039 | C₄Cd₁N₄S₄Zn₁ | 3.589 | 84 | δ1(c) = −1.0 | {a, d, g} |
| 82 | 88970 | C₄Cd₁N₄S₄Zn₁ | 3.589 | 84 | δ1(c) = −1.0 | {a, d, g} |
| 82 | 171416 | C₄Cd₁N₄Se₄Zn₁ | 3.178 | 84 | δ1(c) = −1.0 | {a, d, g} |
| 82 | 249202 | C₄Cd₁N₄Se₄Zn₁ | 3.115 | 84 | δ1(d) = −1.0 | {c, b, g} |
| 82 | 31359 | C₄Co₁Cs₁O₄ | 3.715 | 58 | δ1(d) = −1.0 | {a, c, g} |
| 82 | 31360 | C₄Co₁Cs₁O₄ | 3.620 | 58 | δ1(d) = −1.0 | {a, c, g} |
| 82 | 280028 | C₄Hg₁N₄S₄Zn₁ | 2.679 | 84 | δ1(c) = −1.0 | {d, b, g} |
| 82 | 188764 | C₄Hg₁N₄Se₄Zn₁ | 2.460 | 84 | δ1(d) = −1.0 | {a, c, g} |
| 85 | 24677 | Cl₁K₂Na₁O6S₂ | 5.077 | 296 | δ1(d) = 1.0 | {a, c, b, g} |
| 87 | 78029 | Ba₁O7Si₂V₁ | 0.098 | 130 | δ2(b) = −1.0 | {h, d, e, i} |
| 88 | 99956 | C₄H₈In₁K₁O₁₂ | 3.650 | 216 | δ1(d) = 1.0 | {a, f, b} |
| 88 | 261929 | C₄H₈K₁Lu₁O₁₂ | 3.445 | 260 | δ1(d) = 1.0 | {f, a, b} |
| 124 | 170216 | C₈K₁O₈Y₁ | 2.139 | 200 | δ1(e) = 1.0 | {a, c, n} |
| 128 | 24676 | Cl₂K₅Na₁O₁₂S₄ | 5.229 | 312 | δ1(c) = −1.0 | {a, e, b, h, i, g} |
| 139 | 412833 | Br₄Cs₂I₂Pd₁ | 0.677 | 70 | δ2(b) = −1.0 | {a, h, d, e} |
| 139 | 412835 | Br₄I₂Pd₁Rb₂ | 0.622 | 70 | δ2(b) = −1.0 | {a, h, d, e} |
| 139 | 412834 | Cl₄Cs₂I₂Pd₁ | 0.832 | 70 | δ2(b) = −1.0 | {a, h, d, e} |
| 140 | 409487 | Ba₄Bi₃K₁O₁ | 0.573 | 140 | δ1(d) = −1.0 | {c, a, l, b, h} |
| 140 | 410747 | Ba₁K₁O₁Sb₃ | 0.993 | 140 | δ1(d) = −1.0 | {c, a, l, b, h} |
| 140 | 415036 | Ba₄O₁Rb₁Sb₃ | 0.874 | 140 | δ1(d) = −1.0 | {c, a, l, b, h} |
| 141 | 251540 | As₂Cs₂O₈Th₁ | 3.808 | 176 | δ1(d) = 2.0 | {c, e, b, h} |
| 141 | 173150 | Ce₁K₂O₈P₂ | 1.417 | 176 | δ1(c) = 2.0 | {a, h, d, e} |
| 141 | 249887 | Cl₂Cs₂N₂O6Pb₁ | 2.275 | 164 | δ1(b) = 1.0 | {a, h, e} |
| 148 | 63544 | As₁K₁Ni₁O₄ | 0.112 | 96 | δ1(b) = 1.0, δ2(b) = 1.0 | {f, c} |
| 148 | 63353 | As₁Na₁Ni₁O₄ | 0.100 | 80 | δ1(b) = 1.0, δ2(b) = 1.0 | {f, c} |
| 148 | 27014 | As₂Ba₁Ni₂O₈ | 0.008 | 88 | δ1(b) = 1.0, δ2(b) = 1.0 | {a, c, f} |
| 148 | 280167 | Ba₁Ni₂O₈P₂ | 0.011 | 88 | δ2(a) = 1.0, δ1(e) = 1.0 | {f, c, b} |
| 148 | 249686 | C₄H₄Cd₁O6 | 2.767 | 204 | δ1(e) = −1.0 | {f, d} |
| 148 | 408324 | Ca₂Li6Mn₂N6 | 0.136 | 54 | δ1(a) = 1.0 | {f, c} |
| 163 | 236385 | Br₁₅Cs₂La₁O₃Ta6 | 1.011 | 364 | δ1(e) = 2.0 | {f, c, h, i} |
| 163 | 80424 | Br₁₅Cs₂La₁O₃Ta6 | 1.019 | 364 | δ1(e) = 2.0 | {f, c, h, i} |
| 163 | 65661 | Cl₁₈Cs₁Lu₁Nb6 | 0.922 | 476 | δ1(e) = 4.0 | {c, d, i} |
| 164 | 109713 | C₈H₂₄Cl₁₈N₂Nb6 | 0.484 | 270 | δ2(a) = −1.0, δ1(c) = 1.0 | {d, j, i, g} |
| 166 | 416475 | Ce₁O₁P₁Zn₁ | 0.006 | 70 | δ2(a) = −1.0 | {c} |
| 166 | 414584 | H₁₂B₁₂Br₁Cs₃ | 5.017 | 82 | δ2(a) = 1.0 | {h, b, e} |
| 166 | 414581 | H₁₂B₁₂Br₁K₃ | 4.797 | 82 | δ2(a) = 1.0 | {h, b, e} |
| 166 | 414583 | H₁₂B₁₂Br₁Rb₃ | 5.273 | 82 | δ2(a) = 1.0 | {h, b, e} |
| 166 | 414586 | H₁₂B₁₂Cl₁Cs₃ | 5.374 | 82 | δ2(a) = 1.0 | {h, b, e} |
| 166 | 414585 | H₁₂B₁₂Cl₁Rb₃ | 5.436 | 82 | δ2(a) = 1.0 | {h, b, e} |
| 166 | 98622 | H₁₂B₁₂Cs₃I₁ | 4.630 | 82 | δ2(a) = 1.0 | {h, b, e} |
| 166 | 98619 | H₁₂B₁₂I₁K₃ | 4.959 | 82 | δ2(a) = 1.0 | {h, b, e} |
| 166 | 98620 | H₁₂B₁₂I₁Rb₃ | 4.544 | 82 | δ2(a) = 1.0 | {h, b, e} |
| 194 | 97530 | As₂Ba6Na₂O₁7Ru₂ | 0.058 | 380 | δ1(d) = 2.0 | {a, e, b, k, f, h} |
| 194 | 245668 | Ba₅Br₂O₉Ru₂ | 0.006 | 268 | δ1(b) = 2.0 | {e, k, f, h, d} |
| 194 | 97524 | Ba6Na₂O₁7Ru₂V₂ | 0.074 | 380 | δ1(d) = 2.0 | {a, e, b, k, f, h} |
| 194 | 97526 | Ba6Na₂O₁7Ru₂V₂ | 0.136 | 380 | δ1(d) = 2.0 | {a, e, b, k, f, h} |
| 203 | 20169 | C₄Fe₂Na6O₁6S₁ | 0.616 | 280 | δ1(d) = −1.0, δ2(d) = −2.0 | {c, b, e, f, g} |
| 215 | 62225 | Cs₃Mo₄O₁6P₃ | 0.092 | 162 | δ1(b) = 1.0 | {c, d, e, i} |
| 217 | 52575 | Ag₃Ge₃P6Sn₂ | 0.061 | 166 | δ1(a) = 1.0 | {c, d, e, g} |
| 217 | 52595 | Ag₃P6Si₃Sn₂ | 0.159 | 166 | δ1(a) = 1.0 | {c, d, e, g} |
| 227 | 168524 | C₄Cd₁K₂N₄ | 6.317 | 132 | δ1(b) = −1.0, δ1(c) = 1.0, | {a, d, e} |
| | | | | | δ2(c) = 1.0 | |
| 227 | 23994 | C₄Cd₁K₂N₄ | 4.678 | 132 | δ1(b) = −1.0, δ1(c) = 1.0, | {a, d, e} |
| | | | | | δ2(c) = 1.0 | |
| 227 | 23995 | C₄Hg₁K₂N₄ | 4.597 | 132 | δ1(b) = −1.0, δ1(c) = 1.0, | {a, d, e} |
| | | | | | δ2(c) = 1.0 | |
| 227 | 62084 | C₄Hg₁K₂N₄ | 5.920 | 132 | δ1(b) = −1.0, δ1(c) = 1.0, | {a, d, e} |
| | | | | | δ2(c) = 1.0 | |
| 227 | 14368 | C₄K₂N₄Zn₁ | 6.135 | 132 | δ1(b) = −1.0, δ1(c) = 1.0, | {a, d, e} |
| | | | | | δ2(c) = 1.0 | |
| 227 | 23993 | C₄K₂N₄Zn₁ | 4.963 | 132 | δ1(b) = −1.0, δ1(c) = 1.0, | {a, d, e} |
| | | | | | δ2(c) = 1.0 | |

1. A method for making a catalyst with at least one metallic surface state, comprising:
a) identifying all topological insulators in an Inorganic Crystal Structure Database (“ICSD”),
b) calculating Real Space Invariants of valence bands for all these topological insulators
c) identifying in all these topological insulators Wyckoff Positions where irreducible Wannier Charge Centers (WCCs) are localized, and then
d) selecting as potentially catalytic active compound a topological insulator wherein the Wyckoff Position of WCCs is not occupied by any atom (=Wyckoff Position of obstructed WCCs, =WP_{OAI}) of the topological insulator,
e) synthesizing a crystal of the selected potentially catalytic active compound either so that the crystal is grown in a predefined crystallographic direction (characterized by its Miller indices (h,k,l)) which exposes at least one metallic surface state; or cutting the crystal in a predefined crystallographic direction (characterized by its Miller indices (h,k,l)), so that the at least one metallic surface state is exposed,
wherein the predefined crystallographic direction is the direction of a normal vector (h,k,l) of a surface plane f(x, y, z)=0 which cuts through the Wyckoff Position of obstructed WCCs (WP_{OAI}), but stays away from the Wyckoff Position(s) of atoms of the selected topological insulator (=occupied Wyckoff Position(s), =WP_{OCC}), which condition is fulfilled when:
$$\{ \begin{matrix}( h , k , l ) \cdot ( x - {X}_{j} , y - {Y}_{j} , - {Z}_{j} ) = 0 , \\ ( h , k , l ) \cdot ( x - {x}_{i} , y - {y}_{i} , z - {z}_{i} ) \neq 0 , \\ h , k , l ϵ Z\end{matrix}$$
with the obstructed WCCs localized at
WP_{OAI}={Xⱼ,Yⱼ,Zⱼ|RSIⱼ≠0,j∉occupied positions} and
atoms of the selected potentially catalytic active compound occupying
WP_{occ}={xᵢ,yᵢ,zᵢ|i∈occupied positions}.

2. The method of claim 1, wherein the topological insulator is a topological trivial insulator.

3. The method of claim 1, wherein instead of steps a) through d) the potentially catalytic active compound is selected from the list consisting of:
Ba₁P₈, I₄P₂, Mn₁P₄, Nb₂Se₉, Os₁P₄, P₃Ru₁, P₄Ru₁, P₅Re₂, Re₁S₂, Re₁Se₂, S₂Tc₁, Lu₁P₅, P₅Y₁, As₁Ge₁, As₁Si₁, Ba₁P₃, Bi₁S₂, Bi₁Se₂, Br₄Nb₁, Br₆Si₂, C₂₂F₁₄, C₂Ca₁, Ca₅P₈, Cl₃Mo₁, Cl₃Y₂, Cl₄Nb₁, Cl₄Ta₁, Cs₅Te₃, Ga₁Te₁, Ge₁P₁, Hg₁O₂, In₁Se₁, K₁Sb₂, Na₁P₂, O₂Rb₂, P₃Sr₁, Rb₁Sb₂, Ag₁P₂, As₂Co₁, As₂Ir₁, As₂La₁, As₂Rh₁, Au₁O₁, B₂F₄, B₄Mn₁, Ca₁O₂, Cd₁P₄, Co₁P₂, Cs₁Te₄, Cs₂I₈, Cu₁P₂, Fe₁P₄, Fe₁S₁, Ga₂I₃, Hg₂N₆, Ir₁N₂, Ir₁P₂, Ir₁Sb₂, La₁P₇, La₁S₂, La₁Se₂, Li₂O₂, Mg₁P₄, N₂O₄, N₂S₂, O₂Tc₁, P₂Rh₁, P₇Pb₁, Rh₁Sb₂, Rh₁Si₁, Sb₁Zn₁, Ba₁S₂, Ba₁Se₂, C₂Ba₁, C₂Sr₁, I₆Pt₂, Ni₁P₂, O₂Si₁, P₂Pd₁, S₂Yb₁, S₄V₁, Se₃Tl₂, Se₉V₂, Te₃Tl₂, As₃Ca₄, Cs₂Te₂, K₂O₂, Rb₂Te₂, As₂Fe₁, As₂Os₁, As₂Ru₁, C₁N₁, Fe₁P₂, Fe₁S₂, Fe₁Sb₂, Fe₁Se₂, In₁S₁, N₂Pt₁, Os₁P₂, Os₁Sb₂, P₂Ru₁, Ru₁Sb₂, Ru₁Te₂, Ge₃Os₂, Ge₃Ru₂, Os₂Si₃, Ru₂Si₃, As₁Cd₁, As₁Zn₁, B₂Cl₄, C₂N₂, Cd₁Sb₁, Cl₁O₂, P₄Re₁, P₄Tc₁, Pd₁S₂, B₂Fe₁, Na₁P₅, P₃Re₁, P₃Tc₁, Ba₅P₄, Ba₅Sb₄, K₁Tl₁, Ba₁O₂, F₃La₁, As₆Cs₄, As₆Rb₄, Cs₄P₆, K₄P₆, P₆Rb₄, Al₂Ru₁, Ga₂Os₁, Ga₂Ru₁, C₂Li₂, C₂Na₂, Cs₂O₂, Cs₂S₂, Rb₂S₂, B₃Si₁, H₆Ru₁, O₆₄Si₃₂, K₅Te₃, B₁₀F₁₂, Li₁Si₁, C₁N₂, Cs₁In₃, Ga₃K₁, Ga₃Rb₁, H₈Si₁, C₂Mg₁, Fe₁Ga₃, Ga₃Os₁, Ga₃Ru₁, In₃Ru₁, Li₂S₂, B₄Os₁, Cl₂Zn₁, Hg₁I₂, Hg₂I₄, Al₂Os₁, As₁Ca₂, Bi₁Ca₂, Br₁Hg₁, Br₂Hg₂, Cl₂Hg₂, F₂Hg₂, Ga₃K₂, Hg₁I₁, Hg₂I₂, In₃Rb₂, O₂Sr₁, Ba₁Te₂, O₂Zn₁, S₂Sr₁, Au₁Br₁, Au₁Cl₁, O₃U₁, Br₁₂Zr₆, Cl₁₂Zr₆, I₁₂Zr₆, I₆Si₂, As₁B₆, As₂Bi₂, B₁₂P₂, B₁₂Si₃, B₆O₁, B₆P₁, Br₈Nb₃, C₁B₄, C₃B₁₂, Ga₁S₁, I₈Nb₃, Cr₁N₂, Ga₁Se₁, Mo₁N₂, N₂W₁, Ca₁P₁, Ca₂P₂, K₂S₂, K₂Se₂, Na₂O₂, Na₂S₂, P₁Sr₁, C₂Os₁, Hf₁N₂, K₂Te₂, Mo₁S₂, Mo₁Se₂, Mo₁Te₂, Na₁S₁, Na₂Se₂, S₂W₁, Se₂W₁, Te₂W₁, As₂Pt₁, Cd₁O₂, Cd₁S₂, Cd₁Se₂, Fe₁Te₂, Mg₁O₂, Mg₁Se₂, Mg₁Te₂, N₂Pd₁, Os₁S₂, Os₁Se₂, Os₁Te₂, P₂Pt₁, Ru₁S₂, Ru₁Se₂, S₂Zn₁, Se₂Zn₁, Ag₁Br₁, Ag₁Cl₁, Ag₁I₁, B₄Fe₁, Be₅Pt₁, Br₁Cu₁, Cd₁S₁, Cd₁Se₁, Cd₁Te₁, Cl₁Cu₁, Cu₁I₁, Cu₅Tb₁, O₁Zn₁, S₁Sn₁, S₁Zn₁, Se₁Zn₁, Te₁Zn₁, B₆Ca₁, B₆Si₁, B₆Sr₁ and B₁Li₁, Al₂Cd₂Cl₈, Al₄Cl₁₄Te₄, As₁Fe₁S₁, Au₁Br₈Te₁, B₁₈Cs₈S₁₈, B₁₈Rb₈S₁₈, B₁₈Rb₈Se₁₈, B₈Br₆P₄, Bi₂Br₈Te₄, Bi₄Cl₁₆Te₁₄, Bi₆Cl₂₀Te₄, Br₁₂Ta₂Te₄, Br₁Mo₁Te₄, Br₂Nb₁S₂, Br₂Nb₁Se₂, C₂₂Co₆O₁₈, C₂I₁₀La₆, C₂O₄Pb₁, Cl₁₂Ta₂Te₄, Cl₁₈P₂Re₂, Cl₂Nb₁Se₂, Cl₅O₄Re₂, Cl₆Hf₁Te₄, Cl₈Ga₂Hg₂, Cs₁Sb₂Se₄, Cs₂S₆Sn₂, Cs₂S₈Sb₄, Cs₂Se₆Sn₂, Cs₄P₂Se₁₀, Cu₄P₃Se₄, F₁₂I₄Sb₂, F₁₂Sb₂Te₄, Ge₁Li₁Te₂, Ge₂Te₆Tl₆, Hg₁O₃V₁, Hg₂P₂S₆, I₁₂Nb₂Te₈, I₁Ta₁Te₄, In₂O₅P₁, K₂O₈S₂, K₂Sb₄Se₈, La₆O₁₈Re₄, Li₁Mo₁S₂, Mo₄N₁₄Sr₁₀, Na₂O₈S₂, Rb₂Sb₄Se₈, Si₂Te₆Tl₆, As₂Ga₂Sr₁, C₂Ca₁O₄, Al₂Na₇Sb₅, Ba₃P₆Si₄, Bi₉I₃Rh₂, Cl₇Nb₃Se₅, Ir₂Se₅Sn₁, K₄P₈Te₄, Al₁O₄W₁, As₁Cl₂Hg₂, As₂F₁₂I₄, As₃Ba₂Cd₂, As₃Sr₂Zn₂, Ba₅Cr₁N₅, Bi₄Br₂Ru₁, Br₁₀Te₄Zr₂, C₁B₂O₂, C₁N₁Th₁, C₂Br₂Gd₂, C₂La₂O₂, C₄Cs₂O₄, C₄Li₂O₄, C₄O₄Rb₂, Cd₁P₁S₃, Cd₂P₂S₆, Cd₆Sb₁₂Sr₁₁, Cl₂Hg₂P₁, Cl₂Nb₁S₂, Fe₁P₁S₃, Fe₂P₂S₆, Ge₁K₃S₃, Ge₂K₆S₆, Ge₂K₆Se₆, Hg₆O₇Si₂, I₂O₁Ta₁, K₆Si₂Te₆, Mg₁P₁S₃, Na₄P₂S₆, Ni₁P₁S₃, Ni₁P₁Se₃, Ni₂P₂S₆, P₁S₃Zn₁, P₂S₆V₂, P₂S₆Zn₂, P₆S₁₈Zn₄, Hg₂Mo₂O₇, Hg₂O₄S₁, Hg₂O₄Se₁, Hg₄O₇P₂, K₂Mo₈O₁₆, Ag₅Ge₁O₄, As₁Cd₂Cl₂, As₁Fe₁Se₁, As₁Fe₁Te₁, As₁Ru₁Te₁, As₂Cs₄Te₆, As₂F₁₂Hg₄, As₂Hg₆O₁₀, As₂Hg₆O₈, Ba₁P₃Pt₂, Ba₂P₂S₆, Ba₂P₂Se₆, Ba₆P₆Sn₂, Bi₁Os₁Se₁, Br₁₄Ga₄Te₄, Br₃Hg₂Te₁, C₁D₁K₁O₃, C₂Ag₂O₄, C₂Cd₁O₄, C₂H₆O₆, C₂Li₂O₄, C₂Na₂O₄, C₂O₄Tl₂, C₂O₄Zn₁, C₄Na₂O₄, Ca₁Mo₅O₈, Ca₂P₂S₆, Ca₂P₂Se₆, Cd₂Cl₂P₁, Cl₁₄Ga₄Te₄, Cl₃Cu₁K₁, Cl₃Mo₁S₂, Cl₇O₃Re₂, Co₁K₂O₂, Cs₁O₅V₂, Cs₂O₈S₂, Cs₂Se₆Te₂, Cu₁La₂S₄, Fe₁P₁S₁, Fe₁P₁Se₁, Fe₁S₁Sb₁, Fe₁Sb₁Se₁, Fe₁Sb₁Te₁, Ge₂Na₆Se₆, Ge₂Na₆Te₆, H₄B₂O₄, Hg₁O₄Re₁, Hg₂N₂O₄, Hg₄N₂O₈, Hg₆O₈P₂, I₁Nb₂Te₆, In₄P₆S₁₈, K₄O₈P₂, K₆Se₆Sn₂, K₆Sn₂Te₆, Mo₅O₈Sr₁, Na₆Si₂Te₆, Os₁P₁S₁, Os₁P₁Se₁, Os₁S₁Sb₁, Os₁Sb₁Se₁, Os₁Sb₁Te₁, P₁Pb₁Se₃, P₁Ru₁S₁, P₁Ru₁Se₁, P₁Se₃Sn₁, P₂Pb₂S₆, P₂Pb₂Se₆, P₂S₆Sn₂, P₂S₆Sr₂, P₂Se₆Sn₂, P₂Se₆Sr₂, P₂Se₆Tl₄, Ru₁S₁Sb₁, Ru₁Sb₁Se₁, Ru₁Sb₁Te₁, Ag₂O₂Pb₁, As₁F₆I₅, As₃Br₁Cd₂, As₃Br₁Hg₂, As₃Cd₂I₁, As₆Ba₁Pt₄, As₆Pt₄Sr₁, Au₁C₁₁O₂, Au₁Cl₄Cs₁, Au₁Cl₄Rb₁, Au₁Cl₄Tl₁, Au₁F₄Li₁, Au₁Li₁S₁, B₂Li₂Se₅, Bi₃Cl₁O₄, Br₁Cd₂P₃, Br₂Hg₂O₆, C₂O₄Sn₁, C₄Ag₂O₄, Cd₂Cl₁P₃, Cd₂I₁P₃, Cd₂O₁₂P₄, Cl₁Hg₂O₁, Cl₁Hg₂P₃, Cl₂Hg₄O₂, Cl₄Os₁Sc₄, Cs₁F₇Sb₂, Cs₂Re₃Se₆, Cs₄Re₆S₁₃, Cs₄Re₆Se₁₃, Cs₄S₁₃Tc₆, Cs₄Se₁₃Tc₆, Cs₆Ge₂Se₆, Cs₆Ge₂Te₆, Cs₆Sn₂Te₆, Cu₂O₂Pb₁, Cu₂Re₃Se₆, Fe₂O₁₂P₄, Ge₂K₆Te₆, Hg₂P₂Se₆, K₂Re₃S₆, K₂Re₃Se₆, K₄Re₆Se₁₂, K₄Si₂Tc₆, K₄Se₁₂Tc₆, Mn₂Mo₁P₁₂, Na₂Nb₄O₁₁, Na₂Re₃S₆, Na₂Re₃Se₆, O₃Si₁Sr₁, O₄Pd₁S₁, O₄Pt₁S₁, O₇P₂Pd₂, P₆Pt₄Sr₁, Rb₂Re₃S₆, Rb₂Re₃Se₆, Rb₄Re₆Si₂, Rb₄Re₆S₁₃, Rb₄Re₆Se₁₂, Rb₄S₁₃Tc₆, Rb₄Se₁₂Tc₆, Re₃S₆Tl₂, Re₃Se₆Tl₂, Re₆Se₁₂Tl₄, Br₁₁Cs₁Nb₄, Br₁₁Nb₄Rb₁, Cl₁₁Cs₁Nb₄, Cl₁₁Nb₄Rb₁, Al₂Ca₅Sb₆, Al₂Cl₈Se₄, As₆Ca₅Ga₂, Ba₁Nb₈O₁₄, Ba₃O₁Sb₂, Ba₅In₂Sb₆, C₂K₂O₄, C₂O₄Rb₂, Ca₅In₂Sb₆, In₂Sb₆Sr₅, Nb₈O₁₄Sr₁, Ag₅O₄Si₁, Br₁Hg₂P₃, Nb₂Ni₁O₆, O₉P₂V₂, Al₂Cl₈Te₄, Au₁O₄S₁, Cl₂N₄S₆, Co₁Ge₁Te₁, Cu₁O₃Se₁, Cu₁P₂Se₁, Ge₁Rh₁Te₁, O₆P₂Tl₄, Pt₁Sb₁Si₁, Al₁K₁Sb₄, Al₁P₃Si₁, As₁La₁Te₁, As₂Hg₄O₇, Ba₁P₄Te₂, Cs₂Ge₁Te₄, Cs₂Sn₁Te₄, Ga₁K₁Sb₄, H₂B₁Li₁, La₁Mn₁S₃, La₁P₁S₁, P₁S₁Y₁, P₂Ru₂Th₁, I₁K₄P₂₁, I₁P₂₁Rb₄, B₁₂Li₂Si₂, B₂Ba₁Se₆, In₉K₁Na₃, La₂O₂S₂, Na₄P₂Se₆, Nb₁P₂S₈, F₆Pa₁Rb₁, Au₁Na₁S₁, Cs₂Ni₃S₄, Cs₂Ni₃Se₄, Cs₂Pd₃Se₄, Cs₂Pt₃S₄, Cs₂Pt₃Se₄, Li₂O₄U₁, Na₂O₄U₁, Ni₃Rb₂S₄, Pt₃Rb₂S₄, Au₁Cs₁F₄, Au₅Cs₇O₂, Au₅O₂Rb₇, Br₃Cs₁Li₂, Cl₂I₂Ta₁, Cl₃Cs₁Li₂, Hf₂N₂S₁, Li₂Ni₁O₂, Na₂O₃Ti₁, Na₂O₄Pd₃, O₃Pd₁Sr₂, Al₁B₁₄Li₁, Ba₁Ce₁O₃, C₂B₁₃Li₁, Cu₁₁K₃Te₁₆, O₄P₁Rh₁, O₄Si₁Zn₂, P₂S₆Th₁, P₂S₆Zr₁, Ba₉Br₃₄O₁Pr₆, Bi₄I₂Ru₁, La₄O₁₀Re₂, Br₂Cs₁F₁, C₂Ag₁K₁, C₂Au₁Cs₁, C₂Au₁K₁, C₂Au₁Na₁, C₂Au₁Rb₁, C₂Cu₁Rb₁, C₂Ag₁Cs₁, C₂Cu₁K₁, Cl₃O₁W₁, I₃O₁W₁, Li₆O₄Zn₁, Cl₆Hf₁Se₄, Cl₆Se₄Zr₁, Br₂Cs₂F₂, Cs₂I₆Pd₁, C₄Ba₁O₄, Ag₃Cu₁S₂, Ba₁Cu₂O₂, Ba₁O₇U₂, C₄O₄Pb₁, Cd₁In₂O₄, Cl₂O₁Pd₂, Cu₂O₂Sr₁, Al₁Si₁Te₃, B₁₂Br₁₂Cs₂, B₁₂Cl₁₂Cs₂, B₁₂Cs₂I₁₂, Cd₂P₂Se₆, Cs₈O₁Tl₈, Fe₁P₁Se₃, Fe₂P₂Se₆, Mg₂P₂Se₆, Nb₆O₁₂Ti₂, As₂Hg₂O₆, Ca₁O₆Os₂, O₆Ru₂Sr₁, C₂Cs₂Pd₁, C₂Cs₂Pt₁, C₂K₂Pd₁, C₂K₂Pt₁, C₂Na₂Pd₁, C₂Na₂Pt₁, C₂Pd₁Rb₂, C₂Pt₁Rb₂, H₂B₂Ca₁, Mg₃Nb₆O₁₁, O₂Pr₂S₁, O₂Pr₂Se₁, B₉Mg₁N₁, Cs₄O₁Tl₂, F₁Gd₁O₁, H₈F₄N₂, Br₉Os₂Rb₃, C₉Fe₂O₉, Mo₁S₁Se₁, Ag₂I₁₀Tl₆, Ba₅O₁₀Ru₂, Ca₁Ga₂P₂, Ca₁In₂P₂, Cl₉Cs₃Ru₂, Cl₉Cs₃Ti₂, Cs₃F₉Fe₂, Cs₃I₉Zr₂, In₂P₂Sr₁, K₁Nb₁S₂, K₁Nb₁Se₂, Li₁Nb₁O₂, Li₁Nb₁S₂, Na₁Nb₁O₂, Na₁Nb₁S₂, Na₁Nb₁Se₂, H₁₂B₁₂Cs₂, H₁₂B₁₂K₂, H₁₂B₁₂Rb₂, H₁₂B₁₂Tl₂, H₂₀B₁₂N₂, As₁Rb₃Se₁₆, K₃P₁Se₁₆, H₆Cl₂N₂, F₆O₂Pt₁, Ag₁Cu₄Tb₁, Au₁Sc₁Sn₁, Bi₁Co₁Zr₁, Bi₁Lu₁Ni₁, Bi₁Ni₁Sc₁, Bi₁Ni₁Y₁, Co₁Sb₁Ti₁, Cu₁Rb₁Te₁, Fe₁Nb₁Sb₁, Fe₁Sb₁V₁, Ge₁Pt₁Ti₁, Hf₁Ni₁Sn₁, Hf₁Pd₁Sn₁, Lu₁Ni₁Sb₁, Nb₁Ru₁Sb₁, Ni₁Sb₁Sc₁, Ni₁Sb₁Y₁, Ni₁Sn₁Ti₁, Ni₁Sn₁Zr₁, O₄S₁Zn₁, Pd₁Sb₁Sc₁, Pt₁Sb₁Sc₁, Pt₁Sb₁Y₁, Pt₁Sn₁Ti₁, Rh₁Sb₁Th₁, Ru₁Sb₁Ta₁, Ru₁Sb₁V₁, Ag₆Ge₁₀P₁₂, Nb₃Sb₂Te₅, In₃O₈P₂, Fe₂Ge₁Ti₁, H₆B₆Cs₂, H₆B₆K₂, Ag₂Mo₁O₄, Ag₆K₂S₄, Al₁Cs₁O₂, Al₁K₁O₂, Al₁O₂Rb₁, Al₂Cd₁O₄, Al₂Cd₁S₄, Al₂Cd₁Se₄, Al₂Hg₁S₄, Al₂Hg₁Se₄, Al₂O₄Zn₁, Al₂S₄Zn₁, Al₂Se₄Zn₁, As₄He₂O₆, Ba₂Ge₄S₁₀, Cd₁Ga₂O₄, Cd₁In₂S₄, Cd₁In₂Se₄, Cd₁Lu₂S₄, Cd₁Lu₂Se₄, Cd₁O₄Rh₂, Cd₁S₄Sc₂, Cd₁S₄Y₂, Cd₁Sc₂Se₄, Cd₁Se₄Y₂, Cd₂O₄Si₁, Cd₂O₄Sn₁, Cl₄Li₂Zn₁, Cs₁N₂Nb₁, Ga₂O₄Zn₁, Hg₁In₂S₄, In₂O₄Zn₁, In₂S₄Zn₁, K₈Sb₄Sn₁, Lu₂Mg₁S₄, Lu₂Mg₁Se₄, Mg₁O₄Rh₂, Mg₁Se₄Y₂, O₄Rh₂Zn₁, O₄Sn₁Zn₂, S₄Sc₂Zn₁, S₄Y₂Zn₁, Se₄Y₂Zn₁,
Ag₁Bi₁P₂S₆, As₁Cl₃F₆S₃, As₂Cd₁Ge₁K₁, As₂Cd₁Ge₁Rb₁, Bi₈Cs₄Hg₂Se₁₈, B₁₈Hg₂Rb₄Se₁₈, B₃Cu₁Li₃O₇, Br₁₀O₁Ta₂Te₄, C₁₀H₁₈Cu₂N₂O₁₀, C₁₀H₁₈N₂O₁₀Rh₂, C₁F₃Hg₁O₃S₁, C₁H₅Eu₁O₇P₁, C₁H₅Nd₁O₇P₁, C₁H₅O₇P₁Pr₁, C₂H₁₀Ga₂Ge₄N₂O₁₂, C₂H₂₆B₁₂N₈, C₂H₆Ca₁O₇, C₂H₆K₂O₁₃S₁U₁, C₂H₆O₁₂U₂, C₂H₈Br₃Cu₁N₁O₁, C₂H₈In₂O₁₄Se₂, C₃H₇F₁N₁O₅Sn₁, C₄H₁₁N₁O₁₀, C₄H₁₂Ba₂N₂O₁₀S₂, C₄H₁₂Fe₁O₆S₄, C₄H₁₂N₆O₁₄Se₂U₂, C₄H₁₄F₃N₁O₂V₁, C₄H₁₆Cl₆Cu₂N₂, C₄H₇Cs₁O₁₀, C₄H₇K₁O₁₀, C₅H₁₀N₁O₆, C₆F₆Na₄O₁₂Sn₄, C₆H₁₂Fe₁N₈O₈, C₆H₄Na₄Np₂O₁₈, C₈H₂₀N₆O₁₈S₂U₂, C₈H₂₈F₆N₂O₄V₂, C₈H₄K₆N₈O₆Os₂S₂, C₈O₂Mo₂O₈, Cl₁₀Mo₂N₄S₄, Cl₁₀Nb₂O₁Te₄, Cl₂N₄O₁₂S₁₀, Cs₂P₂Se₆Zn₁, Cu₁O₉Se₃Sr₂, Cu₂Na₂O₁₁Si₄, F₂N₂O₄Xe₁, F₂O₇Te₂V₂, H₁₀F₈In₂N₂O₂, H₁₂I₈Mg₁O₆, H₁₂Mg₁O₁₂S₂, H₁₂O₁₂S₂Zn₁, H₁₄Hg₂O₁₄Te₂, H₁₄N₄O₈S₂, H₁₆B₁₂Na₂O₁₄S₆, H₁₈O₂Se₄Sn₁Sr₂, H₂₄Li₂N₈Te₂, H₂₆B₂₀K₄O₄, H₃₂N₁₄Se₆Sn₂, H₃₄Cl₄Cr₂N₈O₆, H₄Cu₂Na₂O₁₃Si₄, H₆B₂F₈N₂, H₆Cs₂O₁₂P₄, H₆F₂₂N₂Sb₄, H₆O₁₂P₄Rb₂, H₈Na₆O₁₄P₄, K₄Mn₁Mo₃O₁₂, K₄N₂O₁₄S₄, Lu₁Na₁P₂S₆, Na₁P₂S₆Tb₁, Na₁P₂S₆Y₁, P₂Rb₂Se₆Zn₁, C₄H₃Cs₁O₁₄U₂, C₄H₅K₁O₁₅U₂, C₄H₅O₁₅Rb₁U₂, Cs₂Cu₂O₁₉S₁₈, Cu₂Ge₄O₁₃Sc₂, K₃P₅Ru₁Se₁₀, Ag₂Br₆Hg₇P₈, Ag₂Hg₇I₆P₈, Au₂K₂P₂Se₆, Au₂La₄O₂P₄, Au₂P₂Se₆Tl₂, C₂Cl₂O₄Pb₂, C₂H₂Ag₁O₉S₁Tb₁, C₂H₄Ca₂Cl₂O₆, C₂H₆N₂Rb₂, C₄H₆B₁₂Cs₂I₁₂N₂, C₄H₈N₂O₄, H₂₀B₁₂Li₂O₄, In₁K₂P₂S₇, La₂P₄S₁₄Tl₄, C₈H₁₂Ag₂N₄O₄, Ag₁As₁K₁S₂, Ag₁Cu₁O₄P₁, Ag₂Cs₂P₂Se₆, Ag₂O₈P₂V₁, Ag₂P₂Se₆Tl₂, Al₁As₁Cu₁O₅, Al₁Cu₁O₈P₂Rb₁, Al₂Br₆N₂S₂, Al₂Br₆N₂Se₂, As₁F₆N₂S₃, Ba₁La₁Sb₂Se₆, Ba₁Mo₂O₁₆P₄, C₁₀F₄Mn₂O₈, Cl₂Bi₂O₁₂Ru₄, C₁O₆P₁Sn₂, C₂As₂F₁₂N₂Te₄, C₂Cl₁₀N₂Sb₂, C₂Cu₁O₆Tl₂, C₂F₆N₄O₆S₄Se₄, C₂F₆N₄O₆S₈, C₂H₁Cs₁O₄, C₂H₂Na₂O₆, C₂H₄Cs₂O₆, C₂H₄F₆O₆S₂Si₂, C₂H₄Fe₄O₁₄P₂, C₂H₄O₁₄P₂Zn₄, C₂H₆K₂N₂, C₂H₆K₄N₈O₁₀, C₃H₂Na₁O₇Zn₁, C₃H₃Ba₁O₇, C₄H₁₂Cl₈Nb₂S₂, C₄H₁₈B₂P₂, C₄H₂Fe₂O₆, C₄H₂O₈Tl₂, C₆H₁₀O₆Sn₁, C₆H₄Mg₂Na₂O₁₄, C₆O₁₆Rb₂U₂, Cd₁Mo₁O₆P₁, Cd₁P₂Rb₂Se₆, Cl₁₂Mo₂O₄P₂, Cs₂O₁₂P₂U₂, Cs₄O₂S₁₀V₂, Cu₁P₁Se₃Tl₁, Cu₂P₂S₆Tl₂, Cu₂P₂Se₆Tl₂, F₂N₄O₆S₈, Fe₁I₁N₂O₂, Fe₁K₂P₂S₆, Fe₁K₂P₂Se₆, Fe₂K₁O₈P₂, H₁₀Br₂N₂O₂, H₁₀N₂O₈P₂, H₁₂N₄O₄P₂, H₁₂O₆P₂Rb₄S₆, H₁₄Ni₁O₁₂P₂, H₂Hg₆N₄O₁₄, H₂O₆P₂Tl₂, H₃K₁O₆P₂, H₅O₇P₁V₁, H₆Cs₂N₂P₄, H₈K₄O₄P₂S₆, H₈Li₄O₁₂P₂, Hg₁K₂P₂Se₆, K₂Mg₁P₂Se₆, K₂P₂Se₆Zn₁, Li₂O₈P₂V₁, Mo₂O₁₆P₄Sr₁, Na₂O₈P₂V₁, Ni₁O₁₀P₂V₂, Ag₃P₄Si₂Tl₅, Ba₁In₂O₁₄P₄, Ba₁La₂O₁₄Te₅, Ba₁O₈P₂Th₁, Ba₂Gd₂O₁₃Si₄, Bi₂Cl₈Hg₃Te₂, C₁Ag₂Cl₁N₁O₄S₁, C₂Ag₁N₂Na₁, C₂F₆Na₂O₄Sb₂, C₂H₂Cs₂O₅, C₂H₂K₂O₅, C₂H₂K₂O₆, C₂H₂O₅Rb₂, C₂H₄B₂O₂, C₂H₆Fe₁N₂O₄, C₂H₈Cl₃Cu₁N₁, C₂H₈I₂N₄S₂, C₂N₂O₆S₂, C₄H₁₂Mg₁O₆S₄, C₄H₁₆F₄Mn₁N₁O₂, C₄H₄O₁₀Th₁, C₄H₆Ba₁O₁₀, C₄H₆Cd₁O₂S₄, C₄H₆Na₂O₇, C₄H₆O₇Sr₁, C₄H₈Cd₁Cl₂N₂, C₄H₈O₁₂Th₁, C₄H₈O₈Zn₁, C₆H₆Ag₃Co₁N₈, Cd₃Na₂O₁₀Si₃, Cl₃Na₂O₁₂Te₄Y₃, Cu₁Mo₂O₈Sb₁, Eu₁O₈Rb₁S₂, F₉K₅O₄U₂, H₁₄Na₃Np₁O₁₂, H₂F₄K₁Mn₁O₁, H₂F₄Mn₁O₁Rb₁, H₄Ca₂O₁₃P₃V₁, H₄F₄O₂Rb₁V₁, H₈Ni₁O₁₀V₂, Hg₁In₁S₃Tl₁, Hg₁O₇P₂Pd₁, K₂Rb₂Re₆S₁₃, K₄Mo₈O₅₂P₁₂, O₁₄Sr₃Te₄U₁, As₂Cl₃Hg₃Tl₁, Br₃Hg₃Sb₂Tl₁, H₈Cs₄O₄P₂Se₆, H₈O₄P₂Rb₄Se₆, La₂O₈S₂Ta₃, Cl₁N₂S₁Se₂, Cr₂Li₄N₆Sr₂, H₆F₆N₂Si₁, H₆F₁N₁O₂, H₆F₅N₂Sb₁, As₆Ba₄Cd₃Li₂, Ba₄Cd₃Li₂P₆, C₄H₁₂Cl₈Nb₂Se₂, H₈K₄O₄P₂Se₆, Ba₁O₇Sr₁Ta₂, Br₉Cs₅Nb₂S₄, Br₉Nb₂S₄Tl₅, Cl₈Cs₅I₁S₄U₂, Cl₉Cs₅Nb₂S₄, Cl₉Nb₂S₄Tl₅, F₁K₁Nb₂O₆Sr₁, H₁La₂Li₁O₃, La₁O₁₁Sr₂Ta₃, C₄N₄Pt₁Rb₂, Cs₁F₃Mo₁O₂, H₄Al₁F₅O₂Zn₁, K₁Na₂O₁₅Si₆Y₁, La₁Nb₂O₇Rb₁, Li₂O₇P₂Pd₁, O₁₄P₄Pd₃Tl₂, C₄Cd₁Hg₁N₄S₄, C₄Cd₁Hg₁N₄Se₄, C₄Cd₁N₄S₄Zn₁, C₄Cd₁N₄Se₄Zn₁, C₄Co₁Cs₁O₄, C₄Hg₁N₄S₄Zn₁, C₄Hg₁N₄Se₄Zn₁, Cl₁K₂Na₁O₆S₂, Ba₁O₇Si₂V₁, C₄H₈In₁K₁O₁₂, C₄H₈K₁Lu₁O₁₂, C₈K₁O₈Y₁, Cl₂K₅Na₁O₁₂S₄, Br₄Cs₂I₂Pd₁, Br₄I₂Pd₁Rb₂, Cl₄Cs₂I₂Pd₁, Ba₄Bi₃K₁O₁, Ba₄K₁O₁Sb₃, Ba₄O₁Rb₁Sb₃, As₂Cs₂O₈Th₁, Ce₁K₂O₈P₂, Cl₂Cs₂N₂O₆Pb₁, As₁K₁Ni₁O₄, As₁Na₁Ni₁O₄, As₂Ba₁Ni₂O₈, Ba₁Ni₂O₈P₂, C₄H₄Cd₁O₆, Ca₂Li₆Mn₂N₆, Br₁₅Cs₂La₁O₃Ta₆, Cl₁₈Cs₁Lu₁₁Nb₆, C₈H₂₄Cl₁₈N₂Nb₆, Ce₁O₁P₁Zn₁, H₁₂B₁₂Br₁Cs₃, H₁₂B₁₂Br₁K₃, H₁₂B₁₂Br₁Rb₃, H₁₂B₁₂Cl₁Cs₃, H₁₂B₁₂Cl₁Rb₃, H₁₂B₁₂Cs₃I₁, H₁₂B₁₂I₁K₃, H₁₂B₁₂I₁Rb₃, As₂Ba₆Na₂O₁₇Ru₂, Ba₅Br₂O₉Ru₂, Ba₆Na₂O₁₇Ru₂V₂, C₄Fe₂Na₆O₁₆S₁, Cs₃Mo₄O₁₆P₃, Ag₃Ge₃P₆Sn₂, Ag₃P₆Si₃Sn₂, C₄Cd₁K₂N₄, C₄Hg₁K₂N₄ and C₄K₂N₄Zn₁.

4. A method for converting a compound, which has been selected by a method comprising
a. identifying all topological insulators in an Inorganic Crystal Structure Database (“ICSD”),
b. calculating Real Space Invariants of valence bands for all these topological insulators,
c. identifying in all these topological insulators Wyckoff Positions where irreducible Wannier Charge Centers (WCCs) are localized, and then
d. selecting as potentially catalytic active compound a topological insulator wherein the Wyckoff Position of WCCs is not occupied by any atom (=Wyckoff Position of obstructed WCCs, =WP_{OAI}) of the topological insulator,
or,
which has been selected from the list consisting of:
Ba₁P₈, I₄P₂, Mn₁P₄, Nb₂Se₉, Os₁P₄, P₃Ru₁, P₄Ru₁, P₅Re₂, Re₁S₂, Re₁Se₂, S₂Tc₁, Lu₁P₅, P₅Y₁, As₁Ge₁, As₁Si₁, Ba₁P₃, Bi₁S₂, Bi₁Se₂, Br₄Nb₁, Br₆Si₂, C₂₂F₁₄, C₂Ca₁, Ca₅P₈, Cl₃Mo₁, Cl₃Y₂, Cl₄Nb₁, Cl₄Ta₁, Cs₅Te₃, Ga₁Te₁, Ge₁P₁, Hg₁O₂, In₁Se₁, K₁Sb₂, Na₁P₂, O₂Rb₂, P₃Sr₁, Rb₁Sb₂, Ag₁P₂, As₂Co₁, As₂Ir₁, As₂La₁, As₂Rh₁, Au₁O₁, B₂F₄, B₄Mn₁, Ca₁O₂, Cd₁P₄, Co₁P₂, Cs₁Te₄, Cs₂I₈, Cu₁P₂, Fe₁P₄, Fe₁S₁, Ga₂I₃, Hg₂N₆, Ir₁N₂, Ir₁P₂, Ir₁Sb₂, La₁P₇, La₁S₂, La₁Se₂, Li₂O₂, Mg₁P₄, N₂O₄, N₂S₂, O₂Tc₁, P₂Rh₁, P₇Pb₁, Rh₁Sb₂, Rh₁Si₁, Sb₁Zn₁, Ba₁S₂, Ba₁Se₂, C₂Ba₁, C₂Sr₁, I₆Pt₂, Ni₁P₂, O₂Si₁, P₂Pd₁, S₂Yb₁, S₄V₁, Se₃Tl₂, Se₉V₂, Te₃Tl₂, As₃Ca₄, Cs₂Te₂, K₂O₂, Rb₂Te₂, As₂Fe₁, As₂Os₁, As₂Ru₁, C₁N₁, Fe₁P₂, Fe₁S₂, Fe₁Sb₂, Fe₁Se₂, In₁S₁, N₂Pt₁, Os₁P₂, Os₁Sb₂, P₂Ru₁, Ru₁Sb₂, Ru₁Te₂, Ge₃Os₂, Ge₃Ru₂, Os₂Si₃, Ru₂Si₃, As₁Cd₁, As₁Zn₁, B₂Cl₄, C₂N₂, Cd₁Sb₁, Cl₁O₂, P₄Re₁, P₄Tc₁, Pd₁S₂, B₂Fe₁, Na₁P₅, P₃Re₁, P₃Tc₁, Ba₅P₄, Ba₅Sb₄, K₁Tl₁, Ba₁O₂, F₃La₁, As₆Cs₄, As₆Rb₄, Cs₄P₆, K₄P₆, P₆Rb₄, Al₂Ru₁, Ga₂Os₁, Ga₂Ru₁, C₂Li₂, C₂Na₂, Cs₂O₂, Cs₂S₂, Rb₂S₂, B₃Si₁, H₆Ru₁, O₆₄Si₃₂, K₅Te₃, B₁₀F₁₂, Li₁Si₁, C₁N₂, Cs₁In₃, Ga₃K₁, Ga₃Rb₁, H₈Si₁, C₂Mg₁, Fe₁Ga₃, Ga₃Os₁, Ga₃Ru₁, In₃Ru₁, Li₂S₂, B₄Os₁, Cl₂Zn₁, Hg₁I₂, Hg₂I₄, Al₂Os₁, As₁Ca₂, Bi₁Ca₂, Br₁Hg₁, Br₂Hg₂, Cl₂Hg₂, F₂Hg₂, Ga₃K₂, Hg₁I₁, Hg₂I₂, In₃Rb₂, O₂Sr₁, Ba₁Te₂, O₂Zn₁, S₂Sr₁, Au₁Br₁, Au₁Cl₁, O₃U₁, Br₁₂Zr₆, Cl₁₂Zr₆, I₁₂Zr₆, I₆Si₂, As₁B₆, As₂B₁₂, B₁₂P₂, B₁₂Si₃, B₆O₁, B₆P₁, Br₈Nb₃, C₁B₄, C₃B₁₂, Ga₁S₁, I₈Nb₃, Cr₁N₂, Ga₁Se₁, Mo₁N₂, N₂W₁, Ca₁P₁, Ca₂P₂, K₂S₂, K₂Se₂, Na₂O₂, Na₂S₂, P₁Sr₁, C₂Os₁, Hf₁N₂, K₂Te₂, Mo₁S₂, Mo₁Se₂, Mo₁Te₂, Na₁S₁, Na₂Se₂, S₂W₁, Se₂W₁, Te₂W₁, As₂Pt₁, Cd₁O₂, Cd₁S₂, Cd₁Se₂, Fe₁Te₂, Mg₁O₂, Mg₁Se₂, Mg₁Te₂, N₂Pd₁, Os₁S₂, Os₁Se₂, Os₁Te₂, P₂Pt₁, Ru₁S₂, Ru₁Se₂, S₂Zn₁, Se₂Zn₁, Ag₁Br₁, Ag₁Cl₁, Ag₁I₁, B₄Fe₁, Be₅Pt₁, Br₁Cu₁, Cd₁S₁, Cd₁Se₁, Cd₁Te₁, Cl₁Cu₁, Cu₁I₁, Cu₅Tb₁, O₁Zn₁, S₁Sn₁, S₁Zn₁, Se₁Zn₁, Te₁Zn₁, B₆Ca₁, B₆Si₁, B₆Sr₁ and B₁Li₁, Al₂Cd₂Cl₈, Al₄Cl₁₄Te₄, As₁Fe₁S₁, Au₁Br₈Te₁, B₁₈Cs₈Si₈, B₁₈Rb₈S₁, B₁₈Rb₈Se₁₈, B₈Br₆P₄, Bi₂Br₈Te₄, Bi₄Cl₁₆Te₁₄, Bi₆Cl₂₀Te₄, Br₁₂Ta₂Te₄, Br₁Mo₁Te₄, Br₂Nb₁S₂, Br₂Nb₁Se₂, C₂₂Co₆O₁₈, C₂I₁₀La₆, C₂O₄Pb₁, Cl₁₂Ta₂Te₄, Cl₁₈P₂Re₂, Cl₂Nb₁Se₂, Cl₅O₄Re₂, Cl₆Hf₁Te₄, Cl₈Ga₂Hg₂, Cs₁Sb₂Se₄, Cs₂S₆Sn₂, Cs₂S₈Sb₄, Cs₂Se₆Sn₂, Cs₄P₂Se₁₀, Cu₄P₃Se₄, F₁₂I₄Sb₂, F₁₂Sb₂Te₄, Ge₁Li₁Te₂, Ge₂Te₆Tl₆, Hg₁O₃V₁, Hg₂P₂S₆, I₁₂Nb₂Te₈, I₁Ta₁Te₄, In₂O₅P₁, K₂O₈S₂, K₂Sb₄Se₈, La₆O₁₈Re₄, Li₁Mo₁S₂, Mo₄N₁₄Sr₁₀, Na₂O₈S₂, Rb₂Sb₄Se₈, Si₂Te₆Tl₆, As₂Ga₂Sr₁, C₂Ca₁O₄, Al₂Na₇Sb₅, Ba₃P₆Si₄, Bi₉I₃Rh₂, Cl₇Nb₃Se₅, Ir₂Se₅Sn₁, K₄P₈Te₄, Al₁O₄W₁, As₁Cl₂Hg₂, As₂F₁₂I₄, As₃Ba₂Cd₂, As₃Sr₂Zn₂, Ba₅Cr₁N₅, Bi₄Br₂Ru₁, Br₁₀Te₄Zr₂, C₁B₂O₂, C₁N₁Th₁, C₂Br₂Gd₂, C₂La₂O₂, C₄Cs₂O₄, C₄Li₂O₄, C₄O₄Rb₂, Cd₁P₁S₃, Cd₂P₂S₆, Cd₆Sb₁₂Sr₁₁, Cl₂Hg₂P₁, Cl₂Nb₁S₂, Fe₁P₁S₃, Fe₂P₂S₆, Ge₁K₃S₃, Ge₂K₆S₆, Ge₂K₆Se₆, Hg₆O₇Si₂, I₂O₁Ta₁, K₆Si₂Te₆, Mg₁P₁S₃, Na₄P₂S₆, Ni₁P₁S₃, Ni₁P₁Se₃, Ni₂P₂S₆, P₁S₃Zn₁, P₂S₆V₂, P₂S₆Zn₂, P₆Si₈Zn₄, Hg₂Mo₂O₇, Hg₂O₄S₁, Hg₂O₄Se₁, Hg₄O₇P₂, K₂Mo₈O₁₆, Ag₅Ge₁O₄, As₁Cd₂Cl₂, As₁Fe₁Se₁, As₁Fe₁Te₁, As₁Ru₁Te₁, As₂Cs₄Te₆, As₂F₁₂Hg₄, As₂Hg₆O₁₀, As₂Hg₆O₈, Ba₁P₃Pt₂, Ba₂P₂S₆, Ba₂P₂Se₆, Ba₆P₆Sn₂, Bi₁Os₁Se₁, Br₁₄Ga₄Te₄, Br₃Hg₂Te₁, C₁D₁K₁O₃, C₂Ag₂O₄, C₂Cd₁O₄, C₂H₆O₆, C₂Li₂O₄, C₂Na₂O₄, C₂O₄Tl₂, C₂O₄Zn₁, C₄Na₂O₄, Ca₁Mo₅O₈, Ca₂P₂S₆, Ca₂P₂Se₆, Cd₂Cl₂P₁, Cl₁₄Ga₄Te₄, Cl₃Cu₁K₁, Cl₃Mo₁S₂, Cl₇O₃Re₂, Co₁K₂O₂, Cs₁O₅V₂, Cs₂O₈S₂, Cs₂Se₆Te₂, Cu₁La₂S₄, Fe₁P₁S₁, Fe₁P₁Se₁, Fe₁S₁Sb₁, Fe₁Sb₁Se₁, Fe₁Sb₁Te₁, Ge₂Na₆Se₆, Ge₂Na₆Te₆, H₄B₂O₄, Hg₁O₄Re₁, Hg₂N₂O₄, Hg₄N₂O₈, Hg₆O₈P₂, I₁Nb₂Te₆, In₄P₆S₁₈, K₄O₈P₂, K₆Se₆Sn₂, K₆Sn₂Te₆, Mo₅O₈Sr₁, Na₆Si₂Te₆, Os₁P₁S₁, Os₁P₁Se₁, Os₁S₁Sb₁, Os₁Sb₁Se₁, Os₁Sb₁Te₁, P₁Pb₁Se₃, P₁Ru₁S₁, P₁Ru₁Se₁, P₁Se₃Sn₁, P₂Pb₂S₆, P₂Pb₂Se₆, P₂S₆Sn₂, P₂S₆Sr₂, P₂Se₆Sn₂, P₂Se₆Sr₂, P₂Se₆Tl₄, Ru₁S₁Sb₁, Ru₁Sb₁Se₁, Ru₁Sb₁Te₁, Ag₂O₂Pb₁, As₁F₆I₅, As₃Br₁Cd₂, As₃Br₁Hg₂, As₃Cd₂I₁, As₆Ba₁Pt₄, As₆Pt₄Sr₁, Au₁Cl₁O₂, Au₁Cl₄Cs₁, Au₁Cl₄Rb₁, Au₁Cl₄Tl₁, Au₁F₄Li₁, Au₁Li₁S₁, B₂Li₂Se₅, Bi₃Cl₁O₄, Br₁Cd₂P₃, Br₂Hg₂O₆, C₂O₄Sn₁, C₄Ag₂O₄, Cd₂Cl₁P₃, Cd₂I₁P₃, Cd₂O₁₂P₄, Cl₁Hg₂O₁, Cl₁Hg₂P₃, Cl₂Hg₄O₂, Cl₄Os₁Sc₄, Cs₁F₇Sb₂, Cs₂Re₃Se₆, Cs₄Re₆S₁₃, Cs₄Re₆Se₁₃, Cs₄S₁₃Tc₆, Cs₄Se₁₃Tc₆, Cs₆Ge₂Se₆, Cs₆Ge₂Te₆, Cs₆Sn₂Te₆, Cu₂O₂Pb₁, Cu₂Re₃Se₆, Fe₂O₁₂P₄, Ge₂K₆Te₆, Hg₂P₂Se₆, K₂Re₃S₆, K₂Re₃Se₆, K₄Re₆Se₁₂, K₄Si₂Tc₆, K₄Se₁₂Tc₆, Mn₂Mo₁P₁₂, Na₂Nb₄O₁₁, Na₂Re₃S₆, Na₂Re₃Se₆, O₃Si₁Sr₁, O₄Pd₁S₁, O₄Pt₁S₁, O₇P₂Pd₂, P₆Pt₄Sr₁, Rb₂Re₃S₆, Rb₂Re₃Se₆, Rb₄Re₆Si₂, Rb₄Re₆S₁₃, Rb₄Re₆Se₁₂, Rb₄S₁₃Tc₆, Rb₄Se₁₂Tc₆, Re₃S₆Tl₂, Re₃Se₆Tl₂, Re₆Se₁₂Tl₄, Br₁₁Cs₁Nb₄, Br₁₁Nb₄Rb₁, Cl₁₁Cs₁Nb₄, Cl₁₁Nb₄Rb₁, Al₂Ca₅Sb₆, Al₂Cl₈Se₄, As₆Ca₅Ga₂, Ba₁Nb₈O₁₄, Ba₃O₁Sb₂, Ba₅In₂Sb₆, C₂K₂O₄, C₂O₄Rb₂, Ca₅In₂Sb₆, In₂Sb₆Sr₅, Nb₈O₁₄Sr₁, Ag₅O₄Si₁, Br₁Hg₂P₃, Nb₂Ni₁O₆, O₉P₂V₂, Al₂Cl₈Te₄, Au₁O₄S₁, Cl₂N₄S₆, Co₁Ge₁Te₁, Cu₁O₃Se₁, Cu₁P₂Se₁, Ge₁Rh₁Te₁, O₆P₂Tl₄, Pt₁Sb₁Si₁, Al₁K₁Sb₄, Al₁P₃Si₁, As₁La₁Te₁, As₂Hg₄O₇, Ba₁P₄Te₂, Cs₂Ge₁Te₄, Cs₂Sn₁Te₄, Ga₁K₁Sb₄, H₂B₁Li₁, La₁Mn₁S₃, La₁P₁S₁, P₁S₁Y₁, P₂Ru₂Th₁, I₁K₄P₂₁, I₁P₂₁Rb₄, B₁₂Li₂Si₂, B₂Ba₁Se₆, In₉K₁Na₃, La₂O₂S₂, Na₄P₂Se₆, Nb₁P₂S₈, F₆Pa₁Rb₁, Au₁Na₁S₁, Cs₂Ni₃S₄, Cs₂Ni₃Se₄, Cs₂Pd₃Se₄, Cs₂Pt₃S₄, Cs₂Pt₃Se₄, Li₂O₄U₁, Na₂O₄U₁, Ni₃Rb₂S₄, Pt₃Rb₂S₄, Au₁Cs₁F₄, Au₅Cs₇O₂, Au₅O₂Rb₇, Br₃Cs₁Li₂, Cl₂I₂Ta₁, Cl₃Cs₁Li₂, Hf₂N₂S₁, Li₂Ni₁O₂, Na₂O₃Ti₁, Na₂O₄Pd₃, O₃Pd₁Sr₂, Al₁B₁₄Li₁, Ba₁Ce₁O₃, C₂B₁₃Li₁, Cu₁₁K₃Te₁₆, O₄P₁Rh₁, O₄Si₁Zn₂, P₂S₆Th₁, P₂S₆Zr₁, Ba₉Br₃₄O₁Pr₆, Bi₄I₂Ru₁, La₄O₁₀Re₂, Br₂Cs₁F₁, C₂Ag₁K₁, C₂Au₁Cs₁, C₂Au₁K₁, C₂Au₁Na₁, C₂Au₁Rb₁, C₂Cu₁Rb₁, C₂Ag₁Cs₁, C₂Cu₁K₁, Cl₃O₁W₁, I₃O₁W₁, Li₆O₄Zn₁, Cl₆Hf₁Se₄, Cl₆Se₄Zr₁, Br₂Cs₂F₂, Cs₂I₆Pd₁, C₄Ba₁O₄, Ag₃Cu₁S₂, Ba₁Cu₂O₂, Ba₁O₇U₂, C₄O₄Pb₁, Cd₁In₂O₄, Cl₂O₁Pd₂, Cu₂O₂Sr₁, Al₁Si₁Te₃, B₁₂Br₁₂Cs₂, B₁₂Cl₁₂Cs₂, B₁₂Cs₂I₁₂, Cd₂P₂Se₆, Cs₈O₁Tl₈, Fe₁P₁Se₃, Fe₂P₂Se₆, Mg₂P₂Se₆, Nb₆O₁₂Ti₂, As₂Hg₂O₆, Ca₁O₆Os₂, O₆Ru₂Sr₁, C₂Cs₂Pd₁, C₂Cs₂Pt₁, C₂K₂Pd₁, C₂K₂Pt₁, C₂Na₂Pd₁, C₂Na₂Pt₁, C₂Pd₁Rb₂, C₂Pt₁Rb₂, H₂B₂Ca₁, Mg₃Nb₆O₁₁, O₂Pr₂S₁, O₂Pr₂Se₁, B₉Mg₁N₁, Cs₄O₁Tl₂, F₁Gd₁O₁, H₈F₄N₂, Br₉Os₂Rb₃, C₉Fe₂O₉, Mo₁S₁Se₁, Ag₂I₁₀Tl₆, Ba₅O₁₀Ru₂, Ca₁Ga₂P₂, Ca₁In₂P₂, Cl₉Cs₃Ru₂, Cl₉Cs₃Ti₂, Cs₃F₉Fe₂, Cs₃I₉Zr₂, In₂P₂Sr₁, K₁Nb₁S₂, K₁Nb₁Se₂, Li₁Nb₁O₂, Li₁Nb₁S₂, Na₁Nb₁O₂, Na₁Nb₁S₂, Na₁Nb₁Se₂, H₁₂B₁₂Cs₂, H₁₂B₁₂K₂, H₁₂B₁₂Rb₂, H₁₂B₁₂Tl₂, H₂₀B₁₂N₂, As₁Rb₃Se₁₆, K₃P₁Se₁₆, H₆Cl₂N₂, F₆O₂Pt₁, Ag₁Cu₄Tb₁, Au₁Sc₁Sn₁, Bi₁Co₁Zr₁, Bi₁Lu₁Ni₁, Bi₁Ni₁Sc₁, Bi₁Ni₁Y₁, Co₁Sb₁Ti₁, Cu₁Rb₁Te₁, Fe₁Nb₁Sb₁, Fe₁Sb₁V₁, Ge₁Pt₁Ti₁, Hf₁Ni₁Sn₁, Hf₁Pd₁Sn₁, Lu₁Ni₁Sb₁, Nb₁Ru₁Sb₁, Ni₁Sb₁Sc₁, Ni₁Sb₁Y₁, Ni₁Sn₁Ti₁, Ni₁Sn₁Zr₁, O₄S₁Zn₁, Pd₁Sb₁Sc₁, Pt₁Sb₁Sc₁, Pt₁Sb₁Y₁, Pt₁Sn₁Ti₁, Rh₁Sb₁Th₁, Ru₁Sb₁Ta₁, Ru₁Sb₁V₁, Ag₆Ge₁₀P₁₂, Nb₃Sb₂Te₅, In₃O₈P₂, Fe₂Ge₁Ti₁, H₆B₆Cs₂, H₆B₆K₂, Ag₂Mo₁O₄, Ag₆K₂S₄, Al₁Cs₁O₂, Al₁K₁O₂, Al₁O₂Rb₁, Al₂Cd₁O₄, Al₂Cd₁S₄, Al₂Cd₁Se₄, Al₂Hg₁S₄, Al₂Hg₁Se₄, Al₂O₄Zn₁, Al₂S₄Zn₁, Al₂Se₄Zn₁, As₄He₂O₆, Ba₂Ge₄S₁₀, Cd₁Ga₂O₄, Cd₁In₂S₄, Cd₁In₂Se₄, Cd₁Lu₂S₄, Cd₁Lu₂Se₄, Cd₁O₄Rh₂, Cd₁S₄Sc₂, Cd₁S₄Y₂, Cd₁Sc₂Se₄, Cd₁Se₄Y₂, Cd₂O₄Si₁, Cd₂O₄Sn₁, Cl₄Li₂Zn₁, Cs₁N₂Nb₁, Ga₂O₄Zn₁, Hg₁In₂S₄, In₂O₄Zn₁, In₂S₄Zn₁, K₈Sb₄Sn₁, Lu₂Mg₁S₄, Lu₂Mg₁Se₄, Mg₁O₄Rh₂, Mg₁Se₄Y₂, O₄Rh₂Zn₁, O₄Sn₁Zn₂, S₄Sc₂Zn₁, S₄Y₂Zn₁, Se₄Y₂Zn₁,
Ag₁Bi₁P₂S₆, As₁Cl₃F₆S₃, As₂Cd₁Ge₁K₁, As₂Cd₁Ge₁Rb₁, B₁₈Cs₄Hg₂Se₁₈, B₁₈Hg₂Rb₄Se₁₈, B₃Cu₁Li₃O₇, Br₁₀O₁Ta₂Te₄, C₁₀H₁₈Cu₂N₂O₁₀, C₁₀H₁₈N₂O₁₀Rh₂, C₁F₃Hg₁O₃S₁, C₁H₅Eu₁O₇P₁, C₁H₅Nd₁O₇P₁, C₁H₅O₇P₁Pr₁, C₂H₁₀Ga₂Ge₄N₂O₁₂, C₂H₂₆B₁₂N₈, C₂H₆Ca₁O₇, C₂H₆K₂O₁₃S₁U₁, C₂H₆O₁₂U₂, C₂H₈Br₃Cu₁N₁O₁, C₂H₈In₂O₁₄Se₂, C₃H₇F₁N₁O₅Sn₁, C₄H₁₁N₁O₁₀, C₄H₁₂Ba₂N₂O₁₀S₂, C₄H₁₂Fe₁O₆S₄, C₄H₁₂N₆O₁₄Se₂U₂, C₄H₁₄F₃N₁O₂V₁, C₄H₁₆Cl₆Cu₂N₂, C₄H₇Cs₁O₁₀, C₄H₇K₁O₁₀, C₅H₁₀N₁O₆, C₆F₆Na₄O₁₂Sn₄, C₆H₁₂Fe₁N₈O₈, C₆H₄Na₄Np₂O₁₈, C₈H₂₀N₆O₁₈S₂U₂, C₈H₂₈F₆N₂O₄V₂, C₈H₄K₆N₈O₆Os₂S₂, C₈I₂Mo₂O₈, Cl₁₀Mo₂N₄S₄, Cl₁₀Nb₂O₁Te₄, Cl₂N₄O₁₂S₁₀, Cs₂P₂Se₆Zn₁, Cu₁O₉Se₃Sr₂, Cu₂Na₂O₁₁Si₄, F₂N₂O₄Xe₁, F₂O₇Te₂V₂, H₁₀F₈In₂N₂O₂, H₁₂I₈Mg₁O₆, H₁₂Mg₁O₁₂S₂, H₁₂O₁₂S₂Zn₁, H₁₄Hg₂O₁₄Te₂, H₁₄N₄O₈S₂, H₁₆B₁₂Na₂O₁₄S₆, H₁₈O₁₂Se₄Sn₁Sr₂, H₂₄Li₂N₈Te₂, H₂₆B₂₀K₄O₄, H₃₂N₁₄Se₆Sn₂, H₃₄Cl₄Cr₂N₈O₆, H₄Cu₂Na₂O₁₃Si₄, H₆B₂F₈N₂, H₆Cs₂O₁₂P₄, H₆F₂₂N₂Sb₄, H₆O₁₂P₄Rb₂, H₈Na₆O₁₄P₄, K₄Mn₁Mo₃O₁₂, K₄N₂O₁₄S₄, Lu₁Na₁P₂S₆, Na₁P₂S₆Tb₁, Na₁P₂S₆Y₁, P₂Rb₂Se₆Zn₁, C₄H₃Cs₁O₁₄U₂, C₄H₅K₁O₁₅U₂, C₄H₅O₁₅Rb₁U₂, Cs₂Cu₂O₁₉Si₈, Cu₂Ge₄O₁₃Sc₂, K₃P₅Ru₁Se₁₀, Ag₂Br₆Hg₇P₈, Ag₂Hg₇I₆P₈, Au₂K₂P₂Se₆, Au₂La₄O₂P₄, Au₂P₂Se₆Tl₂, C₂Cl₂O₄Pb₂, C₂H₂Ag₁O₉S₁Tb₁, C₂H₄Ca₂Cl₂O₆, C₂H₆N₂Rb₂, C₄H₆B₁₂Cs₂I₁₂N₂, C₄H₈N₂O₄, H₂₀B₁₂Li₂O₄, In₁K₂P₂S₇, La₂P₄S₁₄Tl₄, C₈H₁₂Ag₂N₄O₄, Ag₁As₁K₁S₂, Ag₁Cu₁O₄P₁, Ag₂Cs₂P₂Se₆, Ag₂O₈P₂V₁, Ag₂P₂Se₆Tl₂, Al₁As₁Cu₁O₅, Al₁Cu₁O₈P₂Rb₁, Al₂Br₆N₂S₂, Al₂Br₆N₂Se₂, As₁F₆N₂S₃, Ba₁La₁Sb₂Se₆, Ba₁Mo₂O₁₆P₄, C₁₀F₄Mn₂O₈, Cl₂Bi₂O₁₂Ru₄, C₁O₆P₁Sn₂, C₂As₂F₁₂N₂Te₄, C₂Cl₁₀N₂Sb₂, C₂Cu₁O₆Tl₂, C₂F₆N₄O₆S₄Se₄, C₂F₆N₄O₆S₈, C₂H₁Cs₁O₄, C₂H₂Na₂O₆, C₂H₄Cs₂O₆, C₂H₄F₆O₆S₂Si₂, C₂H₄Fe₄O₁₄P₂, C₂H₄O₁₄P₂Zn₄, C₂H₆K₂N₂, C₂H₆K₄N₈O₁₀, C₃H₂Na₁O₇Zn₁, C₃H₃Ba₁O₇, C₄H₁₂Cl₈Nb₂S₂, C₄H₁₈B₂P₂, C₄H₂Fe₂O₆, C₄H₂O₈Tl₂, C₆H₁₀O₆Sn₁, C₆H₄Mg₂Na₂O₁₄, C₆O₁₆Rb₂U₂, Cd₁Mo₁O₆P₁, Cd₁P₂Rb₂Se₆, Cl₁₂Mo₂O₄P₂, Cs₂O₁₂P₂U₂, Cs₄O₂S₁₀V₂, Cu₁P₁Se₃Tl₁, Cu₂P₂S₆Tl₂, Cu₂P₂Se₆Tl₂, F₂N₄O₆S₈, Fe₁I₁N₂O₂, Fe₁K₂P₂S₆, Fe₁K₂P₂Se₆, Fe₂K₁O₈P₂, H₁₀Br₂N₂O₂, H₁₀N₂O₈P₂, H₁₂N₄O₄P₂, H₁₂O₆P₂Rb₄S₆, H₁₄Ni₁O₁₂P₂, H₂Hg₆N₄O₁₄, H₂O₆P₂Tl₂, H₃K₁O₆P₂, H₅O₇P₁V₁, H₆Cs₂N₂P₄, H₈K₄O₄P₂S₆, H₈Li₄O₁₂P₂, Hg₁K₂P₂Se₆, K₂Mg₁P₂Se₆, K₂P₂Se₆Zn₁, Li₂O₈P₂V₁, Mo₂O₁₆P₄Sr₁, Na₂O₈P₂V₁, Ni₁O₁₀P₂V₂, Ag₃P₄Si₂Tl₅, Ba₁In₂O₁₄P₄, Ba₁La₂O₁₄Te₅, Ba₁O₈P₂Th₁, Ba₂Gd₂O₁₃Si₄, Bi₂Cl₈Hg₃Te₂, C₁Ag₂Cl₁N₁O₄S₁, C₂Ag₁N₂Na₁, C₂F₆Na₂O₄Sb₂, C₂H₂Cs₂O₅, C₂H₂K₂O₅, C₂H₂K₂O₆, C₂H₂O₅Rb₂, C₂H₄B₂O₂, C₂H₆Fe₁N₂O₄, C₂H₈Cl₃Cu₁N₁, C₂H₈I₂N₄S₂, C₂N₂O₆S₂, C₄H₁₂Mg₁O₆S₄, C₄H₁₆F₄Mn₁N₁O₂, C₄H₄O₁₀Th₁, C₄H₆Ba₁O₁₀, C₄H₆Cd₁O₂S₄, C₄H₆Na₂O₇, C₄H₆O₇Sr₁, C₄H₈Cd₁Cl₂N₂, C₄H₈O₁₂Th₁, C₄H₈O₈Zn₁, C₆H₆Ag₃Co₁N₈, Cd₃Na₂O₁₀Si₃, Cl₃Na₂O₁₂Te₄Y₃, Cu₁Mo₂O₈Sb₁, Eu₁O₈Rb₁S₂, F₉K₅O₄U₂, H₁₄Na₃Np₁O₁₂, H₂F₄K₁Mn₁O₁, H₂F₄Mn₁O₁Rb₁, H₄Ca₂O₁₃P₃V₁, H₄F₄O₂Rb₁V₁, H₈Ni₁O₁₀V₂, Hg₁In₁S₃Tl₁, Hg₁O₇P₂Pd₁, K₂Rb₂Re₆S₁₃, K₄Mo₈O₅₂P₁₂, O₁₄Sr₃Te₄U₁, As₂Cl₃Hg₃Tl₁, Br₃Hg₃Sb₂Tl₁, H₈Cs₄O₄P₂Se₆, H₈O₄P₂Rb₄Se₆, La₂O₈S₂Ta₃, Cl₁N₂S₁Se₂, Cr₂Li₄N₆Sr₂, H₆F₆N₂Si₁, H₆F₁N₁O₂, H₆F₅N₂Sb₁, As₆Ba₄Cd₃Li₂, Ba₄Cd₃Li₂P₆, C₄H₁₂Cl₈Nb₂Se₂, H₈K₄O₄P₂Se₆, Ba₁O₇Sr₁Ta₂, Br₉Cs₅Nb₂S₄, Br₉Nb₂S₄Tl₅, Cl₈Cs₅I₁S₄U₂, Cl₉Cs₅Nb₂S₄, Cl₉Nb₂S₄Tl₅, F₁K₁Nb₂O₆Sr₁, H₁La₂Li₁O₃, La₁O₁₁Sr₂Ta₃, C₄N₄Pt₁Rb₂, Cs₁F₃Mo₁O₂, H₄Al₁F₅O₂Zn₁, K₁Na₂O₁₅Si₆Y₁, La₁Nb₂O₇Rb₁, Li₂O₇P₂Pd₁, O₁₄P₄Pd₃Tl₂, C₄Cd₁Hg₁N₄S₄, C₄Cd₁Hg₁N₄Se₄, C₄Cd₁N₄S₄Zn₁, C₄Cd₁N₄Se₄Zn₁, C₄CO₁Cs₁O₄, C₄Hg₁N₄S₄Zn₁, C₄Hg₁N₄Se₄Zn₁, Cl₁K₂Na₁O₆S₂, Ba₁O₇Si₂V₁, C₄H₈In₁K₁O₁₂, C₄H₈K₁Lu₁O₁₂, C₈K₁O₈Y₁, Cl₂K₅Na₁O₁₂S₄, Br₄Cs₂I₂Pd₁, Br₄I₂Pd₁Rb₂, Cl₄Cs₂I₂Pd₁, Ba₄Bi₃K₁O₁, Ba₄K₁O₁Sb₃, Ba₄O₁Rb₁Sb₃, As₂Cs₂O₈Th₁, Ce₁K₂O₈P₂, Cl₂Cs₂N₂O₆Pb₁, As₁K₁Ni₁O₄, As₁Na₁Ni₁O₄, As₂Ba₁Ni₂O₈, Ba₁Ni₂O₈P₂, C₄H₄Cd₁O₆, Ca₂Li₆Mn₂N₆, Br₁₅Cs₂La₁O₃Ta₆, Cl₁₈Cs₁Lu₁Nb₆, C₈H₂₄Cl₁₈N₂Nb₆, Ce₁O₁P₁Zn₁, H₁₂B₁₂Br₁Cs₃, H₁₂B₁₂Br₁K₃, H₁₂B₁₂Br₁Rb₃, H₁₂B₁₂Cl₁Cs₃, H₁₂B₁₂Cl₁Rb₃, H₁₂B₁₂Cs₃I₁, H₁₂B₁₂I₁K₃, H₁₂B₁₂I₁Rb₃, As₂Ba₆Na₂O₁₇Ru₂, Ba₅Br₂O₉Ru₂, Ba₆Na₂O₁₇Ru₂V₂, C₄Fe₂Na₆O₁₆S₁, Cs₃Mo₄O₁₆P₃, Ag₃Ge₃P₆Sn₂, Ag₃P₆Si₃Sn₂, C₄Cd₁K₂N₄, C₄Hg₁K₂N₄ and C₄K₂N₄Zn₁,
and which compound does not provide a surface with at least one metal surface state, into a compound which provides a surface with at least one metal surface state, by cutting or growing a crystal of this compound in a predefined crystallographic direction thereby revealing the at least one metal surface state, wherein the predefined crystallographic direction is the direction of the normal vector (h,k,l) of the surface plane f(x, y, z)=0 which cuts through the Wyckoff Position of obstructed WCCs (=WP_{OAI}), but stays away from the Wyckoff Position(s) of the atoms of the selected topological insulator (=occupied Wyckoff Position(s), =WP_{OCC}), which condition is fulfilled when:
$$\{ \begin{matrix}( h , k , l ) \cdot ( x - {X}_{j} , y - {Y}_{j} , - {Z}_{j} ) = 0 , \\ ( h , k , l ) \cdot ( x - {x}_{i} , y - {y}_{i} , z - {z}_{i} ) \neq 0 , \\ h , k , l ϵ Z\end{matrix}$$
with the obstructed WCCs localized at
WP_{OAI}={Xⱼ,Yⱼ,Zⱼ|RSIⱼ≠0,j∉occupied positions} and
atoms of the selected potentially catalytic active compound occupying
WP_{occ}γ{xᵢ,yᵢ,zᵢ|i∈occupied positions}.

5. The method according to claim 1, wherein the topological insulator compound is characterized by an indirect band gap in the bulk of 0.001 to 7.000 eV.

6. The method according to claim 1, wherein the metal surface state is located within 0.3 to 0.7 e-Volts above or below the Fermi level.

7. A catalyst selected from a list consisting of the following compounds:
Ba₁P₈, I₄P₂, Mn₁P₄, Nb₂Se₉, Os₁P₄, P₃Ru₁, P₄Ru₁, P₅Re₂, Re₁S₂, Re₁Se₂, S₂Tc₁, Lu₁P₅, P₅Y₁, As₁Ge₁, As₁Si₁, Ba₁P₃, Bi₁S₂, Bi₁Se₂, Br₄Nb₁, Br₆Si₂, C₂₂F₁₄, C₂Ca₁, Ca₅P₈, Cl₃Mo₁, Cl₃Y₂, Cl₄Nb₁, Cl₄Ta₁, Cs₅Te₃, Ga₁Te₁, Ge₁P₁, Hg₁O₂, In₁Se₁, K₁Sb₂, Na₁P₂, O₂Rb₂, P₃Sr₁, Rb₁Sb₂, Ag₁P₂, As₂Co₁, As₂Ir₁, As₂La₁, As₂Rh₁, Au₁O₁, B₂F₄, B₄Mn₁, Ca₁O₂, Cd₁P₄, Co₁P₂, Cs₁Te₄, Cs₂I₈, Cu₁P₂, Fe₁P₄, Fe₁S₁, Ga₂I₃, Hg₂N₆, Ir₁N₂, Ir₁P₂, Ir₁Sb₂, La₁P₇, La₁S₂, La₁Se₂, Li₂O₂, Mg₁P₄, N₂O₄, N₂S₂, O₂Tc₁, P₂Rh₁, P₇Pb₁, Rh₁Sb₂, Rh₁Si₁, Sb₁Zn₁, Ba₁S₂, Ba₁Se₂, C₂Ba₁, C₂Sr₁, I₆Pt₂, Ni₁P₂, O₂Si₁, P₂Pd₁, S₂Yb₁, S₄V₁, Se₃Tl₂, Se₉V₂, Te₃Tl₂, As₃Ca₄, Cs₂Te₂, K₂O₂, Rb₂Te₂, As₂Fe₁, As₂Os₁, As₂Ru₁, C₁N₁, Fe₁P₂, Fe₁S₂, Fe₁Sb₂, Fe₁Se₂, In₁S₁, N₂Pt₁, Os₁P₂, Os₁Sb₂, P₂Ru₁, Ru₁Sb₂, Ru₁Te₂, Ge₃Os₂, Ge₃Ru₂, Os₂Si₃, Ru₂Si₃, As₁Cd₁, As₁Zn₁, B₂Cl₄, C₂N₂, Cd₁Sb₁, Cl₁O₂, P₄Re₁, P₄Tc₁, Pd₁S₂, B₂Fe₁, Na₁P₅, P₃Re₁, P₃Tc₁, Ba₅P₄, Ba₅Sb₄, K₁Tl₁, Ba₁O₂, F₃La₁, As₆Cs₄, As₆Rb₄, Cs₄P₆, K₄P₆, P₆Rb₄, Al₂Ru₁, Ga₂Os₁, Ga₂Ru₁, C₂Li₂, C₂Na₂, Cs₂O₂, Cs₂S₂, Rb₂S₂, B₃Si₁, H₆Ru₁, O₆₄Si₃₂, K₅Te₃, B₁₀F₁₂, Li₁Si₁, C₁N₂, Cs₁In₃, Ga₃K₁, Ga₃Rb₁, H₈Si₁, C₂Mg₁, Fe₁Ga₃, Ga₃Os₁, Ga₃Ru₁, In₃Ru₁, Li₂S₂, B₄Os₁, Cl₂Zn₁, Hg₁I₂, Hg₂I₄, Al₂Os₁, As₁Ca₂, Bi₁Ca₂, Br₁Hg₁, Br₂Hg₂, Cl₂Hg₂, F₂Hg₂, Ga₃K₂, Hg₁I₁, Hg₂I₂, In₃Rb₂, O₂Sr₁, Ba₁Te₂, O₂Zn₁, S₂Sr₁, Au₁Br₁, Au₁Cl₁, O₃U₁, Br₁₂Zr₆, Cl₁₂Zr₆, I₁₂Zr₆, I₆Si₂, As₁B₆, As₂B₁₂, B₁₂P₂, B₁₂Si₃, B₆O₁, B₆P₁, Br₈Nb₃, C₁B₄, C₃B₁₂, Ga₁S₁, I₈Nb₃, Cr₁N₂, Ga₁Se₁, Mo₁N₂, N₂W₁, Ca₁P₁, Ca₂P₂, K₂S₂, K₂Se₂, Na₂O₂, Na₂S₂, P₁Sr₁, C₂Os₁, Hf₁N₂, K₂Te₂, Mo₁S₂, Mo₁Se₂, Mo₁Te₂, Na₁S₁, Na₂Se₂, S₂W₁, Se₂W₁, Te₂W₁, As₂Pt₁, Cd₁O₂, Cd₁S₂, Cd₁Se₂, Fe₁Te₂, Mg₁O₂, Mg₁Se₂, Mg₁Te₂, N₂Pd₁, Os₁S₂, Os₁Se₂, Os₁Te₂, P₂Pt₁, Ru₁S₂, Ru₁Se₂, S₂Zn₁, Se₂Zn₁, Ag₁Br₁, Ag₁Cl₁, Ag₁I₁, B₄Fe₁, Be₅Pt₁, Br₁Cu₁, Cd₁S₁, Cd₁Se₁, Cd₁Te₁, Cl₁Cu₁, Cu₁I₁, Cu₅Tb₁, O₁Zn₁, S₁Sn₁, S₁Zn₁, Se₁Zn₁, Te₁Zn₁, B₆Ca₁, B₆Si₁, B₆Sr₁ and B₁Li₁, Al₂Cd₂Cl₈, Al₄Cl₁₄Te₄, As₁Fe₁S₁, Au₁Br₈Te₁, B₁₈Cs₈S₁₈, B₁₈Rb₈S₁, B₁₈Rb₈Se₁₈, B₈Br₆P₄, Bi₂Br₈Te₄, Bi₄Cl₁₆Te₁₄, Bi₆Cl₂₀Te₄, Br₁₂Ta₂Te₄, Br₁Mo₁Te₄, Br₂Nb₁S₂, Br₂Nb₁Se₂, C₂₂Co₆O₁₈, C₂I₁₀La₆, C₂O₄Pb₁, Cl₁₂Ta₂Te₄, Cl₁₈P₂Re₂, Cl₂Nb₁Se₂, Cl₅O₄Re₂, Cl₆Hf₁Te₄, Cl₈Ga₂Hg₂, Cs₁Sb₂Se₄, Cs₂S₆Sn₂, Cs₂S₈Sb₄, Cs₂Se₆Sn₂, Cs₄P₂Se₁₀, Cu₄P₃Se₄, F₁₂I₄Sb₂, F₁₂Sb₂Te₄, Ge₁Li₁Te₂, Ge₂Te₆Tl₆, Hg₁O₃V₁, Hg₂P₂S₆, I₁₂Nb₂Te₈, I₁Ta₁Te₄, In₂O₅P₁, K₂O₈S₂, K₂Sb₄Se₈, La₆O₁₈Re₄, Li₁Mo₁S₂, Mo₄N₁₄Sr₁₀, Na₂O₈S₂, Rb₂Sb₄Se₈, Si₂Te₆Tl₆, As₂Ga₂Sr₁, C₂Ca₁O₄, Al₂Na₇Sb₅, Ba₃P₆Si₄, Bi₉I₃Rh₂, Cl₇Nb₃Se₅, Ir₂Se₅Sn₁, K₄P₈Te₄, Al₁O₄W₁, As₁Cl₂Hg₂, As₂F₁₂I₄, As₃Ba₂Cd₂, As₃Sr₂Zn₂, Ba₅Cr₁N₅, Bi₄Br₂Ru₁, Br₁₀Te₄Zr₂, C₁B₂O₂, C₁N₁Th₁, C₂Br₂Gd₂, C₂La₂O₂, C₄Cs₂O₄, C₄Li₂O₄, C₄O₄Rb₂, Cd₁P₁S₃, Cd₂P₂S₆, Cd₆Sb₁₂Sr₁₁, Cl₂Hg₂P₁, Cl₂Nb₁S₂, Fe₁P₁S₃, Fe₂P₂S₆, Ge₁K₃S₃, Ge₂K₆S₆, Ge₂K₆Se₆, Hg₆O₇Si₂, I₂O₁Ta₁, K₆Si₂Te₆, Mg₁P₁S₃, Na₄P₂S₆, Ni₁P₁S₃, Ni₁P₁Se₃, Ni₂P₂S₆, P₁S₃Zn₁, P₂S₆V₂, P₂S₆Zn₂, P₆Si₈Zn₄, Hg₂Mo₂O₇, Hg₂O₄S₁, Hg₂O₄Se₁, Hg₄O₇P₂, K₂Mo₈O₁₆, Ag₅Ge₁O₄, As₁Cd₂Cl₂, As₁Fe₁Se₁, As₁Fe₁Te₁, As₁Ru₁Te₁, As₂Cs₄Te₆, As₂F₁₂Hg₄, As₂Hg₆O₁₀, As₂Hg₆O₈, Ba₁P₃Pt₂, Ba₂P₂S₆, Ba₂P₂Se₆, Ba₆P₆Sn₂, Bi₁Os₁Se₁, Br₁₄Ga₄Te₄, Br₃Hg₂Te₁, C₁D₁K₁O₃, C₂Ag₂O₄, C₂Cd₁O₄, C₂H₆O₆, C₂Li₂O₄, C₂Na₂O₄, C₂O₄Tl₂, C₂O₄Zn₁, C₄Na₂O₄, Ca₁Mo₅O₈, Ca₂P₂S₆, Ca₂P₂Se₆, Cd₂Cl₂P₁, Cl₁₄Ga₄Te₄, Cl₃Cu₁K₁, Cl₃Mo₁S₂, Cl₇O₃Re₂, Co₁K₂O₂, Cs₁O₅V₂, Cs₂O₈S₂, Cs₂Se₆Te₂, Cu₁La₂S₄, Fe₁P₁S₁, Fe₁P₁Se₁, Fe₁S₁Sb₁, Fe₁Sb₁Se₁, Fe₁Sb₁Te₁, Ge₂Na₆Se₆, Ge₂Na₆Te₆, H₄B₂O₄, Hg₁O₄Re₁, Hg₂N₂O₄, Hg₄N₂O₈, Hg₆O₈P₂, I₁Nb₂Te₆, In₄P₆S₁₈, K₄O₈P₂, K₆Se₆Sn₂, K₆Sn₂Te₆, Mo₅O₈Sr₁, Na₆Si₂Te₆, Os₁P₁S₁, Os₁P₁Se₁, Os₁S₁Sb₁, Os₁Sb₁Se₁, Os₁Sb₁Te₁, P₁Pb₁Se₃, P₁Ru₁S₁, P₁Ru₁Se₁, P₁Se₃Sn₁, P₂Pb₂S₆, P₂Pb₂Se₆, P₂S₆Sn₂, P₂S₆Sr₂, P₂Se₆Sn₂, P₂Se₆Sr₂, P₂Se₆Tl₄, Ru₁S₁Sb₁, Ru₁Sb₁Se₁, Ru₁Sb₁Te₁, Ag₂O₂Pb₁, As₁F₆I₅, As₃Br₁Cd₂, As₃Br₁Hg₂, As₃Cd₂I₁, As₆Ba₁Pt₄, As₆Pt₄Sr₁, Au₁Cl₁O₂, Au₁Cl₄Cs₁, Au₁Cl₄Rb₁, Au₁Cl₄Tl₁, Au₁F₄Li₁, Au₁Li₁S₁, B₂Li₂Se₅, Bi₃Cl₁O₄, Br₁Cd₂P₃, Br₂Hg₂O₆, C₂O₄Sn₁, C₄Ag₂O₄, Cd₂Cl₁P₃, Cd₂I₁P₃, Cd₂O₁₂P₄, Cl₁Hg₂O₁, Cl₁Hg₂P₃, Cl₂Hg₄O₂, Cl₄Os₁Sc₄, Cs₁F₇Sb₂, Cs₂Re₃Se₆, Cs₄Re₆S₁₃, Cs₄Re₆Se₁₃, Cs₄S₁₃Tc₆, Cs₄Se₁₃Tc₆, Cs₆Ge₂Se₆, Cs₆Ge₂Te₆, Cs₆Sn₂Te₆, Cu₂O₂Pb₁, Cu₂Re₃Se₆, Fe₂O₁₂P₄, Ge₂K₆Te₆, Hg₂P₂Se₆, K₂Re₃S₆, K₂Re₃Se₆, K₄Re₆Se₁₂, K₄Si₂Tc₆, K₄Se₁₂Tc₆, Mn₂Mo₁P₁₂, Na₂Nb₄O₁₁, Na₂Re₃S₆, Na₂Re₃Se₆, O₃Si₁Sr₁, O₄Pd₁S₁, O₄Pt₁S₁, O₇P₂Pd₂, P₆Pt₄Sr₁, Rb₂Re₃S₆, Rb₂Re₃Se₆, Rb₄Re₆Si₂, Rb₄Re₆S₁₃, Rb₄Re₆Se₁₂, Rb₄S₁₃Tc₆, Rb₄Se₁₂Tc₆, Re₃S₆Tl₂, Re₃Se₆Tl₂, Re₆Se₁₂Tl₄, Br₁₁Cs₁Nb₄, Br₁₁Nb₄Rb₁, Cl₁₁Cs₁Nb₄, Cl₁₁Nb₄Rb₁, Al₂Ca₅Sb₆, Al₂Cl₈Se₄, As₆Ca₅Ga₂, Ba₁Nb₈O₁₄, Ba₃O₁Sb₂, Ba₅In₂Sb₆, C₂K₂O₄, C₂O₄Rb₂, Ca₅In₂Sb₆, In₂Sb₆Sr₅, Nb₈O₁₄Sr₁, Ag₅O₄Si₁, Br₁Hg₂P₃, Nb₂Ni₁O₆, O₉P₂V₂, Al₂Cl₈Te₄, Au₁O₄Si, Cl₂N₄S₆, Co₁Ge₁Te₁, Cu₁O₃Se₁, Cu₁P₂Se₁, Ge₁Rh₁Te₁, O₆P₂Tl₄, Pt₁Sb₁Si₁, Al₁K₁Sb₄, Al₁P₃Si₁, As₁La₁Te₁, As₂Hg₄O₇, Ba₁P₄Te₂, Cs₂Ge₁Te₄, Cs₂Sn₁Te₄, Ga₁K₁Sb₄, H₂B₁Li₁, La₁Mn₁S₃, La₁P₁S₁, P₁S₁Y₁, P₂Ru₂Th₁, I₁K₄P₂₁, I₁P₂₁Rb₄, B₁₂Li₂Si₂, B₂Ba₁Se₆, In₉K₁Na₃, La₂O₂S₂, Na₄P₂Se₆, Nb₁P₂S₈, F₆Pa₁Rb₁, Au₁Na₁S₁, Cs₂Ni₃S₄, Cs₂Ni₃Se₄, Cs₂Pd₃Se₄, Cs₂Pt₃S₄, Cs₂Pt₃Se₄, Li₂O₄U₁, Na₂O₄U₁, Ni₃Rb₂S₄, Pt₃Rb₂S₄, Au₁Cs₁F₄, Au₅Cs₇O₂, Au₅O₂Rb₇, Br₃Cs₁Li₂, Cl₂I₂Ta₁, Cl₃Cs₁Li₂, Hf₂N₂S₁, Li₂Ni₁O₂, Na₂O₃Ti₁, Na₂O₄Pd₃, O₃Pd₁Sr₂, Al₁B₁₄Li₁, Ba₁Ce₁O₃, C₂B₁₃Li₁, Cu₁₁K₃Te₁₆, O₄P₁Rh₁, O₄Si₁Zn₂, P₂S₆Th₁, P₂S₆Zr₁, Ba₉Br₃₄O₁Pr₆, Bi₄I₂Ru₁, La₄O₁₀Re₂, Br₂Cs₁F₁, C₂Ag₁K₁, C₂Au₁Cs₁, C₂Au₁K₁, C₂Au₁Na₁, C₂Au₁Rb₁, C₂Cu₁Rb₁, C₂Ag₁Cs₁, C₂Cu₁K₁, Cl₃O₁W₁, I₃O₁W₁, Li₆O₄Zn₁, Cl₆Hf₁Se₄, Cl₆Se₄Zr₁, Br₂Cs₂F₂, Cs₂I₆Pd₁, C₄Ba₁O₄, Ag₃Cu₁S₂, Ba₁Cu₂O₂, Ba₁O₇U₂, C₄O₄Pb₁, Cd₁In₂O₄, Cl₂O₁Pd₂, Cu₂O₂Sr₁, Al₁Si₁Te₃, B₁₂Br₁₂Cs₂, B₁₂Cl₁₂Cs₂, B₁₂Cs₂₁I₂, Cd₂P₂Se₆, Cs₈O₁Tl₈, Fe₁P₁Se₃, Fe₂P₂Se₆, Mg₂P₂Se₆, Nb₆O₁₂Ti₂, As₂Hg₂O₆, Ca₁O₆Os₂, O₆Ru₂Sr₁, C₂Cs₂Pd₁, C₂Cs₂Pt₁, C₂K₂Pd₁, C₂K₂Pt₁, C₂Na₂Pd₁, C₂Na₂Pt₁, C₂Pd₁Rb₂, C₂Pt₁Rb₂, H₂B₂Ca₁, Mg₃Nb₆O₁₁, O₂Pr₂S₁, O₂Pr₂Se₁, B₉Mg₁N₁, Cs₄O₁Tl₂, F₁Gd₁O₁, H₈F₄N₂, Br₉Os₂Rb₃, C₉Fe₂O₉, Mo₁S₁Se₁, Ag₂I₁₀Tl₆, Ba₅O₁₀Ru₂, Ca₁Ga₂P₂, Ca₁In₂P₂, Cl₉Cs₃Ru₂, Cl₉Cs₃Ti₂, Cs₃F₉Fe₂, Cs₃I₉Zr₂, In₂P₂Sr₁, K₁Nb₁S₂, K₁Nb₁Se₂, Li₁Nb₁O₂, Li₁Nb₁S₂, Na₁Nb₁O₂, Na₁Nb₁S₂, Na₁Nb₁Se₂, H₁₂B₁₂Cs₂, H₁₂B₁₂K₂, H₁₂B₁₂Rb₂, H₁₂B₁₂Tl₂, H₂₀B₁₂N₂, As₁Rb₃Se₁₆, K₃P₁Se₁₆, H₆Cl₂N₂, F₆O₂Pt₁, Ag₁Cu₄Tb₁, Au₁Sc₁Sn₁, Bi₁Co₁Zr₁, Bi₁Lu₁Ni₁, Bi₁Ni₁Sc₁, Bi₁Ni₁Y₁, Co₁Sb₁Ti₁, Cu₁Rb₁Te₁, Fe₁Nb₁Sb₁, Fe₁Sb₁V₁, Ge₁Pt₁Ti₁, Hf₁Ni₁Sn₁, Hf₁Pd₁Sn₁, Lu₁Ni₁Sb₁, Nb₁Ru₁Sb₁, Ni₁Sb₁Sc₁, Ni₁Sb₁Y₁, Ni₁Sn₁Ti₁, Ni₁Sn₁Zr₁, O₄S₁Zn₁, Pd₁Sb₁Sc₁, Pt₁Sb₁Sc₁, Pt₁Sb₁Y₁, Pt₁Sn₁Ti₁, Rh₁Sb₁Th₁, Ru₁Sb₁Ta₁, Ru₁Sb₁V₁, Ag₆Ge₁₀P₁₂, Nb₃Sb₂Te₅, In₃O₈P₂, Fe₂Ge₁Ti₁, H₆B₆Cs₂, H₆B₆K₂, Ag₂Mo₁O₄, Ag₆K₂S₄, Al₁Cs₁O₂, Al₁K₁O₂, Al₁O₂Rb₁, Al₂Cd₁O₄, Al₂Cd₁S₄, Al₂Cd₁Se₄, Al₂Hg₁S₄, Al₂Hg₁Se₄, Al₂O₄Zn₁, Al₂S₄Zn₁, Al₂Se₄Zn₁, As₄He₂O₆, Ba₂Ge₄S₁₀, Cd₁Ga₂O₄, Cd₁In₂S₄, Cd₁In₂Se₄, Cd₁Lu₂S₄, Cd₁Lu₂Se₄, Cd₁O₄Rh₂, Cd₁S₄Sc₂, Cd₁S₄Y₂, Cd₁Sc₂Se₄, Cd₁Se₄Y₂, Cd₂O₄Si₁, Cd₂O₄Sn₁, Cl₄Li₂Zn₁, Cs₁N₂Nb₁, Ga₂O₄Zn₁, Hg₁In₂S₄, In₂O₄Zn₁, In₂S₄Zn₁, K₈Sb₄Sn₁, Lu₂Mg₁S₄, Lu₂Mg₁Se₄, Mg₁O₄Rh₂, Mg₁Se₄Y₂, O₄Rh₂Zn₁, O₄Sn₁Zn₂, S₄Sc₂Zn₁, S₄Y₂Zn₁, Se₄Y₂Zn₁,
Ag₁Bi₁P₂S₆, As₁Cl₃F₆S₃, As₂Cd₁Ge₁K₁, As₂Cd₁Ge₁Rb₁, Bi₈Cs₄Hg₂Se₁₈, B₁₈Hg₂Rb₄Se₁₈, B₃Cu₁Li₃O₇, Br₁₀O₁Ta₂Te₄, C₁₀H₁₈Cu₂N₂O₁₀, C₁₀H₁₈N₂O₁₀Rh₂, C₁F₃Hg₁O₃S₁, C₁H₅Eu₁O₇P₁, C₁H₅Nd₁O₇P₁, C₁H₅O₇P₁Pr₁, C₂H₁₀Ga₂Ge₄N₂O₁₂, C₂H₂₆B₁₂N₈, C₂H₆Ca₁O₇, C₂H₆K₂O₁₃S₁U₁, C₂H₆O₁₂U₂, C₂H₈Br₃Cu₁N₁O₁, C₂H₈In₂O₁₄Se₂, C₃H₇F₁N₁O₅Sn₁, C₄H₁₁N₁O₁₀, C₄H₁₂Ba₂N₂O₁₀S₂, C₄H₁₂Fe₁O₆S₄, C₄H₁₂N₆O₁₄Se₂U₂, C₄H₁₄F₃N₁O₂V₁, C₄H₁₆Cl₆Cu₂N₂, C₄H₇Cs₁O₁₀, C₄H₇K₁O₁₀, C₅H₁₀N₁O₆, C₆F₆Na₄O₁₂Sn₄, C₆H₁₂Fe₁N₈O₈, C₆H₄Na₄Np₂O₁₈, C₈H₂₀N₆O₁₈S₂U₂, C₈H₂₈F₆N₂O₄V₂, C₈H₄K₆N₈O₆Os₂S₂, C₈I₂Mo₂O₈, Cl₁₀Mo₂N₄S₄, Cl₁₀Nb₂O₁Te₄, Cl₂N₄O₁₂S₁₀, Cs₂P₂Se₆Zn₁, Cu₁O₉Se₃Sr₂, Cu₂Na₂O₁₁Si₄, F₂N₂O₄Xe₁, F₂O₇Te₂V₂, H₁₀F₈In₂N₂O₂, H₁₂I₈Mg₁O₆, H₁₂Mg₁O₁₂S₂, H₁₂O₁₂S₂Zn₁, H₁₄Hg₂O₁₄Te₂, H₁₄N₄O₈S₂, H₁₆B₁₂Na₂O₁₄S₆, H₁₈O₁₂Se₄Sn₁Sr₂, H₂₄Li₂N₈Te₂, H₂₆B₂₀K₄O₄, H₃₂N₁₄Se₆Sn₂, H₃₄Cl₄Cr₂N₈O₆, H₄Cu₂Na₂O₁₃Si₄, H₆B₂F₈N₂, H₆Cs₂O₁₂P₄, H₆F₂₂N₂Sb₄, H₆O₁₂P₄Rb₂, H₈Na₆O₁₄P₄, K₄Mn₁Mo₃O₁₂, K₄N₂O₁₄S₄, Lu₁Na₁P₂S₆, Na₁P₂S₆Tb₁, Na₁P₂S₆Y₁, P₂Rb₂Se₆Zn₁, C₄H₃Cs₁O₁₄U₂, C₄H₅K₁O₁₅U₂, C₄H₅O₁₅Rb₁U₂, Cs₂Cu₂O₁₉Si₈, Cu₂Ge₄O₁₃Sc₂, K₃P₅Ru₁Se₁₀, Ag₂Br₆Hg₇P₈, Ag₂Hg₇I₆P₈, Au₂K₂P₂Se₆, Au₂La₄O₂P₄, Au₂P₂Se₆Tl₂, C₂Cl₂O₄Pb₂, C₂H₂Ag₁O₉S₁Tb₁, C₂H₄Ca₂Cl₂O₆, C₂H₆N₂Rb₂, C₄H₆B₁₂Cs₂I₁₂N₂, C₄H₈N₂O₄, H₂₀B₁₂Li₂O₄, In₁K₂P₂S₇, La₂P₄S₁₄Tl₄, C₈H₁₂Ag₂N₄O₄, Ag₁As₁K₁S₂, Ag₁Cu₁O₄P₁, Ag₂Cs₂P₂Se₆, Ag₂O₈P₂V₁, Ag₂P₂Se₆Tl₂, Al₁As₁Cu₁O₅, Al₁Cu₁O₈P₂Rb₁, Al₂Br₆N₂S₂, Al₂Br₆N₂Se₂, As₁F₆N₂S₃, Ba₁La₁Sb₂Se₆, Ba₁Mo₂O₁₆P₄, C₁₀F₄Mn₂O₈, C₁₂Bi₂O₁₂Ru₄, C₁O₆P₁Sn₂, C₂As₂F₁₂N₂Te₄, C₂Cl₁₀N₂Sb₂, C₂Cu₁O₆Tl₂, C₂F₆N₄O₆S₄Se₄, C₂F₆N₄O₆S₈, C₂H₁Cs₁O₄, C₂H₂Na₂O₆, C₂H₄Cs₂O₆, C₂H₄F₆O₆S₂Si₂, C₂H₄Fe₄O₁₄P₂, C₂H₄O₁₄P₂Zn₄, C₂H₆K₂N₂, C₂H₆K₄N₈O₁₀, C₃H₂Na₁O₇Zn₁, C₃H₃Ba₁O₇, C₄H₁₂Cl₈Nb₂S₂, C₄H₁₈B₂P₂, C₄H₂Fe₂O₆, C₄H₂O₈Tl₂, C₆H₁₀O₆Sn₁, C₆H₄Mg₂Na₂O₁₄, C₆O₁₆Rb₂U₂, Cd₁Mo₁O₆P₁, Cd₁P₂Rb₂Se₆, Cl₁₂Mo₂O₄P₂, Cs₂O₁₂P₂U₂, Cs₄O₂S₁₀V₂, Cu₁P₁Se₃Tl₁, Cu₂P₂S₆Tl₂, Cu₂P₂Se₆Tl₂, F₂N₄O₆S₈, Fe₁I₁N₂O₂, Fe₁K₂P₂S₆, Fe₁K₂P₂Se₆, Fe₂K₁O₈P₂, H₁₀Br₂N₂O₂, H₁₀N₂O₈P₂, H₁₂N₄O₄P₂, H₁₂O₆P₂Rb₄S₆, H₁₄Ni₁O₁₂P₂, H₂Hg₆N₄O₁₄, H₂O₆P₂Tl₂, H₃K₁O₆P₂, H₅O₇P₁V₁, H₆Cs₂N₂P₄, H₈K₄O₄P₂S₆, H₈Li₄O₁₂P₂, Hg₁K₂P₂Se₆, K₂Mg₁P₂Se₆, K₂P₂Se₆Zn₁, Li₂O₈P₂V₁, Mo₂O₁₆P₄Sr₁, Na₂O₈P₂V₁, Ni₁O₁₀P₂V₂, Ag₃P₄Si₂Tl₅, Ba₁In₂O₁₄P₄, Ba₁La₂O₁₄Te₅, Ba₁O₈P₂Th₁, Ba₂Gd₂O₁₃Si₄, Bi₂Cl₈Hg₃Te₂, C₁Ag₂Cl₁N₁O₄S₁, C₂Ag₁N₂Na₁, C₂F₆Na₂O₄Sb₂, C₂H₂Cs₂O₅, C₂H₂K₂O₅, C₂H₂K₂O₆, C₂H₂O₅Rb₂, C₂H₄B₂O₂, C₂H₆Fe₁N₂O₄, C₂H₈Cl₃Cu₁N₁, C₂H₈I₂N₄S₂, C₂N₂O₆S₂, C₄H₁₂Mg₁O₆S₄, C₄H₁₆F₄Mn₁N₁O₂, C₄H₄O₁₀Th₁, C₄H₆Ba₁O₁₀, C₄H₆Cd₁O₂S₄, C₄H₆Na₂O₇, C₄H₆O₇Sr₁, C₄H₈Cd₁Cl₂N₂, C₄H₈O₁₂Th₁, C₄H₈O₈Zn₁, C₆H₆Ag₃Co₁N₈, Cd₃Na₂O₁₀Si₃, Cl₃Na₂O₁₂Te₄Y₃, Cu₁Mo₂O₈Sb₁, Eu₁O₈Rb₁S₂, F₉K₅O₄U₂, H₁₄Na₃Np₁O₁₂, H₂F₄K₁Mn₁O₁, H₂F₄Mn₁O₁Rb₁, H₄Ca₂O₁₃P₃V₁, H₄F₄O₂Rb₁V₁, H₈Ni₁O₁₀V₂, Hg₁In₁S₃Tl₁, Hg₁O₇P₂Pd₁, K₂Rb₂Re₆S₁₃, K₄Mo₈O₅₂P₁₂, O₁₄Sr₃Te₄U₁, As₂Cl₃Hg₃Tl₁, Br₃Hg₃Sb₂Tl₁, H₈Cs₄O₄P₂Se₆, H₈O₄P₂Rb₄Se₆, La₂O₈S₂Ta₃, Cl₁N₂S₁Se₂, Cr₂Li₄N₆Sr₂, H₆F₆N₂Si₁, H₆F₁N₁O₂, H₆F₅N₂Sb₁, As₆Ba₄Cd₃Li₂, Ba₄Cd₃Li₂P₆, C₄H₁₂Cl₈Nb₂Se₂, H₈K₄O₄P₂Se₆, Ba₁O₇Sr₁Ta₂, Br₉Cs₅Nb₂S₄, Br₉Nb₂S₄Tl₅, Cl₈Cs₅I₁S₄U₂, Cl₉Cs₅Nb₂S₄, Cl₉Nb₂S₄Tl₅, F₁K₁Nb₂O₆Sr₁, H₁La₂Li₁O₃, La₁O₁₁Sr₂Ta₃, C₄N₄Pt₁Rb₂, Cs₁F₃Mo₁O₂, H₄Al₁F₅O₂Zn₁, K₁Na₂O₁₅Si₆Y₁, La₁Nb₂O₇Rb₁, Li₂O₇P₂Pd₁, O₁₄P₄Pd₃Tl₂, C₄Cd₁Hg₁N₄S₄, C₄Cd₁Hg₁N₄Se₄, C₄Cd₁N₄S₄Zn₁, C₄Cd₁N₄Se₄Zn₁, C₄CO₁Cs₁O₄, C₄Hg₁N₄S₄Zn₁, C₄Hg₁N₄Se₄Zn₁, Cl₁K₂Na₁O₆S₂, Ba₁O₇Si₂V₁, C₄H₈In₁K₁O₁₂, C₄H₈K₁Lu₁O₁₂, C₈K₁O₈Y₁, Cl₂K₅Na₁O₁₂S₄, Br₄Cs₂I₂Pd₁, Br₄I₂Pd₁Rb₂, Cl₄Cs₂I₂Pd₁, Ba₄Bi₃K₁O₁, Ba₄K₁O₁Sb₃, Ba₄O₁Rb₁Sb₃, As₂Cs₂O₈Th₁, Ce₁K₂O₈P₂, Cl₂Cs₂N₂O₆Pb₁, As₁K₁Ni₁O₄, As₁Na₁Ni₁O₄, As₂Ba₁Ni₂O₈, Ba₁Ni₂O₈P₂, C₄H₄Cd₁O₆, Ca₂Li₆Mn₂N₆, Br₁₅Cs₂La₁O₃Ta₆, Cl₁₈Cs₁Lu₁Nb₆, C₈H₂₄Cl₁₈N₂Nb₆, Ce₁O₁P₁Zn₁, H₁₂B₁₂Br₁Cs₃, H₁₂Bi₂Br₁K₃, H₁₂B₁₂Br₁Rb₃, H₁₂B₁₂C₁Cs₃, H₁₂B₂Cl₁Rb₃, H₁₂B₁₂Cs₃I₁, H₁₂B₁₂I₁K₃, H₁₂B₂₁I₁Rb₃, As₂Ba₆Na₂O₁₇Ru₂, Ba₅Br₂O₉Ru₂, Ba₆Na₂O₁₇Ru₂V₂, C₄Fe₂Na₆O₁₆S₁, Cs₃Mo₄O₁P₃, Ag₃Ge₃P₆Sn₂, Ag₃P₆Si₃Sn₂, C₄Cd₁K₂N₄, C₄Hg₁K₂N₄ and C₄K₂N₄Zn₁,
wherein a crystal of the selected compound is grown in a predefined crystallographic direction (characterized by its h,k,l-indices); or is cut in a predefined crystallographic direction (characterized by its h,k,l-indices),
wherein the predefined crystallographic direction is the direction of the normal vector (h,k,l) of the surface plane f(x, y, z)=0 which cuts through the Wyckoff Position of obstructed WCCs (=WP_{OAI}), but stays away from the Wyckoff Position(s) of the atoms of the selected topological insulator (=occupied Wyckoff Position(s), =WP_{OCC}), which condition is fulfilled when:
$$\{ \begin{matrix}( h , k , l ) \cdot ( x - {X}_{j} , y - {Y}_{j} , - {Z}_{j} ) = 0 , \\ ( h , k , l ) \cdot ( x - {x}_{i} , y - {y}_{i} , z - {z}_{i} ) \neq 0 , \\ h , k , l ϵ Z\end{matrix}$$
with the obstructed WCCs localized at
WP_{OAI}={Xⱼ,Yⱼ,Zⱼ|RSIⱼ≠0,j∉occupied positions} and
atoms of the selected potentially catalytic active compound occupying
WP_{occ}={xᵢ,yᵢ,zᵢ|i∈occupied positions}.

8. A water splitting, ammonia synthesis, CO₂ reduction or oxygen reduction catalyst comprising a the catalyst of claim 7.

9. The method according to claim 6, wherein the metal surface state is located within 0.4 to 0.6 eV above or below the Fermi level.

10. The method according to claim 6, wherein the metal surface state is located within about 0.5 eV above or below the Fermi level.

11. The water splitting, ammonia synthesis, CO2 reduction or oxygen reduction catalyst according to claim 8, wherein the water splitting catalyst is an Oxygen Evolution Reaction (“OER”) catalyst and/or a Hydrogen Evolution Reaction (“HER”) catalyst and the oxygen reduction catalyst is a fuel cell catalyst.
